(19) United States
(12) Patent Application Publication
(10) Pub. No.: US 2010/0175685 A1
(43) Pub. Date: Jul. 15, 2010

(54) Advanced Tracking Concentrator Employing Rotating Input Arrangement and Method

(76) Inventors: Robert Owen Campbell, Boulder, CO (US); Michael George Machado, Boulder, CO (US)

Correspondence Address: PRITZKAU PATENT GROUP, LLC, 993 GAPTER ROAD, BOULDER, CO, 80303, US

(21) Appl. No.: 12/685,529

(22) Filed: Jan. 11, 2010

Related U.S. Application Data
(63) Continuation-in-part of application No. 12/502,085, filed on Jul. 13, 2009.
(60) Provisional application No. 61/080,554, filed on Jul. 14, 2008.

(51) Int. Cl. F24J 2/38; F24J 2/08; F24J 2/00; B23P 15/26

(52) U.S. Cl. 126/601; 126/700; 126/714; 29/890.033

(57) ABSTRACT

Solar concentrators are arranged in an array to define an input aperture such that the solar collector is positionable to face the input aperture of the concentrators skyward. An input axis of rotation extends through the aperture in the skyward direction, and a focus region is smaller than the aperture. Each concentrator includes at least one optical arrangement that is supported for rotation about the input axis for tracking the sun within a predetermined range of positions of the sun using no more than the rotation of the optical arrangement around the input axis. An optical concentrator is described in which a receiving direction extends at an acute angle from an optical axis and in one azimuthal direction outward from the optical axis such that a component of the concentrator is rotatable about the optical axis for alignment to receive input light. A previously unknown inverted off-axis lens is described.

### RELATED APPLICATION

The present application is a Continuation-in-Part of U.S. patent application Ser. No. 12/502,085 entitled TRACKING CONCENTRATOR EMPLOYING INVERTED OFF-AXIS OPTICS AND METHOD, filed on Jul. 13, 2009, which itself claims priority from U.S. Provisional Patent Application Ser. No. 61/080,554 filed on Jul. 14, 2008, entitled Tracking Concentrator Employing Inverted Off-Axis Optics, both of which are incorporated herein by reference in their entirety.

### BACKGROUND

The present invention is generally related to collecting and concentrating solar energy and, more particularly, to apparatus and methods for receiving and concentrating light, for example sunlight, for subsequent use as some form of power.

Applicants recognize that in the field of solar energy that one of the greatest challenges to overcome is the diffuse or low density nature of the energy from the sun. Roughly, on the Earth's surface, each kilowatt of energy from the sun is spread over 1 square meter of area. Currently, the most common solar technologies use the sunlight directly to convert the incoming solar radiation into heat or electricity. At an energy density of only 1 kilowatt/m², (100 milliwatts/cm²), the energy converter often must cover large areas in order to gather and convert a significant amount of energy. Applicants appreciate that the cost of covering a large area with a traditional energy converter can be prohibitive. For example, traditional photovoltaic panels often utilize large areas of expensive semiconductor materials, and solar-thermal converters often utilize large areas of costly metals. In each of these examples, high costs may often render such installations as impractical at least from the standpoint of cost.

One approach to address this problem includes the use of solar concentrators to allow a designer to leverage the energy converter material through the use of relatively low cost reflective or refractive material for focusing solar power to be received by the converter in a more concentrated form as compared to traditional non-concentrating solar collectors. The use of concentrators may reduce the amount of expensive converter material needed in a given application.

FIG. 1 illustrates a diagrammatic elevation view of a conventional concentrating solar collector generally indicated by reference number 10. Solar collector 10 utilizes a parabolic reflector 13 that defines an input aperture having a circular input area with diameter D aligned for receiving solar energy carried by incoming rays sunlight 14. The parabolic reflector is configured for receiving sunlight and focusing the sunlight within a focus region 16 that is substantially smaller than the input area. A receiver 19 is configured for collecting the focused sunlight and for converting it to another form of energy (not shown). For example the receiver could include a photovoltaic (PV) cell for converting the energy directly into electricity, or the receiver could include a solar liquid heater configured for heating water to convert the solar energy into thermal energy.

It is noted that concentrators may be constructed using refractive material. For example, a Fresnel lens may be used to reduce the amount of material required. A description of Fresnel lenses may be found in “Nonimaging Fresnel Lenses: Design and Performance of Solar Concentrators” by Ralf Leutz and Akio Suzuki; published by Springer and which is incorporated by reference.

Attention is now turned to FIG. 2 with ongoing reference to FIG. 1. FIG. 2 illustrates a diagrammatic elevational view of a concentrating solar collector, generally indicated by reference number 20, utilizing a refractive Fresnel lens 23 as a concentrator, having a circular input area with diameter D, aligned for receiving incoming rays of sunlight 14 configured for concentrating the sunlight to a focusing region 16 that is substantially smaller than the input area. As discussed previously with reference to solar collector 10, the focused sunlight is collected by receiver 19 for conversion to a form of energy such as heat or electricity.

As will be described at appropriate points hereinafter, Applicants recognize that while conventional concentrators in some cases may be advantageous from a cost standpoint, at least as compared with systems utilizing non-concentrating collectors, they are not entirely without problems. In some applications, the use of concentrating collectors may introduce specific challenges that are unique to concentrating systems. In other some cases the use of concentration may at least exacerbate problems and/or challenges that may be associated with conventional non-concentrating solar collectors such as PV cells.

The foregoing examples of the related art and limitations related therewith are intended to be illustrative and not exclusive. Other limitations of the related art will become apparent to those of ordinary skill in the art upon a reading of the specification and a study of the drawings.

### SUMMARY

The following embodiments and aspects thereof are described and illustrated in conjunction with systems, tools, and methods which are meant to be exemplary and illustrative, not limiting in scope. In various embodiments, one or more of the above described problems have been reduced or eliminated, while other embodiments are directed to other improvements.

In general, a solar collector is described. In one embodiment, one or more solar concentrators are arranged in an array such that each of the concentrators is in a fixed position in the array. Each of the concentrators is configured to define (i) an input aperture having an input area such that the solar collector is positionable to face the input aperture of each concentrator in a skyward direction such that the input aperture is oriented to receive sunlight from the sun, (ii) an input axis of rotation that extends through the aperture in the skyward direction, and (iii) a focus region that is substantially smaller than the aperture area. Each of the concentrators includes an optical assembly having at least one optical arrangement that is supported for rotation about the input axis for tracking the sun within a predetermined range of positions of the sun using no more than the rotation of the optical arrangement around the input axis such that the rotation does not change the direction of the aperture from the skyward direction. Furthermore, for any specific one of the positions within the predetermined range of positions, the optical arrangement is rotatably oriented, as at least part of the tracking, at a corresponding rotational orientation as at least part of concentrating the received sunlight within the focus region, for subsequent collection and use as solar energy.

In one feature, the optical arrangement serves as an input arrangement for initially receiving the sunlight, and the optical assembly includes an additional optical arrangement following the input arrangement. The additional arrangement is positioned to accept the sunlight from the input arrangement and is configured for rotation about an additional axis of rotation. The input arrangement and the additional arrangement are configured to cooperate with one another in performing the tracking based at least in part on a predetermined relationship between (i) the rotation of the input arrangement about the input axis of rotation and (ii) rotation of the additional arrangement about the additional axis of rotation to focus the received sunlight into the focus region.

In another feature, the input optical arrangement is configured for bending the received sunlight for acceptance by the additional optical arrangement, and the additional optical arrangement is configured for accepting and redirecting the bent light to cause the focusing.

In one embodiment of an optical concentrator, an optical assembly includes one or more optical arrangements. One of the optical arrangements is an input optical arrangement, and the optical assembly is configured for defining (i) an input aperture having an input area for receiving a plurality of input light rays, (ii) an optical axis passing through a central region within the input aperture, (iii) a focus region having a surface area that is substantially smaller than the input area and is located at an output position along the optical axis offset from the input aperture such that the optical axis passes through the focus region, and (iv) a receiving direction defined as a vector that is characterized by a predetermined acute receiving angle with respect to the optical axis such that the optical axis and the receiving direction define a plane. The receiving direction extends in one azimuthal direction outward from the optical axis in the plane such that at least the input arrangement is rotatable about the optical axis for alignment of the receiving direction to receive a plurality of input light rays that are each at least approximately antiparallel with the vector. The optical assembly is further configured for focusing the plurality of input light rays to converge toward the optical axis until reaching the focus region such that the input light is concentrated at the focus region.

In one feature, the focus region includes a given area and, for at least some of the input light that is characterized by at least a particular amount of misalignment with the receiving direction, that input light is rejected by falling outside of the given area of the focus region.

In an additional feature, the optical assembly includes an additional optical arrangement following the input arrangement, and the input arrangement is configured for bending the received light rays for acceptance by the additional arrangement. In one implementation, the additional arrangement can be a CPC configured to accept the light rays from the input arrangement, and the CPC is configured to cause the focusing. In another implementation, the additional arrangement can be an IOA configured to accept the light rays from the input arrangement, and the IOA is configured to cause the focusing.

In one aspect, an inverted off axis lens includes an optical arrangement having an at least generally planar configuration defining (i) a planar input surface having an input surface area and (ii) an axis of rotation that is at least generally perpendicular thereto. The optical arrangement is configured for defining an acceptance direction as a vector that is characterized by a predetermined acute acceptance angle with respect to the axis of rotation such that the axis of rotation and the acceptance direction define a plane. The acceptance direction extends in one fixed azimuthal direction outward from the axis of rotation in the plane such that the optical arrangement is rotatable about the axis for alignment of the acceptance direction to accept a plurality of input light rays that are each at least approximately antiparallel with the vector. The inverted off axis lens is further configured for transmissively passing the plurality of input light rays through the optical arrangement while focusing the plurality of input light rays to converge toward one another until reaching a focus region that is substantially smaller than the input surface area such that the input light is concentrated at the focus region.

In one embodiment of a solar concentrator, the solar concentrator includes the inverted off axis lens arranged in a series relationship following an input optical arrangement with the input surface of the off axis lens facing towards the input arrangement. The inverted off axis lens and the input arrangement are each configured for selective rotation to cooperate with one another such that the input arrangement initially receives the incoming light rays and bends the incoming light rays to produce intermediate light rays for acceptance by the inverted off-axis lens such that the intermediate light rays are at least approximately oriented antiparallel to the acceptance direction. The inverted off axis lens is aligned for accepting the intermediate light rays such that the intermediate light rays serve as the input light rays for the inverted off axis lens and the inverted off axis lens concentrates the intermediate light rays at the focus region of the inverted off-axis lens.

In one embodiment, the inverted off axis lens is a multi-element inverted off-axis optical assembly including an optical assembly having two or more optical arrangements. One of the optical arrangements is a first arrangement that defines (i) an input aperture having an input area and (ii) an axis of rotation that is at least generally perpendicular thereto. The optical arrangements are configured to cooperate with one another for defining an acceptance direction as a vector that is characterized by a predetermined acute acceptance angle with respect to the axis of rotation such that the axis of rotation and the acceptance direction define a plane. The acceptance direction extends in one azimuthal direction outward from the axis of rotation in the plane, and at least the first arrangement is supported for motion that is limited to rotation about the axis of rotation for alignment of the acceptance direction to accept the plurality of input light rays that are each at least approximately anti parallel with the vector. The optical arrangements are further configured for focusing the plurality of input light rays to converge toward one another until reaching a focus region that is substantially smaller than the input surface area such that the input light is concentrated at the focus region.

In one embodiment, a concentrating optical element and associated method are described. The concentrating optical element is configured for receiving and concentrating a plurality of input light rays that are each oriented at least approximately parallel with one another. The concentrating optical element includes a first single-axis focusing arrangement at least generally defining (i) a first plane having an input area, (ii) a first reference direction within the first plane, and (iii) a first orthogonal reference direction within the first plane and perpendicular to the first reference direction. The first arrangement is configured to accept the plurality of input light rays in the parallel orientations and to redirect at least a majority of the light rays in a way that causes the majority of the light rays to converge towards one another along the first reference direction substantially without converging the light rays along the first orthogonal reference direction. The concentrating element further includes a second single-axis focusing arrangement at least generally defining (i) a second plane, (ii) a second reference direction within the second plane, and (iii) a second orthogonal reference direction within the second plane and perpendicular to the second reference direction. The second optical arrangement is aligned in a series relationship following the first arrangement and is configured for receiving the majority of light rays from the first arrangement and for further redirecting the majority of light rays in a way that causes the majority of light rays to converge toward one another along the second reference direction substantially without causing convergence of the light rays along the second orthogonal direction and without substantially influencing the convergence of the light rays along the first reference direction. The second reference direction is azimuthally offset with respect to the first reference direction by a particular azimuthal angle such that the convergence along the first reference direction and the convergence along the second reference direction cooperatively cause the majority of light rays to concentrate within a focus region having an area that is smaller than the input area. In one feature, the concentrating optical element is configured as an inverted off-axis optical element. The first arrangement and the second arrangement are positioned in series along an axis of rotation that is at least approximately centered with respect to the first and second arrangements. The first and second arrangements are cooperatively configured to accept the input rays of light oriented in an acceptance direction characterized by (i) a fixed orientation with respect to the first reference direction and (ii) a fixed acute angle with respect to the central axis, and at least a selected one of the first and second arrangements is configured to bend the light, along a corresponding one of the first and second reference directions, such that the focus region is centered on the central axis.

In another embodiment, a concentrating optical element and associated method are described. The concentrating optical element defines a receiving surface and is configured for receiving a plurality of input rays of light that are parallel with one another and incident on the receiving surface with a specific input orientation with respect to the concentrating element. The concentrating element is further configured for concentrating the input rays of light into a focus region that is smaller than a surface area of the receiving surface such that any given transverse extent across the focus region is substantially smaller than a corresponding transverse extent across the receiving surface. The concentrating optical element includes a plurality of sub-elements transversely distributed in side-by-side relationships with one another to cooperatively define the receiving surface having a surface area such that each sub-element (i) defines one of a plurality of segments of the surface area that is aligned for receiving a corresponding subset of the plurality of input rays of light that is incident on the segment, and (ii) is configured for transmissively redirecting the corresponding subset of light rays toward the focus region such that the plurality of sub-elements cooperate with one another to cause the concentrating of the input rays into the focus region. For any selected one of the sub-elements that is associated with a selected segment, individual ones of the rays in the corresponding subset impinge on different positions from one another on the selected segment of surface area to redirect all the rays in the corresponding subset in a predetermined orientation with respect to the input orientation. The selected sub-element is further configured to redirect all the rays in the subset in the same way such that (i) the predetermined orientation is the same for all of the rays in the corresponding subset, and (ii) the predetermined orientation is independent of the different positions. In one feature, the concentrating optical element is configured such that each sub-element defines a corresponding interface, as the segment of the surface area of that sub-element, between a first optical medium having a first index of refraction and a second optical medium having a second index of refraction. The second index of refraction is different from the first index of refraction, and for any selected one of the sub-elements the corresponding interface is aligned such that all rays in the corresponding subset pass transmissively through that interface from the first optical medium to the second optical medium. The interface of the selected sub-element is configured to cause the redirecting, by optical refraction, based at least in part on the difference between the first index of refraction and the second index of refraction. In one aspect, the first optical medium is one of an optical material and a gas, and the second optical medium is the other one of the optical material and the gas. In another feature, the concentrating optical element is configured to serve as an inverted off-axis optical element wherein the plurality of subsections cooperatively define a central axis that passes through a central region of the receiving surface, and the plurality of subsections is cooperatively configured to accept the input rays of light oriented in an acceptance direction characterized by (i) a fixed acute angle with respect to the central axis, and (ii) a fixed azimuthal orientation with respect to the off-axis optical element. The concentrating element is further configured to bend at least some of the rays of light, as at least part of the redirecting, for centering the focus region such that the central axis passes through the focus region.

In yet another embodiment, an inverted off-axis lens, and associated method are described. The inverted off-axis lens includes an optical arrangement having an at least generally planar configuration defining (i) an input surface having an input surface area and (ii) an optical axis that is at least generally perpendicular thereto. The optical arrangement is configured for defining an acceptance direction as a vector that is characterized by a predetermined acute acceptance angle with respect to the optical axis such that the optical axis and the acceptance direction define a plane, and which acceptance direction extends in one fixed azimuthal direction outward from the optical axis in the plane such that the optical arrangement is rotatable about the axis for alignment of the acceptance direction. The optical arrangement is further configured for receiving a plurality of input rays of light that are parallel with one another, at least to within an approximation, and oriented with an acute input angle with respect to the optical axis. The optical arrangement is supported for rotation about the optical axis and is yet further configured for operation in one of a first mode and a second mode, such that a selected one of the modes of operation is based at least in part on the acute input angle. In the first mode, the acute input angle matches the acute acceptance angle of the acceptance direction, and the optical arrangement is rotatably aligned to accept the plurality of parallel light rays such that the rays are each at least approximately antiparallel with the vector. In the first mode, the optical arrangement transmissively passes the plurality of input light rays therethrough while focusing the plurality of input light rays to converge toward one another until reaching an on-axis focus region that is smaller than the input surface and is at least approximately centered on the axis. In the second mode, the input rays of light are sufficiently misaligned with respect to the acceptance direction such that the optical arrangement focuses the plurality of light rays to converge toward one another until reaching an off-axis focus region that is smaller than the input surface area and is spaced apart from the optical axis in an azimuthal direction that depends on the rotational alignment of the optical arrangement such that the off-axis focus region is movable, by rotational of the optical arrangement, along an arcuate path having a shape that is depends at least in part on the input angle.

In still another embodiment, an optical concentrator and associated method are described. The optical concentrator is provided for receiving and concentrating a plurality of input rays of light that are parallel with one another. The optical concentrator includes an at least generally planar input optical arrangement defining an input aperture having an input area and an input axis that is approximately orthogonal with the planar input area, and the input optical arrangement is configured for receiving and redirecting the rays of light. The optical concentrator further includes an additional optical arrangement, in a series relationship following the input optical arrangement, defining an output axis and configured for accepting the rays of light from the input arrangement and for further redirecting the rays of light. The input optical arrangement and the additional optical arrangement are configured to cooperate with one another for defining (i) a focus region having a surface area that is smaller than the input area and is located at an output position along the output axis offset from the additional optical arrangement and opposite the input optical arrangement such that the output axis passes through the focus region, and (ii) a receiving direction defined as a vector that is characterized by a predetermined acute receiving angle with respect to the input axis such that the input axis and the receiving direction define a plane, and which receiving direction extends in one fixed azimuthal direction outward from the input axis and in the plane such that at least the input arrangement is supported at least for rotation to align the receiving direction to receive the input light rays that each are at least approximately antiparallel with the vector. The input optical arrangement and the additional optical arrangement are further configured to cooperate with one another to focus the plurality of input light rays to converge toward the output axis until reaching the focus region such that the input light is concentrated at the focus region. The input arrangement is tilted with respect to the additional arrangement such that the input axis is tilted by an acute tilt angle with respect to the output axis, and the rotation of the input arrangement, for the rotational alignment of the receiving direction, includes at least one of (i) azimuthal rotation of the input arrangement about the input axis and (ii) precession of the input arrangement about the output axis. In one feature, the input arrangement of the optical concentrator is tilted with respect to the additional arrangement such that the input axis is tilted by an acute tilt angle with respect to the output axis. The rotation of the input arrangement, for the rotational alignment of the receiving direction, includes at least one of (i) azimuthal rotation of the input arrangement about the input axis and (ii) precession of the input arrangement about the output axis.

In a continuing embodiment, a dual-tracking solar collector and an associated method are described. The dual-tracking solar collector is provided for tracking the sun throughout a portion of a given day. The dual-tracking solar collector includes a group of solar concentrators, each of which concentrators is configured to define (i) an input aperture having an input area, and (ii) a focus region that is smaller than the input area. All of the solar concentrators are supported by a support structure that is movable to face the input aperture of each concentrator in a skyward direction such that each input aperture receives sunlight. Each concentrator includes at least one optical arrangement having an adjustable orientation with respect to the support structure and each concentrator is configured to redirect the received light, responsive to the orientation of the optical arrangement, at least for concentrating the received sunlight to produce concentrated sunlight that is focused into the focus region of each concentrator. An external tracking arrangement is in mechanical communication with the support structure and configured for tracking the sun, during the portion of the given day as the sun moves through a predetermined range of positions, by moving the support structure for simultaneously tilting all of the input apertures towards the sun. An internal tracking arrangement is supported by the support structure and in mechanical communication with each optical arrangement. The internal tracking arrangement is configured to cause additional tracking of the sun by adjusting the orientation of each optical arrangement, in a way that changes throughout the portion of the given day, to influence the redirecting of the sunlight such that a total amount of collected sunlight is concentrated into each focus region, as an accumulation of all of the concentrated sunlight throughout the portion of the given day, and the total amount of collected sunlight is greater than a different amount sunlight that would be otherwise be collected without the additional tracking. Each solar concentrator includes an input axis of rotation that extends through the aperture in the skyward direction. The optical arrangement of each concentrator is supported for rotation about the input axis of the concentrator such that the rotation serves as the adjustable orientation for producing the additional tracking using no more than the rotation of the optical arrangement around the input axis such that the rotation does not change the skyward orientation of the aperture.

In an additional embodiment, a solar collector and an associated method are described. The solar collector includes a solar concentrator supported by a support structure such that the concentrator is in a fixed position with a fixed alignment with respect to the support structure. The concentrator is configured to define (i) an input aperture having an input area such that the support structure is positionable to face the input aperture of the concentrator in a skyward direction so that the input aperture is oriented to receive sunlight from the sun, (ii) an input axis of rotation extending through the input aperture in the skyward direction, and (iii) a focus region that is substantially smaller than the aperture area. The concentrator includes an optical assembly having at least one optical arrangement that is supported for rotation about the input axis for tracking the sun within a predetermined range of positions of the sun using no more than the rotation of the optical arrangement around the input axis such that the rotation does not change the direction of the aperture from the skyward direction. For any specific one of the positions within the predetermined range of positions, the optical arrangement is orientable, as at least part of the tracking, at a corresponding rotational orientation as at least part of concentrating the received sunlight within the focus region, for subsequent collection and use as solar energy. In one feature the optical arrangement serves as an input arrangement for initially receiving the sunlight, and the optical assembly includes an additional optical arrangement following the input arrangement to accept the sunlight from the input arrangement. The input arrangement and the additional arrangement are configured to cooperate in performing the tracking based at least in part on the rotation of the input arrangement about the input axis of rotation. In another feature, the input arrangement is integrally formed of an optical material, and the input arrangement is configured to bend the received rays of light for the acceptance by the additional optical arrangement. The input arrangement includes a plurality of optical prisms that cooperatively define (i) an at least generally planar input surface for the receiving of the input rays of light, (ii) a first reference direction lying at least approximately in the planar input surface, and (iii) a second reference direction that lies at least approximately in the planar input surface and is at least approximately orthogonal with the first reference direction. The plurality of prisms is configured to cooperate to cause the bending of the light rays substantially in the first reference direction, substantially without causing bending in the second reference direction. Each of the prisms receives and redirects a corresponding subset of the received light rays such that at least some of the light rays of the corresponding subset serve as a collected portion of the corresponding subset of light for acceptance by the additional arrangement. The optical material has a first index of refraction and each of the prisms of the input arrangement defines an interface between the optical material and an optical medium having a second index of refraction that is different from the first index of refraction. For any selected one of the prisms, the corresponding interface is aligned for bending, as at least part of the redirecting, at least the collected portion of the corresponding subset of the light rays, responsive to the difference between the first index of refraction and the second index of refraction, for the acceptance by the additional arrangement. For any selected one of the prisms the corresponding interface extends lengthwise along the second reference direction and is widthwise tilted at a first acute tilt angle with respect to the input axis such that the input axis serves as one side of the first acute tilt angle and the interface defines another side of the first acute angle, and the bending depends in part on the first acute tilt angle. The corresponding interface serves as a first interface having a first width, and the selected one of the prisms further defines a second interface between the first optical medium and the second optical medium. The second interface is tilted at a second acute angle with respect to the input axis such that the first interface and the second interface intersect to form an edge that extends in the second reference direction. The first acute angle and the second acute angle are aligned to cooperate as adjacent angles such that the input axis also serves as one side of the second acute tilt angle, and the first and second acute tilt angles share a vertex that is at least approximately aligned along the edge such that the vertex points at least generally towards the second optical arrangement, and the second interface has a second width that is smaller as compared to the first width. In yet another feature the solar collector is configured for providing the tracking, at least for a number of days in a year, in different modes including a first mode and a second mode, corresponding to first and second non-overlapping portions, respectively, of each one of the number of days. For each one of the number of days the solar collector operates for a first period of time in the first mode and the solar collector operates for a second period of time in the second mode. The solar collector is further configured to transition from one of the first and second modes to the other one of the first and second modes at a particular time of transition in that day based at least in part on the position of the sun at that time. In the first mode, the input arrangement and the additional arrangement are configured to cooperate to provide the tracking, throughout the first portion of each given day, such that for each of the prisms, the collected portion of the corresponding subset of light rays, incident on the first interface, includes at least a majority of the subset of light rays, and no rays in the subset are directly incident on the second interface. In the second mode, the input arrangement and the additional arrangement are configured to cooperate to provide the tracking, throughout the second portion of each day, such that a diverted portion of the received light rays is incident on a section of the first interface of that prism. At least for any prisms that lie between two adjacent prisms, the diverted portion of the light is bent, as part of the redirecting, to impinge on a particular one of the adjacent prisms such that the diverted portion is further redirected, by the particular adjacent prism, and is not accepted by the additional arrangement. For each of the prisms the second angle is greater than or equal to four degrees, and for each respective one of the number of days, the time of the transition is shifted as compared to a different time of transition that would otherwise occur by having the second angle of less than four degrees. Throughout the year, the solar collector collects an annual harvest of light for that year as a sum of all sunlight received, concentrated, and collected for use as solar energy. The solar collector is configured to cause the shift of the time of transition, for each of the number of days, to extend the first period of time of the first mode to at least contribute to increasing the annual harvest as compared to a different annual harvest that would otherwise be collected throughout the year by having the second angle of less than four degrees.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein are to be illustrative rather than limiting.

FIG. 1 is a diagrammatic view, in elevation, of a reflection type prior art solar concentrator and its operation.

FIG. 2 is a diagrammatic view, in elevation, of a refractive type prior art solar concentrator and its operation.

FIG. 3 is a diagrammatic perspective view, in elevation, of one embodiment of an optical concentrator produced according to the present disclosure, showing components of the concentrator and aspects of its operation.

FIG. 4 is a diagrammatic view, in elevation, illustrating the operation of one example of a conventional off-axis concentrating lens.

FIG. 5 is a diagrammatic perspective view of one embodiment of an Inverted Off-Axis lens (IOA), shown here to illustrate the components of this embodiment of the IOA and its operation with respect to bending and focusing input light.

FIG. 6 is a diagrammatic view, in perspective, shown here to illustrate a number of aspects associated with rotational orientation of the IOA.

FIGS. 7A and 7B are diagrammatic views, in perspective, showing a single IOA solar collector system oriented for use in the morning and afternoon, respectively, during a given day.

FIG. 8 is a diagrammatic view, in elevation, of one embodiment of a bender shown here to illustrate the operation of the bender with respect to receiving a plurality incoming rays of light.

FIG. 9 is a diagrammatic view, in elevation, of one embodiment of a bender shown here to illustrate the three-dimensional nature of the bending action of the bender.

FIG. 10 is a diagrammatic perspective view, shown here to illustrate the operation of a concentrator that is made up of a bender combined with an IOA in accordance with the present disclosure.

FIG. 11 is a diagrammatic view, in elevation, illustrating one embodiment of a Bi-Rotational concentrator or BRIC and its operation in the non-limiting instance of a particular orientation of incoming light.

FIG. 12 is a diagrammatic perspective view illustrating a bender and aspects of its operation with respect to incoming light.

FIGS. 13A and 13B are diagrammatic views each illustrating the field of view of the sky in relation to the sun for different levels of concentration for a given track of the sun in each figure for purposes of comparison.

FIG. 14 is a diagrammatic view, illustrating a field of view that is stretched to advantageously match the sun's path.

FIG. 15 is a diagrammatic view, in elevation, illustrating a linear concentrator configuration employing an array of two IOA's configured for receiving input rays of light 14 and concentrating the light along the axis of a linear target.

FIGS. 16A and 16B are perspective views of conventional two axis solar collectors, shown here to illustrate details of their structures.

FIGS. 17A-C are diagrammatic representations illustrating three different fields of view each of which may be associated with a different type of solar collector or concentrator.

FIG. 18A is a diagrammatic side view, in elevation, showing one embodiment of an array of two concentrators, shown here to illustrate details with respect to the operation of the array.

FIG. 18B is a diagrammatic end view, in elevation, showing the concentrator array embodiment of FIG. 18A.

FIG. 18C is a diagrammatic plan view showing the concentrator array embodiment of FIGS. 18A and 18B.

FIG. 19A is a diagrammatic side view, in elevation, illustrating one embodiment of a split cell system having four concentrators, shown here to illustrate details with respect to the operation of the system.

FIG. 19B is a diagrammatic plan view still further illustrating the split cell system of FIG. 19A, shown here to illustrate still further details with respect to its operation.

FIG. 20A is a diagrammatic perspective view of a bender according to the present disclosure, showing details with respect to its operation.

FIG. 20B is a diagrammatic perspective view of one embodiment of an IOA according to the present disclosure, showing details with respect to its construction and operation.

FIGS. 21A and 21B are diagrammatic perspective views showing yet another embodiment of an IOA that may be utilized for shaping of the focus region

FIG. 22A is a diagrammatic perspective view of a refractive arrangement for use with an IOA to further focus a redirected wedge of light.

FIG. 22B is a diagrammatic perspective view of a reflective arrangement for use with an IOA to further focus a redirected wedge of light.

FIGS. 23A and 23B are diagrammatic views, in elevation, showing different views of one embodiment of a concentrator taken from orthogonal viewpoints to illustrate details of the operation of the concentrator in different coordinate axis planes for a special case wherein the input light is handled by the concentrator in the planes of these figures.

FIGS. 24A and 24B are a diagrammatic views, in elevation, showing different views of the concentrator of FIGS. 23A-23B taken from orthogonal viewpoints to illustrate details of the operation of the concentrator in different coordinate axis planes for an exemplary case in which light enters skewed to the coordinate axes planes.

FIG. 24C is a diagrammatic plan view of the concentrator of FIGS. 24A and 24B, illustrating a projection of components of the light onto a horizontal coordinate axis plane after the light enters the concentrator.

FIG. 25A is a diagrammatic view, in elevation, illustrating one embodiment of a bender, shown here to illustrate details with respect to the structure and operation of the bender.

FIG. 25B is diagrammatic view, in elevation, illustrating the bender of FIG. 25A, shown here to illustrate further details with respect to shading which is dependent upon the incidence angle of incoming light.

FIG. 26A is a diagrammatic view, in elevation, illustrating one embodiment of a concentrator in which a multi-element IOA is used.

FIG. 26B is a diagrammatic view, in elevation, illustrating another embodiment of a concentrator which, in this example, utilizes a single element IOA.

FIG. 26C is a diagrammatic view, in elevation illustrating still another embodiment of a concentrator which, in this example, utilizes an input optical arrangement and an additional optical arrangement to cooperate for purposes of causing the input light to be concentrated at a focus region.

FIG. 27 is a diagrammatic view illustrating coverage of the sky, shown as a rectangle, that is traversed by the sun according to annual and daily variations for a particular bender and IOA.

FIG. 28 illustrates details of the operation of a bender or IOA with respect to certain variations in the configuration of its structure.

FIGS. 29A and 29B are further enlarged views which illustrate details of the operation of the bender or IOA of FIG. 28 with respect to sidewall slope (FIG. 29A) and apex rounding (FIG. 29B).

FIG. 30 is a diagrammatic view illustrating coverage of the sky, shown as a rectangle, that is traversed by the sun according to annual and daily variations, shown here to illustrate the effect of variation in prism configuration in terms of loss of the field of view for a particular bender and IOA.

FIG. 31 is a diagrammatic view of the sky that is traversed by the sun showing annual and daily variation in the position of the sun and shown here to illustrate a tradeoff between adding sky coverage in the morning and evening with losing sky coverage for specific days around noon.

FIG. 32 is a diagrammatic view of the sky that is traversed by the sun showing annual and daily variation in the position of the sun and shown here to facilitate a discussion of confined ranges of bender and IOA rotation versus maintaining tracking capability.

FIG. 33A is a diagrammatic elevational view of one embodiment of a concentrator wherein the bender is tilted with respect to an IOA.

FIG. 33B is a diagrammatic plan view of the concentrator of FIG. 33A, shown here to illustrate further details of its structure and operation.

FIG. 34 is a diagrammatic elevational view of another embodiment of a concentrator having a tilted bender wherein the bender and IOA can be controlled by a filament.

FIG. 35 is a diagrammatic elevational view of one embodiment of a concentrator having a bender that is linked through a hub attached with the IOA such that the bender is rotated on the hub.

FIG. 36 is a diagrammatic view, in elevation, of one embodiment of a concentrator showing a ramp method for tilting the bender relative to the IOA.

FIG. 37 is a diagrammatic plan view which illustrates one embodiment of an array of four concentrators that are rotatably coupled with one another through a drive mechanism to cause the benders to co-rotate about their associated axes using a flexible drive member.

FIG. 38 is a diagrammatic plan view which illustrates another embodiment of an array of four concentrators that are rotatably coupled with one another through a drive mechanism to cause the benders to co-rotate about their associated axes using a geared type arrangement.

FIG. 39A is a diagrammatic plan view showing a solar collector constructed as a panel enclosure housing a concentrator array.

FIG. 39B is a diagrammatic elevational view of the solar collector of FIG. 39A, shown here to illustrate further details of its structure.

FIG. 40 is a diagrammatic plan view of one embodiment of a concentrator having a bender, an IOA 32, and a concentrating arrangement, shown here to illustrate details of its structure.

FIG. 41 is diagrammatic elevational view of a concentration which utilizes a multi-element IOA.

FIG. 42 is a diagrammatic view, in perspective, illustrating the structure and operation of a segmented optical arrangement that is configured as a segmented IOA.

FIG. 43A is a diagrammatic bottom view, in perspective, of the segmented IOA of FIG. 42, shown here for illustrating further details with respect to its configuration.

FIG. 43B is a table describing a number of characteristics of one embodiment of a segmented IOA.

FIG. 44A is a diagrammatic perspective view illustrating a solar collector that includes a linear concentrator, and details with respect to its operation.

FIG. 44B is a diagrammatic perspective view of the solar collector of FIG. 44A, shown here to illustrate further details with respect to its structure and operation.

FIG. 45 is a diagrammatic perspective view of a system having a concentrator array made up of an array of linear concentrators.

FIG. 46 is a diagrammatic perspective view illustrating the structure and operation of a two-dimensional array that includes a number of linear arrays of concentrators supported in side-by-side relationships with one another.

FIG. 47A is a diagrammatic plan view of one embodiment of a two-dimensional array, having several adjacent arrays of linear concentrators, with input optical arrangements arranged in a square pattern.

FIG. 47B is a diagrammatic plan view of one embodiment of a two-dimensional array, having several adjacent arrays of linear concentrators, with input optical arrangements arranged in a hexagonal pattern.

FIG. 48 is a diagrammatic view, in perspective, of an array of linear concentrators, each of which concentrators utilizes a portion of a reflective focusing arrangement.

FIG. 49A is a diagrammatic perspective view illustrating one embodiment of a single-axis focusing arrangement.

FIG. 49B is a diagrammatic perspective view of one embodiment of a single-axis concentrating bender.

FIG. 49C is a diagrammatic perspective view, illustrating an IOA that includes the single axis concentrating bender of FIG. 49B, aligned in a series relationship following the single-axis focusing arrangement of FIG. 49A, showing details with respect to the operation of the IOA

FIG. 50 is a diagrammatic perspective view illustrating one embodiment of a solar collector array having an elongated receiver and details with respect to its operation.

FIG. 51 is a diagrammatic view, in elevation, illustrating one embodiment of a bender, shown here to illustrate details with respect to the structure and operation of the bender.

FIG. 52A is a diagrammatic view, in elevation, illustrating a normal-incidence mode of operation of the bender of FIG. 51.

FIG. 52B is another diagrammatic view, in elevation, illustrating a low-loss mode of operation of the bender of FIG. 51.

FIG. 52C is still another diagrammatic view, in elevation, illustrating a higher-loss mode of operation of the bender of FIG. 51.

FIGS. 53A and 53B are plots representing collection efficiency, during two different days, respectively, of a typical year, for one embodiment of a solar concentrator.

FIGS. 54A and 54B are diagrammatic cutaway views, in elevation, in a given frame of reference that is the same for both views, illustrating operation of the bender of FIG. 51 in two different orientations. FIG. 54A illustrates the bender, in a first orientation, operating in the higher loss mode of FIG. 52C, and FIG. 54b illustrates the bender, in a second orientation that is tilted as compared to the first orientation, operating in the low-loss mode of FIG. 52B.

FIGS. 55A, 55B, and 55C are diagrammatic elevational views showing a BRIC that includes a tilted optical input arrangement, taken at different times during a selected day, to illustrate different orientations of the input arrangement as the BRIC tracks the sun during the selected day.

FIGS. 56A and 56B, respectively, are a diagrammatic elevational view and a diagrammatic perspective view, showing a tilted bender assembly wherein the two views are taken from different viewpoints to illustrate different features of the assembly.

FIG. 57 is diagrammatic elevational view showing a concentrator including an IOA following the tilted bender of FIGS. 56A and 56B, shown here to illustrate various details of the operation of the concentrator.

FIG. 58 is a diagrammatic perspective view of one embodiment of a BRIC including a tilted bender as an input optical arrangement, shown here to illustrate various details of the structure and associated operation of the BRIC.

FIG. 59A is a diagrammatic perspective view of another embodiment of a BRIC including a tilted bender as an input optical arrangement, shown here to illustrate various details of the structure and associated operation of the BRIC.

FIG. 59B is a diagrammatic perspective view of the BRIC of FIG. 59A, taken from the same viewpoint as FIG. 59A, shown here to illustrate the effect of rotation of the tilted bender.

FIG. 60 is a diagrammatic partially cutaway perspective view of a dual tracking collector arrangement shown here to illustrate details with respect to its structure and operation.

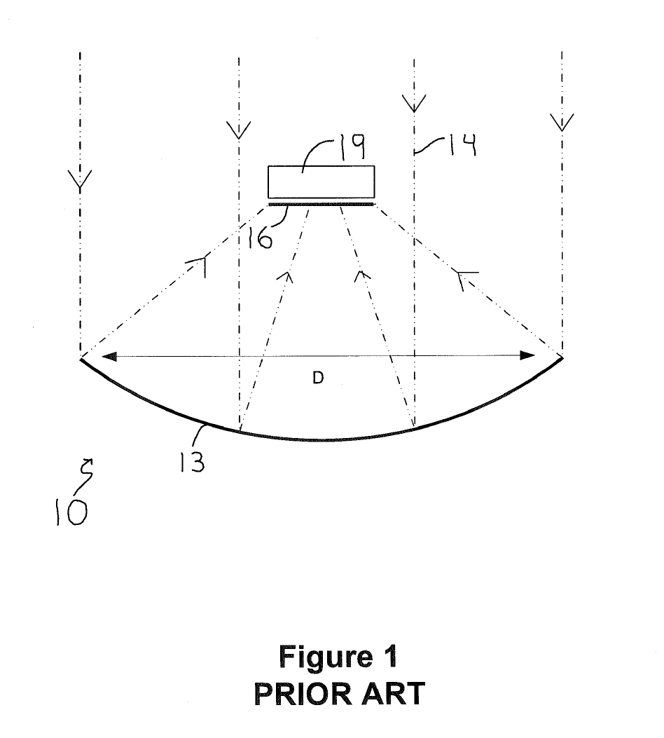

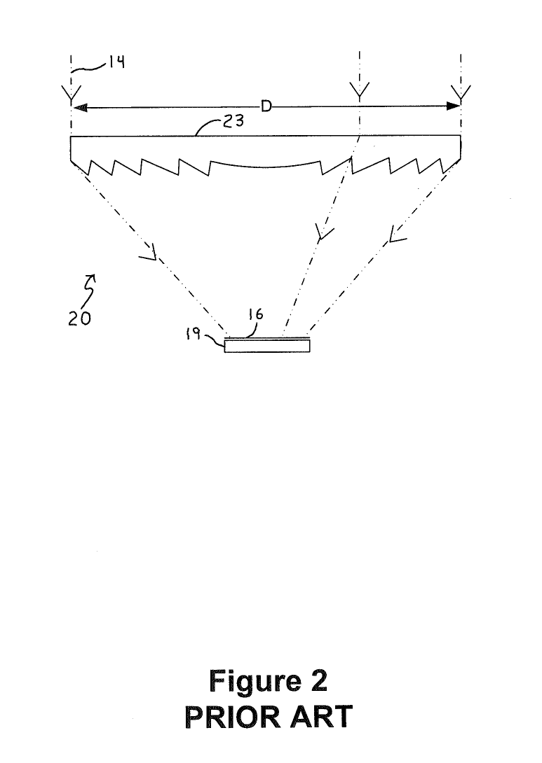

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles taught herein may be applied to other embodiments. Thus, the present invention is not intended to be limited to the embodiment shown, but is to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology, such as, for example, upper/lower, right/left, clockwise and counter-clockwise and the like may be adopted for purposes of enhancing the reader's understanding, with respect to the various views provided in the figures, and is in no way intended to be limiting.

As described previously in the background section, Applicants recognize that while conventional concentrators in some cases may be advantageous from a cost standpoint, at least as compared with systems utilizing non-concentrating collectors, conventional concentrators are not entirely without problems. In some cases the use of concentrators can exacerbate problems and/or challenges that may be associated with conventional non-concentrating solar collectors such as PV cells. For example, in photovoltaic panels, the efficiency of the PV cells generally decreases with increasing temperature. While this is a common concern in the design of non-concentrating panels heating is of yet greater concern when concentrators are used to increase the incoming light intensity by 10× or 100× or higher, and under these circumstances management of heat-related factors can become a serious challenge. In other cases, the use of concentrating collectors may introduce specific challenges that are commonly associated with concentrating systems. For example, many concentrators require the light to enter with a certain angular accuracy which may require that the concentrator move in order to “track” in relation to a light source such as the sun. Conventional tracking systems can be both costly and complex, and in some cases the cost of a tracking system may substantially undermine cost savings that may otherwise be enabled by the use of concentration.

Applicants describe hereinafter a number of solar collectors including optical concentrators that advantageously utilize internal rotational motion for tracking the light arriving from a movable source and concentrating the light onto a target such as a receiver. The optical concentrators of the present disclosure cause input light to pass through a series of one or more optical arrangements, and typically at least one of the arrangements is supported for rotation. In several examples described hereinafter, at least one of the rotating optical elements can be configured as an inverted off-axis lens arrangement that is configured for rotation as at least part of allowing and/or causing the system to track a moving light source. For example, this disclosure details a number of solar collectors that utilize solar concentrators that are configured to define a receiving direction that is adjustable, for tracking motion of the sun, based on rotational orientation of one or more optical arrangements so that, as the sun changes position, the concentrated light exiting the system can be made to continuously illuminate the receiver.

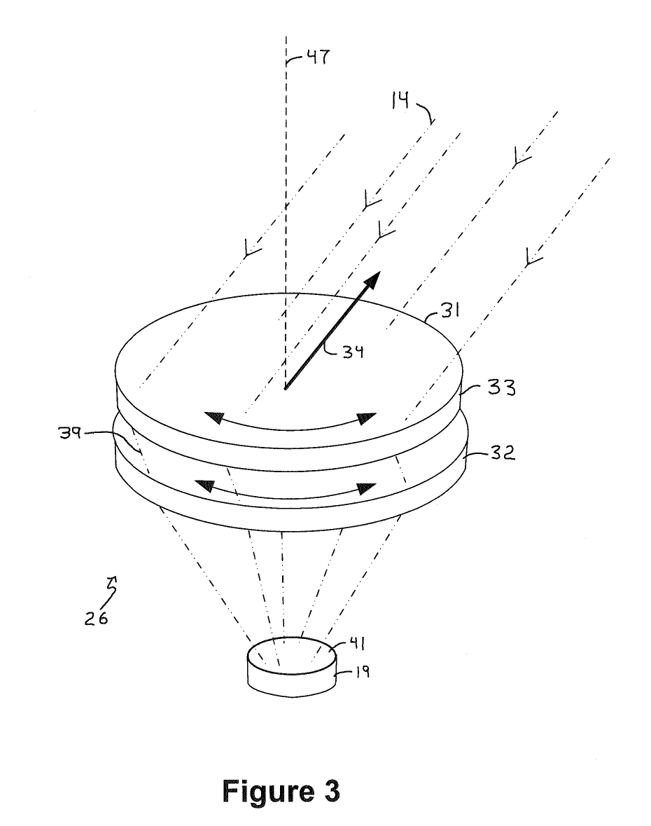

Turning now to the figures, wherein like components are designated by like reference numbers whenever practical, attention is now directed to FIG. 3 which is a diagrammatic perspective view, in elevation, of one embodiment, generally indicated by reference number 26, of an optical concentrator including an inverted off axis lens arrangement 32 in a series relationship following an optical bender arrangement 33. This bender arrangement serves as an input arrangement defining an input aperture 31 having an input surface area, and is configured for initially receiving incoming rays of sunlight 14 and for bending the incoming rays of sunlight to produce intermediate light rays 39 for acceptance by inverted off-axis lens arrangement 32 such that the intermediate light rays serve as input rays of light with respect to the IOA (Inverted Off-Axis lens). The inverted off axis lens arrangement transmissively passes the intermediate light rays such that these rays converge towards one another until reaching a focus region 41 that is substantially smaller than the input surface area.

Each of the optical arrangements of optical concentrator 26 can be configured in a relatively flat, thin and generally planar configuration that may be regarded as being analogous to a that of a Fresnel lens, such that the combination of the two arrangements may be implemented in a correspondingly flat and thin shape. Concentrator 26 defines a receiving direction 34 for receiving the incoming rays of sunlight 14 at an input orientation such that the incoming rays of sunlight are anti-parallel therewith, while the bender and the inverted off axis lens arrangement cooperate with one another such that the optical concentrator receives and concentrates the received light onto focus region 41. The bender arrangement and the inverted off axis lens may be closely spaced such that a substantial portion of the intermediate rays of light leaving the bender arrangement will be accepted and concentrated by the inverted off axis lens arrangement. As will be described in detail at appropriate points hereinafter, the optical arrangements including bender arrangement 33 and inverted off-axis lens arrangement 32 can be rotatably oriented relative to one another and with respect to the incoming rays of sunlight, so that the light exiting the bender arrangement enters the inverted off-axis lens at an angle appropriate to cause the inverted off axis lens to accept and concentrate focus the intermediate light rays such that they converge toward one another until reaching focal region 41. As the direction of the incoming rays of sunlight changes, for example as a result of motion of the sun, the two optical elements 32 and 33 can be rotated for tracking the motion of the sun so that a correctly adjusted rotational relationship between them and relative to the incoming rays of sunlight is maintained for concentrated illumination of the focus region.

The embodiment of concentrator 26 illustrated in FIG. 3 can be referred to as a Bi-Rotational Inverted off-axis Concentrator (BRIC), and in many applications is well suited for use in a fixed or movable solar panel for conversion of sunlight to a form of energy such as thermal or electrical power. Applicants note that in the case of a fixed solar panel, having an array of one or more optical concentrators 26, the sun typically exhibits daily motion relative to panel, for example between sunrise and sunset, as well as seasonal motion, for example from winter to summer. As the sun's position changes with respect to the panel, throughout a given day and throughout seasonal variations, the direction of the incoming rays of sunlight 14 entering the BRIC changes. As will be described in greater detail hereinafter, the BRIC can track this direction change by rotating the bender and the inverted off-axis lens such that they cooperate with one another to continuously adjust the orientation of receiving direction 34 to track the sun for maintaining illumination of focal region 41. It is noted that a receiver 19 may be introduced for converting the focused light into a form of energy. For example a receiving surface of a PV cell may be aligned to overlap the focal region such that a portion of the focused light is converted by the PV cell into electricity.

Applicants recognize that in many applications, including a number of solar collection applications, the use of a BRIC in a solar PV panel provides a number of sweeping advantages as compared to conventional solar panels. For example, as described above, a concentrator can be configured such that the focusing and concentrating of incoming rays of sunlight allows for the use of a receiver (such as PV cell) having an area that is substantially smaller than the input area of concentrator. As compared to conventional non-concentrating PV cells, the systems and method for tracking the sun and concentrating sunlight, as described above and hereinafter throughout this application, can be employed for reducing the required surface area of relatively expensive PV cells required for a given application and therefore reduce the cost of a solar collector at least as compared to a conventional panel. Furthermore, the relatively flat and thin shape of a BRIC allows it to be incorporated inside a panel enclosure having a relatively low profile as compared to the profiles typically associated with conventional concentrator systems. This may allow a concentrating solar PV system to be packaged in an enclosure having a shape and size that is based on conventional standards, and solar panels constructed in accordance with this disclosure may be compatible with existing installation infrastructures that have been developed, for example, for the conventional panels including non-concentrating solar PV panels.

With ongoing reference to FIG. 3, it is again noted that the bender and the inverted off-axis lens of solar concentrator 26 are both supported for rotation. In addition, a receiver 19 may be positioned to provide a receiving surface as a stationary target such that the receiving surface overlaps the focal region, and the receiver may be configured such that at least some of the concentrated light is absorbed by the receiver and converted to a form of energy such as, for example, electrical or thermal power. It is noted that in the context of this disclosure the phrase “stationary target” refers to the fact that the target does not rotate or otherwise move relative to other parts of the panel. If the whole panel is moving to track the sun, then the BRIC will act to concentrate the light on a stationary target attached to the moving panel, and the target may remain stationary relative to the panel enclosure, even in cases where the panel may be in motion. In particular, as one example, an array of one or more solar concentrators 26 may be supported in fixed positions in a supporting structure (such as a solar panel enclosure) and relative to one another, and the bender and the inverted off axis lens may be supported for rotation as described above with reference to FIG. 3, while the receiver may be fixedly supported in relation to its concentrator such that it is not rotated or otherwise moved at least with respect to the supporting structure.

It is noted, as will be described in greater detail immediately hereinafter, that the optical properties of inverted off-axis lens 32 differs substantially as compared to the optical properties of conventional off-axis lenses.

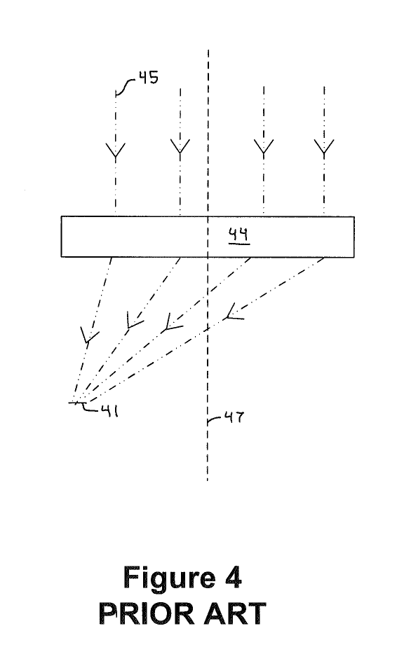

Attention is now directed to FIG. 4 which is a diagrammatic view in elevation illustrating the operation of one example of a conventional off-axis concentrating lens 44, which can be implemented in a number of configurations including but not limited to (i) a continuous surface lens or (ii) as a Fresnel lens. In this example lens 44 is configured to define an optical axis 47, and to receive input rays of collimated light 45 such that the collimated light enters lens 44 in a parallel orientation with optical axis 47. Off-axis lens 44 is further configured to focus the light onto an off-axis focus region 41 that is in an off-axis location such that the focus region does not lie on optical axis 47. It is noted that based on well known conventions, the designation of this lens as an “off-axis” lens is premised on off-axis positioning of the focal region as illustrated in FIG. 4.

It is further noted with reference to FIG. 4 and for purposes of the remainder of this application, the term “optical axis” refers to an at least generally central path along which light tends to propagate through an optical system. In many conventional optical systems, such as imaging systems, an optical axis may be defined as a line through space around which the system is rotationally symmetric. This is not necessarily the case in the examples discussed throughout this disclosure, and it is further noted that in order to perform their intended functions as described herein, both benders as well as inverted off axis lenses generally can be configured in a physically asymmetric manner at least with regard to specific structural and/or optical material properties. In this regard, it may be appreciated by one of ordinary skill in the art that an optical axis of either a bender or an inverted off axis lens can be associated with optical properties of the arrangement and may not necessarily be defined based on any apparent physical symmetry, incidental or otherwise. Returning to discussions regarding nomenclature, it is noted that the term ‘lens’ will refer, hereinafter and throughout this disclosure, to an optical arrangement that can modify the light rays as they pass through the element. The modification, including bending of the direction of the light, may or may not be uniform over the surface of a given lens. Furthermore the modification of light by a given lens may also affect the convergence or divergence of the rays as the rays transmissively pass through the lens.

As will be described in detail immediately hereinafter, an inverted off-axis lens defines an optical axis and is configured such that a focal region of the inverted off-axis lens is on the optical axis while the incoming light is entering in an off-axis orientation. In particular, an inverted off-axis lens is configured to accept incoming light at an angle relative to the optical axis. Based on designations presented herein and used throughout the remainder of this application, the use of the term “inverted” refers to an inversion of the functional operation of an inverted off-axis lens as compared with a conventional off-axis lens.

Summarizing with respect to the discussion above, a conventional off-axis lens is configured to accept incoming light that is on-axis while the focal region is generally positioned at an off-axis location. By contrast, an inverted off-axis lens is configured to accept incoming light that is incident at a skewed angle with respect to the optical axis, and the focal region is located on the axis.

It is noted that the term ‘Inverted Off-Axis lens’ may be referred to throughout this overall disclosure and in the appended claims by the acronym ‘IOA’. With respect to this nomenclature, it is further noted that the IOA may be an individual lens, consisting of one optical element, or it may be configured as an optical arrangement having two or more optical elements and/or components.

Resuming the discussion, the focal region of an IOA may be positioned along the optical axis such that the incoming light arrives at an angle and is then bent and focused into focus region 41. As described above, and as will be described in greater detail immediately hereinafter, an IOA may be regarded as performing two optical functions: (i) bending the incoming light to direct the light along the optical axis and towards the focal region, and (ii) focusing the light for convergence onto the focal region.

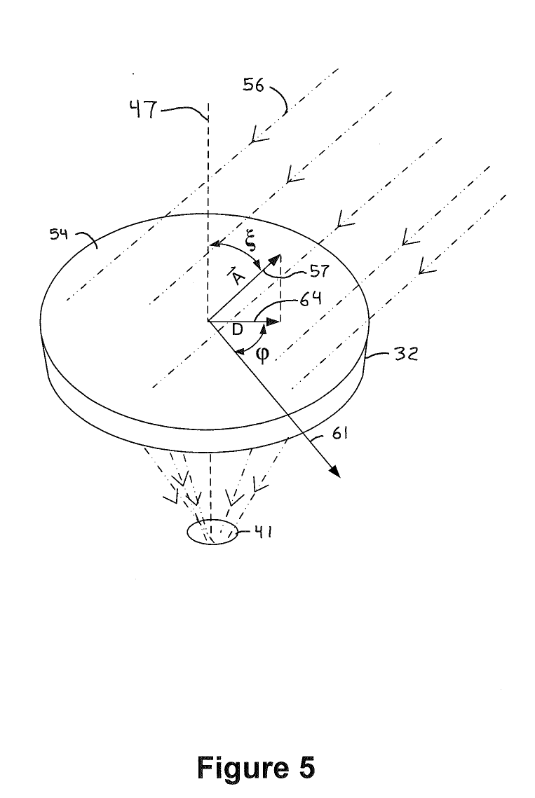

Attention is now directed to FIG. 5, which is a diagrammatic perspective view illustrating bending and focusing properties of one embodiment of IOA 32. The IOA defines an input surface 54, having an input surface area, and is configured for accepting a plurality of parallel input rays 56, and for bending and focusing the plurality of input light rays onto focal region 41. The IOA is further configured for defining an acceptance direction 57 represented in FIG. 5 as a vector A that extends outward from the optical axis in one fixed azimuthal direction having a fixed orientation with respect to the IOA such that the optical axis and the vector define a plane. The IOA is rotatable for orientation of acceptance direction 57 to accept the plurality of input light rays such that the rays are each at least approximately anti-parallel with the acceptance direction 57, and the IOA is yet further configured for transmissively passing the plurality of input light rays while focusing the light rays to converge toward one another until reaching a focus region that is substantially smaller than the input surface area.

While certain aspects of the immediately following points are to be discussed in further detail hereinafter, it is to be understood that (i) input rays of light 56 entering the IOA in the direction that is at least approximately anti-parallel to the acceptance direction are directed to the focal region, (ii) the acceptance direction 57 is a physical characteristic of the IOA that is structurally defined by the IOA itself, and (iii) any misaligned input rays of light (not shown), entering the IOA in a substantially misaligned direction that is sufficiently skewed with respect to the acceptance direction, will be redirected by the IOA to diverge away from the optical axis such that they pass outside of the focal region, and increased misalignment will generally result in correspondingly increased divergence of the bent light way from the focus region.

With ongoing reference to FIG. 5, it is noted that there are significant functional differences between the focal length of an IOA as compared to a conventional focal length associated with a conventional lens, and that for a conventional lens having a focal length, collimated light typically must enter the lens parallel to an optical axis of the lens in order to be directed to a focal region that is removed from the lens by a distance corresponding to the focal length. In cases where the light enters the conventional lens at an angle that is skewed relative to the optical axis of the conventional lens, the light will be typically directed off axis and away from the focal region. By contrast, the IOA accepts collimated light at a skewed angle relative to the optical axis, and directs the light towards a focal region that is located along the optical axis. Applicants recognize, as will be described in greater detail hereinafter, that at least for use in solar concentrators, the inverted off axis characteristics of the IOA, as described immediately above and throughout the disclosure, results in a number of sweeping advantages at least with respect to applications relating to solar collectors having solar concentrators that include one or more IOAs.

It should be appreciated by a person of ordinary skill in the art, having this overall disclosure in hand, that the presence of a unique acceptance direction, in accordance with the immediately foregoing descriptions, implies that there is at least some kind of rotational asymmetry that should be inherently present in the physical structure and/or material properties of the IOA, and in an absence of this form of asymmetry in the structure of the IOA, it is not reasonably possible for the IOA to define a distinct acceptance vector in a manner consistent with the descriptions herein. For example, in one embodiment that will be described in detail at appropriate points hereinafter, the IOA may include prisms that are integrally formed therewith, and the prisms may be oriented in parallel with one another along a reference direction (not show in FIG. 5) and configured to cause the aforementioned bending of the input rays of light. Prisms oriented in this manner provide one example for satisfying the requirement for rotational asymmetry in the IOA.

While acceptance direction 57 (represented in FIG. 5 as vector A) is defined by structural and/or optical properties of the IOA, and therefore remains fixed in the frame of reference of the IOA, it is to be understood that relative to earth's frame of reference the acceptance direction only changes if and when the IOA itself changes position. For example, when the IOA is rotated, the acceptance direction rotates accordingly to sweepingly define a surface of a cone, as will be described immediately hereinafter. In view of the immediately foregoing points, and for purposes of descriptive clarity, it is useful to define an appropriate set of coordinates for describing the acceptance direction as the IOA changes position, rotatably or otherwise. In this regard, it is to be understood that the acceptance direction of the IOA can be regarded as a 3D (three dimensional) vector in the context of conventional three dimensional space. In accordance with well known principles of analytic geometry, any 3D vector that is solely utilized for describing a direction in space can be designated to have an arbitrary magnitude (most commonly 1, or “unity”) and can be henceforth designated using only two angular coordinates. The acceptance direction of an IOA can be represented in accordance with the standard practices with a fixed zenith angle ξ (the angle between vector \vec{A} and the optical axis), and a fixed direction relative to the IOA represented in FIG. 5 as vector D which is a projection 64 of vector \vec{A} onto input surface 54. Using this system of coordinates in accordance with the foregoing conventions, acceptance direction 57 (represented in FIG. 5 as vector \vec{A}) maintains the aforedescribed constant magnitude of unity and the aforedescribed constant angle ξ. It is therefore clear that as long as optical axis 47 remains fixed, the orientation in space of acceptance direction 57, rotatably changing or not, can be fully specified by angle φ with respect to reference axis 61. Since the acceptance direction 57 is itself fixed with respect to the frame of reference of the IOA, then it is equally appropriate to describe the rotational orientation of the IOA according to the same nomenclature, and the statement that the IOA is azimuthally oriented with angle φ can be reasonably considered as being synonymous with a statement that the acceptance direction is azimuthally oriented with angle φ.

It is further noted that the projection 64 (designated in FIG. 5 as vector D) of acceptance direction 57 onto IOA surface 54 is also fixed with respect to the IOA, and is also oriented at angle φ relative to reference direction 61. As one additional aspect of nomenclature that may be used throughout this disclosure, projection 64 is to be considered as a direction through space in which the IOA is “pointing”. Carrying this terminology one step further, in order for the IOA to accept input rays of light 56, for bending and concentrating, IOA 32 is pointed in an opposing orientation as compared to the input rays of light such that a projection of the input rays (not shown) onto surface 54 is anti-parallel with projection 64 (represented in FIG. 5 as vector D).

There are two conditions that can be met in order for input rays 56 to be aligned anti-parallel with acceptance vector 57 thereby causing the IOA to accept the input rays of light for bending and concentrating onto focus region 41, and these two conditions may at times be designated hereinafter and throughout this disclosure according to the following shorthand notation: (i) the IOA is rotatably oriented to be pointed towards the input rays of light, and (ii) the input rays of light enter the IOA at the zenith angle ξ of the IOA. Foreshortening the terminology yet further, for use in subsequent descriptions, input rays of light 56 and IOA 32 may be regarded as being “aligned with one another” at times when these conditions are met, and hereinafter throughout this disclosure a statement that the IOA and the input rays of light are aligned with one another is to be interpreted as stating that these two conditions have been met at least to a reasonable approximation. For purposes of further clarification, it is noted that a statement that the IOA is pointed towards the input rays of light, is only to be interpreted as stating that the first of the two conditions has been met, and under these circumstances, the IOA and the input rays may or may not be aligned with one another. For purposes of descriptive clarity, two examples resulting in misalignment will be discussed immediately hereinafter.

As a first example (not shown) resulting in misalignment, if the IOA were to be rotated away from the appropriate rotational orientation that is illustrated in FIG. 5, than the input rays of light and the acceptance angle would become skewed relative to one another, thus resulting in a misaligned condition such that the IOA and the input rays of light are not aligned with one another.

As another example resulting in misalignment, if the IOA in FIG. 5 were to be tilted, for example by pivoting the IOA about reference direction 61, a sufficiently large tilt would result in a mismatch (not shown) between the acceptance direction and the input rays of light, and input rays of light and the acceptance direction would be correspondingly skewed with respect to one another, resulting in yet another condition such that the IOA and the input rays are misaligned relative to one another.

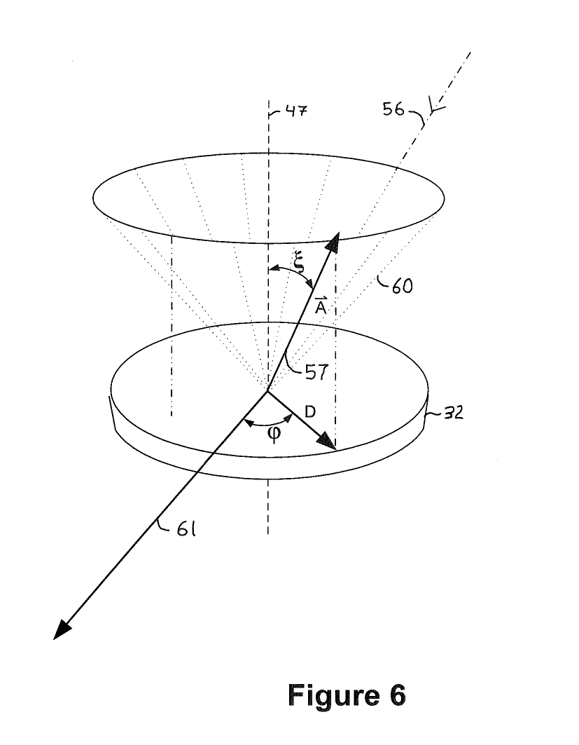

Attention is now turned to FIG. 6 with ongoing reference to FIG. 5, the former of which is a diagrammatic perspective view of IOA 32 illustrating a number of aspects associated with rotational orientation of the IOA. As described above in reference to FIG. 5, the acceptance direction (represented in FIG. 5 as vector A) is defined by the IOA based on structural and/or optical material properties of the IOA, and therefore acceptance direction 57 remains stationary in a frame of reference of the IOA. Therefore, as the IOA is rotated about its axis of rotation, the acceptance direction may be regarded as sweeping a surface 60 of a cone, indicated in FIG. 6 with dotted lines and hereinafter referred to as an acceptance cone, associated with the IOA. As will be described immediately hereinafter, the acceptance cone serves as a conceptual and/or visual aid that will be referenced hereinafter in the context of descriptions relating to performance of the IOA especially in regard to cooperation between the IOA and other optical arrangements. Employing terminology that is consistent with the description of FIG. 5, it is to be understood that any input ray of light 56 propagating toward the IOA, and having a direction that lies on the surface 60 of the acceptance cone, can be accepted by the IOA for bending and focusing, provided that the IOA is rotated to an appropriate rotational orientation for accepting that ray. In other words, adopting the shorthand terminology set used previously in reference to FIG. 5, if (i) the input ray of light 56 lies on the acceptance cone of the IOA, and (ii) the IOA is rotatably oriented such that the IOA is pointed toward the incoming rays light, then the IOA is appropriately oriented to accept and concentrate the input rays of light. By contrast, any misaligned ray that has a substantially different direction that does not at least approximately lie on the acceptance cone will be misaligned with the IOA regardless of the specific rotational orientation of the IOA.

As described above in reference to FIG. 5, the acceptance direction, remains fixed with respect to the IOA, and motion of the IOA that is restricted to rotation about one axis (such as the optical axis of the IOA) can be described in the earth's frame of reference and based on well-established conventions of analytic geometry, with a zenith angle (represented in FIGS. 5 and 6 as ξ) and azimuth angle φ. As described previously, in cases where the motion of a given IOA is solely limited to rotation about the optical axis of the IOA, the zenith angle ξ remains fixed with respect to the IOA even while the IOA rotates, and therefore the acceptance cone is characterized by zenith angle ξ.

As described above in reference to FIG. 3, and as will be described in greater detail at various points throughout the remainder of this disclosure, Applicants recognize that IOA 32 can be combined with additional optical arrangements for continuously tracking the sun throughout much of the day in a highly advantageous manner that is limited to rotation of the optical arrangements. It is noted however, that the mere use of an IOA does not in itself insure the existence of a continuous tracking capability, and that a single IOA configured solely for rotational motion while being held in an otherwise fixed orientation, cannot be utilized by itself (in an absence of additional optical arrangements) for tracking the sun continuously throughout the day. Nevertheless, for purposes of enhancing the readers understanding, the use of a single IOA will be described below, in the context of a solar collector system.

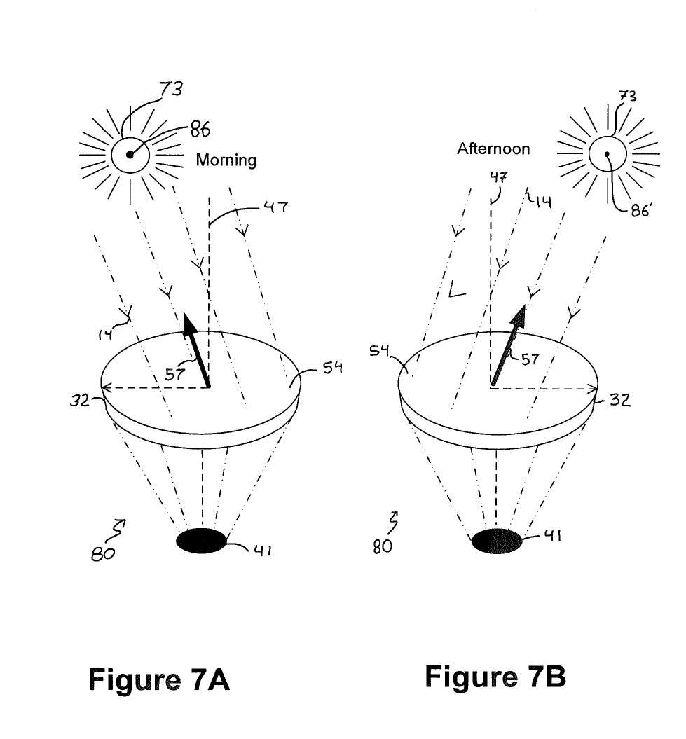

Attention is now directed to FIGS. 7A and 7B, which are diagrammatic perspective views depicting a single IOA solar collector system 80 positioned for use at two different times (morning and afternoon) during a given day. The solar collector illustrated in FIGS. 7A and 7B is in a fixed position, with a fixed alignment, and includes an IOA 32 supported for rotation about an optical axis 47. The IOA acts as a solar concentrator and is configured such that input surface 54 of the IOA defines an input aperture having an input area such that the solar collector is positionable such that the input aperture faces in a skyward direction such that the input aperture is oriented to receive sunlight from the sun (the sun being indicated by reference number 73). The solar concentrator is further configured to define optical axis 47 as extending through the aperture in the skyward direction, and the solar concentrator is yet further configured to define a focus region 41 that is substantially smaller than the aperture area. The solar collector is in a fixed position with fixed alignment, and for each of the morning and afternoon positions, as will be described in detail immediately hereinafter, the IOA can be rotatably oriented for receiving and concentrating received rays of sunlight 14.

As described above, concentrator 80 is configured such that rotation of the IOA lens about axis 47 rotates acceptance direction 57 thereby pointing the IOA in varying directions. FIGS. 7A and 7B illustrate this principle by depicting a single concentrating IOA lens being utilized as a solar concentrator. However, it is noted that this solar concentrator functions ideally only twice per day: once in the morning and once in the afternoon, as illustrated in FIGS. 7A and 7B and as will be described immediately hereinafter.

During the morning the solar concentrator will function properly only at a particular time of the morning when the morning sun is at a position 86 such that the rays of sunlight 14 are aligned anti-parallel with acceptance direction 57, at which time IOA 32 bends and focuses the rays sunlight toward focal region 41. At other times during the morning, the IOA can be pointed towards the incoming rays of sunlight, but the incoming rays of sunlight at these other times nevertheless do not enter the IOA at the zenith angle ξ of the IOA, and therefore the IOA is misaligned with respect to the incoming rays of sunlight.

Similarly, during the afternoon, the solar concentrator will function properly only at a particular time of the afternoon when the afternoon sun is at a position 86′ such that the incoming rays of sunlight 14 are aligned anti-parallel with acceptance direction 57, at which time IOA 51 bends and focuses the rays sunlight toward focal region 41. At other times during the afternoon, the IOA can be pointed towards the incoming rays of sunlight, but the incoming rays of sunlight at these other times nevertheless do not enter the IAO at the zenith angle ξ of the IOA.

It is noted that single IOA tracker 80 can be used successfully, for continuously tracking the sun throughout a substantial portion of the day, only when utilized with an additional 1- or 2-axis tracking system. One example of such an arrangement, to be described in detail in a subsequent portion of this disclosure, is a solar panel enclosure supporting an array of one or more single-IOA trackers 80 (each tracker has one single IOA) each of which trackers is attached to an external mechanical tracker mechanism. In many conventional applications, a mechanical tracker mechanism may be configured to move a conventional solar panel for continuously pointing the panel such that the panel faces directly towards the sun. In the arrangement under discussion, having an array of single-IOA concentrators, a mechanical tracker may be configured for facing the panel toward the sun within a predetermined tolerance based on the bend angle of the IOA, and the IOA can be rotated to correct for any mechanical misalignment associated with the mechanical tracker.

Having described the basic operating principles of an IOA, and having illustrated the use of a single-IOA solar concentrator having only limited tracking abilities, the description is now directed to optical properties and operating principles relating to an optical arrangement that is configured as a bender. It is first noted that a bender may be considered as being perhaps somewhat analogous to an IOA to the extent that a bender shares certain characteristics that are at least loosely analogous with associated characteristics of an IOA. For example, as one analogous characteristic, a bender receives incoming rays of light and redirects the incoming rays by bending the rays through a given angle and in a given direction with respect the bender and relative to the incoming rays, such that the bender redirects the incoming rays of light in a way that changes depending on the rotational orientation of the bender relative to an orientation of the incoming rays of light. It is noted however that a bender is not configured to cause any focusing of the incoming rays of light. Hence the name “bender”. In this regard, a bender may perhaps be considered as somewhat analogous to a limited special case of a uniquely specified IOA-like device that has an infinite focal length. While this consideration is regarded by Applicants as being more or less a curiosity, the analogy may be nevertheless useful for illustrative and descriptive purposes at least for helping to establish consistent terminology for distinguishing benders from IOA's while putting forth various descriptions relating to cooperation between these two distinct classes of arrangements.

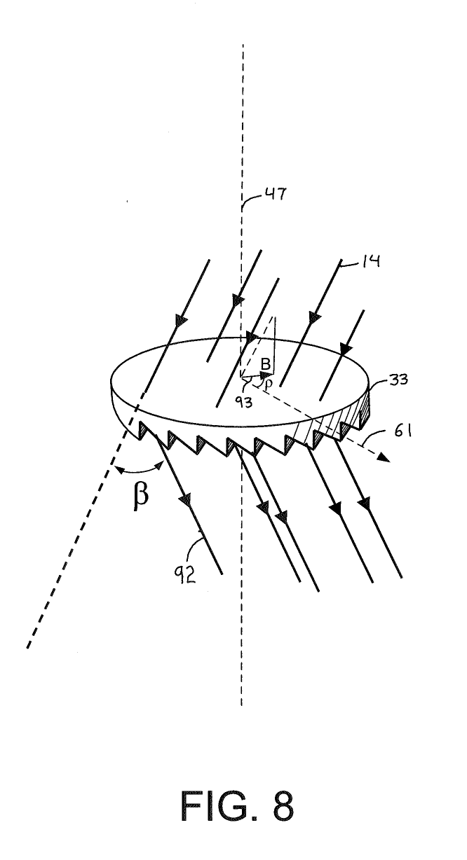

Having introduced a number of general considerations relating to benders, attention is now directed to FIG. 8 which is a diagrammatic perspective view illustrating the operation of a bender 33 as it receives a plurality incoming rays of light 14. As depicted in FIG. 8, and as will be described in greater detail hereinafter, all of the rays of light are parallel with one another, and bender 33 bends the rays in a way that may depend in part on the rotational orientation of the bender with respect to the incoming rays of light. Furthermore, unlike the IOA, the amount and direction of bending typically does not depend on where a given ray strikes the bender, and therefore each one of the plurality of incoming parallel rays of light is bent in the same way as the others such that the bender produces a plurality of output rays of light 92 that are all parallel with one another.

It is noted, as described immediately above, that the parallel relationship between the incoming rays of light is maintained during the bending, regardless of the rotational orientation of the bender, at least in part because (i) the incoming rays of light are all parallel with one another, and (ii) the incoming rays of light are all bent in the same way.

It will be appreciated by one of ordinary skill in the art that while the bender may be configured to have a rotationally symmetric overall shape, such as a circular shape as depicted in FIG. 8, the bending performance requires that there should be some functional form of asymmetry with respect to rotation about an optical axis 47 of the bender. As was the case regarding IOAs this asymmetry may be structural in nature (for example if the bender is configured using prisms) or the asymmetry may relate to optical properties of materials that are utilized within the bender. In view of these considerations regarding asymmetry, the rotational orientation of the bender can be characterized and described utilizing similar conventions and terminology established previously for specifying rotational orientation of IOA's.

As described immediately above, Bender 33 is configured to exhibit different bending performance depending on the orientation of the bender with respect to the incoming rays of light. In this regard, it is useful to establish a bender direction 93 as a reference direction that can be associated with the bender as illustrated in FIG. 8 as a vector B. Once established and/defined for a given bender, the bender direction is to be regarded as being fixed with respect to the bender such that the bender direction can serve as a reasonable reference for describing the orientation of the bender with respect to the incoming rays of light and with respect to the earths frame of reference. In view of the immediately forgoing description regarding asymmetry of the bender, and consistent with the disclosure as a whole, a person of ordinary skill in the art will readily appreciate that it is helpful at least for purpose of descriptive clarity to establish some form of reference feature, in this case bender direction 93, as a reasonable basis for specifying the orientation of the bender.

Since bender direction 93 remains fixed with respect to the bender, it is clear that any rotation of the bender results in a corresponding change of direction of bender direction 93, as illustrated in FIG. 8 by an angle ρ between the bender direction and a spatial coordinate axis 61. It is noted that coordinate axis 61 is to be regarded as being fixed in space, for example in the earth's frame of reference. In other words, as bender 33 rotates about optical axis 47, the rotational orientation changes in a way that can be specified as a changing value of angle ρ relative to the spatially fixed axis 61. In this regard, the angle ρ can be used to specify the bender direction relative to the optical axis of the bender. For descriptive purposes, certain aspects of the foreshortened terminology defined for IOAs will also be adopted for use in describing benders. In particular, the bender direction may be regarded as the direction the bender is “pointing”. Furthermore, for a given plurality of parallel incoming rays of light, and in terms of previously established nomenclature, the bender can be considered as “pointing toward” the light. In this regard, the bender is pointing toward the light if a projection of the light onto the surface of the bender is collinear with the bender direction. Furthermore, as will be described in greater detail hereinafter, when the bender is pointing towards the light in this manner, the bender performs in such a manner that the bent light is bent by an angle β and remains in a plane defined by incoming ray of light 14 and bender direction 93. Additionally, at times when these conditions apply with respect to incoming rays of sunlight, then the bender may be considered as pointing toward the sun.

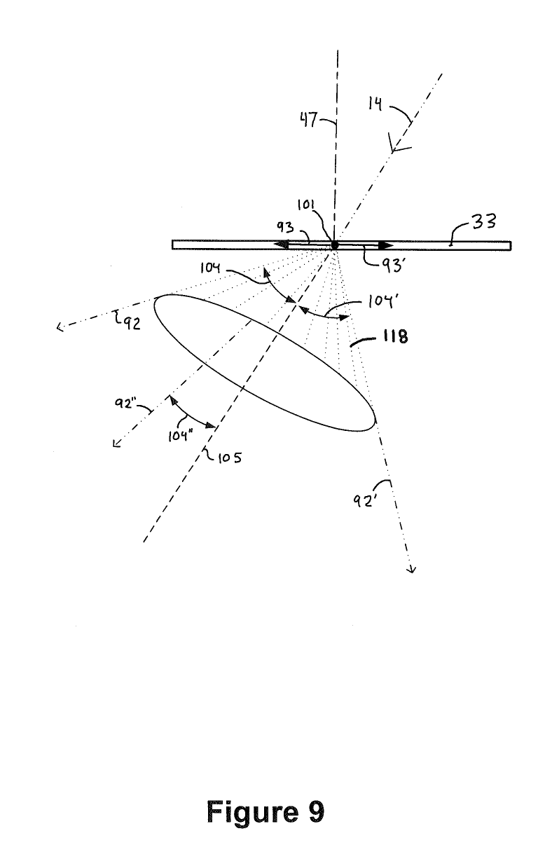

Attention is now directed to FIG. 9 in conjunction with FIG. 8. FIG. 9 is a diagrammatic elevational view illustrating the 3D nature of the bending action of bender 33. An incoming ray of light 14 encounters the bender at a point 101 and is bent in a way that depends on the rotational orientation of the bender, as will be described immediately hereinafter.

In a first orientation wherein the bender is rotated about optical axis 47 so that the bender direction 93 points away from the incoming light, as illustrated in FIG. 9, the incoming ray of light 14 is redirected to produce an output ray of light 92 that is bent by a bending angle 104 relative to an axis 105 that is a collinear extension of input ray of light 14.

In a second orientation of the bender wherein the bender is rotatably oriented about axis 47 such that bender direction 93′ points toward the incoming light, as illustrated in FIG. 9, the incoming ray of light 14 is redirected to produce an output ray of light 92′ that is bent by bending angle 104′, between output ray 92′ and axis 105, having the same angular value as angle 104 but corresponding to a different orientation as compared to that of output ray 92. In other words, based on the two different orientations of the bender with respect to the incoming ray of light, output ray 92 and 92′ are bent by the same amount but in opposite directions. It is noted that in these cases the direction of bending differs, but the amount of bending corresponds to the bending angle β.

In a third orientation the bender is rotated by ninety degrees with respect to both of the first and second orientations such that the bender direction (not shown) points out of the plane defined by the figure. With this orientation of the bender the incoming ray of light 14 is redirected to produce an output ray of light 92″ that is bent by a bending angle 104″, between output ray 92″ and axis 105, also having the same angular value as angle 104 but corresponding to a different orientation as compared to both of output rays 92 and 92″. It is noted that magnitudes of the bending angles 104, 104′ and 104″ all have the value β corresponding to the bending angle of the bender.

In a manner that is consistent with the foregoing three examples, rotation of the bender whilst maintaining incoming ray 14 in a fixed direction as illustrated in FIG. 8 causes the output ray of light 92 to sweep out the surface of an exit cone 118 such that the surface is defined as having the angle 104 with respect to axis 105.

With ongoing reference to FIGS. 8 and 9 it was generally assumed, for purposes of descriptive clarity, that the amount of bending relative to axis 105 remained constant and independent of the angle at which light enters the bender. This assumption can be invalid. For example, if the first bender is implemented using refractive optics, then the nonlinear nature of Snell's law can make the bending angle a function of the light ray entry angle and direction. The system still can still function, however. The non-constant nature of bending angle β warps or otherwise distorts the shape of the exit cone of the first bender optical element at least to some extent. For purposes of clarifying the foregoing point, it is again noted that in an ideal bender, that does not have a distorted exit cone, angles 104,104′, and 104″ all have the same value β corresponding to the bending angle of the bender. On the other hand, in the case of a non-ideal bender with a warped exit cone, these angles may differ somewhat from one another. This may add a certain degree of complexity to predictive calculations required to determine where the exit and acceptance cones intersect, and but the same basic principles are still in play, since even a substantially warped and/or distorted surface still bears substantial resemblance to that of a cone.

Having initially introduced concentrator 26 with reference to FIG. 3, and having described the basic operating principles of an IOA, with reference to FIGS. 5 and 6, and of a bender, with reference to FIGS. 8 and 9, various aspects of the foregoing descriptions relating to concentrator 26 will be re-introduced immediately hereinafter in order to combine, clarify and expand upon various details relating to the operation of concentrator 26.

Referring again to FIG. 3, and summarizing with respect to operation of solar concentrator 26, based in part on terminology set forth in the descriptions relating to FIGS. 5-9, optical concentrator 26 includes IOA 32 in a series relationship following a bender arrangement 33 with input surface 39 of the IOA facing towards the bender arrangement. IOA 32 and bender 33 are each configured for selective rotation to cooperate with one another such that the bender arrangement initially receives incoming rays of sunlight 14 and bends the incoming rays of sunlight, in a manner that is consistent with the descriptions in reference to FIGS. 8 and 9, to produce intermediate light rays 39 for acceptance by the IOA such that the intermediate light rays can be at least approximately oriented anti-parallel to the acceptance direction of the IOA. In one embodiment, the bender arrangement receives and bends the incoming rays to change their direction without causing any focusing of the incoming light rays, and in accordance with the descriptions relating to FIGS. 8 and 9, the bender may be rotatably oriented, at least with respect to the incoming rays of light, to bend the incoming rays of light such that the resulting intermediate rays of light have a direction that is aligned with the surface of the acceptance cone of the IOA, and the IOA can be rotatably oriented for accepting and concentrating the intermediate rays of light. In all cases, at least for a predetermined range of orientations of input rays of light 14, the bender arrangement (or some other input element) and the IOA cooperate with one another such that the bender is rotatably aligned in an orientation that allows the intermediate rays to serve as input rays 56 of the IOA (FIG. 5), and the IOA is rotatably oriented to accept the intermediate light rays (as input rays) and concentrate the intermediate light rays at focus region 41 in a manner that is consistent with the descriptions of an IOA appearing above with reference to FIGS. 5 and 6. In other words, the input element (for example, a bender) and the IOA can be rotatably oriented, with respect to one another and with respect to the input rays of sunlight, to cooperate with one another such that the intermediate light rays 39 are aligned to be at least approximately oriented anti-parallel to the acceptance direction of the IOA.

Based on the forgoing descriptions in conjunction with the disclosure taken as a whole, it may be appreciated that for a bender-IOA combination to serve as a concentrator for properly tracking the sun over a predetermined range of positions, such as, for example, a given range of positions corresponding with apparent motion of the sun throughout a given day, the aforementioned cooperation, between a bender arrangement and the IOA, can be reasonably achieved provided that the bender and the IOA are configured at least generally in accordance with the criterion that follow below.

Based in part on the descriptions relating to FIGS. 8 and 9 in conjunction with FIG. 3, for a given incoming ray of light that is received through an input aperture defined by bender 33 and incident on the input surface thereof, rotating of the bender about it's associated optical axis causes the resulting output ray of light to sweepingly define an exit cone such that for a given rotational orientation of the bender, the incoming ray of light is bent to produce an output ray of light that radiates away from a point of incidence of the incoming ray of light, and radiates away from the bender such that the output ray of light lies on the surface of the exit cone. As described previously in reference to FIG. 9, for a given incoming ray of light the corresponding exit cone of the bender at least approximately delineates the range of bending directions that may be selected, for a given input ray of light, by selectively rotating the bender.

It is to be understood that in the context of concentrator 26, output ray 92 of FIG. 9, produced by the bender from the incoming ray of light, is to be regarded as corresponding to intermediate ray 39 of FIG. 3, and as described previously, the intermediate ray in turn serves as the input ray of light for IOA 32 of FIG. 5. Combining and appropriately interpreting the descriptions and terminology relating to FIG. 3, FIG. 9, and FIG. 5, it should be appreciated that the output ray produced by the bender serves in the context of IOA 32 as the input ray that is to be accepted for bending and focusing by the IOA.

Considering now FIGS. 5 and 6 in the context of the immediately foregoing points, it will be appreciated by a person of ordinary skill in the art that in order for the IOA to accept and focus the output ray of light from bender 33, it is necessary that (i) the output ray of light from the bender lies on the acceptance cone of the IOA within some approximations, and (ii) the IOA may be rotatably oriented such that the acceptance direction is oriented to be anti-parallel with the output ray of light from the bender within some approximation.

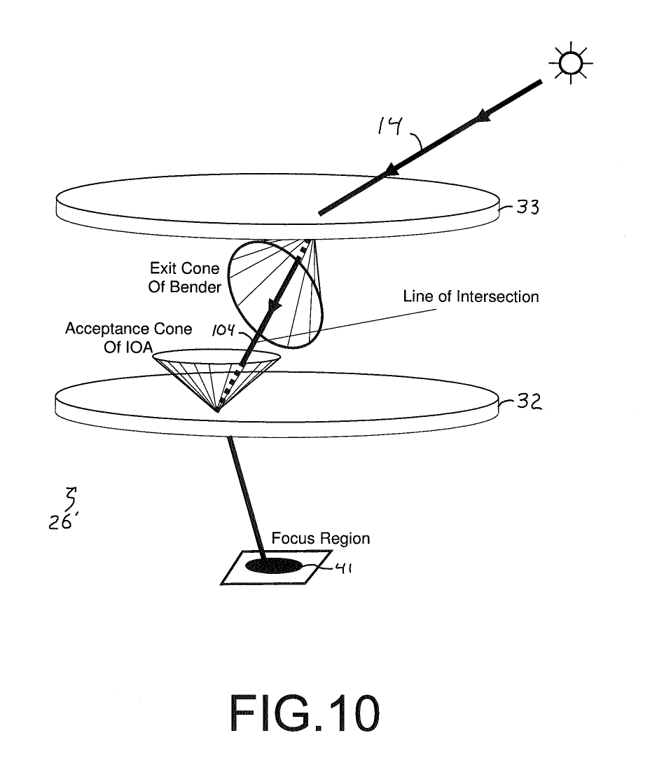

Attention is now turned to FIG. 10 the combined operation of a concentrator comprising a bender combined with an IOA as illustrated. FIG. 10 illustrates one embodiment of a bender-IOA concentrator generally indicated by reference number 26′ and configured such that the bender and the IOA cooperate with one another in the manner set forth previously. In order for concentrator 26′ to track the sun over a predetermined range of positions, throughout a portion of the day and/or including seasonal variations, bender 33 and IOA 32 are configured for compatibility with one another such that for each anticipated orientation of incoming rays of sunlight 14 (i) the associated exit cone of the bender intersects the acceptance cone of the IOA along a line of intersection 104 that extends from the bender to the IOA, (ii) the bender is rotatably oriented such that the output ray of the bender is collinear with the line of intersection at least to an approximation, and (iii) the IOA is rotatably oriented such that the acceptance direction of the IOA is collinear with the line of intersection 104 and therefore is anti-parallel with the output ray of light from the bender at least to an approximation. With the bender and the IOA selectively rotated for cooperating with one another in the manner set forth immediately above, the output ray of light from the bender serves as the input ray of light for the IOA, and the IOA bends and focuses this input ray of light for passage to focus region 41.

It is noted that as the sun changes position, the orientation of the incoming rays of sunlight changes and therefore the exit cone of the bender shifts and/or changes correspondingly, and the optical source can be tracked during these changes only for as long as the line of intersection is actually present between the two cones, and the tracking is achieved by adjusting the rotational orientations of the bender-IOA combination such that they cooperate with one another for receiving and concentrating the incoming rays of sunlight in the manner set forth above with reference to FIG. 10. In view of the foregoing point, it can be appreciated by a person of ordinary skill in the art that for a given position of the sun, the aforedescribed cooperation between the bender and the IOA can be achieved only insofar as the exit cone (of the bender) and the acceptance cone (of the IOA) overlap one another such that a line of intersection is present, and for each orientation of the incoming rays of light, corresponding throughout the day to the given position of the sun, this requirement for a line of intersection between the two cones represents a criterion that should be satisfied in order for the solar collector to concentrate the incoming rays of sunlight. It will be further appreciated that for a given day, at a particular geographic location, and at a given time of the year and a given view of the sky available to the concentrator, this criterion may in some cases set practical limits as to what range of sun positions during the day will produce light that can be tracked by the concentrator.

For further explanatory purposes, one example illustrative of a special case in which the relationships between various parameters are somewhat simplified as compared to more general cases will now be described. For simplicity, it will be assumed that for a given bender-IOA combination, all focus action is performed by the IOA, and that the bender serves only to bend the light by a particular bending angle β. For additional simplicity, it will be assumed in this example that the bending angle β is equal to the zenith angle ξ defined by the IOA.

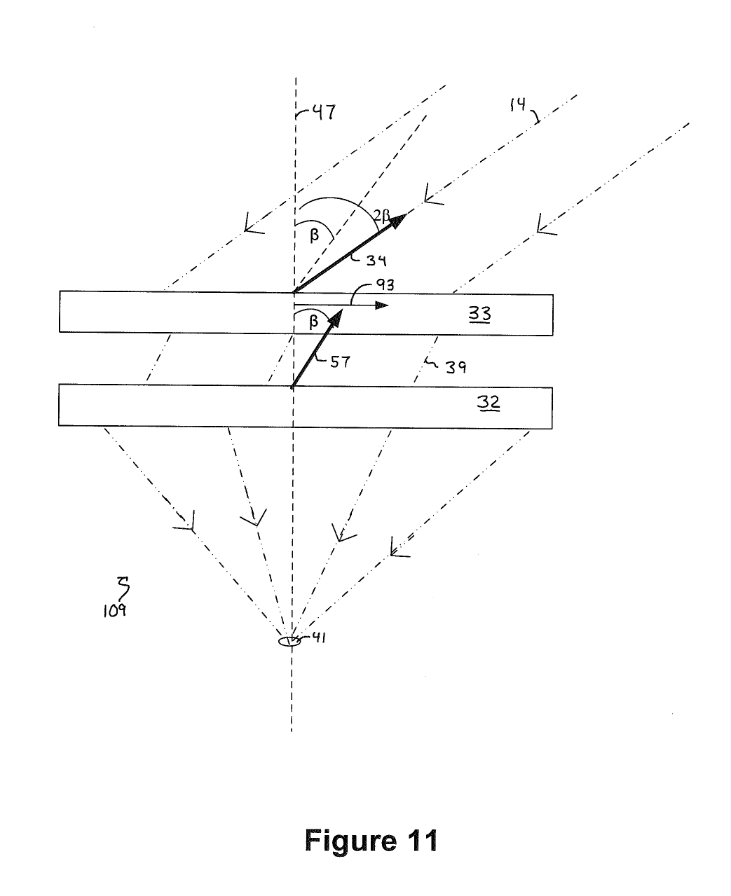

Attention is now directed to FIG. 11 which is illustrative of the special case under consideration. FIG. 11 is a diagrammatic view, in elevation, depicting one embodiment as a special case of a Bi-Rotational concentrator or BRIC generally indicated by reference number 109. For purposes of descriptive clarity it is noted that the view of FIG. 11 is taken in a plane that bisects the assembly such that optical axis 47 lies in the plane as shown.

Bender 33 and an IOA 32 are configured for rotation around optical axis 47. Furthermore, in the example at hand, the bender and the IOA are specifically matched with one another such that the IOA is configured with an acceptance direction (fixed with respect to the IOA) characterized in part by a acceptance angle ξ (the zenith angle of the acceptance direction relative to the optical axis) having a value equal to the bending angle β of the bender such that ξ=β. Furthermore, the incoming rays of light 14 lie in the bisecting plane and are oriented to enter the system at a receiving angle 2·β, (twice the IOA zenith angle β), relative to the optical axis 47. It is noted that for purposes of illustrative clarity the description with reference to FIG. 11 will initially be restricted to consideration of incoming rays of light 14 that lie in the plane of the cross section.

Bender 33 is configured, based on a particular design configuration that will be presented in detail hereinafter, such that the bending angle may be at least approximately constant regardless of the angle of the arriving light rays. The bender is rotatably oriented to be pointed towards the incoming light such that bender direction 93 of the bender lies in the bisecting plane and the bender receives the incoming rays of sunlight and bends these rays by a bending angle β having a magnitude equal to the zenith angle ξ of IOA 91 thereby producing intermediate rays of light 39 that lie in the bisecting plane and which are tilted with respect to the optical axis by angle β to match the zenith angle (ξ=β for the example at hand) defined by IOA 32.

IOA 32 is positioned and rotatably oriented such that the acceptance direction 57 (represented by vector \vec{A}) lies in the bisecting plane and is anti-parallel with respect to the intermediate rays of light such that the IOA bends and focuses the intermediate rays of light for concentration at a focal region 41 of the IOA.

While the foregoing description with respect to FIG. 11 has been restricted to a particular set incoming rays of light that lie in the bisecting plane, it is noted that in view of the disclosure as a whole, based on the operating principles set forth previously with respect to benders and IOA's, a person of ordinary skill in the art will recognize that a plurality of incoming light rays that are each oriented parallel with respect to this particular set of light rays will also be received and focused by concentrator 109 such that they are directed through focus region 41.

Having described the operation of optical concentrator 109 with respect to a particular orientation of incoming rays of light 14, it is to be understood that concentrator 109 may be utilized for receiving and concentrating other rays of light (not shown) that are oriented at different angles. For example, in a case where incoming rays of light 14 are oriented with the entrance angle having a different value that is substantially smaller than 2·β, then one or both of the bender and the IOA will need to be rotated to different orientations in order that they cooperate with one another to bend and focus the incoming rays of light in a manner that is consistent with the operating principles described with reference to FIG. 10 and previously in this disclosure.

For example, with respect to the embodiment of FIG. 11, for a given plurality of mutually parallel incoming rays of light having entrance angles substantially less than 2·β, the bender defines an exit cone, as described above in reference to FIG. 9, based in part on the orientation of the incoming rays of light, and the given plurality of incoming light rays is receivable, based on the appropriate rotational orientations of the bender and the IOA, as long as the previously described criterion is satisfied such that exit cone intersects the acceptance cone of the IOA along a line of intersection that extends from the bender to the IOA. It is noted that for receiving and concentrating the plurality of incoming light rays it is generally necessary to rotate the bender to align the intermediate rays to be collinear with the line of intersection, and it is also generally necessary to rotate the IOA for directing the acceptance direction to be collinear with the line of intersection in order that the IOA bends and concentrates the intermediate rays of light.

With ongoing reference to FIG. 11, it is again noted that the illustrated embodiment represents a special case wherein the bender and the IOA are configured such that bending angle β (defined the bender) is equal to zenith angle ξ (defined by the IOA). Applicants recognize that with respect to this particular embodiment, incoming rays of light that enter the concentrator in a parallel orientation with optical axis 47 can be received and concentrated regardless of the angular orientation of the bender. As mentioned previously, bender 33 is configured, based on a particular design configuration that will be presented in detail hereinafter, wherein the bending angle has a value β that may be at least approximately constant regardless of the angle of the arriving light rays. Therefore, incoming rays of light that enter the concentrator parallel with the optical axis will produce intermediate rays that are bent in the bender direction (the direction in which the bender points) by the amount β. In other words the incoming rays of light are bent by an amount towards the direction in which the bender is rotatably pointed. And, for the special case of incoming rays of light 14 that are parallel with optical axis 47, regardless of the orientation of the bender, the IOA can be oriented such that the acceptance direction of the IOA is anti parallel to the intermediate rays of light so produced.

### Vector Description of the BRIC

The following discussion describes a number of aspects related to determination of the correct orientations for the two IOAs to align the optical system to a given optical source. This discussion again assumes that bend angle 104 of the bender is not a function of input angle or direction, and that bend angle 104 has a value that is equal to the azimuthal angle ξ associated with the acceptance direction of the IOA such that ξ=β. As will be described immediately hereinafter, the operation of a bender may be described mathematically by decomposing a vector representing the incoming ray into three components, as based on a number of definitions that will be described immediately hereinafter.

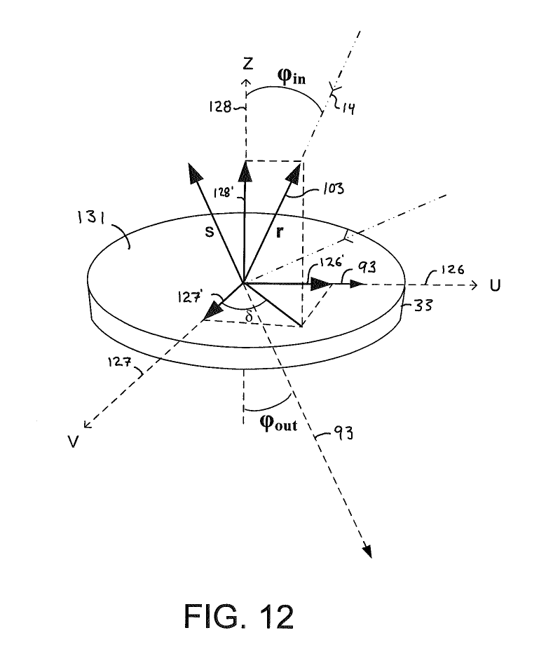

Attention is now turned to FIG. 12 which is a diagrammatic perspective view illustrating one embodiment of bender 33. FIG. 12 illustrates an incoming ray of light 14 incident upon bender 33. Incoming ray of light 14, and any other direction vector of interest, may be mathematically represented, in accordance with established principles of analytic geometry that will be familiar to a person of ordinary skill in the art, by decomposing the ray based on a coordinate system defined by three mutually orthogonal axes including (i) a ‘u-axis’ 126, a ‘v-axis’ 127, and a ‘z-axis’ 128. As illustrated in FIG. 12, z-axis 128 is aligned with the optical axis of the optical arrangement, and the u and v axes lie in a plane defined by an input surface 131.

The directional orientation of incoming ray of light 14 can be represented by a unit input vector 103 (of unit length) pointing in the direction of the incoming ray 14, and based upon the immediately foregoing definitions unit input vector 103 may be mathematically decomposed, in accordance with the aforementioned established conventions, for representation as a 3-vector r including u, v, and z components 126′, 127′ and 128′, respectively, with values rᵤ, rᵥ, and r_{z}, with each value corresponding to an associated projection of vector 103 onto the u-axis, the v-axis, and the z-axis. While 3-vector r is graphically depicted as pointing in opposition to incoming ray of light 14, it is to be understood that this is to be considered as an arbitrary convention defined for purposes of convenience, and that the 3-vector r, defined in this manner, corresponds with the orientation of incoming ray of light 14, and is not intended as corresponding with the direction of the incoming ray of light. In the equations that follow, all orientations will be mathematically represented based on this convention, and will be physically interpreted accordingly. It is further noted that while the bender itself may attenuate the light to some extent, the description at hand relates only to the bending of the light and not to attenuation and/or other modifications. In this regard, it will be appreciated by a person of ordinary skill in the art that that “normalized” vectors (of unit length) are appropriate for use as input as well as output vectors at least insofar as their use is restricted to descriptions relating to the bending, and not to attenuation and/or other modifications to the light. Thus, any incoming ray 103 can be mathematically represented using Cartesian coordinates as 3-vector r (having unit length) that is decomposed into u, v, and z components as follows:

$$\vec{r} = ( \begin{matrix}{r}_{u} \\ {r}_{v } \\ {r}_{z}\end{matrix} ) \qquad ( EQ 1 )$$

Analytic geometry may be utilized in conjunction with trigonometry and linear algebra in order to mathematically model the effect of passing a ray through the bender. For example, with the incoming ray entering the bender being represented by the 3-vector r of Eq. 1, the orientation of resulting output ray may be described by the 3-vector s, (also having unit length) utilizing the aforedescribed coordinates, as:

$$\begin{matrix}\vec{s} = ( \begin{matrix}{s}_{u} \\ {s}_{v} \\ {s}_{z}\end{matrix} ) = ( \begin{matrix}cos β & 0 & - sin β \\ 0 & 1 & 0 \\ sin β & 0 & cos β\end{matrix} ) \cdot \vec{r} \\ = ( \begin{matrix}cos β & 0 & - sin β \\ 0 & 1 & 0 \\ sin β & 0 & cos β\end{matrix} ) \cdot ( \begin{matrix}{r}_{u } \\ {r}_{v} \\ {r}_{z}\end{matrix} )\end{matrix} \qquad ( EQ 2 )$$

The 3-vector s is a unit vector that merely describes the orientation of output ray 93, and is not to be interpreted as representing the physical ray itself. In particular, 3-vector s of Equation 2 corresponds with the orientation of the output ray of light, but is not intended for correspondence with the direction of the output ray of light. A person of ordinary skill in the art will readily appreciate that the foregoing matrix equation implies the v-axis component remains unchanged during the bending such that sᵥ=rᵥ, and therefore the bending action of the IOA may be regarded as being restricted to lie within the u-z plane. Furthermore, in view of this recognition and based on the foregoing mathematical description, it can be appreciated that the U axis corresponds with bender direction 93 in accordance with previous descriptions in reference to FIG. 8, and as illustrated by the presence in FIG. 12 of bender direction 93 overlying u-axis 126. Using the terminology set forth previously in reference to FIG. 8, if a particular in-plane input ray (not shown) lies in the u-z plane, it will remain in the u-z plane during bending, and this orientation of the bender direction relative to the incoming ray of light corresponds with the previously described scenario wherein the bender is pointed towards the incoming ray of light. Based on previously introduced terminology, a case wherein the incoming ray of light lies in the u-z plane of FIG. 12 represents a case where the bender is to be regarded as pointing toward the incoming rays of light.

While the bending action may be calculated in Cartesian coordinates in accordance with the foregoing descriptions, a person of ordinary skill in the art will readily appreciate that the performance of the system may also be characterized based on other systems of coordinates, even while the above mathematical technique may be utilized, provided that the appropriate conversions between coordinate systems are properly executed and are performed at an appropriate step of any given overall determination. For example, an orientation of the incoming ray of light 14 may be characterized using a first angle φᵢₙ (relative to the optical axis) and a second angle δ (relative to the v-axis), as illustrated in FIG. 12, and well known techniques may be employed for converting this orientation to the system of Cartesian Coordinates defined above, at which point the formula above may be employed for characterizing the bending. The resulting 3-vector s can be converted back to polar coordinates (again using well known mathematical techniques) to find φₒᵤₜ represented in FIG. 12 as the angle of the light 93 exiting bender 33 relative to the optical axis. The resulting equation for φₒᵤₜ is:

$${φ}_{out} = {tan}^{- 1} ( \frac{\sqrt{{( \begin{matrix}sin {φ}_{i n} \cdot cos δ \cdot cos β - \\ cos {φ}_{i n} \cdot sin β\end{matrix} )}^{2} + {sin}^{2} {φ}_{i n} \cdot {cos}^{2} δ}}{sin {φ}_{i n} \cdot cos δ \cdot sin β + cos {φ}_{i n} \cdot sin δ} ) \qquad ( EQ 3 )$$

It will be further appreciated by a person of ordinary skill in the art, that these calculations may also be performed as numerical computations by utilizing well known analytical optics techniques. For example, in many cases ray tracing may be employed for simulating the operation of a specific bender, IOA and/or combination thereof.

Based on the analytical techniques described above, in conjunction with well established techniques associated with physical optics, and in view of this disclosure as a whole, a person of ordinary skill in the art will appreciate that a special case of a concentrator 109 described with reference to FIG. 11 may be utilized for tracking the sun over a wide range of positions throughout the day. For example, it may be readily appreciated that concentrator 26′, configured with ξ=β=22.5 degrees and located in Boulder Colo. (with the concentrator facing such that is tilted south at an angle of approximately 40 degrees from horizontal), is capable of tracking the sun throughout a substantial portion of a given day. It is again noted that concentrator 26′ is capable of achieving this performance based solely on rotation of the bender and the IOA, and does not require any additional tracking mechanism in order to achieve this remarkable performance.

### Shaping of IOA Acceptance Ray Profile

In the foregoing discussions, the term ‘focal region’ rather than ‘focal point’ has been used to describe the location of concentration of light rays from a lens. This distinction has been made since the term ‘focal point’ applies to a more traditional imaging optics where collimated light focuses to a point. Instead of being designed with techniques restricted to imaging optics, an IOA can be constructed using analogous methods (such as non-imaging Fresnel concentrating lens techniques), wherein the light rays are directed into a focus region and never converge to a point. One approach to accomplishing this is to directly incorporate a non-imaging Fresnel concentrating lens as part of an optical IOA arrangement. Another general approach is to employ non-imaging optical principles in the design of the IOA. It is noted that a good source on the design of non-imaging lenses can be found in Nonimaging Fresnel Lenses: Design and Performance of Solar Collectors by Leutz and Suzuki, which is incorporated herein by reference. By employing non-imaging optical techniques in the design of an IOA, it is possible to increase the range of directions about the acceptance direction wherein light entering the IOA will still be concentrated and directed into the focus region. In other words, it is possible to exploit the nature of a non-imaging IOA in order to decrease sensitivity to misalignment of the incoming rays of light, such that within a predetermined range of misalignment, the incoming rays of light are nevertheless received and concentrated into the focal region.

As described in the reference by Leutz and Suzuki referred to above, the design of a non-imaging lens involves processing the boundary of the input aperture of the lens and designing the optics so that an input ray of light that is misaligned will still be directed into a particular region. The Leutz and Suzuki references consider only the magnitude of misalignment and thus the range of allowable misalignment is circularly symmetric. Applicants recognize that this is not a requirement, and that by configuring an optical arrangement such that misalignment design values are a function of the direction of the incoming ray, non-imaging optical arrangements can be created that have an asymmetric range of allowable input rays. Applicants further recognize that by utilizing these principles, an IOA can be designed so that the incoming ray distribution can be more oval shaped, which can have the advantage that the sun's path traverses the long axis of the oval, thus requiring less frequent or less accurate movement to track the sun.

For a concentrator comprising a given combination of optical arrangements the design of a given concentrator acceptance range may in many cases be complex, the required analytical techniques are believed to be well described in the Leutz reference, and applicants believe that a person of ordinary skill in the art having this disclosure in hand, will be readily able to implement a number of embodiments based on the descriptions herein. Introducing foreshortened terminology for describing the functioning of a concentrator such as concentrator 26, and variations thereof, a concentrator may be regarded as defining a concentration ratio based on the area of the focal region and the area on the input aperture defined by the concentrator. Furthermore, a concentrator that is configured with a given concentration ratio generally will receive and concentrate rays that are within a given range of misalignment angles. This range of misalignment angles can be considered as defining a “field of view” of the concentrator defined herein as a range of positions of the sun in the sky from which light may be received and concentrated without employing any tracking motion, rotational or otherwise. For example, the field of view of concentrator 26 is that range of positions of the sun in the sky for which concentrator 26 is capable of receiving and concentrating light without performing any rotational adjustments. It is to be understood that the field of view as described above does not account for the question of whether the sun ever actually occupies all the positions in the field of view, and that it is possible to configure a solar concentrator to exhibit a field of view that includes vacant positions that the sun never actually occupies, regardless of the time of day or the time of year. Applicants are aware that even non-imaging optical systems tend to be governed by the well known and fundamental principles of optics that impose theoretical limits with respect to field of view of imaging and non-imaging systems alike. In this regard, a concentrator system having a wide field of view that includes a wide range of vacant positions in the sky may be perhaps be considered as wasting at least a portion of the field of view. Applicants recognize that a wide-field system having circular symmetry may be inherently wasteful in this respect since the sun tends to follow an at least somewhat linear trajectory, and that such a system may be modified to change the shape of the field of view to another shape that more closely matches a given path of the sun in the sky, to account for daily and/or seasonal variation of the position of the sun in the sky.

Concentrators function by taking the light from a given area and focusing the light to a smaller area. A symmetrical circular 10× concentrator may receive sunlight through a circular aperture defined by the concentrator, and may concentrate the received sunlight by bending and focusing the light to a focus region that is 1/10^{th} as large as the input aperture. A solar energy application represents a special case where the light source is continuously moving but the path of the light source is known. These applications typically employ concentrators that take the sun's energy from a near circular area and concentrate it to a smaller circular or square area. This requires that the optics track the sun throughout the day. The greater the concentration, the closer the input light area is to the size of the sun in the sky and therefore the more stringent the tracking requirements. In applications of low concentration, the tracking can be more tolerant since the sun can move through the larger field of view before adjustment of tracking is required.

Attention is now turned to FIGS. 13 A and 13 B which are diagrams, generally indicated by reference number 130 and 130′, respectively, illustrating fields of view 133 and 133′ including a range of positions 136 of the sun as the sun moves through a predetermined portion of a given day. It is noted that FIGS. 13A and 13B both depict the same range of positions 136, but that field of view 133′ in FIG. 13B is substantially smaller than field of view 133 in FIG. 13A. FIGS. 13A and 13B illustrate the concept that tolerance in positioning is less critical for lower concentration, based on the principle that a lower concentration system tends to have a wider field of view, and it can be appreciated based on FIGS. 13A and 13B that it is possible to avoid repositioning the field of view for some time as the sun makes its way across the field of view 133, while more frequent repositioning will be needed in a higher concentration having field of view 133′.

With ongoing reference to FIG. 13A, based on the terminology set forth above with regard to general discussions and definitions for the field of view, it is noted that at least a portion of field of view 133 may be regarded as being wasted since it appears to include a substantial portion of vacant positions in the sky, and Applicants recognize that it may be therefore be advantageous to stretch the field of view to at least better match the sun's path that is indicated by way of consecutive positions 136.

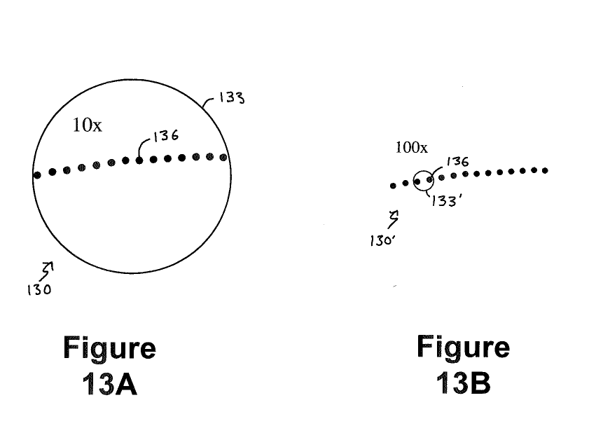

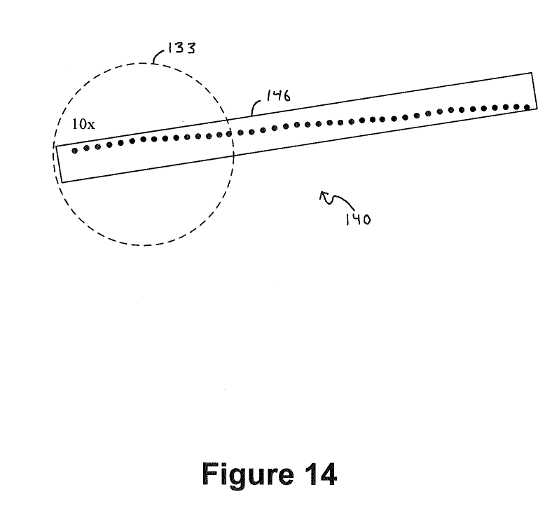

Attention is now directed to FIG. 14 with reference to FIG. 13A. FIG. 14 is a diagram, generally indicated by reference number 140, illustrating a field of view 146 that is stretched to match the sun's path. A stretched Field of view 146 corresponds with a magnification of roughly 10× and has an area that is approximately the same as field of view 133 (field of view 133 is initially shown in FIG. 14, overlaying field of view 146 and represented with a dashed line). It is clear from FIG. 14 that a modified concentrator exhibiting stretched field of view 146 covers more of the sun's path as compared to an unmodified concentrator exhibiting field of view 133, and therefore the modified concentrator can maintain tracking of the sun in a way that requires less repositioning. Thus, by designing the field of view to match the sun's motion through the sky, it is possible to reduce the tracking requirement of the panel and/or relax mechanical performance specifications that relate to the associated tracking mechanism. While it is possible to employ this approach in conjunction with conventional solar collectors, Applicants recognize that this approach may be especially advantageous when employed in the context of concentrators described in this overall disclosure, especially since the non-imaging optics utilized for producing IOA's lends itself well to configuring the field of view in a customized way.

For example, by modifying a concentrator to provide a field of view that is stretched to match the path of the sun (or other predictable light source) in the manner described immediately above, the need to reposition can be reduced. For example, if IOA 32 of concentrator 26 is modified for producing a field of view having a stretched shape similar to the field of view of FIG. 14, it may be possible to relax certain specifications and/or requirements related to tracking, especially with respect to mechanical specifications and/or requirements that relate to rotation of the IOA. For example, it may be possible to reduce a required range of rotation, and to also reduce the number of times during the day that the rotational orientation is adjusted. It is noted that this approach can also be applied to mechanical tracking systems or combined IOA/mechanical trackers. As one possible simplification, it may be possible to configure a tracker for tracking the sun based on a set of discreet ‘resting’ positions as opposed to a smooth and continuous profile of positions. For example, concentrator 26 could be modified for rotational orientation of one or more optical arrangements (benders and/or IOAs) and the field of view could be sufficiently stretched such that in order to track the sun throughout a given day the concentrator is only required toggle between two receiving directions—for example a first receiving direction for the morning, and a second receiving direction for the afternoon. Alternatively, concentrator 26 may be modified for defining a set of discreet receiving directions and to change from one to the other on an hourly basis. Applicants recognize that a tracker that locks into fixed positions, at least generally in accordance with the foregoing descriptions, may be less expensive to implement than a continuous tracker.

### IOA Tracking

It is to be appreciated that the method of tracking disclosed herein provides a number of remarkable advantages as compared with traditional concentrator systems and associated methods. Perhaps the most significant advantages stem from the simplicity of the drive mechanisms needed to implement this technology. For example, in the context of concentrator 26, a tracking concentrator system, for example including a bender and an IOA, can utilize two sets of moving parts that are independent of one another such that moving the IOA does not move the bender, and vice versa. Furthermore, as described previously in reference to FIG. 3, the configuration of the optical system can be compact, at least along the direction of the optical axis, and does not change position or form-factor as the system is tracking. This allows a rotating drive mechanism (for rotating a bender and/or an IOA) to be placed inside the product package, such as a low profile panel and/or enclosure, for shielding the drive mechanism from weather and wind. This in turn significantly reduces the requirements related to environmental resistance, at least for any actuators, drive mechanisms and/or control systems that are required for rotatably adjusting the IOA and the bender. The use of optical concentrators that track the sun based solely on rotational motion may significantly reduce the cost of optical tracking and enable its use in applications that were previously impractical at least for reasons relating to cost and/or size of conventional trackers.

Applicants recognize that there are yet further advantage associated with configurations that rely solely on rotation for tracking the sun. At least with regard to mechanical considerations, it is noted that rotation is often easier to accomplish than translation, and can therefore be achieved at lower cost. In addition, moving mechanical components that rotate are capable of being balanced. For example, at least with respect to embodiments that are configured such that the rotating optical arrangements (benders and/or IOAs) are inherently balanced, the system may be arranged such that the only torque required by the tracking actuators is the torque required for acceleration and overcoming friction. If the optical tracking application is fairly slow, as it generally is in solar applications, then the torque requirements become minimal. This further reduces the size, complexity, and cost of the implementation.

Applicants further recognize that it may be advantageous to modify a low cost conventional concentrator, at least with the addition of an IOA, in order to improve tracking performance while relaxing certain requirements with respect to the associated tracking mechanism. A person of ordinary skill in the art, having this disclosure in hand, may identify a concentrating system with a simple low cost tracking mechanism, and may then improve the system at least by addition of an IOA such that the modified system includes a fine adjustment, in part resulting from the use of the IOA for improving tracking performance.

Another class of advantages of the IOA-based optical trackers is that the target of the optical system need not move. For example, in an IOA tracking solar photovoltaic (PV) concentrator, the target of the concentrated light, the PV cell, does not move as the system tracks. A stationary optical path is clearly easier, and therefore less expensive, to implement. Additionally, in the solar concentrator example, the stationary PV cell can eliminate the need for moving the conductors that carry the power away from the cell and can significantly simplify the removal of excess heat from the target.

As described in greater detail hereinafter, a solar collector may be configured that utilizes an array of one or more concentrators to redirect and focus the sun's rays on receivers that are configured for absorbing the concentrated light for conversion to a form of power such as electricity or thermal power. Each concentrator may include at least one optical element (IOA or bender) that is supported for rotation as at least part of focusing the sun's rays onto an unmoving target. If more than one optical arrangement (such as an IOA and/or bender) is utilized, then the first optical arrangement to interact with the incoming light may serve as an input arrangement for initially receiving incoming rays of sunlight. In effect, the concentrators act as a solar tracker so that the target, electrical connections and support structure of the assembly need not move and the only moving parts are rotatable optical arrangements in the concentrators, and their associated drive mechanisms and components thereof. Applicants recognize that the panel can be movable (e.g. with an external 1- or 2-axis tracker) and in this case the internal target tracking could be used as a secondary tracker or as an integral part of the whole tracking system. Thus, one approach is to utilize an external mechanical tracker as a coarse (not highly accurate) tracker with an internal BRIC tracker/concentrator acting as a fine tracker utilizing rotation of optical arrangements as described throughout this disclosure. This particular approach may be utilized to relax requirements associated with the external mechanical tracker to allow the tracker to be designed with a lower cost configuration.

Having described the operation of concentrator 26, and having described various details with respect to the operation and characteristics of benders and IOA's. A number of general system level considerations relating to solar concentrators will be presented immediately hereinafter.

### One-IOA Systems

Overall concepts relating to two distinct one-IOA designs will be described hereinafter. A first one-IOA embodiment is a 1-dimensional array having one or more IOAs for focusing light onto a linear target. The concentration gain is not as great as compared with a 2-dimensional concentrator (such as concentrator 26). However, Applicants recognize that this first embodiment may provide advantages at least for use with solar-thermal systems where the target may be linear in nature, such as a pipe, though this first embodiment may also be applicable for use with a linear array of PV cells. The IOA itself may include a bender followed by a concentrator. The concentrator may be a 2-dimensional (point-type) concentrator (such as a conventional lens), or a 1-dimensional (line-type) concentrator (such as a cylindrical lens) that is mounted parallel to the 1-dimensional target. Thus, the concentrator may be physically independent of the rotatable IOA, or may be partially combined with the rotatable IOA.

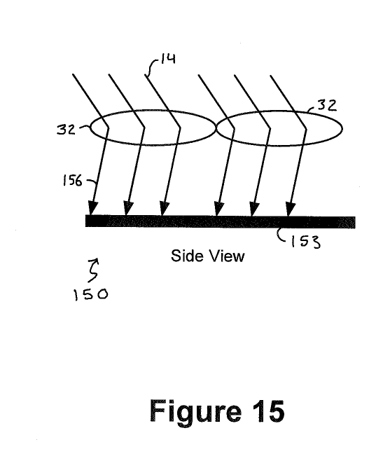

Attention is now directed to FIG. 15 which is a diagrammatic representation, in elevation, of a linear concentrator configuration, generally indicated by reference number 150 and employing an array of two IOA's 32 configured for receiving input rays of light 14 concentrating the light along the axis of a linear target 153.

The IOA's are controlled, for example by a drive mechanism (not shown) to rotate and to continuously point towards the incoming rays of sunlight and to direct the exit rays to the target 153. IOA output rays 156 may move up and down the target (left and right in FIG. 15) since there is only one IOA per concentrator to correct for one axis of the sun's position. Typically, the IOA output rays striking the target will be incident at an angle (not perpendicular) to the target, however the IOA output rays may enter perpendicular to the target at specific times during the day when the sun's ray angle matches the IOA bend angle such that the IOA output rays leave perpendicular to the IOA and are directed towards the target.

As one aspect of the operation of concentrator system 150, with the target oriented East-West, then seasonal North-South variation of the sun can be fully corrected. Four examples are worth noting to understand this system. When the sun is in the east with no northern or southern displacement, then the IOA may rotate so that the light is bent toward the target—with no north or south bending since the sun is already on a target-IOA plane. When the sun is in the north and the day and the time are such that sun is positioned along the acceptance direction of the IOA, then the incoming rays of sunlight will bend downward to the target with no east or west component. A similar configuration occurs when the sun is in the south. These last two examples result in the sun's rays entering the target perpendicularly.

Of interest are the cases when the IOA bend angle is less than the sun angle, or when the IOA bend angle is more than the sun angle. In these cases, the sun angle of concern is the angle between the sun's rays and the plane made by the target line-IOA line. With an east-west orientation of the target, the important sun angle is the north-south angle since any east-west angle will not need to be corrected in order for output rays 156 to strike the target, since the sun's rays will be allowed to strike the target with an angle along the target axis (east-west). If the IOA bend angle is less than the sun angle, then the IOA will correct part of the sun's angle, but not all of it and so the rays may strike the target at an angle, but the rays will strike the target at a steeper angle (more perpendicular) than if the IOA were not present. Alternatively, if the IOA bend angle is greater than the sun angle, then the incoming rays of light are focused on the target, but will strike the target at an angle in the opposite direction than if no IOA were present. In fact, there should be a point such that the angle of the sun equals the bend angle and then the rays that fall on the target will be directly below the exit rays from the IOA. For example, if the IOA bend angle is 30 degrees, then the sun's position should be at 30 degrees to have the light rays striking perpendicularly to the target. This 30 degree angle is the total angle made up of the vector sum of the east-west angle and the north-south angle.

As can be seen, the rays will strike the target perpendicularly two times during the day (when the sun is east at the bend angle, and when the sun is west at the bend angle). Thus, if the panel assembly of the IOAs is continuously rotated, then it may be possible for the rays exiting the IOA to strike the target perpendicularly at all times. This in effect becomes a 2-axis tracker with one axis external to the panel that moves the whole panel, and one axis internal to the panel that bends the light to the target. Note: the two axes are not necessarily orthogonal.

IOA with Mechanical Tracker

This second embodiment separates the tracking motion of the panel into two different tracking methods. Traditionally, a solar panel is either fixed (not moving) or is moving so that it is pointed toward the sun—this is generally referred to as “tracking”. (The solar panel has a “direction” which is the perpendicular to the surface of the panel in the direction of the incoming light: thus when the solar panel is pointed toward the sun, the panel is positioned so that the light enters the panel at right angles.) Oftentimes, depending on the configuration of a given solar collector, there may be at least two motivations for tracking the sun: (i) when tracking the sun, the amount of sunlight that enters the panel may be increased as compared to a fixed non-moving panel, and (ii) typical concentrating solar panels often require the sunlight to enter the panel at a constant angle at all times—thus as the sun moves across the sky, the panel can rotate in relation to this movement such that the panel points directly toward the sun. By contrast, a fixed non-moving panel receives less light in the morning and evening due to the shallow angle of the light entering the panel which is commonly called the ‘cosine effect’. This is such a large effect that a number of manufacturers of traditional solar panels presently offer tracking on their panels to recover this lost morning/evening power.

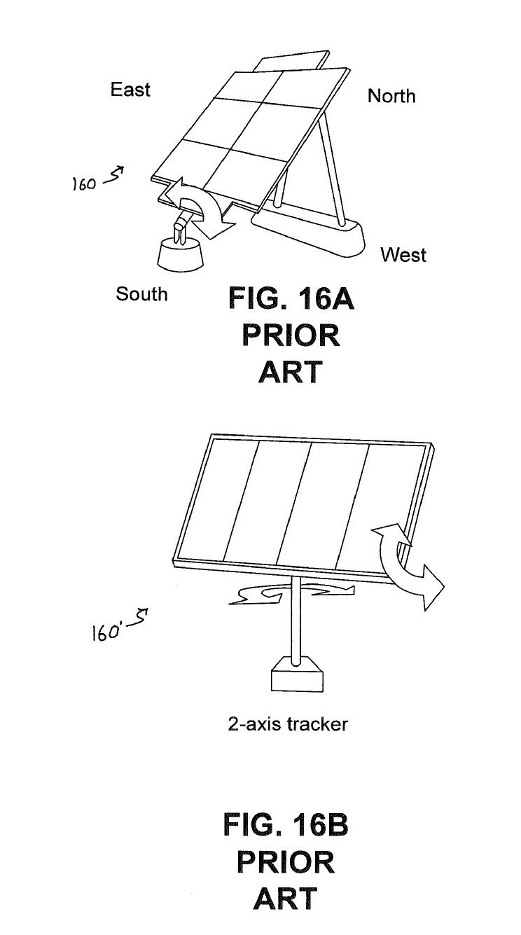

Attention is now directed to FIG. 16A, which illustrates a perspective view of one embodiment of a conventional one axis tracker generally indicate by reference number 160. Different levels of tracking are common: one relatively simple case is a one-axis tracker where the panel is pointed (its direction normal to the surface where the light enters the panel) about the East-West direction of the sun's daily motion, but not the North-South direction of the sun's seasonal motion as shown in FIG. 16A. Thus, in the morning, the panel can be pointed to the east in the general direction of the sun, and throughout the day the panel may rotate about a north-south axis of rotation so that the panel will be pointed to the west during the evening. (The axis of rotation is commonly tilted to further improve the amount of light entering the panel, and this tilt is often preferably arranged to be comparable to the latitude of the installation.) Because the sunlight may not enter the panel perpendicularly at all times throughout the year, this method may not be suitable for concentrated solar panels that typically require the light to enter nearly perpendicular to the panel surface. If the panel has a one-axis tracker, then seasonal variations may result in a +/−23.5 degree entrance angle to the panel with an additional possible daily angle error if the panel is tilted too far in front of the sun or too far behind the sun. Thus a one-axis tracker in some cases may not applicable for a concentrating system.

Attention is now turned to FIG. 16B, which illustrate perspective views of a conventional two axis tracker generally indicated by reference numbers 160′. The two axis tracker shown in FIG. 16B rotates to follow the sun in the east-west daily motion as well as the north-south seasonal motion. Thus it is possible for the sunlight to enter the panel in a fixed (perpendicular) direction at all times of the year and throughout at least a substantial portion of each day. Due to typical construction techniques, a given two axis tracker may be much more complex and costly than a given one axis tracker. Thus, a two-axis tracker is primarily used for concentrator panels where the panel can point toward the sunlight with a very small angle error and one-axis trackers are primarily used for non-concentrator panels where the light may enter off of the panel.

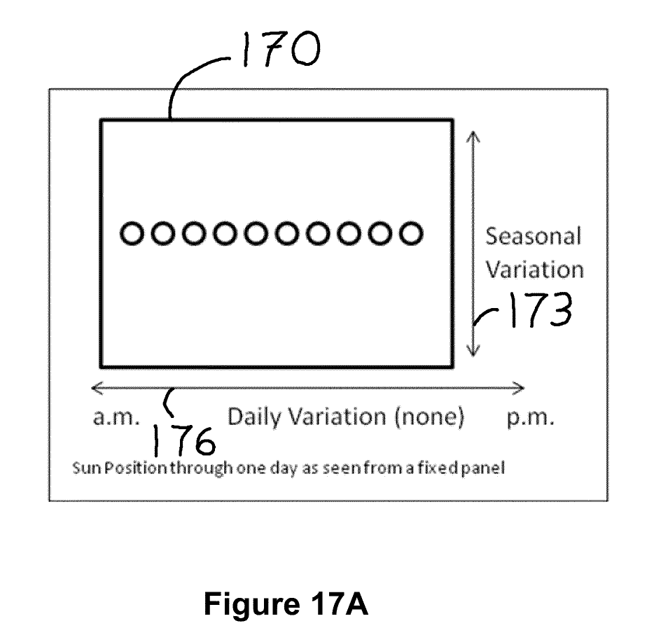

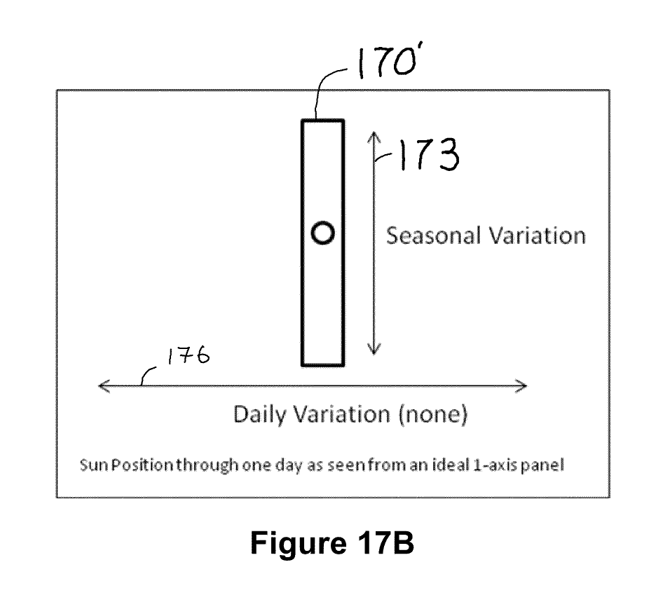

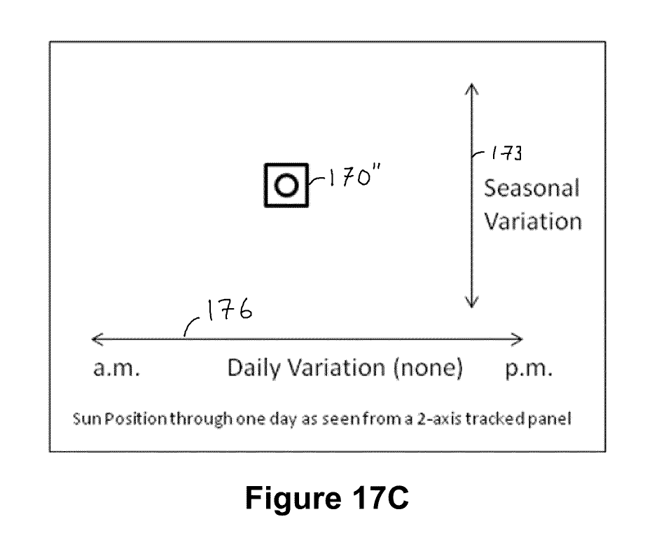

Attention is now directed to FIGS. 17A, 17B, and 17C which are diagrammatic representations illustrating three different fields of view generally indicated by 170, 170′ and 170″, respectively, that may be each associated with a different solar collector (or solar concentrator). FIG. 17A illustrates effective field of view 170 that may be associated with a non-tracked (fixed) solar collector such as a conventional PV solar panel. FIG. 17B illustrates a field of view 170′ that may be associated with a solar collector (or solar concentrator) that employs one-axis tracking, and FIG. 17C illustrates a field of view that may be associated with a solar collector (or solar concentrator) that employs two-axis tracking. In FIG. 17A, the associated solar collector may receive and collect incoming rays of sunlight with the sun in locations from +/−23.5 due to seasonal variation 173 and from +/−90 due to daily variation 176.

FIG. 17B illustrates field of view 170′ associated with a collector wherein a one-axis tracker has been incorporated such that field of view 170′ associated with viewing and/or with receiving and concentrating sunlight during daily variation is reduced as compared to field of view 170 (FIG. 17A) such that field of view 170′ covers an annual seasonal variation 176 where the sun is high in the summer and low in the winter as illustrated in FIG. 17B by a double headed arrow representing seasonal variation 176, and it is to be understood that the associated one axis tracker may be configured for tracking daily variation 173 indicated by a double arrow in FIG. 17B.

FIG. 17C illustrates field of view 170″ associated with a solar collector wherein a two-axis tracker has been incorporated such that field of view 170″ associated with viewing and/or with receiving and concentrating sunlight during daily variation is reduced as compared to field of view 170′ (FIG. 17B) such that field of view 170″ covers no seasonal or daily variation, and it is to be understood that the associated two axis tracker may be configured to track seasonal variation 173 and daily variation 176.

With ongoing reference to FIG. 17B it is noted that if the associated one axis tracker exhibits a certain degree of error, then an IOA can be utilized in accordance with previous descriptions, to compensate for this error. Referring to FIG. 17C it is noted that the associated tracker is required to track the motion of the sun at all times during the day and throughout the year. The accuracy of tracking typically required for this form of two axis tracking may be prohibitively expensive and may require a mechanically stiff structure to maintain the required orientation while supporting an array of panels. It is noted that IOAs may be incorporated in the associated collector such that IOAs are able to contribute to correcting errors in the overall tracking to allow for relaxed specifications relating to tracking requirements, for example as described in reference to FIGS. 13 and 14.

Returning to FIGS. 17B and 17C, the assumed one or two axis tracking is compatible with an associated embodiment of a solar collector that that utilizes at least one solar concentrator having field of view 170′ or 170″, respectively. By incorporating a light bending optical arrangement, such as a bender or an IOA, the incoming rays of light may be redirected toward a receiver, such as a PV cell or light/heat gathering elements. Thus, an angle between the optical axis of the concentrator and the incoming rays of sunlight is the bend angle of the IOA, and the incoming rays of sunlight may be redirected to the target receiver. Previously, it was demonstrated how two optical arrangements may be configured to redirect the light so that light entering a concentrator anywhere within a range of receiving directions can be received and concentrated. This same method can be used here so that as the concentrator is moved by a one axis tracker, an IOA can correct for any non-normal sunlight angle so that the light exiting a given IOA is normal to the receiver surface. In fact, since the tracker may be regarded as relaxing the requirements as to the receiving range of the concentrator, the optical arrangements may be rotatably aligned to correct for a smaller angle error. Thus the tracker may be made at a lower cost or with different requirements with the understanding that any smaller tracking errors may be compensated by rotation of the optical arrangements. Furthermore, for a tracker that supports a plurality of IOA and/or bender or bender equipped concentrators, since each IOA and/or bender-equipped concentrator can independently correct for tracking errors, mechanical specifications and/or requirements of the tracker may be relaxed so that angular variations across the tracker from one concentrator to another can be corrected separately in each of a plurality of concentrators used in a given multi-concentrator system. With this in mind, it is recognized that an associated tracker could be configured in a cost-reduced manner such that it does not move smoothly throughout the day and perhaps has fixed positions that it rests in and ‘ratchets’ between these fixed positions throughout the day.

If a single optical arrangement (such as a bender or an IOA) can bend the light more than the seasonal variation (+/−23.5°), then the single optical arrangement can correct for the North-South seasonal error while the 1- or 2-axis tracker will correct for the daily sun position. The addition of the optical arrangement allows for the 1- or 2-axis external tracker to be simpler in design and less accurate in its positioning. In the simple case of Spring Equinox when the sun is passing directly over and perpendicular to the panel, at noon, the optical axis of a panel may be tilted east or west (relative to the sun location) by the bend angle so that the input optical arrangements thereon would see the sunlight entering at the bend angle and bend the light so that it is normal to the surface inside the panel and can subsequently be concentrated onto the target. Since the optical arrangement may correct for any light entering at the bend angle and the seasonal variation is less than the bend angle, then there is a panel orientation such that the light will enter the panel at the bend angle so that the optical arrangement can bend the light and concentrate the light onto the target. (Note: at Winter Solstice when the sun is 23.5° below (south) of the normal of the panel, then the 1-axis tracker would point the panel toward the sun direction—in the east-west direction—and the optical arrangement would correct for the low sun entrance angle.) Thus the 1-axis tracker may adjust so that the sun is entering at the angle that is required by the optical arrangement in order to provide the needed corrections with respect to tracking the sun, and a single optical arrangement combined with a 1-axis tracker can be used to orient the sunlight in the panel for use in a solar concentrator. Similarly using an IOA-bender configuration may allow a greater range of sun angle corrections and permit the panel to be oriented perpendicular to the sun without requiring a panel offset to compensate for the IOA bending angle.

As another embodiment of this method, a light bending film could be applied over an entire solar panel that supports a plurality of concentrators, such that light entering all the concentrators in the panel is pre-compensated (or “biased”) with a bend angle. If the panel is mounted so that the seasonal variation is not symmetric, (the winter angle is not equal to the summer angle), then the incoming rays of light could be bent by a fixed angle such that the light in the panel is symmetric with respect to seasonal variation. For example, if the panel is mounted 20° too far northward (e.g. panel tilt of 20° when mounted equatorially), then the seasonal variation will be from 3.5° North to 43.5° South and the optical arrangements (such as benders and/or IOAs) would need to correct for the worst case of 43.5°. If a fixed 20° light bending film is added to the panel, then the light angle may be reduced by 20° resulting in a symmetric north/south variation of +/−23.5°. This simplifies the overall design by reducing the worst case angle correction and balances the system. Note, that due to well known variations of sunlight intensity during the seasons (more intensity during the summer and less intensity during the winter), it may be advantageous to have the panel tilted with a north-south offset to maximize the total amount of energy captured during the year. This is especially true with a one-axis tracker where the only north-south correction is performed by the IOAs and not by a physical movement of the panel.

### Dual Optical Arrangements

A bender-IOA embodiment of an optical concentrator may include (i) an input bender, which changes the direction of light rays that pass therethrough and (ii) a lower IOA that accepts rays of light at a given off-axis (off-normal) direction and focuses these rays to a receiver (generally centered) below the lens. The combination of these two rotatable optical arrangements permits the sun's rays to be directed to a single unmoving receiver when the sun is anywhere within a range of receiving directions relative to the concentrator. The extent of this range of receiving directions is a function of the two optical arrangements and is normally made to be as large as possible. The lower IOA has many configurations such as a light bender with a reflective concentrator, a light bender with an embedded refractive concentrator, or a combination with the concentration being accomplished by refraction and/or reflection.

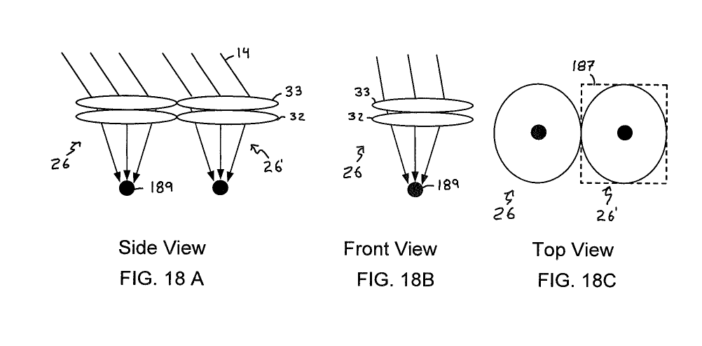

Attention is now directed to FIGS. 18A, 18B and 18C which are diagrammatic illustrations of elevational, end, and plan views respectively of an array of two concentrators 26 and 26′ each including input bender 33, lower IOA 32 and the receiver 189. In the end view, the second concentrator is not visible behind the front concentrator. Note that input rays of sunlight 14 entering the input bender are in different directions on the two views. This is due to the separation of the sun's ray vector into two components (a side view component and a front view component). The actual sun ray angle is the vector sum of these two components.

The Lower IOA's 32 and 32′ may be constructed with a circular light bending IOA followed by a square or other shaped concentrator arrangement 187 (represented in FIG. 18C using a dashed line) to acquire the light that falls between the IOA's. This configuration has the advantage of using the sun's rays when the sun is nearly directly overhead. This concentrator design, while shown as square, could be any shape. For example if the panel is designed as a hexagonal pattern, then a hexagonal concentrator would be preferred as compared to the square. In fact, the arrangement of the light benders, the arrangement of concentrators and the arrangement of the receivers do not have to be linear or one-to-one. For example, a 2-by-2 array of light benders could send light rays to two concentrators which could then send the light rays to one receiver. Alternatively, a single IOA light bender could send rays to multiple concentrators and receivers.

### Split-Cell

A split cell embodiment may be based on an array of concentrators with receiver locations that are not centered with respect to the concentrators. In particular, when the receivers are located between the concentrators, in a plan view, then it may be possible to concentrate light rays that do not pass through an IOA within the concentrator, but that pass between the IOAs, as will be described immediately hereinafter.

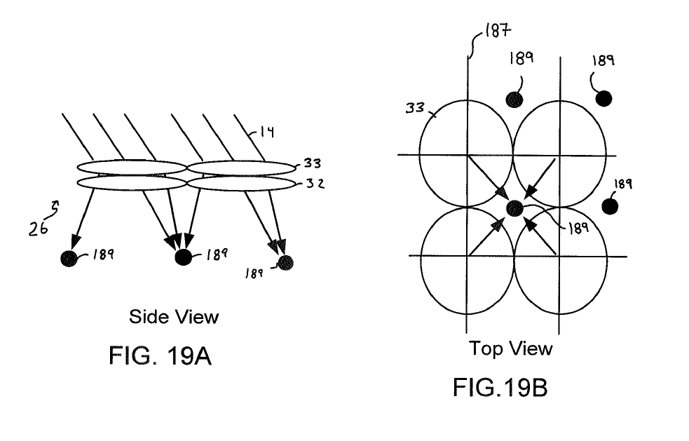

Attention is now turned to FIGS. 19A and 19B which illustrate elevational and plan views, respectively, of a split-cell system having four concentrators 26. The plan view of FIG. 19B shows receivers 189 located directly between the concentrators so that the light rays collected on the receivers can be from four different IOAs and from the space between the IOAs (the inter-IOA gap). Thus, input rays of sunlight 14 that enter between the IOAs in the inter-IOA gap may be combined with the sun's rays from the four IOAs to create a greater light intensity than that without the inter-IOA contribution. Since receiver 189 collects all of the light from its associated square as compared to just the light from its associated circle, the increase of light intensity can be 20% or more depending upon the design efficiency. Note that as the sun increases its angle, then some of the inter-IOA gap contribution will decrease and possibly result in no contribution; however, the design could also be optimized to collect the light at an off-normal angle and reduce the light collected when the light is directly above each concentrator. Note also, that the total amount of light entering each receiver need not be less than the design in FIG. 18.

In the following example it may be easier to implement the light bending independently from the concentration. Furthermore, the shape of the receiver does not have to be circular as is described next.

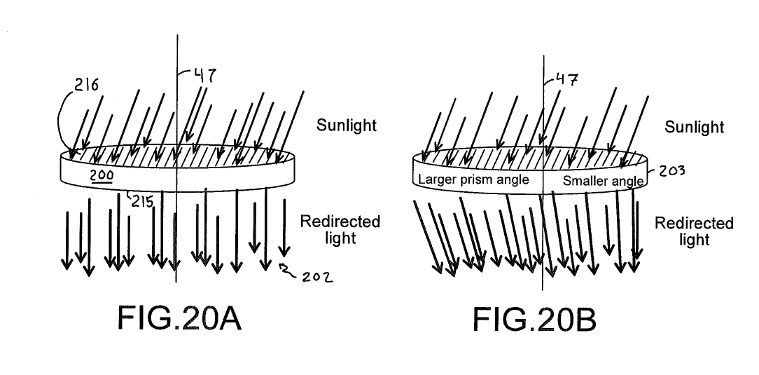

Attention is now directed to FIGS. 20A and 20B which are diagrammatic perspective views of a bender 200 and IOA 203, respectively. FIG. 20A depicts a circular shaped bender that rotates on its axis of rotation (optical axis 47) to align the incoming sunlight to its angled surfaces (in the form of prisms and represented by the parallel lines in the diagram) which redirect that light. It is assumed that all the prisms are at the same angle and therefore bend the incoming light by the same angle. In this case, a cylindrical column of light 202 is coming out from bender 200.

### Shaping of the Focus Region

If an IOA is formed by modifying a bender by changing the prism angle of each prism, a line or rectangle can form focus region. FIG. 20B shows the effect of an angle change for each prism moving from the left side to the right side; it is seen that the light on the left is bent more to the right and the light on the right is bent more to the left. The light exiting IOA 203 forms a wedge that can be approximated as a single line or rectangle at a distance below IOA 203. The varied redirection is shown in FIG. 20B. The effect of this varied prism angle IOA is analogous to a combination including a conventional IOA combined with a cylindrical lens which has the ability to concentrate the light to a more rectangular shaped focus region.

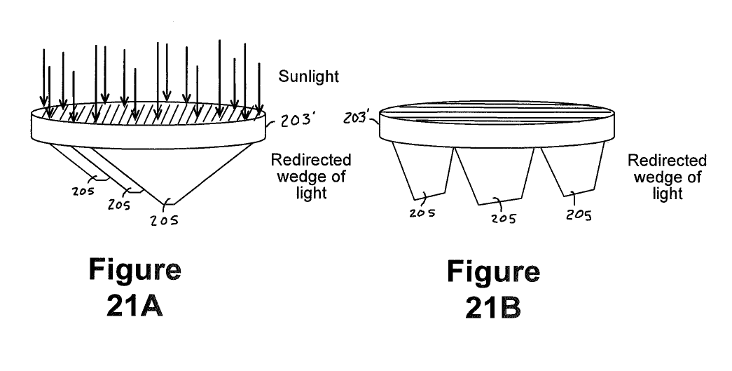

Attention is now directed to FIGS. 21A and 21B which are diagrammatic views, in perspective, showing two different illustrations of yet another embodiment of an IOA 203′ that may be utilized for shaping of the focus region. An additional concentrator, either reflective or refractive, can be used to change the line(s) of light or rectangle(s) of light into another shape such as a circle or small rectangle by concentrating the light in different directions. One simple method of implementing this is by using an A-frame refractor or reflector (not shown) following IOA 203′. FIGS. 21A and 21B show an implementation resulting in wedges of light 205 from two different perspectives.

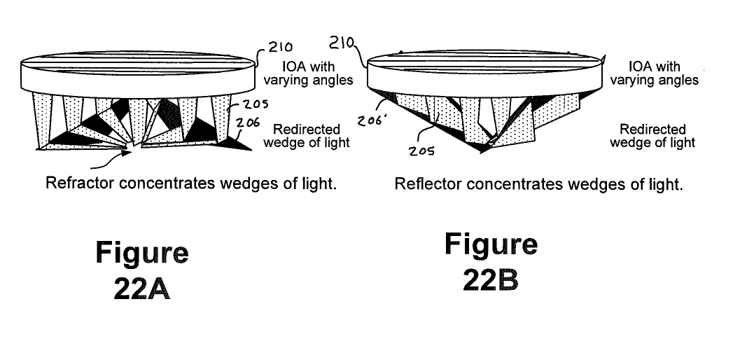

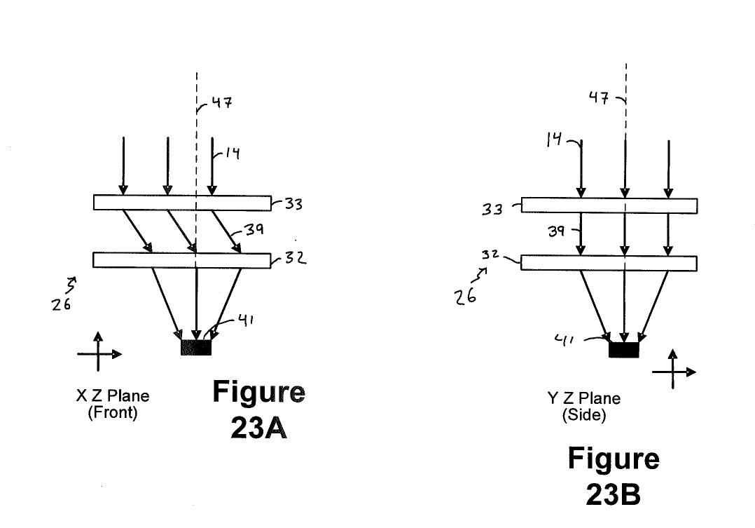

Attention is now directed to FIGS. 22A and 22B which illustrate yet two more applications related to shaping of the focus region. FIG. 22A illustrates a refractor and FIG. 22B illustrates a reflector design using this concept to further focus and redirect wedges of light 205 in other directions as compared to FIGS. 21A and 21B. The tent shaped piece illustrated in FIG. 22A is a refractor 206 that rotates with an optical arrangement 210 (a bender or an IOA) which bends the wedges of light exiting optical arrangement 210 to focus them at a point or small rectangle. Similarly, the system in FIG. 22B utilizes a reflector 206′, schematically represented in FIG. 22B as an upside down tent that is suspended from the edge of the optical arrangement. This performs the same function as the refractor concentrator—it concentrates the light from the wedges to the focus region using reflection rather than refraction. Thus the optical arrangement may be configured to perform a one dimensional concentration along one axis and the secondary concentrator (refractor or reflector) may perform a second concentration along the perpendicular (or other) axis. The combination of both one dimensional concentrations results in a two dimensional concentration resulting in a shaped focal region as illustrated in FIGS. 22A and 22B. It is noted that it may be easier and less expensive to implement the light bending and concentration in two separate functions rather than combining all functions in one optical interface.

Another option is to configure optical arrangement 210 as an IOA that provides concentration in the second direction. This may avoid additional interfaces and therefore additional optical losses. In this case, the IOA could have a complex configuration attained by convolving the light bending function with the concentrating function. The light exiting the IOA would be redirected refractively or reflectively, providing the same function as the “tents” in the previous examples without adding an additional optical layer.

Another method of 2D concentration is to use upper and the lower surface of the IOA for a combined concentration. One simple method of doing this is to use the same variable angle prism walls as discussed previously with reference to FIG. 20B on a lower IOA surface 215 (see FIG. 20B) and a similar variable angle prism wall on the upper IOA surface 216 (see FIG. 20B) where the direction of the prisms is rotated 90 degrees as compared to the lower IOA. Also, the tilt angle for the upper IOA prisms may be set to a nominal of zero degrees so that no light bending occurs for this direction. For example, the upper IOA surface may be configured to concentrate in the X-axis and the lower IOA surface may be configured to concentrate in the Y-axis to result in a 2-dimensional concentration using one IOA.

These methods along with variations of these methods can be used to direct light from a moving source to a single location or multiple locations. Varying levels of concentration can also be achieved. The shape of the illuminated area can also be varied. Furthermore the distance to the focus region can be reduced by focusing the light to multiple points. Using multiple smaller focus regions may also reduce the heat gain at each focus region location which could have a direct benefit for PV applications. All of these have benefits in applications that have limitations in spacing, that have requirements in light concentration, spot size requirements or light location requirements.

### Bender-IOA Combination

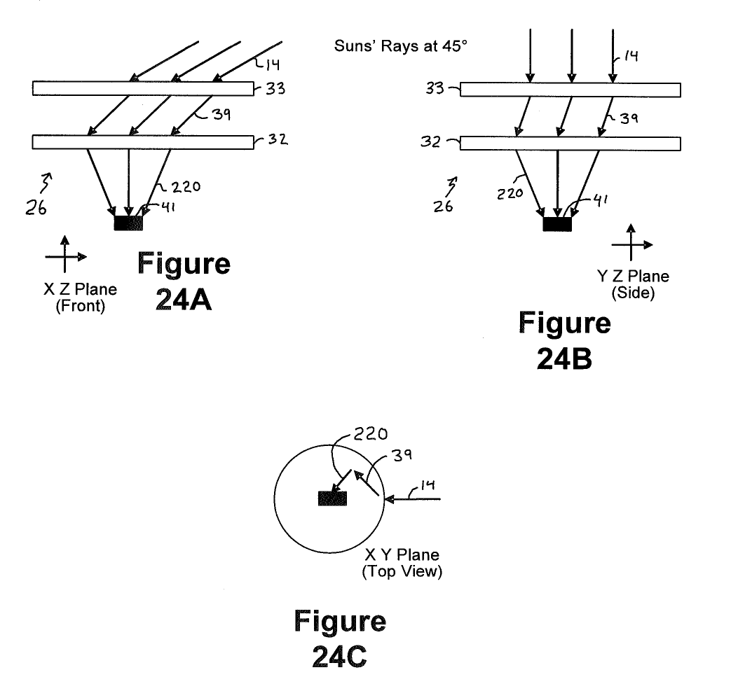

Attention is now turned to FIGS. 23A and 23B which are diagrammatic representations showing two plan views of the same concentrator generally indicated by the reference number 26. In this example, an upper bender 33 has a bending angle β=30° for bending incoming rays of light 14 by 30 degrees, and a lower IOA 32 has an acceptance direction with a zenith angle of ξ=30 degrees in order to focus the rays to the target. Thus, the upper bender can be rotationally configured so that its exit rays are 30 degrees from normal in order to match the lower IOA.

FIGS. 23A and 23B may be regarded as illustrating a particular mode of operation wherein the sun's rays entering at the normal to the concentrator. (The sun is positioned so that it is intersected by the optical axis). If it is assumed that the bender has been rotated so that its bend direction is oriented to the right along the positive x-axis, then the intermediate rays 39 exit the upper bender at a 30 degree angle from the optical axis to be collected by the lower IOA which is rotated to point towards the intermediate rays so that these rays will be focused to the focus region. Thus, if the bender bends the rays of light to the right, then the lower IOA will be rotatably pointed so that it bends the rays of light to the left resulting in the rays exiting the lower IOA normal to the IOA surface and parallel to optical axis 47.

As a second example that cannot be easily visualized in a single plane, attention is now turned to FIGS. 24A, 24B and 24C, which are diagrammatic representations illustrating elevational, end and plan views, respectively of an embodiment of a concentrator generally indicated in all three views by reference number 26. If the input rays of sunlight 14 enter bender 33 at an angle of 45 degrees from normal as seen from the front, then the bender may be rotatably oriented so that intermediate rays 39 exit at 30 degrees from optical axis 47 making them more vertical. Since this is a two dimensional problem with rotation, the change of direction of the rays from 45 degrees to 30 degrees may not be accomplished in one plane. In this example, the light rays will change direction out of the plane made by the 45 degree incoming rays and optical axis 47. It can be seen from the top view in FIG. 24C that in this perspective, the input rays of light 14 may be regarded as entering from the side and being successively bent first by the bender to a first angled direction as indicated in the top view by intermediate rays 39, and then by the IOA in a second angled direction as indicated in the plan view by IOA output rays 220.

To better understand this rotation, referring to FIG. 24A, first consider the bender rotated so that its bend direction points to the right in the direction of the positive x-axis. The 30 degree bend angle (β=30°) of the bender will bend the ray downward so that the ray will exit the bender at 15 degrees from optical axis 47. If the bender then rotates 90 degrees so that its bend direction is pointed away, into the paper, and in the direction of the positive y-axis, the bender will now add its 30 degree bend component in the direction of the y-axis which cannot be seen from the front view—the front view would show the ray passing the bender without any change of angle. The side view, however, will show the ray entering normal to the bender and then bending 30 degrees upon exiting the bender. Thus, the ray will continue at 45 degrees as seen from the front view since there has been no bending in this dimension and add a bend of 30 degrees as seen from the side view. The result is that the ray has a new direction, 45 degrees sideways and 30 degrees forward (or backward). The vector sum of these two angles is 54 degrees from normal which is too shallow. Thus, by rotating the bender, the ray direction has changed from being too steep at 15 degrees to being too shallow at 54 degrees. Since the ray direction will change smoothly and continuously with the bender rotation, then there will be a certain bender rotation angle that results in a 30 degree exit angle from the bender. This is the rotation angle that is required for bender 33 to prepare the ray for entering IOA 32. IOA 32 is then rotated to be pointed towards the intermediate rays of light for concentration by the IOA into the focal region 41.

### One Embodiment of a Bender

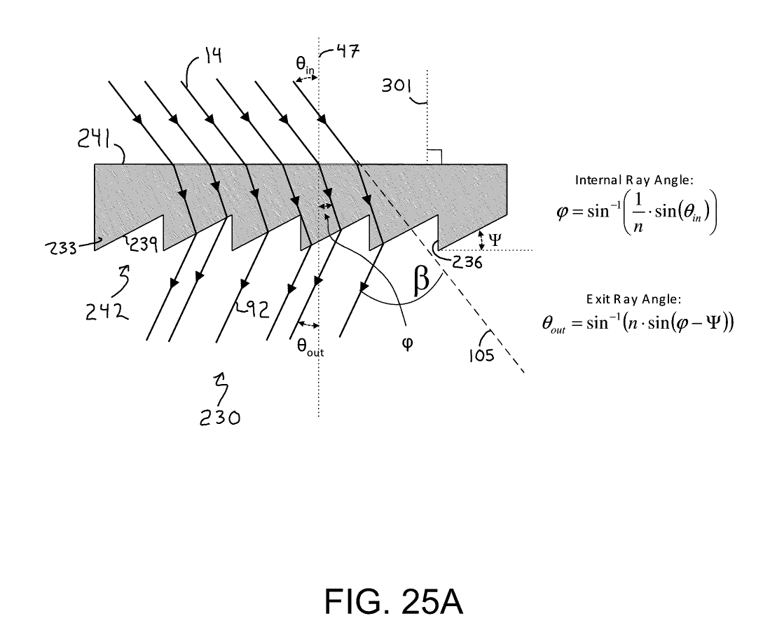

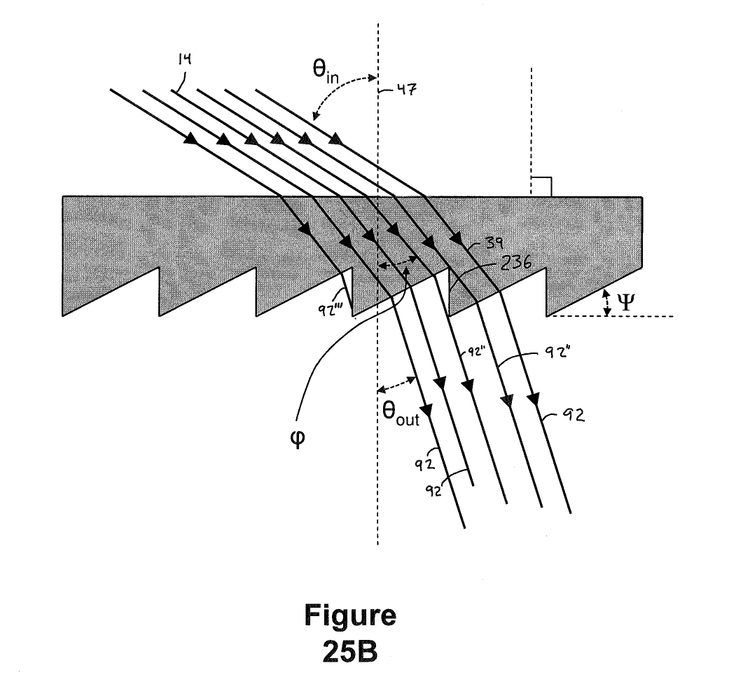

Attention is now directed to FIG. 25A, which is a diagrammatic plan view illustrating one embodiment of a bender generally indicated by reference number 230. The use of a prism array provides one approach for configuring a bender. A prism array may consists of a 1 dimensional array of prisms 233 as illustrated in FIG. 25A. Typically each prism of the prism array will have a vertical wall 236 and a sloped wall 239 on a prismatic side 242 of the array. A flat surface 241 faces towards the incoming rays of light. This is similar in structure and manufacture to a conventional Fresnel lens, although it is not circularly symmetric as in the case of many Fresnel lenses. It should also be noted that the principles and techniques taught hereafter can equally well be employed by a practitioner of ordinary skill in the art to embody a bender with two prismatic sides, or more specifically a bender with both sides defining separate 1 dimensional arrays of prisms.

In one orientation, as illustrated in FIG. 25A, flat side 241 faces towards incoming rays of light 14 and prismatic side 242 faces toward output rays of light 92. It is assumed that the incoming rays of light are parallel with one another, and that the orientation of the rays will bend as they enter the higher index of refraction material. Note that if the rays were to then exit a surface parallel to the first surface as in flat glass, then the rays would return to their original angle. However, when the output rays exit the prismatic side of the prism array, they may leave through the vertical wall or the sloped wall. In this embodiment, the bender is configured so that the optical axis 47 is aligned parallel to a normal axis 301 that is perpendicular (normal) to flat surface 241, and the incoming rays of light enter the bender at an incoming angle φᵢₙ as illustrated in FIG. 25A.

It is noted that for incoming rays of light that enter from the left and not from the right, then the exiting rays will exit the bender through the sloped wall only, and will not exit the bender through the vertical walls. For a given set of incoming rays of light (parallel with one another and entering with incoming angle θᵢₙ) the bender produces output rays of light 92 (parallel with one another and exiting the prism array with an output angle θₒᵤₜ). It is further noted that output angle θₒᵤₜ is related to, but not equal to, the incoming angle θᵢₙ, and that the bending angle β can be derived, based on the values of θᵢₙ and θₒᵤₜ in conjunction with the geometry illustrated in FIG. 25A. As described previously in reference to FIGS. 8 and 9, in the context of a particular incoming ray of light, the term bending angle refers throughout this disclosure to the change of angle of the rays of light caused by the bender, and may be regarded as the angle β of output ray 92 relative to extension 105 of incoming ray of light 14. For example, consistent with this definition, and by inspection of FIG. 25A, it is evident that bender 230 bends incoming ray of light 14 by the bending angle of β=θᵢₙ+θₒᵤₜ. It is noted that this is a special case, and it is not to be assumed that the bending angle β is a constant for all possible values of θᵢₙ.

A person of ordinary skill in the art will recognize that the amount of bending can be determined, based on well know principles of optics, by the angle of the sloped wall, the refractive index of the bender material, and the application of Snell's Law. With ongoing reference to FIG. 25A, with the angle of the sloped wall relative to the flat surface represented as angle Ψ, and with the index of refraction of the bender material represented as index n, then θₒᵤₜ may be expressed as follows:

$$\begin{matrix}{θ}_{out} = Ψ + {sin}^{- 1} ( n \cdot sin ( {sin}^{- 1} ( \frac{1}{n} \cdot sin ( {θ}_{i n} ) ) - Ψ ) ) \\ = Ψ + {sin}^{- 1} ( sin ( {θ}_{i n} ) \cdot cos ( Ψ ) - \sqrt{{n}^{2} - {sin}^{2} ( {θ}_{i n} )} \cdot sin ( Ψ ) )\end{matrix} \qquad ( EQ 4 )$$

In the following three examples, we will consider the angle of (i) the incoming rays of the light 14 entering the bender (ii) internal rays of light 239 passing through the bender and (iii) output rays of light 92 exiting the bender are considered assuming a bender index of refraction n=1.5 and a prism angle Ψ=40° from flat.

For the sun directly overhead and incoming rays of light 14 entering at angle of θᵢₙ=0° (from optical axis 47), the internal ray angle inside the bender will also be 0° but the ray angle upon exiting the bender (θₒᵤₜ) will be −34.6° (to the left). This corresponds, for this particular incoming ray of light, with a bending angle of β=34.6 degrees.

For incoming rays of light entering at (θᵢₙ) angle of 10° (from optical axis 47), the internal ray angle will be 6.6°, and the rays upon exiting (θₒᵤₜ) will be −15.6° (to the left). This example is the situation as depicted in FIG. 25. This corresponds with a bending angle of β=25.6 degrees.

For incoming rays of light entering at (θᵢₙ) angle of 22.3° (from optical axis 47), the internal ray angle will be 15°, and the rays upon exiting (θₒᵤₜ) will be 0° (relative to the optical axis). This corresponds with a special case wherein the bender bends the incoming rays of light so that they exit the bender parallel to the optical axis, and bending angle β=θᵢₙ=22.3°.

While the assumption of a constant bending angle has served as a useful approximation for descriptive and illustrative purposes, it is again noted that this is only an approximation, and does not necessarily represent the precise bending performance of a given bender, as illustrated above in the context of a specific embodiment. Nevertheless, this approximation tends to be sufficiently realistic such that it is useful to characterize a given bender as exhibiting a specific “bend angle” even if this number is subject to variation based on the orientation of incoming rays of light, and in the context of this disclosure, a given bender may be specified as having a specific bend angle, even in cases where that bend angle may vary. In order for a specific bend angle to serve as a useful reference, it is helpful to maintain consistency, from one bender to another, as to the definition of bend angle. In view of the foregoing points, the “bend angle” of any given bender, when specified as a single value, is to be associated throughout this disclosure with the special case when output rays are oriented parallel to the optical axis of the bender, for example in the way that is described in the third example set forth immediately above.

For example, while the bender embodiment of the present discussion exhibits variations depending on the orientation of the incoming rays of light, the bender embodiment illustrated in FIG. 25A is to be specified, based on this convention, as exhibiting a “bending angle” of β=22.3° such that the incoming rays of light are bent so that the resulting output rays are parallel with the optical axis.

The following table specifies a number of embodiments that are assumed to utilize the geometry illustrated in FIG. 25A, with each bender embodiment exhibiting a different bending angle (specified in the table as “bend angle”) in accordance with the definition set forth immediately above. The upper row corresponds to a desired bending angle, with each column being associated with bending angles 15, 20, 25, 30, 35 and 40 degrees, and the second and third rows specify prism angles Ψ required to achieve the desired bending angle in benders that utilize two different materials, Acrylic and Polycarbonate, respectively. It is assumed, as noted in the table, that acrylic has a refractive index of approximately 1.49 and polycarbonate has an refractive index of approximately 1.58.

TABLE 1

Bend Angle (deg)

| Material | Index | 15 | 20 | 25 | 30 | 35 | 40 |
|---|---|---|---|---|---|---|---|
| Acrylic | 1.49 | 29 | 37 | 45 | 51 | 57 | 62 |
| Polycarbonate | 1.58 | 25 | 32 | 39 | 45 | 51 | 55 |

Attention is now turned to FIG. 25B, which illustrates the operation of bender 33 with respect to incoming rays of light 14 that are oriented to cause shading as will be described in further detail at one or more appropriate points hereinafter. Input rays of light 14 enter at angle θᵢₙ of 40° from the optical axis; the internal ray angle φ may be 25.4° and the rays upon exiting may have θₒᵤₜ=17.8° directed to the right as shown in FIG. 25B. In this example, light is bent by a bend angle of β=22.2 degrees, however some of the exiting light rays encounter vertical wall 236 and are refracted off in a different direction (not shown), to cause shading.

### One Embodiment of a Solar Concentrator

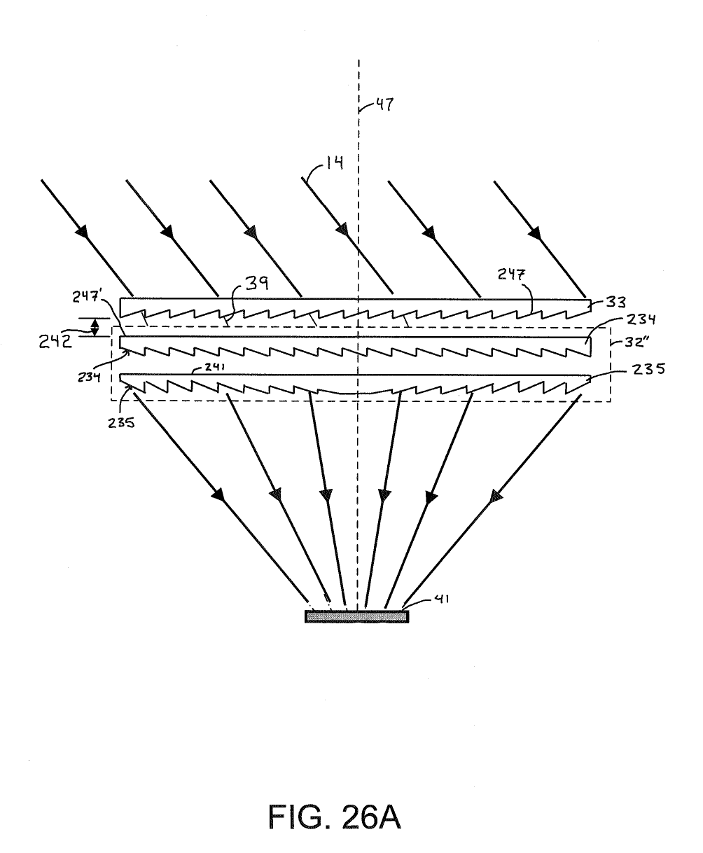

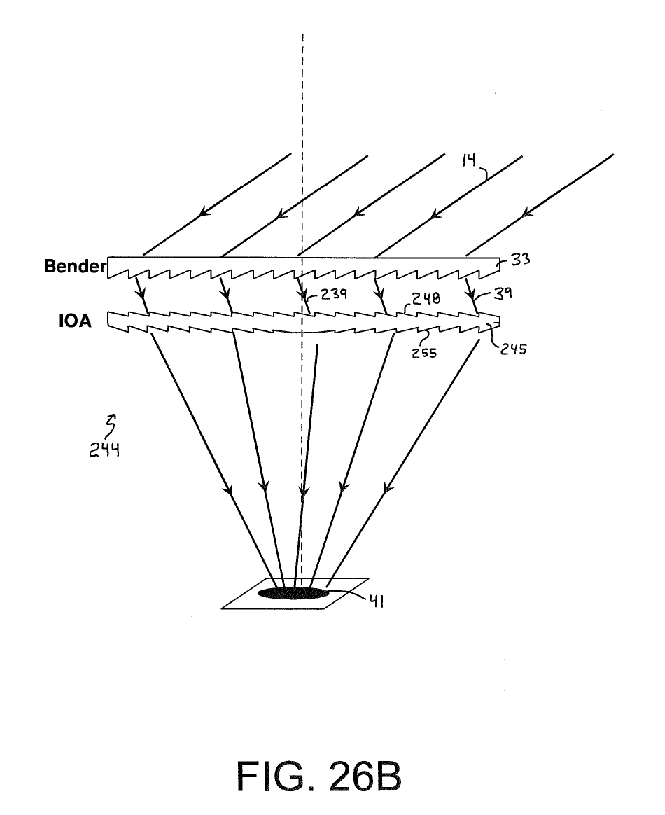

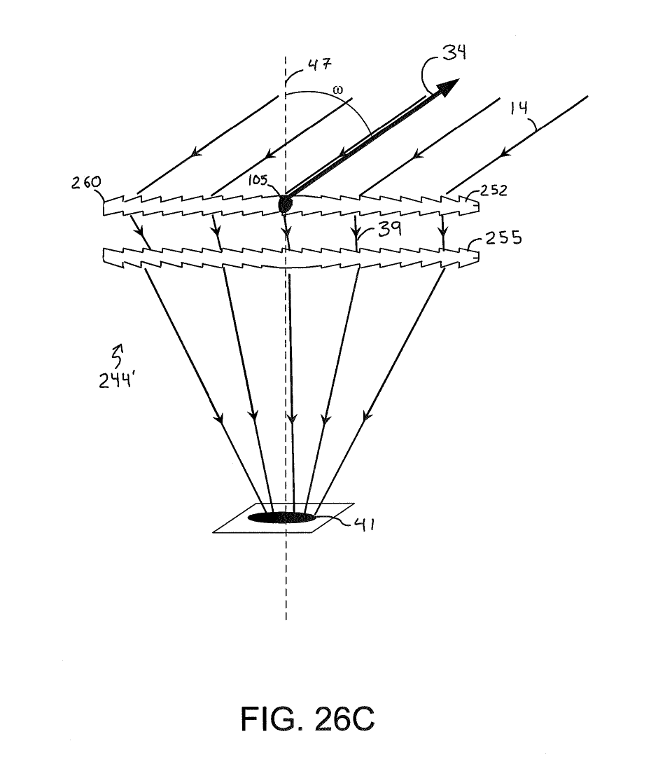

Attention is now drawn to FIG. 26A, which is a diagrammatic plan view illustrating one embodiment of a solar concentrator, generally indicated by reference number 26″ that utilizes a multi element IOA 32″. A bender 33 initially receives incoming rays of light 14 and redirects the incoming rays of light for acceptance by multi-element IOA 32″ configured for accepting and concentrating the rays by focusing the rays into focus region 41. Multi-component IOA 32″ includes a bender 234 and a Fresnel lens 235, and bender 33 and IOA 32″ are both supported for rotation about optical axis 47. It is noted that the Fresnel lens can be either fixed in position, or it can be supported for rotation about the optical axis 47, and may be configured as a converging or concentrating lens for focusing light that enters normal to its upper surface so that it is directed to pass through focal region 41.

It is noted that bender 234 and Fresnel lens 235 cooperate with one another to function as an IOA in accordance with previous descriptions in reference to FIGS. 5 and 6, and the references herein describing IOA 32″ as a “multi-element” IOA are premised on the presence of two or more elements therein. As discussed in reference to FIG. 8, FIG. 9 and FIG. 25, bender 234 may receive intermediate rays of light 39 and bend the intermediate rays of light by bending angle β (of bender 234) to be parallel with optical axis 47, and the Fresnel lens concentrates the intermediate rays of light into focal region 41.

A specific embodiment of concentrator 26″ will be described immediately hereinafter. This specific embodiment is capable of concentrating the sunlight by at least approximately 10:1, and is capable of tracking the sun within a cone of approximately +/−45 degrees around the optical axis. While the concentrator is tracking the sun and concentrating the light onto the receiver, the concentrator can remain fixed in position and orientation, and the only movement can be restricted to the rotation of the two benders.

It may be useful to refer to FIG. 25A and the corresponding description to better understand the specific description of the benders. Bender 33 may be configured as an acrylic disk with a circular input surface (as flat side 241) of 120 mm in diameter and a bend angle of β=20°. Input surface 241 of bender 33 defines an input aperture for the concentrator, and has an aperture area of approximately 113 cm². A bottom surface 247 of bender 33 is a linear prism array with a pitch of 1 mm and with the vertical walls (FIG. 25 236) angled 2° to promote overall ease-of-manufacturing. From the previous table of bender designs, the sloped wall portion of the bottom side of the bender (FIG. 25, reference number 239) may have an angle Ψ of approximately 37°.

Bender 234 can be chosen to be an acrylic disk with an input area of 120 mm in diameter, and the bend angle can be chosen to be 30°. The larger bend angle for the second bender is chosen to enable the concentrator to target the sun when the sun is near or on the optical axis. During this situation, the sunlight enters the topmost bender nearly normal, which tends to increase the amount of bending that will occur. Increasing the bend angle of the bottommost bender allows it to restore light entering the concentrator nearly parallel to the optical axis to parallel again before entering the Fresnel lens. The bend angle of the bottommost bender should be increased until it approximately matches the increased bend angle of the topmost bender for light entering that bender from normal. As with bender 33, bottom surface 247 of bender 234 is a linear prism array with a pitch of 1 mm and with the vertical walls (FIG. 25, item 236) angled at 2° to aid manufacturing. Again, from the previous table of bender designs, the sloped wall portion of the bottom side of the bender (FIG. 25, item 239) can have an angle Ψ of approximately 51°.

It may be advantageous to place the two benders as close together as manufacturing and operational tolerance allow and still permit rotation for maintaining a small gap 242 between bender 33 and bender 234 FIG. 26A. If the two benders are not closely spaced, a portion of the light leaving the first bender, which is at an angle relative to the optical axis, may miss the second bender, and light could be wasted. For the specific implementation under discussion, the gap may be readily configured to be under 1 mm and this maintains such wasted light to less than approximately 1%.

The Fresnel lens may have a diameter equal to or larger than that of the bottommost bender in order to not lose (and therefore waste) any further light energy. For example, a non-imaging Fresnel lens, as described in Leutz and Suzuki, may be used as this provides a reasonably efficient configuration. However, a more commonly available imaging Fresnel lens, such as is available from Fresnel Technologies (101 W. Morningside Drive, Fort Worth, Tex. 76110, 817-926-7474, www.fresneltech.com), can be used as well. Lower pitch Fresnel lenses may be preferred as they can have fewer edges and corners which may scatter light and correspondingly reduce efficiency, however as pitch drops—lenses often become thicker. One reasonable choice for this specific embodiment is the Fresnel Technologies Item #18.2 lens that has a pitch of 25/inch and focal length of 6 inches. It is noted that Fresnel lenses are generally not reversible and that this lens is designed to be placed grooved-side up which is the opposite from the depiction of the Fresnel lens in FIG. 26A which indicates it is placed flat-side up. This particular lens also operates flat side up at low concentration ratios, such as is the case here. However, the effective focal length is shorter when reversed.

Still referring to FIG. 26A, the concentration factor of solar concentrator 26″ may be determined by the square of the ratio of the Fresnel lens focal length to the distance from the focal length to the receiver. Thus, assuming the focus region is located 4.5 inches below the Fresnel lens, the concentration factor is (6/1.5)² or 16:1. The receiver should be at least 1/16 the aperture area of the concentrator, or at least 30 mm in diameter. However, this does not imply that the receiver will receive light with an intensity 16× as great as sunlight. Losses from reflection at the interface of each refractive material, imperfections in the optics (particularly in the sharp corners), and losses from light intersecting the vertical walls and bending the incorrect direction may limit the optical efficiency to below 70% for this embodiment. Thus, this concentrator may intensify the light hitting the receiver by a factor approximately of 10-11×.

Attention is now directed to FIG. 26B in conjunction with FIG. 26A. FIG. 26B is a diagrammatic plan view of a concentrator, generally indicated by reference number 244, utilizing a single-element IOA 245. An input surface 248 of single-element IOA 245 may include a bender prism array configured to serve as a bender for receiving and bending intermediate rays 239 in a way that is analogous to the operation of bender 234 in FIG. 26A, and an output surface 255 may include a focusing prism array configured to cause focusing in a way that is analogous to the operation of Fresnel lens 235 of FIG. 26A. The bender prism array and the focusing prism array may cooperate with one another to serve as an IOA as described previously with reference to FIGS. 5 and 6. Applicants believe that a person of ordinary skill in the art, having this disclosure in hand, will be readily able to modify the designs presented previously and throughout this disclosure to configure a single element IOA as described with reference to FIG. 26B. In particular, configuring the output surface as a Fresnel lens may be achieved in accordance with well known design techniques associated with Fresnel lenses. With regard to the input surface, Applicants believe that a person of ordinary skill in the art may readily adapt and incorporate the teachings herein in order to configure the input surface for bending in an appropriate way such that the input and output surfaces cooperate with one another to serve as an IOA in the manner described herein.

Furthermore, for reasons of illustrative clarity the forgoing example describes the operation of a concentrator with a single-element IOA that operates analogously with the concentrator of FIG. 26A such that the bending and focusing functions of IOA 245 are performed separately and by opposing faces of the IOA. In this regard, applicants further recognize that there is no requirement that the bending and focusing action must be separated between the input and output surfaces, respectively, and these two opposing surfaces may be configured to cooperate with one another in a variety of complex combinations to perform the bending and focusing functions as described herein, and Applicants believe that a person of ordinary skill in the art, having the present disclosure in hand, may readily generate a variety of configurations that will perform in a manner that falls within the scope these descriptions.

As described immediately above in reference to FIG. 26B, the bending and focusing functions may be combined in a variety of complex ways between the opposing surfaces of single element IOA 245. Applicants further recognize that there is no requirement that the input optical arrangement should be limited to receiving and bending, or that an additional optical arrangement (following the input optical arrangement) should be limited to serving solely as an IOA (for accepting and concentrating), and that all of the functions of the solar concentrator may be combined in complex ways and distributed or re-distributed across among multiple optical arrangements. It is noted that these functions include, but are not limited to, (i) the initial receiving and bending previously described with respect to the bender, and (ii) the accepting and concentrating previously described with respect to the IOA.

Attention is now directed to FIG. 26C which is a diagrammatic elevational view of one embodiment of a concentrator 244′ including an input optical arrangement 252 and an additional optical arrangement 255. The concentrator is configured for defining (i) an input aperture 260 for example as an outer periphery of the input arrangement having an input area for receiving incoming rays of light 14, (ii) an optical axis 47 passing through a central region 105 of the input aperture, (iii) a focus region 41 having a surface area that is substantially smaller than the input area and is located at an output position along the optical axis offset from the input aperture such that the optical axis passes through the focus region, and (iv) a receiving direction 34 defined as a vector that is characterized by a predetermined acute receiving angle ω with respect to the optical axis and one or both of the optical arrangements is rotatable about the optical axis for alignment of the receiving direction to receive the incoming rays of light. The input arrangement and the additional arrangement are further configured to cooperate with one another for focusing the plurality of input light rays to converge toward the optical axis until reaching the focus region such that the input light is concentrated at the focus region.

While a number of embodiments described herein utilize a bender as the input arrangement, and an IOA as the additional arrangement, it is again noted that there is no requirement that the arrangements be disposed in this order. However, Applicants recognize that if a given concentrator is modified by re-arranging the order of the arrangements, in many cases, it may be necessary to substantially re-configure the arrangements themselves in order that they cooperate with one another to receive and concentrate the incoming rays of light in a manner that is at least generally consistent with the performance of optical concentrators (for example optical concentrator 26) described herein and throughout this overall disclosure. While substantial modifications of the optical arrangements may be required in conjunction with any particular re-ordering of the optical arrangements, Applicants believe that a person of ordinary skill in the art, having this disclosure in hand, may implement concentrator 244′ in a variety of ways, utilizing a variety of optical arrangements, in accordance with the teachings herein and without adhering to any particular restriction as to ordering of the arrangements. For example, in one embodiment, as described previously, the input arrangement may be a bender, and the additional arrangement may be an IOA. In another embodiment, the input arrangement and the additional arrangement may both be configured as IOAs. It is further noted that there is no requirement that optical arrangements 252 and 255 should consist of only one optical component, ands that one or both of these optical arrangements may include a plurality of optical components.

### Prism Wall Slope

Referring again to FIGS. 25A and 25B, and considering the embodiment of bender 233 illustrated therein, it is again noted that in cases when the incoming rays of light enter bender 233 at an incoming angle that is equal to the bending angle (such that θᵢₙ=β) then the output rays will exit the bender parallel with the optical axis thereof. Returning now to this description, the case where θᵢₙ is increased beyond β will be examined immediately hereinafter.

Attention is again turned to FIG. 25B, which, as described previously, illustrates the operation of bender 33 with respect to incoming rays of light 14 that are oriented to cause shading as will be described in further detail at appropriate points hereinafter. Input rays of light 14 enter at angle θᵢₙ of 40° from the optical axis; the internal ray angle φ may be 25.4° and the rays upon exiting may have θₒᵤₜ=17.8° directed to the right as shown in FIG. 25B. In this example, light is bent by a bend angle of β=22.2 degrees, however some of the exiting light rays encounter vertical wall 236 and are refracted off in a different direction, to cause shading, as will be discussed in greater detail immediately hereinafter.

If the angle is sufficiently increased, then there will be a shading effect where some of the rays of light are interfered with by part of the bender, and these rays of light may no longer be parallel to the non-interfered rays of light. This shading effect is shown in FIG. 25B where the exiting rays of light designated by the reference numbers 92 are not limited. However, the output rays of light 92″ may be at least partially blocked, and output rays 92′″ are at least partially blocked. This shading effect can be minimized or removed by several methods including changing the slope of the vertical prism wall or modifying the top or bottom of the bender surface.

Establishing the optimal slope of the prism walls is not a trivial matter and may be different for the bender than for an associated IOA. In the case above, for the 23° entering angle of light, the exit light was normal to the bender. This is the design case for the associated IOA. In this case, the internal ray angle was found to be 15°, thus the vertical wall could be sloped up to this 15° angle with no negative effects. Thus, under normal operation, this part of the associated IOA (between vertical and 15° should never transmit any light rays). This design freedom can be used to improve the prism performance by adjusting the prism corners (from vertical to slope and back to vertical) so that the area of the prism that interacts with the light will be more optimally oriented. In a similar manner, the bender can have its vertical wall modified to improve performance, however there are more trade-offs for the upper bender.

In order to examine the prism wall effects, related aspects of operation of the operation of concentrators are observed. At least within a reasonable approximation, as described previously, a BRIC includes a bender that can be oriented to redirect the incoming light onto an exit cone followed by an IOA that accepts this light and redirects it to the target. In this basic embodiment, the illumination entering the bender is essentially redirected as it travels through the two optical arrangements (the bender and the IOA). In this description, the bender rotates as frequently as needed to keep the sun within its field of view. The IOA rotates in relation to the bender as needed to maintain the light on the target. The amount of rotation required is determined by the sun's movement through the sky in its daily and annual cycle. For an ideal location on earth, the sun's path moves +/−23.5 degrees north to south to north annually and +/−90 degrees as it moves east to west daily.

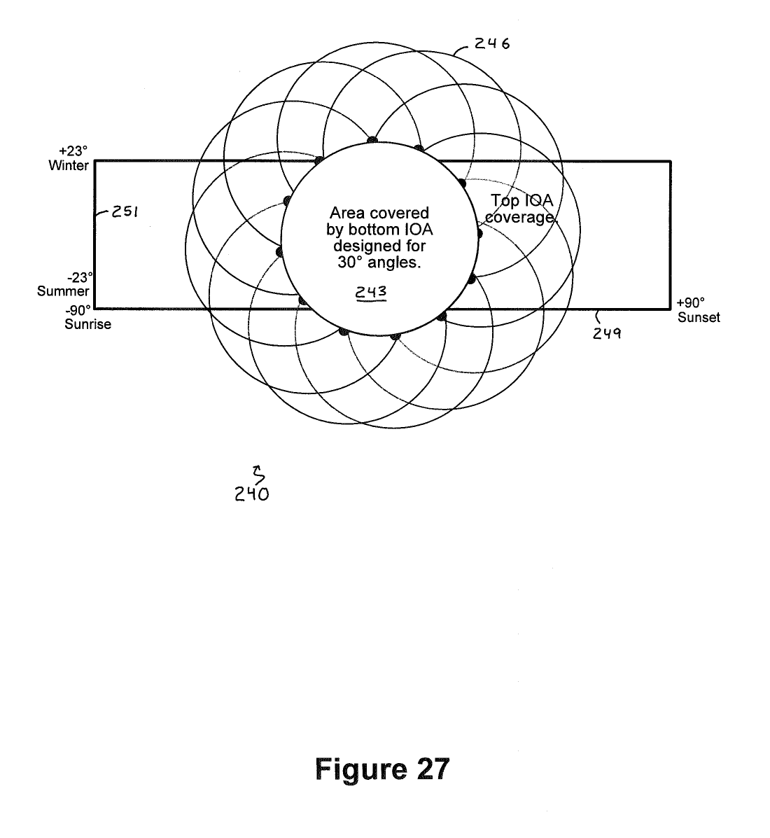

Attention is now directed to FIG. 27 which is a diagrammatic view generally indicated by the reference number 240, illustrating the coverage of the sky where the horizontal axis of the rectangle corresponds with a daily tracking range 249 representing a portion of a given day from sunrise to sunset and the vertical axis of the rectangle corresponds with a seasonal tracking range 251 representing seasonal variation from summer to winter. The diagram (FIG. 27) depicts this space and how the bender and the IOA cooperate with one another if the bender has a bending angle of 30° and if the IOA has a acceptance direction fixed at an angle of 30° relative to its associated optical axis. It is expected that the sun will traverse a straight line from left to right in the rectangular box each day, and this line will move from the top of the rectangle in winter to the bottom of the rectangle in the summer. The IOA coverage, as shown by the central circle 243 for the IOA and the series of circles 246 for the bender, is shown centered on the rectangle. This is the ideal configuration, but any particular installation may shift this configuration to be centered above or below the center of the rectangle.

Here it can be seen that a system, having a bender and an IOA, configured with the bender and the IOA matched with one another such that ξ=β=30°, exhibits a lack of coverage in the morning and the evening (near sunrise and sunset). While the sunlight angle at these times is non-optimum for energy collection, it would still be beneficial to collect this energy since this represents a loss of potential energy conversion on a daily basis.

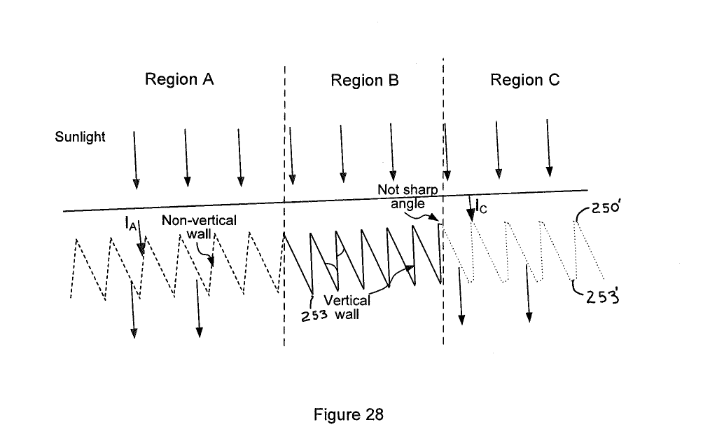

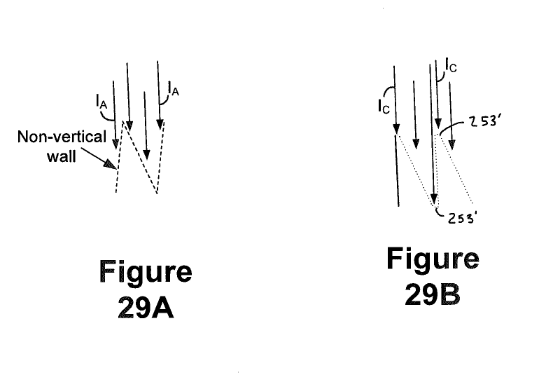

The IOA in FIG. 27 may be composed of Prism-like Fresnel lens, as will, be described immediately hereinafter. In this regard, attention is now directed to FIG. 28 which illustrates three different variations of bender and/or IOA cross-sections that may be employed as will be described immediately hereinafter. Each variation is shown in a region labeled as regions A-C separated by dashed lines. The central region B in FIG. 28 is shown with vertical walls and sharp angles (i.e. not beveled) as the ideal configuration although not required. Practical manufacturing constraints, such as those imposed by injection molding or other plastic forming methods, make it more likely that the vertical walls will have a small slope (as shown to the left in Region A with one such slope indicated in the figure as a “non-vertical wall”) and/or that the sharp corners will be rounded (as shown to the right in Region C). The sunlight comes from the top of FIG. 28, and of particular interest is the effect of the non-vertical wall (as in Region A), a “top apex 250 and a bottom apex 253 as shown. Depending on the time of day and day of the year, the sunlight can impinge on the associated bender or IOA at various angles, but at any given moment, the rays are parallel to each other. The bender or IOA is rotated so that the impinging rays strike the sloped surfaces and are redirected by an angle that is a function of the sloped wall. However, when the sun is directly over the bender or IOA, the sun's rays will enter the bender or IOA in a perpendicular direction and be parallel to the vertical walls. The sunlight will, however, strike the non-vertical wall, because of it's a small sloped angle, at approximately noon on the equinoxes. When the sun is east or west (early or late in the day compared to noon), or north or south (early or late in the year compared to the Spring or Autumn equinox) then the sun will enter the bender or IOA with an angle and may not strike the non-vertical wall.

If the vertical walls are perfectly vertical and top apex 250 and bottom apex 253 are perfectly sharp (not rounded), there will be no optical shading loss—i.e. nearly all of the light entering the bender or IOA will exit the bender or IOA in the preferred direction. However, cases where there is a slight slope to the vertical wall and/or the top apex and/or the bottom apex are not perfectly sharp, some of the incoming light will be redirected in a manner not consistent with the design expectation and will result in “shading” loss. These cases are shown in FIG. 28 wherein the areas the light that is not transmitted properly is noted at the non-vertical walls (as I_{A} in Region A), and for the non-sharp top apex 250′ and non-sharp bottom apex 253′ (as I_{C} in Region C). In these cases, the angle formed between the sunlight and the surface is not the expected or designed angle, and the light will not be sent in the appropriate direction, and this loss of sunlight can be mapped into a hole in the bender or IOA's coverage of the sky, as will be described hereinafter.

Attention is now directed to FIGS. 29A and 29B which are diagrams depicting the shading loss for the near vertical sunlight entry normally at the equinoxes when the sun entry angle is normal to the bender or IOA surface.

FIGS. 29A and 29B shows that the loss due to shading is limited to certain times of the year and then only at certain times of the day for the non-vertical wall and the non-ideal angles. When the amount of energy produced throughout the year is optimized, it is potentially advantageous to reduce the performance at certain times of the day and on certain days of the year if the gains in performance at other times and day are larger. Specifically, the design should call for and tolerate small angles on the vertical wall and curvature or non-sharp angles for the bottom apex of the bender and or IOA if these result in overall cost reductions or performance improvement when measured over the lifetime of the panel. Thus, a slight loss in performance for a short period of time on a few days of the year may be a good tradeoff if performance is enhanced by a greater amount at other times throughout the year.

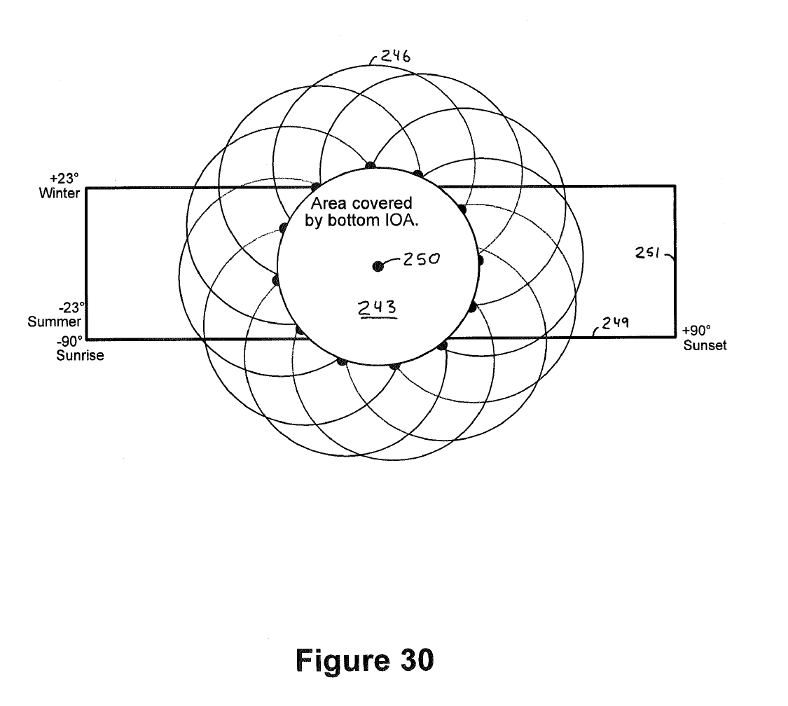

Attention is now directed to FIG. 30 which is a diagram showing the loss of coverage for a 2 degree angle on the vertical wall and can also be used to understand the loss due to control of sharpness of the prism angles. Notice that an area 250 is a corresponding area of loss that is a nearly negligible loss compared to the total area of the collector. Even though it occurs during the prime solar energy time of day, it is for a very short time and for very few days, thus when averaged over the year, this is a very small loss of total energy production.

It is important to understand that sunlight at shallow angles near sunrise and sunset has less energy potential for a fixed panel design since the shallow angle reduces the amount of energy impinging upon the panel. Therefore it is more important to collect the light in the prime hours, and in the diagram above, this means centering coverage ring 243 horizontally unless there are other special conditions that may modify the theoretical sunlight distribution. The example shown in FIG. 30 assumes a bender with bend angle design of 30° and an IOA with an acceptance angle having zenith angle of 30° which means coverage of the first 30° of sun in the morning and the last 30° of light before sunset are lost (since the two arrangements each are assumed to track 30° for a total of 60° out of a total of 90° for sunrise to noon and for noon to sunset). This loss can be regained by increasing the bend angle and the zenith angle to 45° for the bender and the IOA, respectively, as one example, but there is a limit to the total amount of bending that one optical arrangement can perform. When the two optical arrangements are designed to different associated bender and zenith angles, the coverage of the morning and evening sunlight can be increased at the cost of a hole in the center. The hole in the center would have a radius nearly equivalent to the difference in angles between the two IOAs. So combining a bender with a 30° bender angle and IOA with a 45° zenith angle would result in a 15° hole—or half the diameter of the current center circle.

Additionally, while the IOA often is associated with a requirement that the light exiting it should normally be centered below it, the bender does not have this requirement. Thus the IOA has a fundamental optimal angle for the vertical wall based on the fact that the light entering the IOA is pre-determined and the light exiting the IOA (in the absence of concentration) must be vertical, this sets the vertical wall angle limits. Referring back to the discussions around FIG. 25B, it was noted that for a properly designed IOA (with an exit ray angle normal to the IOA), the internal ray angle was 15° for that particular example; thus for that example, the vertical wall could have a slope as large as 15° and still not create a shadowing effect. For a refractive IOA, the vertical wall limit is a function of the index of refraction of the IOA, the wall angle of the IOA, and acceptance zenith angle β of the IOA. Since the bender does not require the light to exit normal to the surface, it has a different requirement for the vertical wall angle. This vertical wall angle can be adjusted to trade off performance at low angle as compared to high (near vertical) angles. Thus a shallower vertical wall angle 252 (See FIG. 28) may perform better when the sun is at a low entrance angle (as shown in FIG. 25B) since the shadowing effect will be reduced, but when the sun is directly overhead, this same shallow vertical wall angle will now cause a shadowing effect. As can be seen in FIG. 25B, when the vertical wall is truly vertical, there is a shading effect at low entrance angles, and this can be removed by adding a slope to the vertical wall. The penalty of adding a slope is that when the sun is directly overhead, the rays may hit the non-vertical wall and be misdirected. However since the sun is directly overhead only a few minutes a day for a few days per year, this loss of performance may improve overall (annual) performance due to the increased performance at morning and evening for all days of the year. (Also, as described later, if the bender has a tilt associated with it, then the sun's rays may never enter normal to the surface, so there may be no performance penalty associated with adding a slope to the vertical wall.

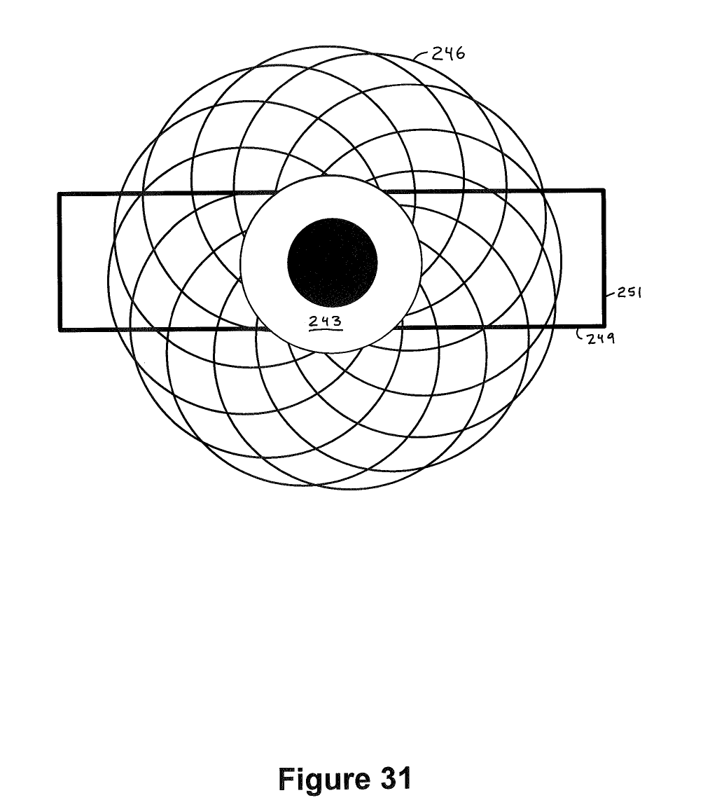

Attention is now directed to FIG. 31 which illustrates the coverage of the sky where the horizontal axis of the rectangle corresponds to a daily tracking range 249 representing a portion of a given day from sunrise to sunset and the vertical axis of the rectangle corresponds to a seasonal tracking range 251 representing a given year from summer to winter. This shows the tradeoff between adding sky coverage in the morning and evening balanced against losing sky coverage for specific days around noon. The diagram is scaled for degrees in both the vertical and horizontal directions. However, if the actual time spent by the sun in each position of the rectangle is considered as well as the angle of the sun in each position (which translates to how much energy is convertible), it is seen that the vertical axis of +/−23.5° actually represents 365 days of the year while the horizontal axis represents only 1 day. Further, the spacing between days on the vertical axis is not uniform—that is the sun does not move the same number of degrees each day towards the north and south. In fact, the sun moves faster around solstice (center of the vertical axis) and slows down at the winter and summer (ends of the vertical axis). So a small dot of non-coverage in the center does not impact very many days. The convertible energy from the sun is greatest in the midday sun (center of the horizontal axis) and least at the beginning and end of the day (ends of the horizontal axis). There is also a summer-winter effect where there is more convertible energy in the summer than the winter. When these are considered, there is an optimal combination of sky coverage near sunrise and sunset tradeoff with loss of coverage for a short period around noon for a few days around solstice. Accordingly, one angle can be used for the bender to limit shading losses while increasing the angle of the IOA to cover a greater portion of the sky each morning and evening.

Thus it may be desirable to reduce the noon optimal performance of a system in order to gain performance at other times of the day or year.

### Method of Rotation of IOA

As described above, the optical arrangements (for example the bender and the IOA) may be selectively rotated such that a set of two or more optical arrangements in a given concentrator cooperate with one another in order to continuously compensate for the sun's motion for maintaining concentration of the sun's rays on a fixed (stationary) target, and one method of moving a particular optical arrangement is by rotation about the center axis of the arrangement. It is noted that, in all previous descriptions, rotation of the optical arrangements has been described with respect to the optical axis of each of the aforedescribed optical arrangements, and it is to be understood that the optical axis in the foregoing examples has been aligned to be collinear with an axis of rotation such that both the optical axis and the axis of rotation may be considered as equivalent for the descriptive purpose of serving as a reference axis in space. While as few as one concentrator may comprise a solar collector, it is also possible to construct a panel of multiple concentrators containing many optical arrangements wherein groups of optical arrangements can be rotatably controlled together using one or more drive mechanisms. The optical arrangements may be physically supported about their center, suspended by their edges, suspended in a fluid, or in any manner such that they may rotate in a controlled way.

### Limits of Rotation

In order to consider a number of rotation methods and apparatus that are possible, it may be helpful to consider the requirement of the rotation needed to track the sun. In particular, if the rotation can be limited to less than 360 degrees, then this may simplify the motion and allow other forms of rotation. The amount of rotation required is determined by the sun's movement through the sky in its daily and annual cycle having seasonal variations. For any location on earth, the sun's path moves within a range of +/−23.5 degrees north to south to north annually and it moves +/−90 degrees (nominally) as it moves east to west daily.

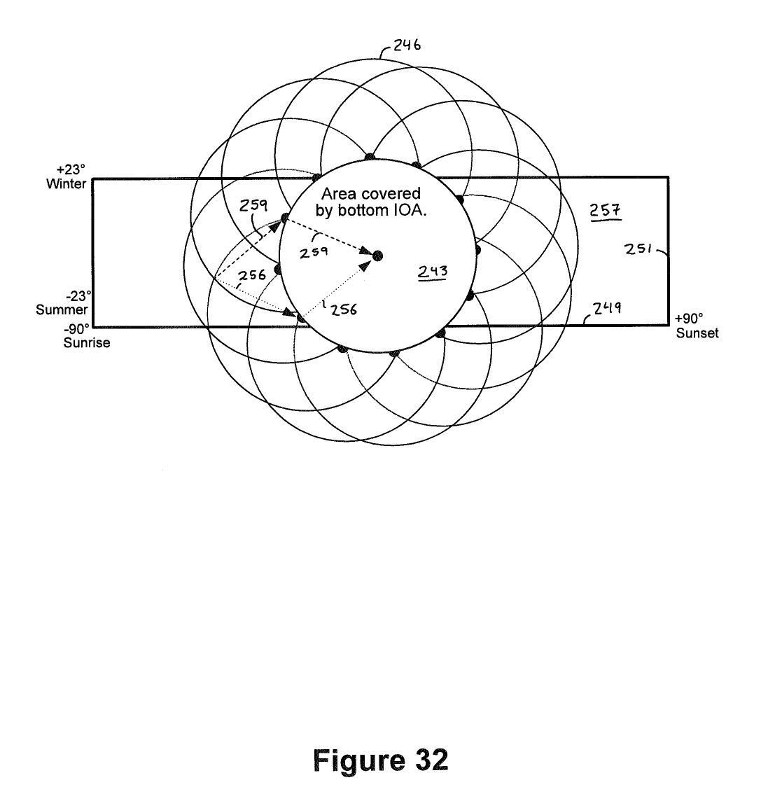

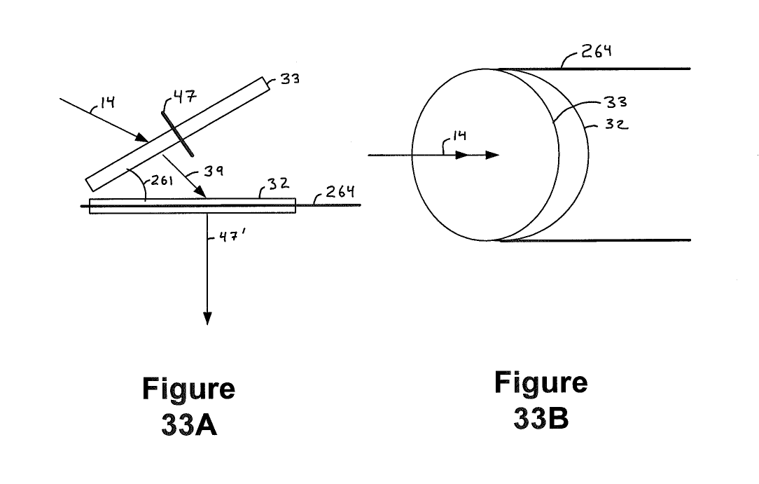

Attention is now directed to FIG. 32 which is a diagram schematically depicting this space and how the two optical arrangements cooperate with one another to cover this space in an example where the bender has a bend angle of β=30° and the IOA has an acceptance direction with a zenith angle of ξ_{A}=30° such that the range of receiving directions for the collector describe a receiving cone with an area that is approximated in FIG. 32 as a circle. It is expected that the sun will traverse a straight line from left to right in rectangular box 257 each day, and this line will move from the top of the rectangle to the bottom of the rectangle and back to the top throughout the year. The IOA coverage 243, as shown by the circle for the IOA and the overall coverage of the series of circles 246 for the bender is shown centered on the rectangle. This is the ideal configuration, but it is not required and any given installation may shift this configuration to be centered above or below the center of the rectangle.

The pair of pointing directions 256 and the pair of pointing directions 259 on the same diagram show how there are two distinct solutions for the orientations of the optical arrangements for a light source at any particular point in the range of operation. By evaluating the extremes of +/−23.5° (winter to summer) and the center line (solstice), it can be determined if the range of angles of the optical arrangements can be limited.

Notice that for a given concentrator including a particular bender-IOA combination, it is possible to bend the light from the incoming angle to the target by two different methods. In the context of FIG. 32, it is possible to use a configuration that includes an IOA that is not pointing upward when the sun is located in the lower half of the diagram (from 0 to −23°). This means that we can confine the IOA to a 180 degree rotation plus the additional approximately 14° to accommodate the reverse rotation to the summer and the same approximately 14° to accommodate the reverse rotation to the winter. The 14° is found by taking the Tangent of the angle described by the east-west motion (90°) and the north-south motion (23°) which provides 14°. This means that the IOA can be confined to approximately a 208° rotation which is much less than the full 360° and permits simple linkages and other limited rotation methods to be used to orient the IOA.

It is observed that the bender can be confined to a similar rotational limit if the two optical arrangements are properly paired (with bend angle equal to zenith angle as described above) since their function can be reversed as shown by the two pointing directions illustrated in FIG. 32. However, if the two optical arrangements (the bender and the IOA) are not compatible in this regard, then the limits may be different for the two IOAs.

In order to confine the rotation to these limited levels, it may require a discontinuity in angle orientation of the optical arrangements sometime during the day to switch the direction of thereof, although this can be accomplished fairly rapidly in comparison to the motion of the sun.

### Rotational Methods

Two methods of rotating the IOA in an array configuration are disclosed. The bender is typically mounted as an array so that all of the benders in an array are rotated, for example by a first drive mechanism, synchronously with one another for maintaining the same orientation as one another. The IOAs may be configured in a separate array that such that all the IOA's are rotated, for example by a second drive mechanism, independently from the bender array, but controlled in a similar manner.

Attention is now turned to FIGS. 33A and 33B which illustrate diagrammatic elevational and plan views, respectively, of one example of a concentrator having a bender 33 that is tilted with respect to an IOA 32. The bender may be tilted, relative to the IOA to improve the acceptance angles allowed for the concentrator by a fixed tilt angle 261 that is set so that optical axis 47 of the bender is at least approximately aligned to the acceptance direction of the IOA. Thus, if the IOA exhibits an acceptance direction having a zenith angle of 30 degrees, then the bender may be tilted at a tilt angle of approximately 30 degrees or less. This allows the top bender to function in a way that is analogous to a bender used in conjunction with a concentrating lens to implement an IOA, as was depicted in FIG. 31. As has been discussed previously, the bender in a multi-element (bender+lens) IOA is operated with light rays exiting it parallel to the optical axis, which significantly reduces shading losses. A top bender operating at a tilt approximately equal to the acceptance direction of the following IOA operates under the same condition: light rays will exit it parallel to the bender's tilted optical axis and shading losses will be significantly reduced. However, in order to facilitate this desirable arrangement, as the IOA rotates to track the sun, the tilted optical axis of the bender can rotate to stay aligned with the acceptance direction of the IOA.

A single drive mechanism can be configured for rotating both the bender and the IOA in a coordinated way to maintain tracking by causing the tilt direction to follow the acceptance direction of the lower IOA. The bender would also be allowed to rotate around its own optical axis. Thus two rotations are still required: (i) the full concentrator rotation of both IOAs about the IOAs optical axis 47′ and (ii) the rotation of the bender about its own tilted axis 47. A filament 264 can serve as at least a part of a drive mechanism to provide rotation of IOA 32 and the bender such that the IOA and the bender are rotatably coupled with one another. The tilt angle can be reduced, but should be larger than zero to gain an advantage in accepting lower angle sunlight and in reducing the effect of the non-vertical walls of the IOA, if a prism array configuration is used.

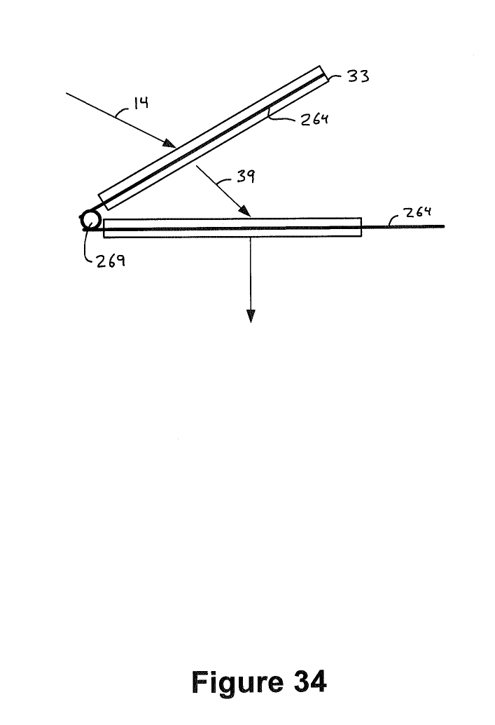

Attention is now directed to FIG. 34 which illustrates another example of a concentrator wherein a bender 33 can be controlled by wrapping a filament 264 such that it extends around a peripheral edge of IOA 32 first, then wraps around and grips a peripheral edge of bender 33 to provide bender control. The filament is routed from the IOA to the bender at a junction 269 where the two optical arrangements are nearest. Filament 264 can be firmly gripping (and/or fixedly attached with) the bender so that it rotates the bender without affecting the IOA.

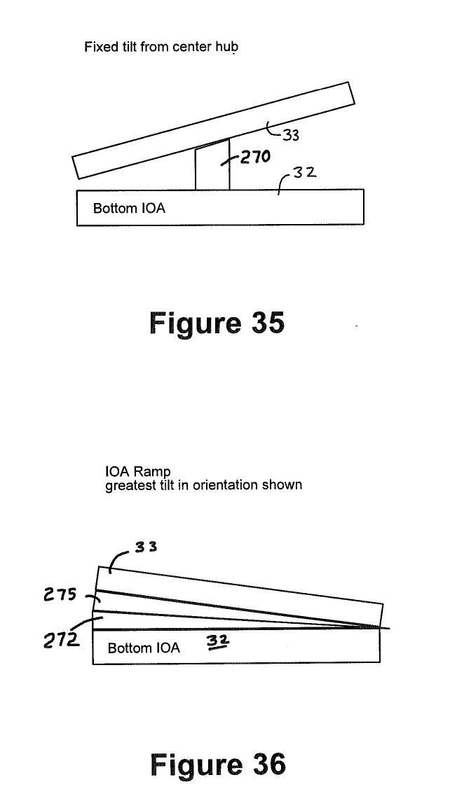

Attention is now directed to FIG. 35 which represents a concentrator having a bender that is linked through a hub 270 attached with the IOA such that the bender rides on the hub as shown in FIG. 35. The illustration of FIG. 35 is schematic in nature, and it is to be understood that the illustrated configuration can be achieved in a number of different configurations.

Attention is now directed to FIG. 36 which is a schematic diagram showing some examples of bender-IOA tilt by utilizing a ramp method. The ramp method uses a first ramp 272 on the upper part of the IOA and a second ramp 275 on the bottom of the bender. Thus, when the two optical arrangements are pointed in the same direction the ramps add in height and tilt the bender; when the optical arrangements are pointed in opposite directions (such as when the sun is directly overhead), then the ramps cancel and the arrangements are parallel to each other.

When we consider the function of the bender, there is a tradeoff between increasing the top angle, which in turn increases the amount of the early morning and late evening sun that is accessible, and shading loss, which increases with increasing top angle.

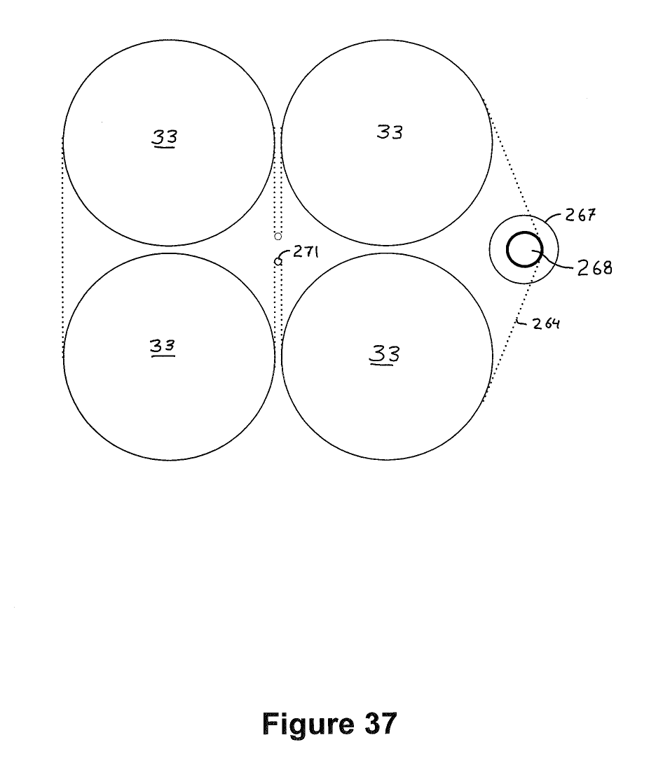

Attention is now directed to FIG. 37 which is a plan view showing an array of four concentrators that are rotatably coupled with one another through a drive mechanism including a filament 264, typically thread, chain, and/or wire, that can be wrapped around a portion of each bender in the array so that as the filament is moved, it causes the benders to rotate about their associated axes. The pattern of the filament is made so that there may be little or no slippage of the benders and each bender rotates the same amount; a serpentine pattern can be used in this embodiment. A groove or slot in the circumference of the benders may be used to keep the filament in place around the optical arrangement. Alternatively, the filament may be self centering by using a band or tape or similar method.

The filament is moved by a motor 267 which drives the filament in a controlled manner to rotate the benders to the proper angle. At least one motor for each array may be used, or one motor 268 with a shifting transmission to connect the motor to either one of the arrays may be used. The filament may wrap around an output shaft of the motor, and then proceed around each of the benders in the array. Center posts 271 may be used to wrap the filament a half-turn so that the filament changes direction after leaving one lens and before entering the next lens. If a larger array is needed, then additional center posts could be added. Thus if the filament is moving down from the right side of one lens, then it can be guided such that it moves up as it enters the left side of the adjacent lens. While FIG. 37 is a plan view, and therefore illustrates only benders which are positioned as input arrangements for initially receiving input rays of light (not shown), it is recognized that the same techniques may be applied with respect to IOA's (not shown in FIG. 37) and that the same filament may wrap around IOA, for example in accordance with FIGS. 33 and 34.

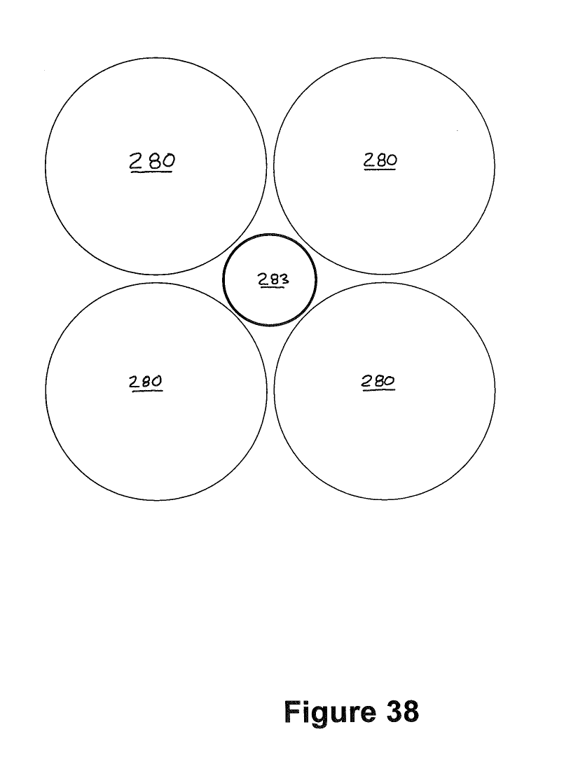

Attention is now turned to FIG. 38 which is a schematic representation illustrating yet another example of a drive mechanism for rotating the optical arrangements 280 using gears where each optical arrangement could have a set of teeth (not shown) that mesh with a drive gear 283. In the present example, a central gear 283 with gear teeth (not shown) around the outside of the gear may rotate, causing optical arrangements 280 that are meshed with central gear 283 to rotate. It is noted that this same method of rotation could be expanded for any number of optical arrangements such that the optical arrangements have gear teeth that would mesh with the central gear to allow for rotation. Furthermore, one or more additional gears (or filaments) could connect some of the drive gears to, or each gear could be driven by its own distinct motor.

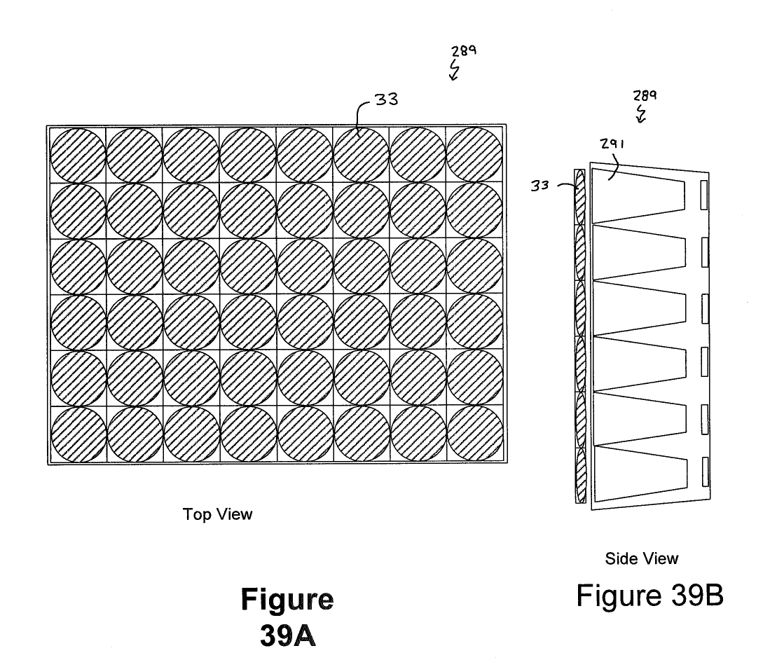

Attention is now turned to FIGS. 39A and 39B which are diagrammatic plan and elevational views, respectively, of a solar collector constructed as a panel enclosure and generally indicated by reference number 289. The panel enclosure houses a concentrator array. As discussed previously, the concentrators may be organized into the array in patterns that are rectangular, hexagonal, or of any other shape that may provide for a high areal efficiency in the packing of the concentrators. Control filaments (not shown) may run in a fashion that rotatably couples the concentrators so that selected optical arrangements within each concentrator rotate synchronously with the corresponding selected optical arrangements in the other concentrators. For example, filaments may link the rotation of benders in each concentrator so that they synchronously rotate together and additional filaments may similarly synchronously link the rotation of the IOAs within each concentrator. Therefore, at least in the example at hand, when one bender rotates 10 degrees clockwise, then all benders rotate 10 degrees clockwise, and the IOAs do not rotate. Or, when one IOA rotates 60 degrees counter-clockwise, then all IOAs rotate 60 degrees counter-clockwise, and the benders do not rotate. In this regard, the drive mechanism is to be considered as rotatably coupling all the benders with one another, and as rotatably coupling all the IOAs with one another. The side view of FIG. 39B also shows reflective concentrators 291 below the IOA.

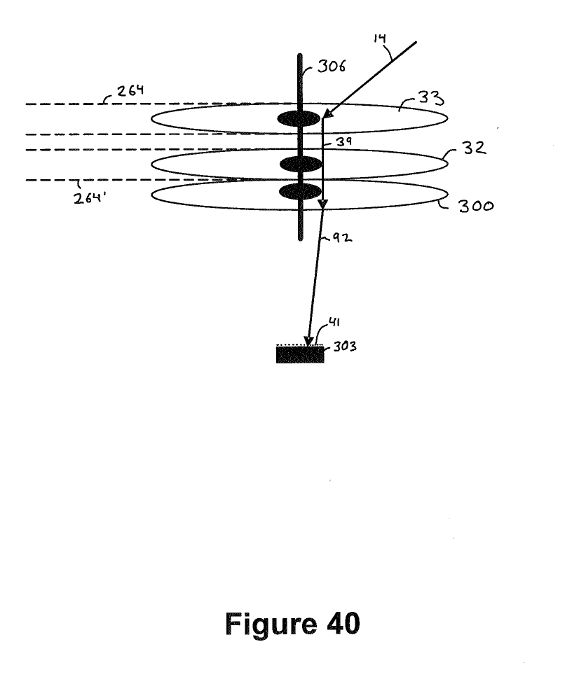

Attention is now directed to FIG. 40 which is a diagrammatic plan view of a concentrator having a bender 33, an IOA 32, and a concentrating arrangement 300. The optical arrangements including the bender, the IOA, and the concentrating arrangement are set above focus region 41 at a distance such that the light energy is uniformly illuminating the focus region as seen in FIG. 40. This distance is variable and is a trade-off between lens efficiency (longer is better) and compact panel size (shorter is better).

Bender 33 can utilize an array of prisms with each prism having a width, or pitch, of 1 mm. Each prism indicates a sloped wall that is at an angle of approximately 40 degrees relative to the surface tangent, and a vertical wall that is approximately 90 degrees to the surface tangent. This sloped-wall/vertical-wall pattern repeats over the full surface of the bender.

At least with respect to the example at hand, it may be desirable for the sloped wall angle to be maximized to produce the largest acceptance angle possible given the index of refraction of the material. The maximum angle is calculated when the rays of light enter vertically and are bent as far as possible, which is given by the critical (Total Internal Reflection) angle. This angle is Θ(prism)=arcsin(1/n), where n is the index of refraction. Thus, for an index of refraction of 1.5, the maximum angle is 41.8 degrees. If the prism includes a 90 degree vertical angle, then the prism ramp angle generally should not exceed this and should be less than this angle to allow for tolerance and a larger field of view of the sun. One exemplary design choice is the use of a 40 degree angle, though with a higher index of refraction material, the angle can be different.

The vertical side wall of each prism may also be modified if direct light above the lens is not to be completely concentrated to the target. This may be useful in examples wherein the top lens is tilted with respect to the line connecting the center of the lens to the center of the target. This may also be useful if more of the lower angle performance can be gained at the expense of the near vertical performance, which only occur a few minutes a day for a few days per year.

The pitch (prism width) can be adjusted based upon the sharpness of the corners of the prism (more rounded corners of the prism produce losses so a larger pitch may be preferred) and the volume of material of the prism (a larger pitch require more material which is more costly and will produce more optical aberrations).

By way of example, the bender can be a disk of acrylic with a diameter of 120 mm and maximum thickness of 2 mm with a 3 mm hole centered for support, and the prisms can be integrally formed with the disk. The bender disk rotates about a center hole. The outer rim of the disk can include a slot to accept a filament that provides for rotation. The flat side of the bender can face towards the sun and the prismatic side is facing the target. This bender may be made by standard casting or injection molding techniques. Any suitable dimensions can be used so long as the device functions consistent with these descriptions.

In the example at hand, concentrator 300 immediately follows the IOA. The concentrator can be configured such that that it causes a focus region spot size of 30 mm at the design distance of 12 cm. In one embodiment, the IOA and the concentrator are integrated into one optical element which removes two optical interfaces. This IOA will have a complex surface related to the convolution of the light bending prisms and the concentrating Fresnel and should be numerically modeled for optimal efficiency. The examples described herein are in no way intended to be limiting, and it is to be understood that there are innumerable solutions to this lens shape, that are considered to enable overall performance, as described. The IOA may be fabricated using a variety of well-known manufacturing techniques, including but not limited to injection molding and the like. It is to be understood that the concentrator need not be integrally fabricated with the rotating IOA refractive element, and that in another embodiment, the concentrator may be a compound parabolic concentrator (CPC) or similar reflective concentrator that can be arranged as a separate and distinct component from the rotating IOA refractive element. Additionally, the IOA could be completely reflective where the reflective element bends the light and concentrates the light; thus the system could comprise one refractive IOA bender and one reflective IOA as the complete optical system.

In the example at hand, the bender can be rotated about its axis by filament 264 and the IOA may be rotated about its axis by filament 264′. A PV solar cell 303 of 30 mm diameter can be fixedly centered under the concentrator so that it may be fully illuminated. The PV solar cell can be attached to a metal backing plate (not shown) which may serve as a heat sink for the thermal energy added by the concentrated solar radiation. Note, that as compared to a standard non-concentrating solar panel, this BRIC method has nearly the same solar density and thermal density, thus the thermal penalty for a BRIC panel should be no greater than that of a standard solar panel without concentration.

This design has a theoretical concentration of 16 as the sun's rays are captured over a 120 mm diameter area and concentrated over a 30 mm diameter area resulting in a 4× reduction in diameter and a 16× reduction in area. However, due to an approximate 4% reflective loss on each lens interface, (6 optical interfaces), the lens efficiency is approximately 78%, and a protective cover layer (not shown) is typically about 90% efficient, resulting in a concentration factor of about 11. All values are for demonstration only and any suitable values may be used so long as the device functions consistent with these overall descriptions.

Control circuitry (not shown) may be configured to direct the filaments 264 and 264′ to move causing the bender and the IOA to rotate in such a manner that the sun's rays are illuminating focus region 41 for reception by PV cell 303 at least at times when the rays are within the range of receiving angles of the concentrator.

Variations with respect to FIG. 40 include: combining the IOA and the concentrator into one integral optical arrangement; tilting the bender to point more closely towards the sun; using a different rotational method other than the outer diameter drive filaments 264 and 264′; replacing the PV cell with multiple receivers; removing a central rotation hub 306 and supporting each of the three optical arrangements by their respective edges or sides; using multiple concentrators in side-by-side relationships with one another to concentrate onto one single target and so on.

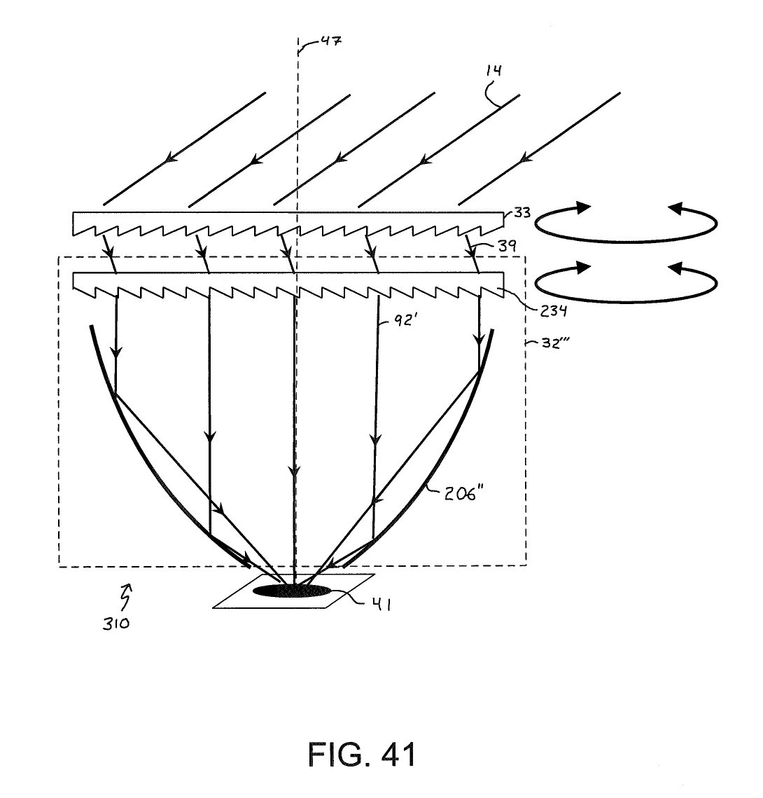

Attention is now directed to FIG. 41 in conjunction with FIG. 22B and FIGS. 26A and 26B. FIG. 41 is a diagrammatic elevational view of a concentrator, generally indicated by reference number 310 utilizing a bender 33 (as an input optical arrangement) followed by a multi element IOA 32′″ (indicated in the figure with a dashed box). The multi-element IOA includes a bender 234 and a reflector 206″ having a parabolic contour. Bender 234 accepts intermediate rays of light 39 and redirects the accepted rays for collection by reflector 206″ which collects and concentrates the redirected light into focus region 41, as illustrated in FIG. 41.

In one embodiment, bender 33 and bender 234 may be configured to cooperate with one another such that output rays 92′ exiting bender 234 may be collimated (parallel with one another) in an orientation that is at least approximately parallel with optical axis 47. With regard to this embodiment, Applicants believe that a person of ordinary skill in the art will recognize that there are a variety of well known techniques for utilizing parabolic reflective surface for collecting and concentrating collimated light. For example, reflector 206″ may be configured as a concentric parabolic concentrator (CPC) according to well known techniques. These techniques are discussed in “Nonimaging Optics” by Roland Winston, Juan C. Minano, and Pablo Benitez; published by Elsevier Academic Press and which is incorporated herein by reference. While an example utilizing collimated output rays 92′ has been presented herein for purposes of descriptive clarity, it is to be appreciated that there is no requirement that output rays 92′ should be collimated and/or parallel with optical axis 47, and a person of ordinary skill in the art, having this overall disclosure in hand, may readily implement a variety of configurations in which reflector 206″ can be configured to collect output rays 92′ that have been received and bent by bender 234 and are neither collimated nor parallel with optical axis 47. However, it is to be appreciated, based on well known principles of optics, that a given reflector 206″, in order to collect and concentrate the light as described herein, may require that output rays 92′ fall within some predetermined range of angles relative to optical axis 47.

With ongoing reference to FIG. 41 it is noted that bender 33 and bender 234 may be selectively rotated with respect to one another and relative to the orientation of the incoming rays of light, in order for the bender and the multi element IOA to cooperate with one another, in accordance with the descriptions in this overall disclosure, for receiving and concentrating incoming rays of light 14. It is further noted that in one variation of the embodiment described herein, reflector 206″ may be attached to bender 234 such that bender 234 and reflector 206″ co-rotate. In another variation, reflector 206″ may be stationary in the earth's frame of reference such that it does not rotate with bender 234.

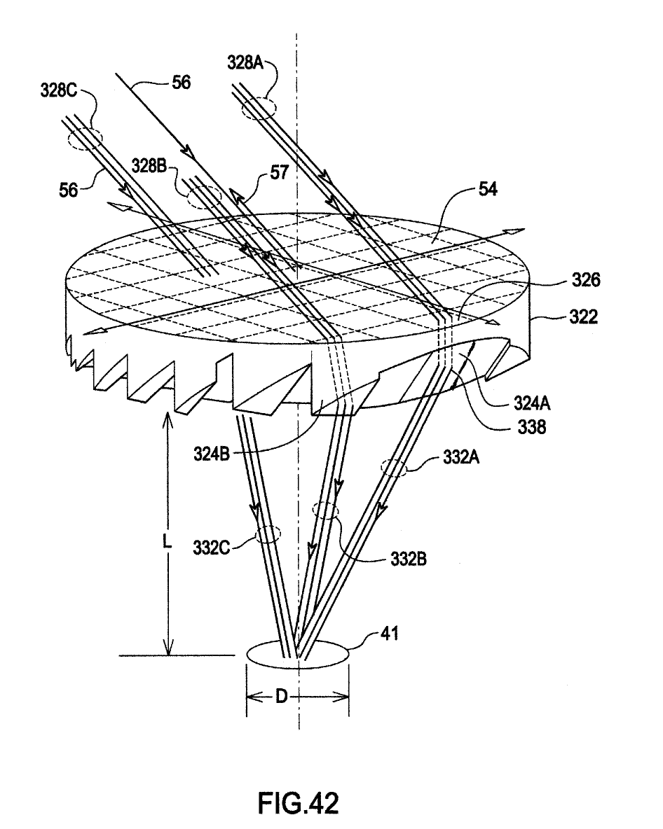

FIG. 42 is a diagrammatic perspective view illustrating the operation of a segmented optical arrangement that is configured as a segmented IOA and generally referred to by reference number 322. As described previously with reference to FIG. 5, the IOA defines an acceptance direction 57 and is aligned for receiving a plurality of input rays of light 56 that are parallel with one another and incident on input surface 54 with an input orientation, with respect to optical arrangement 322, that is at least approximately anti-parallel to acceptance direction 57. The IOA is further configured for concentrating the input rays of light into a focus region 41 that is smaller than the input surface.

Segmented IOA 322 of FIG. 42 includes a plurality of sub-elements 324 transversely distributed in side-by-side relationships with one another and having a thickness throughout the vertical extents of the IOA in the view of the figure. The sub-elements cooperatively define the input surface such that an uppermost end of each sub-element defines a segment 326 of the input surface, shown using dashed lines, a selected one of which is indicated by this reference number. Each segment is aligned for receiving a corresponding subset 328 of the plurality of input rays of light that is incident on the segment, and for transmissively redirecting it's corresponding subset of input light rays toward focus region 41 such that the plurality of sub-elements cooperate with one another for concentrating the input rays into the focus region. It is noted that the general reference number 328 may refer generally to light that is incident on each sub-element, and that individual subsets of input rays 328A, 328B, and 328C are identified in FIG. 42 with dashed circles. For purposes of illustrative clarity these subsets are depicted as including three rays that are each incident on a single corresponding segment, and it is to be understood that there is no special significance in the choice to depict each subset as having three rays, and that there could be more or less rays in each subset.

With respect to the embodiment illustrated in FIG. 42, individual ones of the rays in each subset may impinge on different positions of the segment corresponding to that subset, and each individual one of the rays is redirected in the same way as the other rays in that subset such that a corresponding subset of output rays 332 are all at least approximately parallel with one another as indicated in FIG. 42. In other words, each sub-element defines a segment of surface area that receives a corresponding subset of input rays, and the sub-element is configured to redirect each of the rays in the subset in the same way to produce a corresponding subset of output rays that are each at least approximately parallel with one another and that have at least approximately the same predetermined orientation with respect to the input orientation of the subset of input rays. It is noted that the general reference number 332 may refer generally to light that is produced by each sub-element, from subsets of input rays 328, and that individual one's of the subsets of output rays are indicated in FIG. 42 with reference numbers 332A, 332B and 332C, corresponding, respectively to subsets of input rays 328A, 328B and 328C.

While different input rays received by the same sub-element are redirected by that sub-element in the same way, it is noted that in order to cause focusing into focus region 41, different sub-elements may be configured to redirect incoming rays differently from one another. For example sub-element 324A may be configured to receive and redirect input rays 328A in a first predetermined orientation relative to the input orientation, such that the corresponding output rays 332A are directed to focus region 41, while a different sub-element 324B may be configured to receive and redirect input rays 328B in a second predetermined orientation relative to the input orientation such that corresponding output rays 332B are directed to focus region 41. With respect to this particular example, it is to be understood that if this were not the case, and if sub-element 324B redirected the input rays in the same way as sub-element 324A, then the output rays 332B could fall outside of focus region 41.

It is noted that that IOA 322 redirects and concentrates the received input rays of light in a two-dimensional way such that the focus region of this example forms a circular spot that is smaller than that the circular input surface. The description is in no way intended to be limiting, and in this regard, it is to be understood that there is no requirement the input surface and/or the focus region should be circular, and there is no requirement that they should have the same shape as one another. However, irrespective of the shape of focus region 41, the segmented optical arrangement may be configured for concentrating the input rays of light into a focus region that is smaller than the input surface and has a predetermined shape such that any given transverse extent across the focus region is substantially smaller than a corresponding transverse extent across the input surface. For example, with respect to the foregoing embodiment, any diameter of the circular focus region is substantially smaller than the corresponding diameter of input surface 54. In another example (not shown), the input surface may define a square, and the focus region may define a smaller square such that any transverse extent of the smaller square, such as a diagonal extent in a given direction from one corner to another, is smaller than the corresponding diagonal extent, along the same given direction, of the input surface. In yet another example (not shown) the input surface may define a square, and the focus region may define circle that is substantially smaller than the square such that any transverse extent of the circle, such as a diameter extending in a given direction across the circle, is smaller than the corresponding transverse extent, along the same given direction, of the square input surface.

Having described the overall performance of one embodiment of a segmented optical arrangement, configured for receiving and concentrating input rays of light in a two dimensional way, a number of specific details with respect to this embodiment will be described immediately hereinafter.

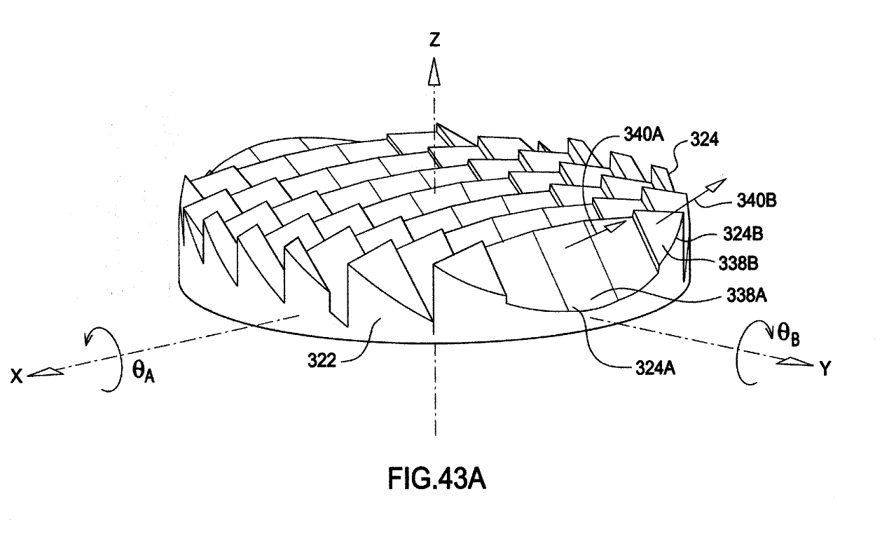

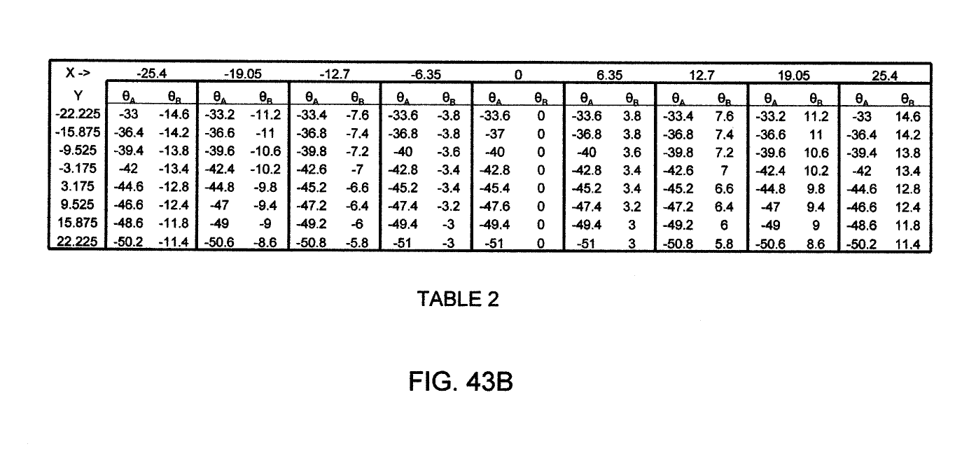

Attention is now directed to FIG. 43A which is a diagrammatic bottom view, in perspective, of one embodiment of segmented optical arrangement 322, presented so that the reader is able to discern various features thereof. Each sub-element of this embodiment includes a substantially flat interface that is tilted at a particular orientation with respect to the IOA. For example a first sub-element 324A includes first interface 338A tilted at a first orientation 340A as indicated in FIG. 43A by a first vector, and second sub-element 324B includes second interface 338B tilted at a second orientation 340B as indicated in FIG. 43A by a second vector. The first and second orientations are different from one another. The segmented arrangement, and all of the sub-elements thereof, may be composed of a first optical medium, such as, for example, glass, polycarbonate, or acrylic, having a first index of refraction. The optical arrangement may be surrounded by a second optical medium, such as air, having a second index of refraction that is different from the first index of refraction. The interfaces associated with each of the sub-elements in segmented optical arrangement 322 may be configured to cooperate with one another for receiving and concentrating input rays of light 56 (FIG. 42) in accordance with the previous description. In particular, as will be described immediately hereinafter, the orientations of each of the interfaces may be aligned, with respect to the segmented optical arrangement, for redirecting the rays of light by optical refraction based at least in part on (i) the orientation of each interface, and (ii) a difference between the index of refraction of the first medium and the second medium.

Returning now to FIG. 42, it is noted that first and second sub-elements 324A and 324B, respectively, described immediately above with reference to FIG. 43A, are both visible in FIG. 42 and are indicated in both figures by the same reference numbers.

Referring to FIGS. 42 and 43, sub-element 324A may be configured to receive and redirect input rays 328A in a first predetermined orientation relative to the input orientation, such that the corresponding output rays 332A are directed to focus region 41. More particularly, based at least on the descriptions above with reference to FIG. 43A, subset 328A of input rays may be received by interface 338A of sub-element 324A and redirected, by optical refraction, based on (i) the orientation of interface 338A, and (ii) a difference between the index of refraction of the first medium and the second medium.

Similarly, as described above with respect to FIGS. 42 and 43, second sub-element 324B may be configured to receive and redirect input rays 328B in a second predetermined orientation relative to the input orientation such that corresponding output rays 332B are directed to focus region 41. In particular and again based at least on the descriptions above with reference to FIGS. 42 and 43, subset 328B of input rays by be received by interface 338B of sub-element 324B and redirected, by optical refraction, based on (i) the orientation of interface 338B, and (ii) a difference between the index of refraction of the first medium and the second medium.

The embodiment of the segmented optical arrangement 322, described above with reference to FIGS. 42 and 43, in being configured to operate as an IOA, may serve as IOA 32 in various ones of the concentrators disclosed herein, including, as one non-limiting example, the BRIC described with reference to FIG. 3. With respect to embodiments in which segmented optical arrangement 322 is configured to serve as an IOA, the arrangement may be referred to hereinafter as a segmented IOA.

While FIG. 43A illustrates one embodiment of a segmented IOA that includes rectangular and/or square interfaces 338, Applicants recognize that there is no requirement that a segmented IOA should be limited in this regard. A given IOA may include interfaces having different combinations of shapes including but not limited to squares, rectangles, triangles, and/or various polygons.

It is considered by Applicants that a person of ordinary skill in the art, based on the overall geometry described herein with respect to segmented IOA 322, and based on well known optical techniques, including but not limited to application of Snells law, with respect to interfaces 338 and with respect to flat surface 241 (FIG. 42), may readily determine a set of requirements for orientations 340 (FIG. 43A) of each interface 338 (FIG. 43A) of a given segmented IOA, and may readily customize the given IOA for exhibiting a set of predetermined characteristics including but not limited to (i) acceptance angle ξ (ii) a focal length L, and (iii) focal region size and shape.

Attention is now turned to FIG. 43B, which is a design table, for a segmented IOA, designated in the figure as Table 2. The latter describes a design for one embodiment of a segmented IOA, configured to exhibit an acceptance angle of approximately ξ=30 degrees, and a focal length of approximately L=150 mm. This embodiment is further configured to receive input rays of light 328 (FIG. 42) that are anti-parallel to acceptance direction 34 (FIG. 42) and to focus them into focal region 41 (FIG. 42) having an approximate diameter of D=10 mm. The upper row of Table 2 corresponds to an approximate X coordinate for a central location of each interface 338 and the leftmost column corresponds to an approximate Y coordinate for a central location of each interface 338. The X and Y coordinates in Table 2 may be interpreted according to the X and Y axes illustrated in FIG. 43A as arrows, with positive X and Y values corresponding to the direction indicated by the head of each respective arrow, and with the values X=0 and Y=0 corresponding to a central location (not shown) on the IOA. For each coordinate that is designated in Table 2, the table lists orientation 340 (FIG. 43A), for the corresponding interface, as an angle in, degrees, having values θ_{A} and θ_{B}, which may be interpreted as angles of rotation about the X axis and the Y axis, respectively, with the values θ_{A}=0 and θ_{B}=0 corresponding to an orientation along the positive direction of the Z axis. Positive values for angles θ_{A} and θ_{B} may be interpreted as corresponding to the directions of their respective illustrations in FIG. 43A. It can be assumed that the segmented IOA described in Table 2 is composed of polycarbonate and has an index of refraction of 1.58. Each sub-element may be configured as a 6.35 mm×6.35 mm square, with the boundaries of each sub-element being oriented according the dashed lines superposed on flat surface 241 (FIG. 42).

As described previously, a number of required characteristics for a given concentrator may be determined at least in part by a given shape of a given receiver. For example, as described with reference to FIG. 15, and as will described in further detail immediately hereinafter, a linear concentrator may be provided and configured for use with a linear target, such as an elongated receiver having an elongated receiving surface. In one embodiment, described above with reference to FIG. 15, a solar-thermal solar collector may include a tubular receiver, that is configured as a long and narrow pipe having a correspondingly elongated receiving surface, and an associated concentrator may be particularly configured for concentrating light for acceptance by this elongated receiving surface. In the descriptions that follow, a number of additional features will be brought to light with respect to linear concentrators. For example, as will be described in greater detail hereinafter, a linear solar thermal concentrator, including an elongated receiver such as the aforedescribed tubular receiver, may be configured for tracking the sun in a manner that relies on rotation of only one optical arrangement, and does not require cooperation between rotational alignments of two optical arrangements. Furthermore, a linear solar concentrator, for use with an elongated receiver, may be configured as a linear concentrator that is only required to focus light along one reference axis.

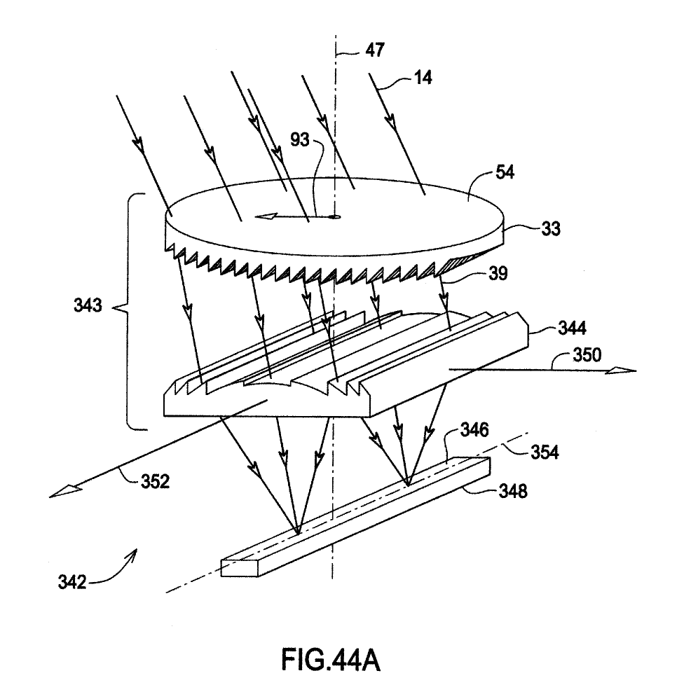

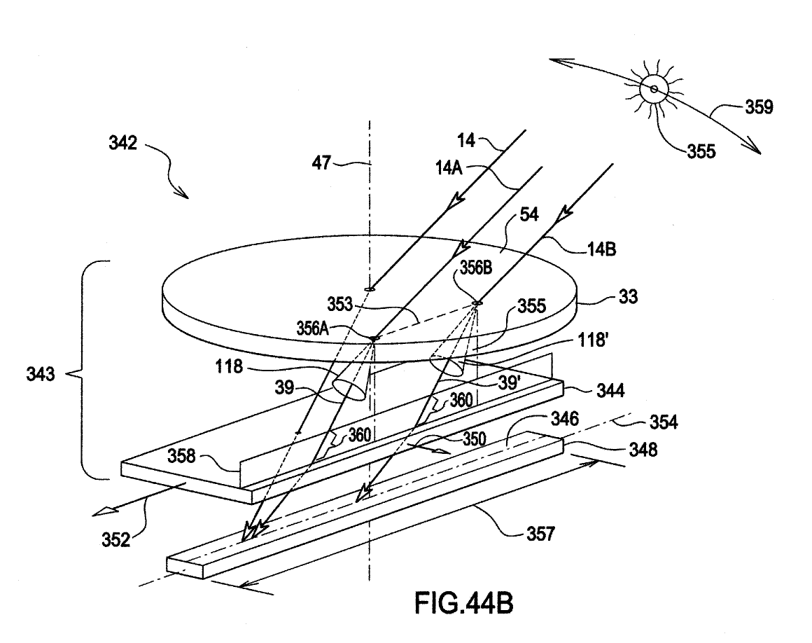

Attention is now directed to FIG. 44A, which is a diagrammatic perspective view of a solar collector, generally indicated by the reference number 342. Solar collector 342 includes a linear concentrator 343 that is configured for receiving a plurality of incoming rays of light 14 that are at least approximately parallel with one another and that are incident on bender 33. In accordance with the descriptions above with reference to FIG. 8, the bender is characterized in part by bend angle β (not shown) and bender direction 93. Furthermore, the bender defines an input surface 54 and is supported for selective rotation, over a range of rotational orientations, about an input axis 47. The bender redirects the incoming rays of light in a way that depends on a selected rotational orientation of the bender, to produce a plurality of intermediate rays of light 39 such that at least some of the intermediate rays are subsequently focused by a single-axis focusing arrangement 344 for concentration into an elongated receiving surface 346 of an elongated receiver 348. Single axis focusing arrangement 344 defines a first reference direction 350 and a second reference direction 352, and is aligned such that the first and second reference directions are both at least approximately perpendicular to one another and to input axis 47. Furthermore, the single axis focusing arrangement is configured for focusing the intermediate rays of light in the first reference direction, without substantially changing the direction of these rays along the second reference direction, such that any intermediate rays of light that are incident on the single axis focusing element, and that are orthogonal with the first reference direction, will be focused toward a line of focus 354 that is at last approximately parallel with second reference direction 352. Elongated receiver 348 is aligned such that receiving surface 346 is oriented lengthwise along line of focus 354 such that at least some of the focused rays are incident on the receiving surface.

The single-axis focusing arrangement, in one embodiment, may be a conventional cylindrical lens. In another embodiment, as will be described hereinafter, the single axis focusing arrangement may be a cylindrical reflective trough. In still another embodiment, the linear concentrator may be integrally formed of an optical material, as a conventional cylindrical fresnel-type lens, and may include a plurality of optical prisms that are parallel with one another in adjacent side-by-side relationships as illustrated in FIG. 44A. Irrespective of the particular embodiment, the single axis focusing arrangement may be aligned such that both of its reference directions are at least approximately perpendicular to input axis 47, and the single axis focusing arrangement may be configured for receiving light and redirecting the intermediate rays of light for focusing in the first reference direction substantially without redirecting light along the second reference direction. Furthermore, a single axis focusing arrangement may be configured to define a line of focus 354 such that any received light that is perpendicular to the first reference direction may be focused at least generally theretowards. Furthermore, for purposes of enhancing the readers understanding, as will be described immediately hereinafter, the single axis focusing arrangement may be regarded as defining an acceptance plane, perpendicular to the first reference direction and intersecting the given location, such that any incoming ray that is received by the focusing arrangement, and that lies in this plane, may be focused toward the line of focus.

As described above, with reference to FIG. 44A, and in accordance with previous descriptions relating to FIG. 8 and EQ. 2, linear concentrator 343 may be configured such that incoming rays of light 14 are bent in a way that depends on the rotational orientation of bender 33. In particular, as described with reference to FIG. 9, for a given orientation of an incoming ray of light, rotation of the bender may cause intermediate rays of light 39, produced by the bender from the received incoming ray of light, to at least approximately sweep out an output cone. As will be described immediately hereinafter, in a manner that is analogous with previous descriptions relating to BRIC concentrators, the bender and the single axis focusing arrangement can be aligned, relative to one another, such that the output cone of the bender and the acceptance plane of the focusing arrangement intersect with one another at least along one line of intersection, and for any selected one of a range of orientations of the incoming rays, associated with a position of the sun in the sky, the rotational orientation of the bender may be adjusted such that the intermediate rays of light are oriented along this line of intersection and are subsequently received and focused.

Attention is now directed to FIG. 44B which is a diagrammatic perspective view of solar collector 342, illustrating selected aspects of its operation. First and second incoming rays 14A and 14B, parallel with one another and incident at a given orientation, are incident on input surface 54 of bender 33 at two different locations of incidence 356A and 356B. As described above, for a given input ray of light, incident on input surface 54 at a given location of incidence, single axis focusing arrangement 344 may be regarded as defining an acceptance plane 358, perpendicular to first reference direction 350 and intersecting input surface 54 at the location of incidence, such that any intermediate ray that lies in this acceptance plane (and therefore perpendicular to first reference direction 350), may be focused toward the line of focus. In order to facilitate illustrative clarity, locations 356A and 356B of the example at hand are disposed on a line of intersection 353 that defines an intersection between an acceptance plane 358 and input surface 54, such that both locations of incidence can be considered with respect to the same acceptance plane.

It is noted that a position 355 of the sun is illustrated in FIG. 44B, as one of a range of positions 359, and for purposes the description at hand, input rays of light 14 may be considered as corresponding to rays of sunlight associated, for example, with position 355 of the sun.

Incoming rays of light 14A and 14B are bent in a way that depends on the rotational orientation of the bender, such that rotation of the bender causes the corresponding intermediate rays of light 39 and 39′ to sweep out exit cones 118 and 188′, respectively, as described previously with reference to FIG. 9. Solar collector 342 can be configured for tracking the sun, for a range of positions thereof, for example by rotating bender 33 for aligning the intermediate rays of light along lines of intersection 360 that are defined as an intersection of the exit cone of the bender and the acceptance plane of the single axis focusing arrangement for each point of incidence, such that the intermediate trays are focused at least generally towards line of focus 354.

While this illustrative model may be regarded as closely analogous with one illustrative model for operation of a BRIC-type concentrator, previously described with reference to FIG. 10, the two approaches differ, at least somewhat, with respect to various aspects of cooperation between the bender and the associated additional optical arrangement that follows the bender, as will be described immediately hereinafter.

It is noted, as illustrated in FIG. 44B, that the receiver has a finite length 357, and so for a given incoming ray of light, focusing of that light toward line of focus 354 is not by itself sufficient to insure collection of the focused light by the receiver. Depending on (i) the orientation of the given incoming ray of light and (ii) the location of incidence on input surface 54, the corresponding focused ray may miss the receiver. For example, incoming ray of light 14A, incident on bender 33 at location 356A, is focused towards line of focus 354 yet nevertheless misses the receiver, and is therefore not collected, while incoming ray of light 14B, incident on bender 33 at location 356B, is focused towards line of focus 354 such that the corresponding focused light is incident on receiving surface 346 and may therefore be collected by receiver 348 for conversion into some form of energy.

It is noted that any intermediate ray of light received by the single axis focusing arrangement and parallel with the acceptance plane thereof, can be focused towards line of focus 354 with no need for any adjustment, rotational or otherwise, of the single axis focusing arrangement. By contrast, referring again to FIG. 10 and the related descriptions, in the context of a solar collector utilizing a BRIC and having an IOA as an additional optical arrangement following a bender, a given intermediate ray of light received by an IOA, lying on the acceptance cone thereof, may or may not be focused, depending at least in part on the rotational orientation of the IOA. At least for these reasons, it can be appreciated that solar collector 342, having a linear solar concentrator including a bender and a single axis focusing arrangement, may be configured for tracking the sun by rotation of the bender, and without a need for adjustment, rotational or otherwise, of any other optical elements, whereas a solar concentrator including a BRIC, may require coordinated rotational alignment between two optical elements, for example a bender and an IOA. At least in cases where an elongated receiver can be employed, the use of a linear concentrator, in accordance with the foregoing descriptions, may be regarded as providing yet further remarkable advantages, at least for the reason that only rotation of one optical arrangement may be required.

While solar collector 342 may require rotation of bender 33 in order to track the sun, it is to be understood that this solar collector, at least for a range of rotational orientations of the bender, is not to be considered as defining a unique acceptance direction, at least for the reason that a selected rotational orientation of the bender may allow for collection of incoming light having more than one orientation. As one illustrative example, in a particular configuration (not shown) with the bender pointed in a direction that is parallel with the second reference direction, any incoming rays of light that are perpendicular with the first reference direction of the single axis focusing arrangement, and that are received by the input surface of the bender, may be focused toward the line of focus.

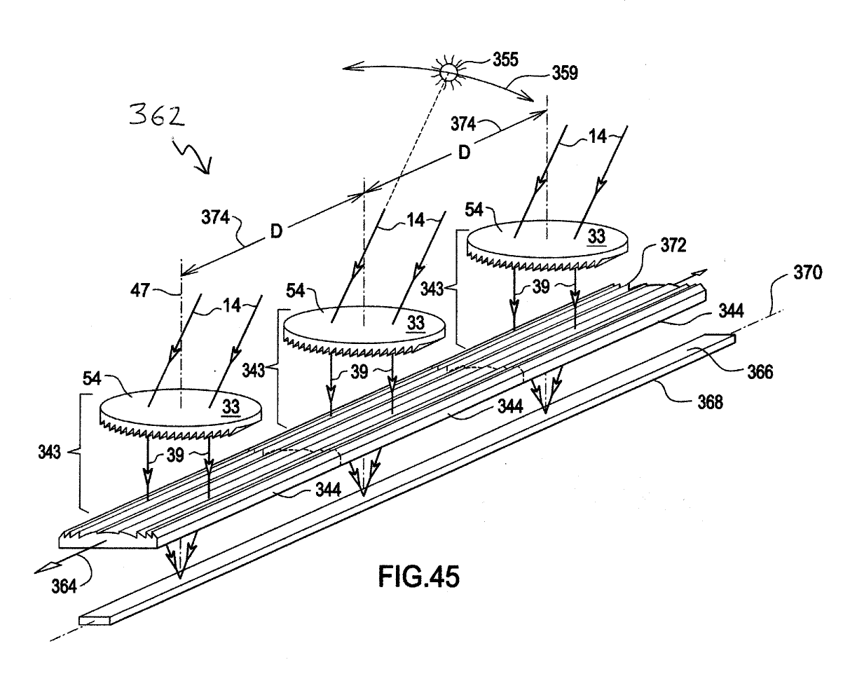

Attention is now directed to FIG. 45, which is a diagrammatic perspective view of a concentrator array, generally indicated by the reference number 362, of linear solar concentrators 343, several of which are indicated in FIG. 45 using brackets. Linear solar concentrators 343 may each be configured in accordance with the foregoing descriptions relating to FIGS. 44A and 44B. The array of linear concentrators may be supported by a support structure (not shown) such that each input surface 54 is positionable to face in a skyward direction for initially receiving sunlight, illustrated in FIG. 45 as incoming rays of light 14. Each of concentrators 343 may be configured for tracking the sun, throughout a range of positions of the sun throughout a typical year, at least in part by rotatably aligning bender 33 in accordance with the above descriptions. As illustrated in FIG. 45, all of the linear concentrators are aligned with one another such that the second reference direction of all the focusing elements are at least approximately aligned along a single axis 364 to cause all of the lines of focus of the concentrators to be correspondingly aligned with one another to cooperate in defining one combined line of focus 370. Collector 362 includes a combined elongated receiver 368 having a combined receiving surface 366 that may be aligned along combined line of focus 370. Furthermore, in the embodiment illustrated in FIG. 45, the single axis focusing elements of each of the linear concentrators may be integrally formed with one another as one combined focusing element 372 that is shared by all concentrators in the array such that single axis 364 serves as the second reference direction associated with combined focusing element 372. Accordingly, the boundaries therebetween are indicated with dotted lines in order to signify that these arrangements may be integrally formed with one another from one piece of optical material. It is noted that the concentrators in linear array 362 may be spaced apart, for example by a center-to-center distance D, as indicated by a double-headed arrow in FIG. 45, for reasons that will be brought to light immediately hereinafter.

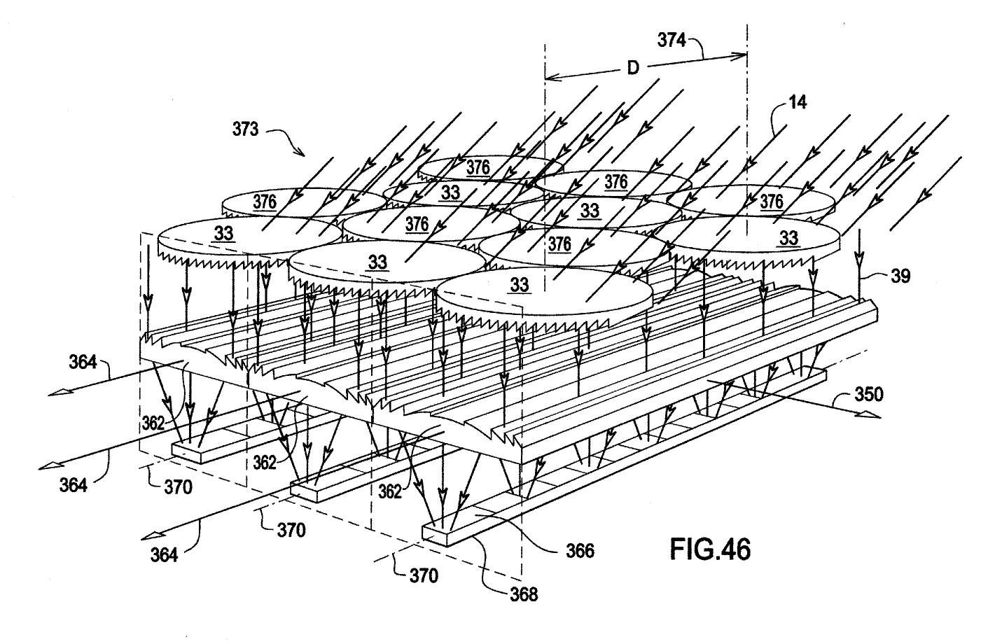

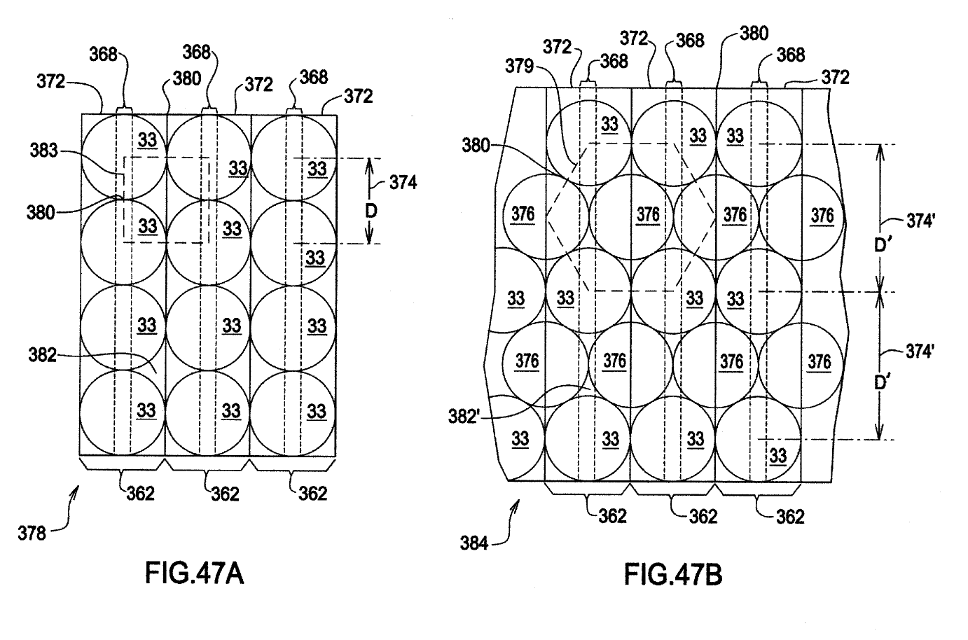

Having described a linear array of linear concentrators, attention is now directed to FIG. 46 which is a diagrammatic perspective view of a two-dimensional array, generally indicated by reference number 373, including a number of linear arrays supported in side-by-side relationships with one another. It is noted that the concentrators in each linear array are spaced apart from one another by distance D, as described immediately above, that is sufficient to provide space for additional benders 376 that are disposed between adjacent linear arrays and configured for receiving and bending input rays of light 14 to produce additional intermediate rays such that for each additional bender a first portion of the additional intermediate rays is received by a selected one of the elongated focusing arrangements, and a second portion of the additional intermediate rays is directed into an adjacent one of the elongated focusing arrangements. Based at least on the foregoing descriptions, with reference to FIGS. 47A and 47B, it is to be appreciated that additional benders 376 can be rotatably aligned in the same way as benders 33, such that the corresponding first and second additional intermediate rays will be at least approximately orthogonal to first reference direction 350 of the corresponding focusing arrangements that receive those additional intermediate rays of light, causing the intermediate rays of light to be focused accordingly.

It is noted that spacing D between benders 33 has a value that is sufficient to allow for positioning of the intermediate benders in an advantageous way at least with respect to a number of characteristics that will be described in detail immediately hereinafter.

Attention is now turned to FIG. 47A which is a plan view, generally indicated by the reference number 378, of a two dimensional array having three adjacent linear arrays 362 of linear concentrators with benders that can be spaced apart from one another a distance D that is sufficiently large, as compared to the diameter of each bender, to provide sufficient mechanical clearance between the benders in each linear array, as will be understood by a person of ordinary skill in the art. Each linear array includes elongated single-axis focusing arrangement 372 and combined elongated receiver 368, as described above with reference to FIG. 45.

The linear concentrator arrays are disposed in side-by-side relationships with one another and spaced apart by center-to-center distance D, sufficient for providing at least some mechanical clearance between the benders, and this spacing may be determined in part to provide sufficient mechanical clearance for drive mechanisms utilized for rotating the benders. It is noted, with respect to the embodiment of FIG. 47A that benders 33 are distributed relative to one another such that the center-to-center orientations define a square pattern, as indicated by a dashed square 383, to establish a total interstitial area as a sum of a plurality of the interstitial areas 382 (one of which is indicated). Applicants appreciate that (i) any light that is incident on interstitial areas may be regarded as lost and/or rejected light, since this light will not be received and/or redirected by the benders, and that (ii) a different two dimensional array can be configured for reducing the total amount of interstitial area between the benders, as will be described immediately hereinafter.

Attention is now directed to FIG. 47B, which is a plan view of one embodiment of a two dimensional concentrator array, generally indicated by the reference number 384, that is arranged according to the same manner of arrangement of benders previously depicted in FIG. 46. Concentrator array 384 includes linear arrays 372 having benders 33 and additional benders 376 as described above. Each linear array includes combined focusing arrangement 362 and combined elongated receiver 368 as described above if reference to FIGS. 45 and 46. Benders 33 are spaced apart from one another sufficiently by distance D′ to provide space for additional benders 376 and to insure sufficient mechanical clearance 380 between all of the benders. It is noted, with respect to the embodiment of FIG. 47A that benders 33 are distributed relative to one another such that the relative placement of the centers of the benders can be considered as defining a hexagonal pattern, as indicated by a dashed hexagon 379, for reducing interstitial area 382′ as compared to that of concentrator array 378 of FIG. 47A. Applicants appreciate that the embodiments of FIG. 46 and FIG. 47B may be of benefit in this regard, at least as compared to array 378 of FIG. 47A, at least for the reason that reduced interstitial space correspondingly reduces the amount of wasted light.

With respect to the foregoing embodiments, it is noted that the single-axis focusing arrangements that are utilized can be transmissive elements such as conventional cylindrical lenses, or fresnel lenses, that may focus the intermediate light rays based on optical refraction. As described above with respect to FIG. 46A, there is no requirement that the single-axis focusing arrangement should be transmissive, and the structures and methods of the immediately foregoing descriptions may be modified for substituting a reflective single axis focusing arrangement, as will be described immediately hereinafter with reference to one particular embodiment.

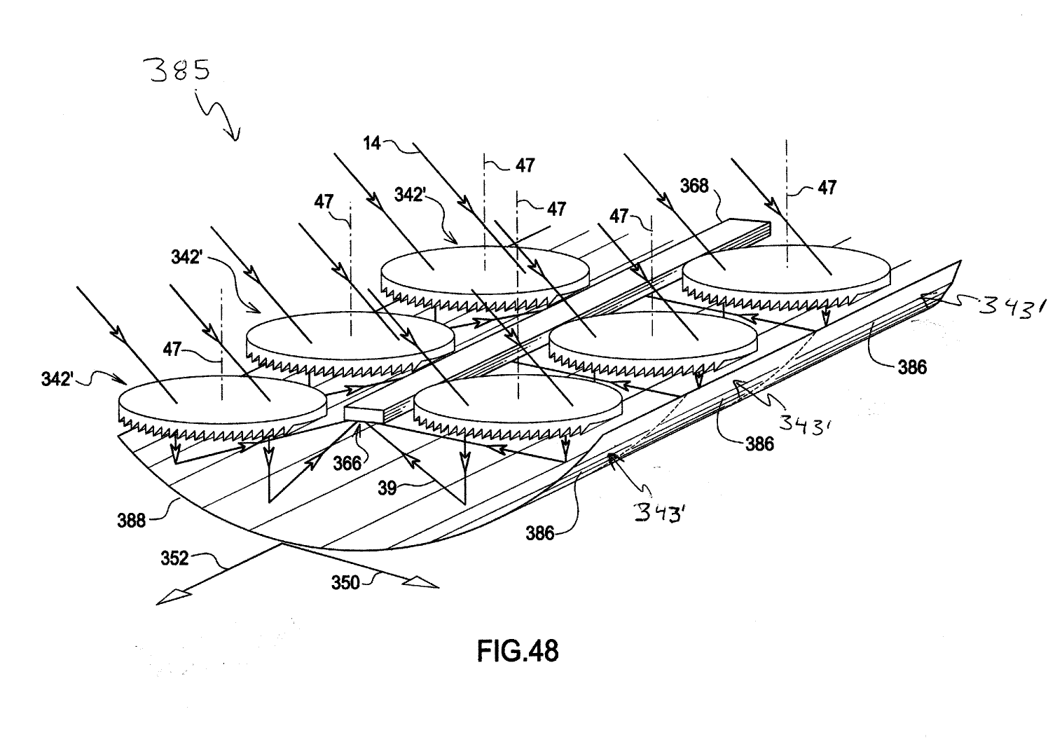

Attention is now directed to FIG. 48 which is a diagrammatic view, in perspective, of an array, generally indicated by reference number 385, of linear concentrators 343′. Each concentrator includes a bender 33 and a portion 386 of an elongated single-axis reflective arrangement 388. Each concentrator is configured for receiving incoming rays of light 14 and for redirecting the incoming rays of light for producing therefrom intermediate rays of light 39 such that the intermediate rays of light are focused onto the combined receiving surface of combined elongated receiver 368. It is noted that in the illustrated perspective view, combined receiving surface, 366 is not visible in FIG. 48, since it is facing in a downward direction.

Elongated reflective focusing arrangement 388 may be configured as a single axis focusing arrangement having first and second reference directions 350 and 352 that are orthogonal with one another and are both oriented transversely with respect to input axes 47. It is noted that for each concentrator 343′ of concentrator array 385, the bender and the associated reflective portion may cooperate with one another to receive and focus incoming rays of light 14 in the same overall manner described above with respect to concentrator 343 (FIGS. 44A and 44B), with the single axis focusing being caused by reflection as opposed to refraction. In particular, as described above with reference to single axis focusing arrangement 344, elongated reflective focusing arrangement 388 may focus intermediate rays of light 39, along first reference direction 350, without substantially changing the direction of the intermediate rays along second reference direction 352. Furthermore, as described with reference to single axis focusing arrangement 344 (FIG. 45), elongated reflective focusing arrangement 388 may be configured such that at least a portion of the intermediate rays of light that are incident thereon, and that are orthogonal to first reference direction 350, will be focused into combined receiving surface 366 of combined elongated receiver 359.

Having described a number of linear concentrators that utilize a single axis optical arrangement for focusing in one direction, the descriptions are now turned toward further embodiments of optical concentrator arrangements that combine at least two single axis optical arrangements, in cross-wise orientations with one another, for focusing light in more than one direction.

Returning now to FIG. 5 and FIG. 26A, an IOA may be configured to define (i) an optical axis 47, (ii) a focus region 41, and (ii) a receiving direction 57, oriented at an acute angle with respect to the optical axis, such that input rays of light that are anti-parallel with the receiving direction are bent and focused into the focus region of the IOA. The IOA may be configured with two or more optical arrangements that each contribute to one or both of the bending and the focusing. In certain embodiments, such as the multi-element IOA 32″ illustrated in FIG. 26A, the first optical arrangement may be configured for bending, and the second optical arrangement may be configured for focusing. The two optical arrangements may be configured to cooperate with one another to perform the bending and focusing in a way that causes the combination thereof to serve as an IOA.

Similarly, as described with reference to FIG. 26B, an integrally formed IOA may be configured such that a first optical arrangement, integrally formed with the input surface, performs the bending action of the IOA, and a second output arrangement, integrally formed with the output surface, performs the focusing action of the IOA. It is noted, however, as described previously with reference to FIG. 26B, there is no requirement that the bending and focusing action must be separated between the input and output surfaces, respectively, and the bending and focusing actions may be combined in a variety of complex ways between the opposing surfaces of an integrally formed IOA. Similarly, for a multi-element IOA having two or more optical arrangements, Applicants recognize that the bending and focusing actions may be combined in a variety of different ways between multiple optical elements thereof.

For example, as will be described immediately hereinafter, a multi-element IOA may include a first optical arrangement that serves as a single axis focusing element for focusing along a first reference direction that is at least approximately transverse to the optical axis of the multi-element IOA, and a second optical arrangement may provide bending and focusing in a second reference direction that is also transverse with respect the optical axis and is at least approximately perpendicular with the first reference direction.

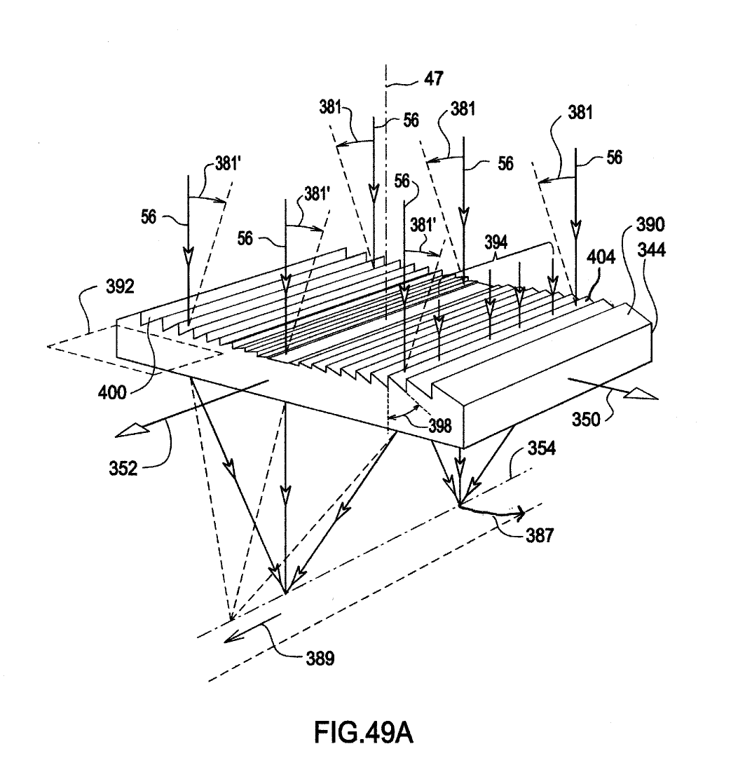

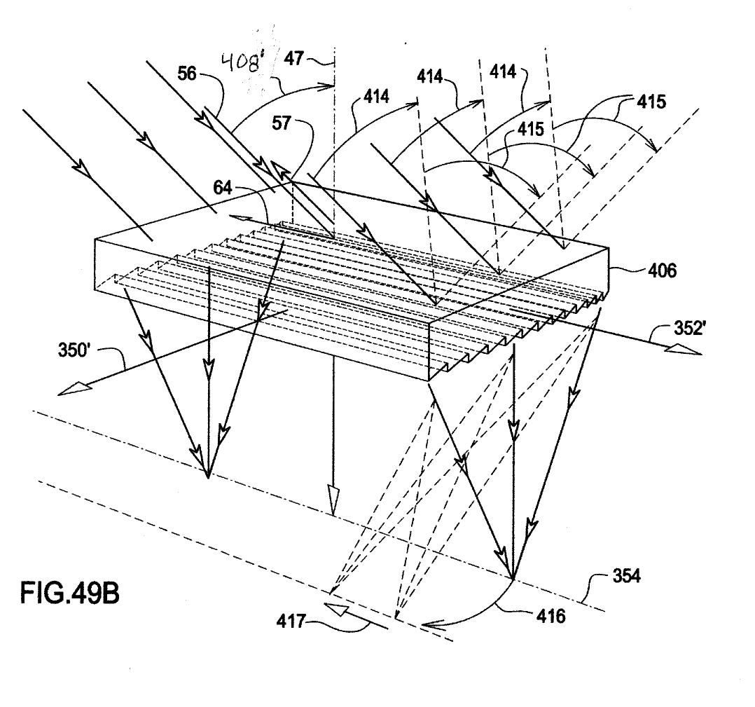

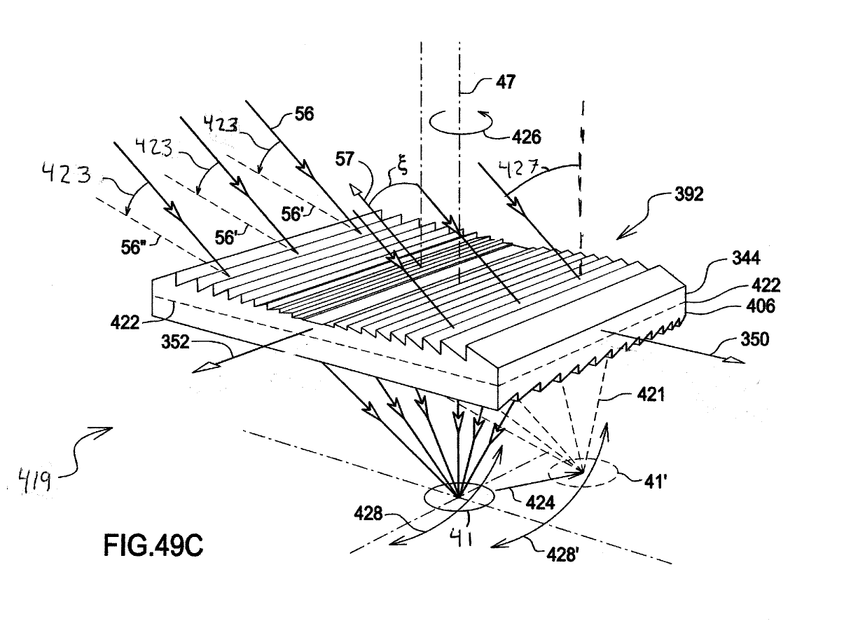

Attention is now directed to FIG. 49A, which is a diagrammatic perspective view illustrating one embodiment of a single axis focusing arrangement 344, described previously with reference to FIGS. 44A and 44B, and presented here for facilitating descriptions related to selected details thereof. As described previously, the single axis focusing arrangement defines an input axis 47, first and second reference directions, 350 and 352 respectively, and line of focus 354. The single axis focusing arrangement may be configured for receiving input rays of light 56 and for focusing the input rays of light along the first reference direction towards line of focus 354 without substantially redirecting these rays of light in the second reference direction. As described previously, the single axis focusing arrangement may be configured such that any received rays of light that are perpendicular with the first reference direction are at least generally focused towards line of focus 354. In addition, it is to be understood that the single axis focusing arrangement may be configured for performing the focusing action for a range of input orientations, and that the bent rays may be correspondingly shifted, in some cases causing a corresponding shift in position of the line of focus. For example, if input rays of light are reoriented by rotation about second reference direction 352, by an angle 381, illustrated relative to three of the input rays of light, then the line of focus may shift along arc 387. As another example, if the input rays of light are reoriented by rotation about first reference direction 350, by an angle 381′, then the line of focus may not move laterally, but the line of focus may shift in its lengthwise direction 389, as indicated by an arrow in FIG. 49A.

Based on well known principles of optics, it can be appreciated that the single axis focusing arrangement can be expected to exhibit some degree of aberration such that even for input rays of light that are precisely parallel with one another, the focused rays may not all be aligned with sufficient precision to intersect with the line of focus, and may fall within some finite width (not shown) to either side of this line. It can be appreciated that the degree of aberration may depend on the orientation of the input rays, and single axis focusing arrangement 344 may be configured to exhibit a predetermined degree of aberration with respect to input rays of light having a selected orientation. For example, the single axis focusing arrangement can be customized to exhibit enhanced performance with respect to input rays of light that are oriented in parallel with input axis 47, such that the arrangement exhibits a pre-determined degree of aberration that is lower than a different degree of aberration that would otherwise be exhibited with respect to rays that are incident at some angle 381.

The embodiment illustrated in FIG. 49A may be formed of an optical material and may include a plurality of optical prisms, a selected one of which is indicated by the reference number 390. The prisms cooperatively define an at least generally planar input surface 392 for receiving input rays of light 56. The input surface is somewhat of an averaged planar surface defined in cooperation by the features of the surface and a portion of which is shown offset using a dashed line designated by the reference number 392.

Each prism may receive and redirect a corresponding subset 394 of the input rays of light, indicated in FIG. 49A by a bracket, such that at least some of the light rays of the corresponding subset serve as a collected portion of that subset of light rays. With respect to the embodiment illustrated in FIG. 49A, the optical material may serve as a first optical medium having a first index of refraction. The optical arrangement may be surrounded by air, as a second optical medium having a second index of refraction. Each prism may define an interface 396 between the first and second optical media. For any selected one of the prisms, the corresponding interface extends lengthwise along the second reference direction and is widthwise tilted at an angle 398 with respect to input axis 47, to align the interface for redirecting subset 394 of input rays at least generally towards the line of focus based at least in part on (i) a difference between the first index of refraction and the second index of refraction, and (ii) angle 398 between the interface 396 and optical axis 47.

Each prism further defines a second interface, which best admits of illustration in the view of FIG. 49A indicated by the reference number 400. It is to be understood that each prism 396 includes a corresponding second interface 400. The second interface may intersect with the first interface to form an edge 404 that extends in the second reference direction. The first and second acute angles are cooperatively aligned as adjacent angles with the edge at least approximately serving as a vertex that points upward and is shared by both angles.

Attention is now directed to FIG. 49B, which is a diagrammatic perspective view of a single axis concentrating bender 406 that defines an input axis 47, first and second reference directions 350 and 352, respectively, and line of focus 354. Single axis concentrating bender 406 is a focusing arrangement that is configured for receiving input rays of light 56, at an angle 408 relative to input axis 47, and for bending and focusing the rays of light, towards line of focus 354, without substantially redirecting the rays of light in the second reference direction. While the concentrating bender may be configured for producing line of focus 354, at a particular position in space, based on input rays incident with a particular value of angle 408, it is to be understood that the input rays may be received over a range of input angles, and that any shifting of the angle of the input rays may result in corresponding shifts of the focused rays in a manner that is at least generally consistent with the descriptions set forth immediately above with reference to FIG. 49A. For example, a rotation of the input rays by an angle 414 about the second reference direction may cause the line of focus to move along an arc 416, and a subsequent rotation about the first reference direction by an angle 415, may cause the focused rays to move along this displaced line of focus in a direction 417.

As described above with respect to the single axis focusing arrangement, it can be appreciated that the concentrating focusing arrangement may exhibit some degree of aberration such that even for input rays of light that are precisely parallel with one another, the focused rays may not all be precisely aligned with the line of focus, and may fall within some finite width (not shown) to either side of this line. Concentrating bender 406 may be customized to exhibit a predetermined degree of aberration for input rays of light with a selected orientation. The degree of aberration may change as the input orientation changes. For example, for parallel input rays of light that are oriented at particular angle 408, the single axis focusing arrangement may be configured to exhibit a pre-determined degree of aberration, such that shifting the input rays to an angle 414 may cause an increase in the degree of aberration.

Attention is now directed to FIG. 49C, which illustrates one embodiment of an IOA, generally indicated by the reference number 419, that includes single axis focusing arrangement 344 (FIG. 49A), aligned for initially receiving input rays of light 56 (one of which is individually designated), and concentrating bender 406 (FIG. 49B) aligned in a series relationship following the single axis focusing arrangement. The two optical arrangements are fixed in a crosswise relationship with one another with a boundary 422 therebetween, shown as a dashed line. It is noted that there is no requirement that the two optical arrangements should be configured as separate components. Accordingly, boundary 422 indicates that these arrangements, in one embodiment, may be integrally formed with one another, for example, as one piece of the same optical material. It is further noted that the two arrangements of the embodiment at hand are oriented relative to one another such that first reference direction 350, of the single axis focusing arrangement, is at least approximately parallel with the second reference direction 352′ (FIG. 49B) of the concentrating focusing arrangement, and therefore specifies the same direction, at least to an approximation. Similarly, second reference direction 352 of the single axis focusing arrangement is at least approximately parallel with first reference direction 350′ (FIG. 49B) of the concentrating focusing arrangement. In this regard, with respect to the embodiment of FIG. 49C, it can be appreciated that a total of four different reference directions are described in relation to only two different spatial axes. Accordingly, for purposes of descriptive clarity, the reference directions for the IOA structure may hereinafter be referred to as reference directions 350 and 352 taken as shown for IOA 422, since these two reference directions serve as a sufficient basis set of directions for supporting further description of this embodiment.

Single axis focusing arrangement 344 is configured to accept plurality of input rays of light 56, incident on input surface 392 at an acute non-zero angle with respect to input axis 47, and to redirect at least a majority of the light rays, in a manner that is consistent with the above descriptions referring to FIG. 46A, to cause a majority of the light rays to converge toward one another along reference direction 350 substantially without converging the light rays along second reference direction 352. Concentrating bender 406 is aligned in a series relationship following the single axis focusing arrangement, and is configured for bending and focusing the majority of light rays from the single axis focusing arrangement and for further redirecting the majority of light rays to converge toward one another along second reference direction 352 without causing convergence along the first reference direction 350.

The single axis focusing arrangement and the concentrating focusing arrangement are configured to provide their respective focusing and bending actions as described above with reference to FIGS. 49A and 49B, respectively. Each one of the optical arrangements provides it's associated focusing action in a direction that is crosswise oriented with respect to the focusing action of the other arrangement, such that that the two focusing actions may be combined to cause a dual axis focusing action for concentrating the light into focusing region 41 having a surface area that is smaller as compared with input surface 392. In particular, the single axis focusing arrangement provides initial focusing with reference direction 350, without substantially redirecting light with reference direction 352, and the concentrating bender provides subsequent focusing action with reference direction 352, without substantially redirecting light with reference direction 350. The concentrating bender bends the light towards input axis 47 such that input axis 47 intersects with the focusing region.

Referring to FIG. 49C in conjunction with FIG. 5, it should be evident to the reader that IOA 419 functions in an overall manner that is consistent with previous descriptions with respect to IOA 32. For example, IOA 420 defines an acceptance direction 57 having a predetermined acute acceptance angle with respect to axis 47 such that (i) the input axis and the acceptance direction define a plane (not shown), and (ii) the acceptance direction extends in one fixed azimuthal direction (along reference direction 352 in FIG. 49C) outward from the optical axis and in the plane. The IOA is rotatable about input axis 47 for alignment of the acceptance direction and for receiving, for example, input light rays 56 that are parallel with one another and oriented with an acute angle relative to axis 47.

In one mode of operation, the IOA may be supported for rotation about axis 47. For input rays of light 56 entering at an acute angle that at least approximately matches acute angle ξ of the acceptance direction, the IOA may be rotatably aligned for orienting the acceptance direction to be at least approximately anti-parallel with incoming rays of light 56, such that the IOA receives the input rays of light and transmissively passes the input rays of light therethrough, while focusing the rays to converge toward one another until reaching focus region 41 that is at least approximately centered on input axis 47, as illustrated in FIG. 49C. It is noted that IOA 419 may be configured to exhibit various predetermined characteristics with respect to this first mode of operation. For example the IOA may be configured to exhibit a pre-determined degree of aberration, at least resulting from a combination of the aberrations described above with respect to the focusing action of the two respective optical arrangements, such that even for precisely parallel input rays that are precisely anti-parallel with the acceptance direction, the aberration would cause the focal region to be larger than it otherwise would be if there were no aberrations present. In other words, a higher degree of aberration may result in a larger focus region. It is noted that IOA 419 may serve as the IOA of the BRIC described with reference to FIG. 3, and which appears in various figures including but not limited to FIGS. 5,10 11, 18, 19, 23, 24, 26B.

Having described the operation of IOA 419, with respect to one mode of operation in which the input rays are at least approximately anti-parallel with the acceptance direction of the IOA, a description with respect to misaligned rays will now be provided for further explanatory purposes. Misaligned input rays of light 56′, illustrated with dashed lines in FIG. 49C, entering the IOA in a substantially misaligned direction that is skewed with respect to the acceptance direction, may be directed by IOA 419 to diverge away from the optical axis such that they are transversely displaced outside the focus region, as illustrated in FIG. 5. It is noted that increased misalignment may generally result in correspondingly increased displacement of the bent light away from focus region 41. As will be seen, misaligned rays, in FIG. 49C are sufficiently skewed to cause all of the corresponding output rays to fall outside of focus region 41. Having described one aspect of IOA performance relating to misaligned rays, particular attention is now drawn to a case of a plurality of misaligned rays that are each at least approximately parallel with one another.

With respect to a plurality of input rays of light that are parallel with one another and misaligned relative to the acceptance direction of the IOA, the IOA may be configured to produce output rays 421 that converge to an off-axis focus region 41′ that is transversely displaced from focus region 41 associated with the first mode of operation. In particular, as illustrated in FIG. 49C, IOA 419 may be configured such that the misaligned rays are redirected to converge toward one another to cause a predetermined misalignment, for example by an angle 423, producing an off-axis focus region 41′ that is offset from focus region 41 by a corresponding displacement 424.

It is again noted that the IOA may exhibit a degree of aberration that results in part from a combination of the previously described aberrations due to the two optical arrangements 344 and 406. Based in part on the descriptions above, it may be appreciated that an IOA can be customized to exhibit a predetermined degree of aberration for a particular orientation of the input rays of light, and this degree of aberration may change depending on the orientation of the input rays. Accordingly, the size of the focal region may depend at least in part on the orientation of the input rays relative to the IOA. In one embodiment, IOA 419 may be customized to exhibit a predetermined degree of aberration for input rays of light that are at least approximately anti-parallel with acceptance direction 57. Increased misalignment of the input rays may cause (i) correspondingly increased displacement of the focal region, as described above, and (ii) increased aberration such that the size of the focal region grows as the displacement increases.

Applicants recognize that for a given orientation of input rays of light, the focus region may be moved by changing the alignment of the IOA. For example, starting in the mode of operation in which the input rays are at least approximately anti-parallel with the acceptance direction of IOA 419, a clockwise or counter-clockwise rotation of the IOA, about axis 47, as indicated in FIG. 49C by an arrow 426, causes the IOA to operate in a misaligned mode of operation such that focal region 41 moves, responsive to the rotation, transversely with respect to axis 47 along an arcuate path 428. Similarly, in another misaligned mode of operation with misaligned input rays 56′ focused into offset focus region 41′, the rotation of IOA 419 causes off-axis focus region 41′ to move transversely along an offset arcuate path 428′. It is noted that the acceptance direction co-rotates along with the IOA, and that for any given fixed orientation of the input rays, any rotation of the IOA can be expected to cause a correspondingly different degree of misalignment, between the input rays of light and the acceptance direction of the IOA, that may result in a corresponding different degree of aberration such that the size of the focus region may change, responsive to this rotation, as the focus region sweeps along the actuate path.

Summarizing with respect to the above, an IOA having an at least generally planar configuration may be configured for defining (i) planar input surface 392 having a predetermined surface area, (ii) optical axis 47, and (iii) an acceptance direction as a vector that is characterized by a predetermined acceptance angle ξ such that the optical axis and the acceptance direction define a plane, and which acceptance direction extends in one fixed azimuthal direction outward from axis 47 such that the optical arrangement is rotatable about the axis for alignment of the acceptance direction. The IOA is further configured for receiving a plurality of input light rays that are parallel with one another and oriented with an acute angle 427 with respect to the optical axis. (For purposes of illustrative clarity, this angle is shown at a location that is transversely displaced from the axis.) It is noted, as will be described immediately hereinafter, that the IOA may be operated in a selected one of first and second modes. Depending on the mode of operation of the IOA, angle 427 may or may not be matched with acute angle ξ of the acceptance direction.

In the first mode, the incoming rays of light are oriented such that acute angle 427 matches acute acceptance angle ξ of the IOA. The IOA is rotatably aligned to accept the plurality of parallel light rays such that the rays are each at least approximately anti-parallel with the acceptance direction. The IOA transmissively passes the input light rays therethrough while focusing the input light rays to converge toward one another until reaching focus region 41 that is smaller than the input surface and is at least approximately centered on axis 47

In the second mode, the input rays of light are sufficiently misaligned with respect to the acceptance direction of the IOA such that the IOA focuses the input rays of light to converge toward one another until reaching an off-axis focus region that is smaller than the input surface area and is spaced apart from the optical axis in an azimuthal direction that depends on the rotational alignment of the optical arrangement such that the off-axis focus region is movable, by rotational of the IOA, along an arcuate path having a shape that is depends at least in part on acute angle 427.

Having summarized a number of characteristics of IOA 419, Applicants recognize that at least a number of these characteristics of IOA 419 may be exhibited by other embodiments of IOA's. As one non-limiting example, segmented optical arrangement 322 may be configured to serve as a segmented IOA that exhibits at least generally similar characteristics in response to aligned and/or misaligned input rays of light. With the input rays oriented anti-parallel to the acceptance direction of the segmented IOA, rotation of the segmented IOA may cause associated focal region 41 to move along arcuate path 41 in the manner described immediately above with respect to IOA 419. Similarly, for input rays of light that are misaligned with respect to the acute angle of the acceptance direction, the segmented IOA may be expected to produce an offset focus region as described above with respect to IOA 419. Rotation of the segmented IOA can be expected to cause this focus region to move in a manner that is consistent with the motion associated with IOA 419.

As described above, Applicants appreciate that in certain applications the use of an elongated receiver in a solar collector may at least partially define various overall requirements, at least with respect to a given concentrator that may be configured for use therewith. For example, as described above, the use of an elongated receiver may, in certain configurations, provide a basis for remarkably advantageous methods and configurations for tracking the sun, for example by allowing for a reduced number of rotating optical arrangements for tracking the sun. In particular, a number of examples were presented in which an elongated receiver was aligned with at least one concentrator having a bender, in combination with a single axis focusing arrangement, for tracking the sun solely by rotation of the bender. In these examples, focusing of the received rays of light was provided by the single-axis focusing arrangement, and not by the bender. Applicants appreciate that at least for certain embodiments of linear concentrators, it may be possible to reduce the number of optical arrangements therein combining bending and focusing action into one single optical arrangement. For example, as will be described immediately hereinafter, an elongated receiver may be aligned in a series relationship following an IOA. The IOA may be configured for receiving and focusing sunlight, to bend and focus the sunlight into a focus region. Furthermore, the IOA may be configured for tracking the sun such that rotation of the IOA causes the focus region to move along an arcuate path that intersects a receiving surface of the elongated receiver.

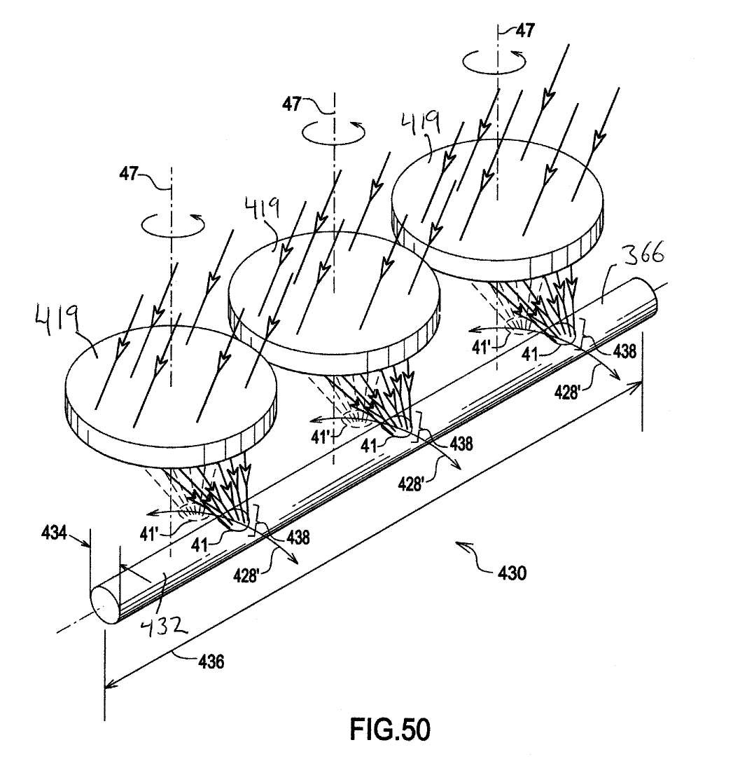

Attention is now directed to FIG. 50, which is a diagrammatic perspective view of a solar collector array, generally indicated by reference number 430, that includes three IOA's 419 that are each aligned in a series relationship with an elongated receiver 432 such that each IOA serves as a concentrator for tracking the sun through a range of positions. While solar collector array 430 includes three IOA's, it is noted that each of the IOA's may be configured in at least the same general way, as illustrated in FIG. 50. Accordingly, the descriptions below may at times refer to only one IOA, with the understanding that these same descriptions are applicable to all three of the IOA's.

Each IOA 419 is supported for rotation around an input axis 47, and defines an acceptance direction (not shown) and an associated focus region 41 that is approximately centered on the input axis of that IOA. Furthermore, each IOA may be arranged such that the input surface thereof is positionable to face in a skyward direction and is oriented to receive sunlight, as input rays of light 56. For a predetermined range of positions of the sun, the IOA may be configured for operation in the second mode, with the input rays of light misaligned relative to the acceptance direction of that IOA, to focus the sunlight, such that a rotation of the IOA causes off-axis focus region 41′ to move along arcuate path 428′.

The elongated receiver may have a width 434, and an extended length 436 that is substantially longer than width 434. The receiver may be aligned with respect to all of the IOA's such that for any selected position of the sun, each of arcuate paths 428′ overlaps a corresponding portion 438, as indicated by brackets, of the receiver, so that each of the off-axis focus regions is moveable, responsive to the rotational alignment of it's associated IOA, along it's associated arcuate path, such that the focus region can be positioned to overlap a receiving surface 366 of receiver 432. It can be appreciated that the described configuration provides for tracking the sun by continuously and/or periodically adjusting rotational orientation of IOA 419 for maintaining the overlap between the focus region and the corresponding portion of the receiving surface, as illustrated in FIG. 50. For example, for a given position of the sun (not shown) each of IOA 419 may initially be aligned with an initial orientation such that incoming rays of sunlight 56 are initially focused into off-axis focus regions, indicated using dashed lines, that do not overlap the receiver. Clockwise rotation 432′ may be applied to move the off-axis focus region to overlap the receiver as illustrated in FIG. 50 by focus regions 41′, as depicted by solid lines.

### Shading Due to Arrays of Prisms

Having described a number of embodiments of solar collectors and associated solar concentrators, selected features thereof will be brought to light order to enhance the readers understanding at least with respect to the initial receiving and bending of light by an array of prisms. In particular, a number of aspects relating to light loss due to shading by prisms, as described previously, with reference to FIGS. 28 and 29, are described in further detail hereinafter, and these shading characteristics are subsequently described in view of their influence on overall collection efficiency of solar collectors.

Attention is now directed to FIG. 51, with further reference to FIG. 25A. FIG. 51 is a diagrammatic elevational view illustrating a bender 420, including an array of prisms 442 that cooperatively define an input surface 443 for receiving a plurality of input rays of light 14. Each prism includes a first interface 444 (one of which is indicated), for receiving and bending input rays of light 14, in accordance with EQ. 4, as described previously with reference to FIG. 25A. The bender defines an optical axis 47 that is at least approximately perpendicular to a planar surface 131. First interface 444 is tilted at a tilt angle τ with respect to optical axis 47, such that the bender redirects input ray of light 14, at least approximately in accordance with EQ. 4, to produce output rays 92 that are bent with respect to the input rays by bender angle β. It is to be understood that tilt angle τ, illustrated in FIG. 51 for characterizing the tilt angle of interface 444, is complementary to the angle ψ used in FIG. 25A, and that for appropriate application of EQ. 4, with respect to FIG. 51, tilt angle τ should be substituted into the equation based on the identity ψ=90−τ. Bender 440 bends input rays of light, by an amount β, in alignment with a first reference axis 150, without substantially redirecting the input rays of light in a second reference direction 152 that is mutually perpendicular, at least to an approximation, both to optical axis 47 and to first reference direction 150.

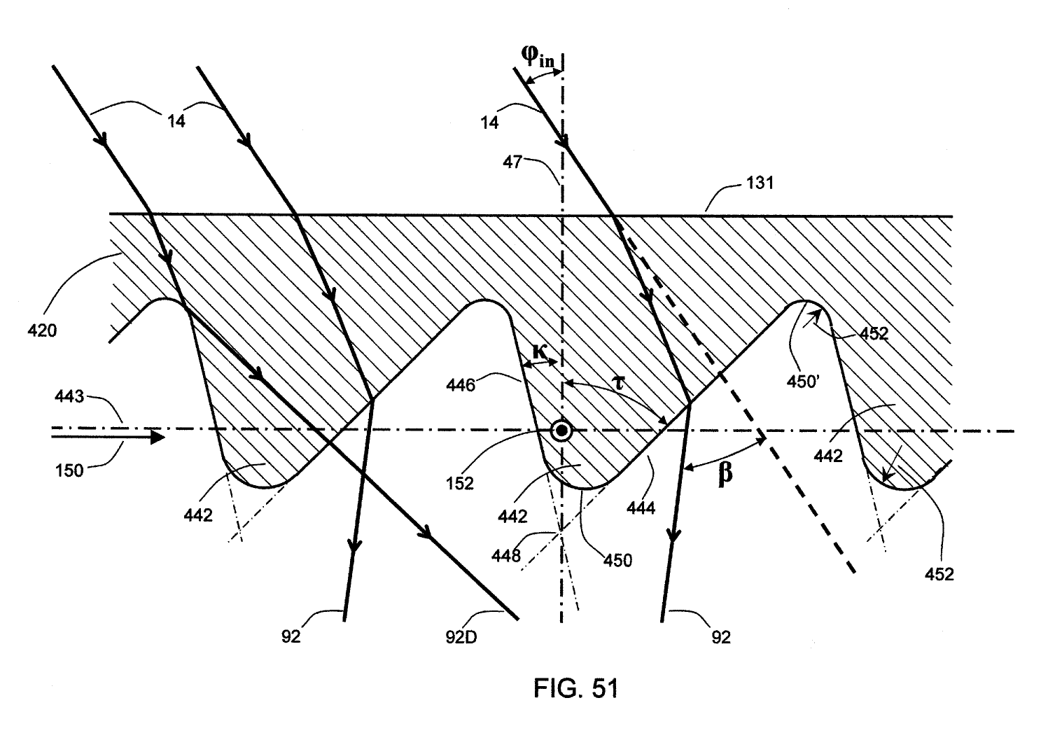

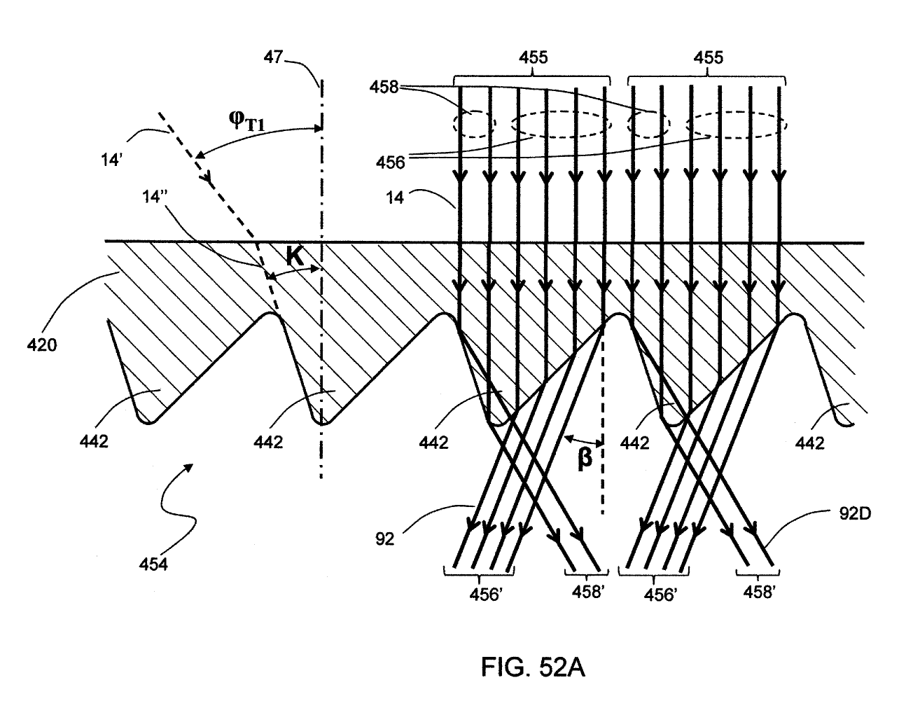

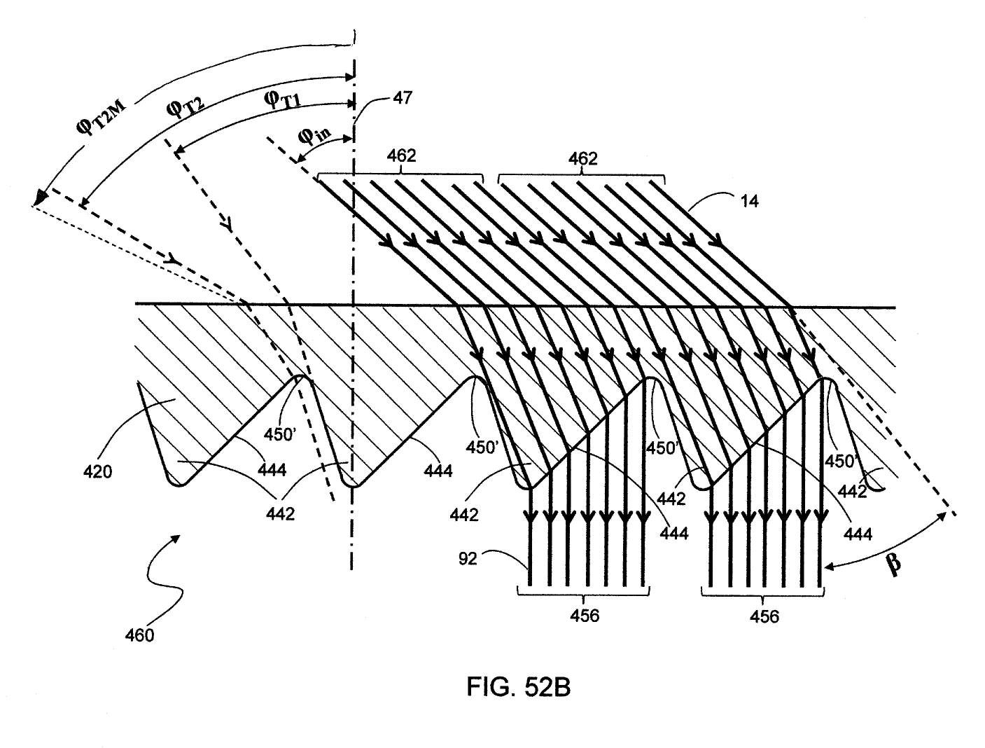

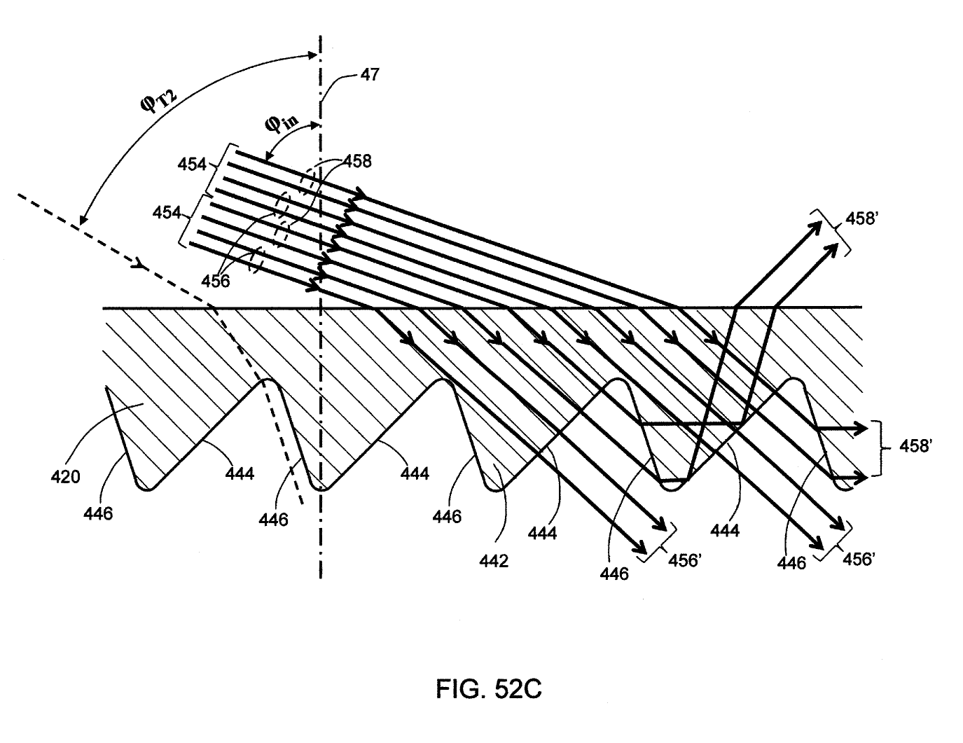

It is noted that the illustration of FIG. 51 is not to be interpreted as being limited to orientations in which the bender is pointed directly toward the input rays of light, and that each of the input rays of light may include a substantial component of light along the second reference direction. Accordingly the angle φᵢₙ is to be interpreted, not as an angle between the incoming rays and optical axis 47, but as an angle between optical axis 47 and a projection of input ray 14 into the plane of the figure and defined by axis 47 and reference direction 150. The output rays are to be interpreted according to the same illustrative convention, and FIG. 51 is to be interpreted as illustrating the projection of the output rays into the plane of the figure. The foregoing describes operation of the bender in the context of a tracking solar concentrator, at least for the reason that a solar concentrator having bender 420 as an input arrangement, as described previously, may operate in various orientations such that the bender is not oriented directly towards the sun. It is noted that the descriptions below, with reference to FIGS. 52A, 52B and 52C, yet to be introduced, are premised on and illustrated in accordance with the same conventions with respect to the interpretation of input rays of light 14 and the orientations thereof as represented in part by angle φᵢₙ. It is further noted, based on the geometry of the bender as described herein, in conjunction with well known principles of optics, that any input rays 14 that are incident at angle φᵢₙ, and that have a substantial component of light along the second reference direction, may be bent at least somewhat differently as compared with rays that do not. Nevertheless, EQ. 4 may be applied with respect to these rays, and remains valid in this regard, at least to an approximation, and from a practical application standpoint.

While first interface 444 provides for the bending action of bender 440, it can be appreciated that various other prism features may be present, in addition to the first interface of each prism, and at least some of these features may cause light loss due to shading. As described with reference to FIGS. 28 and 29A, and as illustrated in further detail in FIG. 51, a second interface 446 (one of which is indicated) may be tilted at a draft angle κ relative to the optical axis. It is noted, based on well established terminology of analytic geometry, that angles τ and κ form adjacent angles that share one single apex 448 (shown in phantom using dashed lines that are extensions from the first and second interfaces and one of which is individually designated) such that optical axis 47 serves as one side in each of the angles τ and κ, while first and second interfaces 444 and 446 serve as the other side in angles τ and κ, respectively. As another additional feature, the first and second interfaces of each of the prisms are joined at an outside edge 450 (one of which is indicated) that is inset from the apex and extends lengthwise along each prism. Furthermore, at least for any prism that lies between a pair of adjacent prisms, the first interface of one prism may intersect with the second interface of an adjacent one of the prisms to form an inside edge 450′ (one of which is indicated) that defines a boundary between adjacent ones of the prisms.

It is noted that the prisms in FIG. 25A are diagrammatically illustrated as having sharp edges with a distinct line of intersection between the interfaces associated with that edge. A person of ordinary skill in the art will appreciate that perfectly sharp, consistent edges can be challenging to produce, at least based on practical considerations with respect to well known manufacturing techniques, and that even with the use of state-of-the-art manufacturing techniques, edges 450 and 450′ may deviate from a perfectly sharp, consistent edge, at least to some degree, in ways that can be at least generally characterized and/or represented in FIG. 51 as a radius 452. While these deviations are represented by a radius 452, Applicants appreciate that such deviations may take on other forms. It is recognized that the form of a given deviation may depend on particular details of a given manufacturing process, and may be unpredictable in form at least to some extent.

It is noted that an input ray of light 14D that is incident directly on any edge, for example, edge 450′ as illustrated in FIG. 51, may be diverted to produce output ray 92D propagating in a substantially different direction as compared to output rays 92. For an embodiment of a solar collector that includes bender 420, for example, as an input optical arrangement for initially receiving incoming rays of sunlight, diverted output ray 92D may be sufficiently misaligned relative to output rays 92 such that output ray 92D is not collected by the receiver of the solar collector at hand. In this regard, the edges may be considered as causing shading losses such that output ray 92D may be rejected by the solar collector. Accordingly, output ray 92D is representative of what may hereinafter be referred to as lost and/or rejected light. For a given bender in an associated solar collector, it can be assumed that at least a substantial portion of any rays that are incident on any of prism edges 450 and 450′, directly or otherwise, may be rejected by that solar collector, and while this form of light loss, due to shading by the edges, has been described with respect to one illustrated orientation of input rays of light 14 and 14D, Applicants appreciate that an amount of lost and/or rejected light incident on edges 450 and 450′ may depend in part on the orientation of the input rays of light which, in turn, may correspondingly influence an amount of light that is lost and/or rejected in this manner. Furthermore, as will be described hereinafter, other features of the prisms, such as second interfaces 446, can further contribute to a total amount of diverted and/or rejected light, and these contributions may likewise depend on the orientation of the input rays of light.

Attention is now drawn to FIG. 52A, which is a diagrammatic elevational view illustrating a normal-incidence mode of operation, of bender 420, previously described with reference to FIG. 25A. In this mode of operation, each prism 442 receives a corresponding subset 455 of the plurality of input rays of light. As is evident in view of FIG. 28A described in detail above, the second interface (previously referred to as the vertical wall) of each prism causes a degree of shading loss. Still further details will be provided with regard to this behavior in view of FIG. 52A.

For each of the prisms, a collected subset 456 of the subset is incident on the first interface thereof, and is bent by bend angle β, in accordance with previous descriptions, to produce subset 456′ of output rays of light 92. A diverted subset 458 is directly incident on the second interface, to produce diverted subset 458′ of diverted rays of light 92D that are substantially misaligned as compared to output rays of light 92. The descriptive nomenclature of “collected” and “diverted” subsets, as subsets 456 and 458 of the incoming rays of light, and as subsets 456′ and 458′ of output rays of light, may be employed throughout the remainder of this disclosure. In the context of optical concentrators and/or solar collectors, an increase in the collected subset, relative to the diverted subset, may tend to enhance the collection efficiency thereof, and an increase in the diverted subset may tend to diminish collection efficiency.

Applicants appreciate that in the context of concentrators and/or solar collectors that include a bender, at least some of the collected rays of light produced by that bender may, on the one hand, be bent for acceptance by one or more of (i) an additional arrangement that may produce further bending and/or concentration of the light rays, and (ii) a receiver. On the other hand, the bender can cause shading losses by producing diverted rays of light that may be subsequently rejected such that they are not accepted by any additional optical arrangement or by any receiver. By way of non-limiting example, in the case of a solar collector utilizing bender 420 and having some form of receiver that is aligned for receiving and collecting subset 456′ of output rays of light 92, diverted output rays of light 92D may be sufficiently misaligned such that these diverted rays of light fall outside of the receiver, and may therefore be regarded as being rejected by that solar collector.

In view of the foregoing descriptions, A collected subset of input rays 456, incident on second interface 446 of a given prism, is collected and bent to produce a collected subset of output rays 456′. The prisms in bender 420 may cause shading losses by diverting a diverted subset of input rays 458 to produce a diverted subset of output rays of light 458′. Diverted subset of output rays of light 458′ may be diverted by the second interface of a given prism, or by some other feature in a given bender (for example an edge), such that the diverted output rays are substantially misaligned with output rays 92 of the bender.

Descriptive terminology used herein, including but not limited to the terms “diverted” and “collected”, has been adopted for purposes of descriptive clarity, and is in no way intended to be limiting. Insofar as the descriptions encompass methods and structures intended for collecting and concentrating light, it should be appreciated that a given solar collector may be configured to allow for some fraction of the light that is diverted, rejected, or otherwise lost, for example, as caused by the aforedescribed shading losses, to be recovered, through complex paths including different combinations and/or permutations of various optical phenomena occurring within the collector, for subsequent collection by the given receiver. Thus the light that is received by a given receiver in such an embodiment may include recovered light.

While the input rays of subset 455 illustrated in FIG. 52A are oriented with φᵢₙ=0, it is noted that bender 420 may operate in the illustrated normal-incidence mode with these input rays of light oriented in a first range of angles φᵢₙ such that 0<φᵢₙ<φ_{T1}, where φ_{T1} is the angle of an input ray of light 14′ that is bent by flat side 241 of the bender to produce ray of light 14″ within the prism at an angle κ, relative to the input axis 47, as shown in the figure.

For an embodiment in which the ratio of the index of refraction, of the material through which light travels inside the bender to the index of refraction of the material through which light travels before entering the bender is n, then the angle φ_{T1} may be expressed as follows:

φ_{T1}=sin⁻¹(n·sin(κ)) (EQ 5)

In particular, the bender may be configured such that for at least some values of φᵢₙ, in the range 0≦φᵢₙ<φ_{T1}, a majority of input light rays are collected, to be received by a receiver, and a relative minority of the input rays are diverted as a result of shading losses. As described previously with reference to region A of FIG. 28, shading losses caused by the bender may be at a maximum, with respect to this aforedescribed range of angles, for orientations with φᵢₙ=0. Furthermore, for a bender that is configured in the manner illustrated by FIG. 52A, these shading effects may be expected to be less pronounced for non-zero values of φᵢₙ in the range of angles 0<φᵢₙ<φ_{T1}, and within this range, an increase in φᵢₙ tends to cause a decrease in the amount of diverted light.

A solar collector, utilizing bender 420 as an input optical arrangement for initially receiving incoming rays of sunlight, may be configured for operation with respect to subset rays 455, in the normal-incidence mode, to exhibit shading losses that tend to be at a maximum for φᵢₙ=0, and that tend to become less pronounced for increasing values of φᵢₙ, at least until φᵢₙ reaches a first transition value φᵢₙ=φ_{T1}. Conversely, this solar collector can be expected to provide a collection efficiency that exhibits a reduced value, for φᵢₙ=0, and for larger values of φᵢₙ the collection efficiency may increase at least until φᵢₙ reaches a first transition value φᵢₙ=φ_{T1}.

Having brought to light a number of details relating to operation of bender 420, it is noted that for input orientations having orientations with an input angle φᵢₙ that exceed the first transition value φ_{T1}, according to the relationship φᵢₙ>φ_{T1}, bender 420 may operate in one of two different modes of operation that will be described immediately hereinafter with reference to FIGS. 52B and 52C.

Attention is now drawn to FIG. 52B, which is a diagrammatic view, in elevation, illustrating a low-loss mode of operation of bender 420, wherein each prism 442 receives and bends a corresponding subset 462 of the plurality of input rays of light, by bend angle β, to produce a corresponding subset 456 of output rays 92 (one of which is indicated). As will be described in greater detail hereinafter, bender 420 may operate in the low loss mode for at least part of a second range of angles φ_{T1}<φᵢₙ<φ_{T2}, and for this second range of angles, as will be described at appropriate point hereinafter, a solar collector including bender 420 as an input optical arrangement, may operate in low-loss mode to exhibit a predetermined collection efficiency that can be higher than would otherwise be exhibited with bender 420 operating in the normal incidence mode described with regard to FIG. 52A. For φᵢₙ larger than φ_{T2}, the bender may operate in a higher-loss mode that will be described at appropriate points hereinafter with reference to FIG. 52C.

In the low-loss mode of operation, with input orientations satisfying the relationship φ_{T1}<φᵢₙ<φ_{T2}, the input rays of light are oriented such that at least a majority of each subset of input rays is incident on the first interface of each prism. For any prism that is adjacent to other prisms (in other words the prism is not an end member of an overall array), first interface 444 is configured to intercept and bend input rays of light 14 to prevent these rays from impinging directly on the second surface of an adjacent prism, such that approximately none of the input rays in each subset are directly incident on the second interface. Furthermore, bend angle β is sufficiently large to prevent the output rays 92 from striking an adjacent prism. It is noted that this criterion may be regarded as a sufficient basis for determining φ_{T2}. It is considered by Applicant that a person of ordinary skill in the art, having this disclosure in hand, should be readily capable of making this determination based on well known techniques in optics and analytic geometry. Nevertheless, for purposes of completeness, it is noted that the transition angle φ_{T2} can be expressed as follows:

$${ϕ}_{T 2} = {sin}^{- 1} ( n \cdot sin ( Ψ - {sin}^{- 1} ( \frac{1}{n} \cdot sin ( Ψ - κ ) ) ) ) \qquad ( EQ 6 )$$

wherein ψ may be determined based on Eq. 4. It is further noted that imperfections due to manufacturing may be unavoidable, and various defects and/or irregularities may be present with respect to shapes and/or sizes of various features of the bender, and with respect to the various features of the prisms thereon. Recognizing this, it should be appreciated that while the majority of input rays in each subset may avoid direct incidence upon the second interface, at least while the bender operates in the low loss mode, to at least generally avoid input rays from directly impinging on the second surface, some small number of rays may nevertheless strike the second surface, at least as a result of manufacturing-related imperfections, particularly for input rays that deviate only slightly from orientations having φᵢₙ=φ_{T1}. In this regard, imperfections and/or manufacturing tolerances can be expected to blur the transition between the low loss mode and the normal-incidence mode, at least by causing localized variations in the value of φ_{T1}. For sufficiently small deviations μ from φᵢₙ=φ_{T1}, and for input rays having orientations such that φᵢₙ=φ_{T1}±μ, the operation of the bender may not be strictly defined in terms of one mode or the other. However, for sufficiently large deviations Δ, with orientations having φᵢₙ=φ_{T1}+Δ, the number of rays striking the second interface may be so small as to be considered inconsequential. Therefore, employing somewhat simplified terminology for the benefit of the readers understanding, for orientations with φᵢₙ>φ_{T1}, the operation of the bender in the low loss mode will be characterized hereinafter as allowing none of the input rays to strike the second interface of each prism, irrespective of localized variations in φ_{T1}.

Attention is now directed to FIG. 52C, which is a diagrammatic view, in elevation, illustrating operation of bender 420, in a higher-loss mode wherein each prism 442 receives a corresponding subset 454 of the incoming rays of light, and a collected subset 456 is received and bent by the first interface of each prism to produce a collected subset 456′ of output rays 92. A diverted subset 458 is incident on a section of the first interface of each prism, and for any prism that is not an end member of the array of prisms, the diverted subset of light is bent by the first interface to impinge on the second interface of an adjacent prism such that the diverted subset is further redirected by this second interface to produce a diverted subset of output rays 458′. Furthermore, as will be described in greater detail hereinafter, bender 420 may operate in the higher loss mode for input rays of light oriented in any one of a third range of angles φᵢₙ>φ_{T2}. For this range of angles, as will be described at appropriate point hereinafter, a solar collector including bender 420, as an input optical arrangement operating, in this higher loss mode, may exhibit a predetermined collection efficiency that drops as the angle φᵢₙ increases.

It is again noted that the illustrations of FIGS. 52A, 52B, and 52C are intended to be interpreted according to the same illustrative conventions established above with respect to FIG. 51, and are not intended as being limited to orientations in which the bender is pointed directly toward the input rays of light. The illustrated input and output rays are projections onto the plane of the figure. Accordingly, as described above, the angle φᵢₙ is an angle between (i) optical axis 47 and (ii) a projection of input ray 14 into a plane of the figure defined by optical axis 47 and second reference direction 152. Furthermore, as described above with reference to FIG. 51, while a substantial component along the second direction (i.e. normal to the plane of the figure) may cause small changes to the bend angle as compared to input rays having no component of light along this direction, a person of ordinary skill in the art, having this disclosure in hand, should be readily able to account for any degree to which these changes may influence transitions between modes as described herein.

As described above with regard to the low loss mode and the higher-loss mode, transitions between these modes may be somewhat blurred, at least in part due to manufacturing imperfections and/or defects. At least for this reason, the ranges of φᵢₙ associated with these modes have been mathematically characterized in the above descriptions according to inequalities “>” and “<”, since for borderline orientations with φᵢₙ=φ_{T1}, or φᵢₙ=φ_{T2} the bender operation may be regarded as exhibiting some interim combination of two different modes, and the transitions between modes can be somewhat blurred. It is further noted that environmental stresses and/or strains, during the course of normal operation, may cause deformations in the bender that can be expected to affect the operation of the bender in much the same way as the aforedescribed manufacturing imperfections, and these deformations may contribute to blurring of the transitions between modes.

Having described three modes of operation of a bender, including a normal incidence mode, a low-loss mode, and a higher-loss mode, further details will be brought to light with regard to cooperation between these modes, throughout a typical year, in the context of a solar collector that includes bender 420 as an input optical arrangement for initially receiving incoming rays of sunlight.

As described throughout this overall disclosure, a solar concentrator may be configured to include a bender as an input optical arrangement for initially receiving incoming rays of sunlight and for bending the incoming rays of sunlight for acceptance by one or more of an additional optical arrangement, and a receiver. For example, bender 420 may serve as bender 33 in one or more of the BRIC embodiments described above with reference to FIG. 3, FIG. 10, FIG. 19A, FIG. 19B, FIG. 23A, FIG. 23B, FIG. 26A, and FIG. 26B. Similarly, bender 420 may be utilized as the input optical arrangement in one or more of the linear concentrators described with reference to FIG. 44A, FIG. 44B, FIG. 45, FIG. 46, FIG. 47 and FIG. 48. In any of the foregoing examples, the concentrator at hand may be configured such that the bender serves as an input arrangement to define an input aperture having an input area that is positionable to face in a skyward direction so that the input aperture is oriented to receive sunlight from the sun, and input axis 47 extends through the bender in the skyward direction. Furthermore, based at least on a number of embodiments and methods described throughout this disclosure, the concentrator may be further configured to define a focus region that is substantially smaller than the aperture area, and the concentrator may include a support structure configured such that bender 420 is supported for rotation about input axis 47 for at least contributing to tracking the sun within a predetermined range of its positions using no more than the rotation of the optical arrangement around the input axis such that the rotation does not change the direction of the aperture from the skyward direction. Furthermore, for any specific one of the positions within the predetermined range of positions, the bender may be orientable, as at least part of the tracking, at a corresponding rotational orientation as at least part of concentrating the received sunlight within the focus region, for subsequent collection and use as solar energy.

The bender may be configured to operate in different ones of the three modes described above with reference to FIGS. 52A, 52B and 52C, at different times throughout any given day of a typical year, including the low-loss mode and the higher-loss mode, and a given solar collector, having the bender as an input arrangement, may exhibit a collection efficiency that varies, throughout the given day, from one mode to another, at least for the reason that the amount of diverted light, produced by the bender, tends to vary depending on the mode of operation thereof, and the diverted light tends not to be accepted by any additional optical arrangement that may follow the bender, or by the receiver. In this regard, the bender and an IOA may cooperate with one with one another such that each mode of operation of the bender gives rise to a corresponding mode of operation of the concentrator. In order to maintain consistency with respect to terminology, the collector may hereinafter be referred to as operating in different modes, and each of these modes may be identified by the previously established terminology as the normal incidence mode, the low-loss mode, and higher-loss mode.

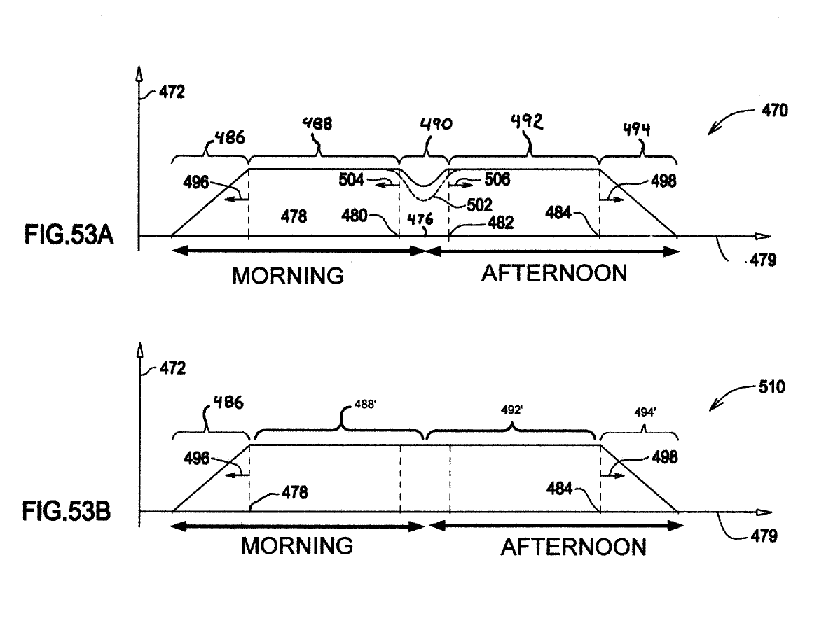

Attention is now turned to FIG. 53A, which is a plot, generally indicated by reference number 470, representing collection efficiency, for one embodiment of the solar collector of FIG. 3 having a BRIC with bender 420 serving as bender 33. A vertical axis 472 represents a collection efficiency that may be defined as a ratio between a total amount of light that is focused on the receiving surface 41 (FIG. 3), divided by a total amount of light that is incident on the input area of the bender. A horizontal axis 474 represents the passage of time throughout a selected day and includes morning and afternoon periods as illustrated in FIG. 53A by two double-headed arrows. At a time 476 that occurs at a midpoint between the morning and afternoon periods of the selected day, the sun may be in a position that is approximately directly overhead such that the sunlight therefrom is approximately parallel with input axis 47.

As described above, a collection efficiency of the BRIC, represented in plot 470 by a curve 477, varies throughout the day based primarily on the mode of operation of bender 420. For various portions throughout the selected day, the BRIC may at any given time be regarded as operating in a selected one of the normal-incidence mode, the low-loss mode, and the higher-loss mode . . . . The different portions of the day are each identified by brackets, and include a first morning portion 486, a second morning portion 488, a midday portion 490, a first afternoon portion 492 and a second afternoon portion 494. Each of the brackets is vertically aligned with a designated portion of the day, as indicated by dashed lines which, in turn, are vertically aligned with transitions times 478, 480, 482, and 484, at which times operation of the bender transitions between the different modes, responsive to the angle φᵢₙ, as described above with reference to FIGS. 52A, 52B and 52C. As indicated in FIG. 53A, the bender may be configured to operate in the higher-loss mode during first morning portion 486 of that day and to subsequently change, approximately at transition time 478, to operate in low-loss mode during second morning portion 488 of that day. After operating in the normal-incidence mode during a midday portion 490, the bender may again operate in the low-loss mode during first afternoon portion 492 of that day and may subsequently transition, approximately at transition time 484, to operate in again in higher-loss mode throughout second afternoon portion 494 of that day.

In a manner that is consistent with descriptions throughout this overall disclosure, for any selected one of the transition times, the angle φᵢₙ may depend at least in part on a relationship between (i) the position of the sun at the selected transition time, (ii) a skyward direction in which BRIC is facing, and (iii) the rotational direction in which the bender is pointed. As described above, the bender and the IOA may both be supported for rotation and may be configured for tracking the sun, for example, by cooperating with one another to maintain the acceptance direction in an orientation that points towards the sun while the sun moves though a range of positions throughout a given day.

With respect to a given solar collector including a given receiver, it will be appreciated by a person of ordinary skill in the art that curve 477 representing variations in efficiency of a solar collector, may be utilized, based on well known techniques, for determining an expected daily harvest for any selected day of a typical year as a total amount of light that is collected by the given receiver for conversion to another form of energy. It will be further appreciated that a yearly harvest, for the given collector, can be determined, based in part on variations in efficiency, as a sum of all the daily harvests for the typical year. In this regard, it is again noted that the efficiency, as plotted, may be defined as a ratio between a total amount of light that is focused on the receiving surface divided by a total amount of light that is incident on the input area of the bender, and it is noted that a number of additional variations may need to be accounted for in order to determine the daily and/or yearly harvest, as will be described immediately hereinafter.

It will be appreciated by a person of ordinary skill in the art that the total amount of light that is incident on an area of an input aperture of the given collector, may vary throughout the selected day, irrespective of the efficiency, based on a number of well known affects. As one example, variations in the amount of incident light may result from the well known cosine law, such that for any given solar collector having a flat input aperture, defining an input axis that is normal thereto and oriented in a fixed position throughout the selected day, the amount of light received by that aperture may be at least approximately proportional to the cosine of the input angle of the sunlight relative to the input axis. As another example, at any given time of any given day, sunlight must travel through the atmosphere by a distance that depends on the position of the sun at that given time such that the atmosphere causes an amount of light loss, in part due to well known atmospheric optical scattering phenomena, that depends at least in part on this distance. Typically, the distance is longest in the early morning and late afternoon, and shorter at midday, and as the sun changes position throughout the given day and/or year, this distance changes, resulting in corresponding changes to the amount of light loss. While it is considered by Applicants that a person of ordinary skill in the art, in making a determination of the daily and/or yearly harvest with respect to a given solar concentrator will be readily able to account for the aforedescribed additional variations, further details relating to this determination will nevertheless be described immediately hereinafter, for purposes of still further enhancing the readers understanding.

With respect to a given solar concentrator, including a given receiver, it can be appreciated that at any given time during a selected day, the total amount of light being collected by the given receiver may be determined as being proportional to the product of the efficiency (from curve 477) at that time of day and the amount of incident light at that time of day. It is noted that both the efficiency and the amount of incident light may depend, at least in part, on the position of the sun in the sky and on the relative position of the sun in relation to the input axis of the concentrator, and that the change in efficiency and the amount of incident light through the selected day and from day to day may be regarded as attributable to the change in the position of the sun. It can then be further appreciated that the harvest for a selected day may be determined as the sum of all the light collected by the receiver throughout that day and that a yearly harvest for a typical year may be determined as the sum of harvest for all days of that year.

Referring again to FIG. 53A, in one embodiment, the solar concentrator may be configured to operate in the higher-loss mode during first morning portion 486 of that day and to subsequently change, approximately at transition time 478, to operate in low-loss mode during second morning portion 488 of that day. After operating in the normal-incidence mode during a midday portion 490, the concentrator may again operate in the low-loss mode during first afternoon portion 492 of that day and may subsequently transition, approximately at transition time 484, to operate in again in higher-loss mode throughout second afternoon portion 494 of that day. As described previously with reference to FIGS. 52B and 52C, and as illustrated in FIG. 53A, the collection efficiently in the low loss mode may exceed that of the higher-loss mode, and Applicants appreciate that it may be highly advantageous to customize the harvest for the selected day by modifying bender 420, in a manner that will be described immediately hereinafter, in order to shift transition times 478 and 484, as indicated in FIG. 53A by arrows 496 and 498, for extending portions 488 and 492 of the morning and afternoon, respectively, in which the BRIC operates in the low-loss mode. It is noted that these shifts are directed in opposing directions to cause transition time 478 to occur earlier, and transition time 484 to occur later than would otherwise occur without this shift.

As described immediately above, it may be advantageous to customize the harvest of a BRIC solar concentrator, at least for the selected day, by modifying a given bender to shift transition times 478 and 484 for extending the amount of time, during the selected day, in which the bender operates in low-loss mode 460. Based at least on the above descriptions with reference to FIGS. 52B and 52C, Applicants recognize that these shifts may be accomplished by modifying the bender to increase draft angle κ of the second interface associated with each of the prisms of bender 420. In particular modifying the bender by increasing draft angle κ, may correspondingly increase the value of the transition angle φ_{T} to a greater value φ_{T1M} that is illustrated, for purposes of descriptive clarity, in FIG. 52B.

Based at least on the descriptions above with reference to FIG. 52A, it is evident that the aforedescribed increase in draft angle κ for prisms 442 can be expected to influence the operation of the bender in the normal-incidence mode, at least as compared to an unmodified bender, to cause an increase in the amount of diverted light, and a corresponding decrease in the amount of collected light, such that the efficiency of the collector is reduced during operation in this mode. This modified efficiency is indicated in FIG. 53A by a dashed line 502. In addition, the increase in draft angle κ may be further expected to cause shifts 504 and 506, indicated by arrows, such that transition 480 occurs earlier in the day, and transition time 482 occurs later in the day.

Applicants appreciate that an the increased draft angle κ may, on one hand, tend to increase harvest as a result of shifts 496 and 498. On the other hand, the increased draft angle may tend to decrease harvest, both as a result of shifts 502 and 506, and as a result of diminishing collection efficiency with respect to the middle portion of the day during which the bender operates in the normal-incidence mode. Depending on the embodiment at hand, the tendency to decrease harvest, for the selected day, could at times exceed the tendency for increase, such that increased draft angle κ may cause a net reduction of harvest for the selected day. However, it is noted that this reduction may apply to only a minority of days of a typical year, and that the harvest for a typical year may nevertheless be substantially increased, providing surprising advantages with respect to yearly harvest, as will be described immediately hereinafter.

It is noted that operation in the normal-incidence mode requires light with input orientations with a relatively small angle φᵢₙ as compared with other modes of operation, and for a solar collector to operate in this mode, for example in the middle of the day, it is necessary for the sun to be at an overhead position in the sky that allows for the angle of incidence φᵢₙ to lie within the range 0<φᵢₙ<κ. Conversely, it is necessary for the solar collector at hand to be oriented in a skyward direction such that the condition 0<φᵢₙ<κ applies for the selected day. While this is taken to be the case for the embodiment at hand, it is to be understood that relative to a fixed orientation of the solar concentrator, for a particular geographic location, the sun sweeps out different paths in the sky for different days. Moreover, seasonal variations in these paths may result in sufficiently large differences among these paths, particularly from one season to another, such that for a majority of days in a typical year, the BRIC may be configured to operate for entire days, and even for entire seasons, with no operation in the normal incidence mode. For example, the BRIC may be located in Colorado at 105° west longitude and 40° north latitude and oriented so that it is tilted due south and an angle of 40° relative to horizontal. (It is noted that it is a well known technique to enhance the yearly harvest of a solar collector with a fixed orientation by tilting it so that it faces due south and is at an angle relative to horizontal equal to its latitude.) A BRIC oriented in this manner, positioned at this location, may have the sun pass directly overhead, φᵢₙ≈0, only two days each year: the vernal and autumnal equinoxes. On those two days, the sun may only be at φᵢₙ<5° for approximately 20 minutes on either side of solar noon. The amount of time the sun will be at φᵢₙ<5° may be less for any day before or after each of the equinoxes. Within ten days of each equinox, this amount of time will be less than half as much. And, more than fifteen days before or after each equinox, the sun will never be at φᵢₙ<5°. Accordingly, for a BRIC that includes a bender 420, configured such that that φ_{T1}=5°, then the BRIC can be expected to operate in the normal-incidence mode for no more than 60 days, and on each of those days the BRIC can be expected to operate in this mode for no more than 40 minutes. Based at least on this example, Applicants appreciate that a given BRIC may be configured to exhibit normal-incidence mode only on a substantially small minority of days as compared to the number of days during which operation in this mode can be avoided, as will be further described immediately hereinafter.

Attention is now directed to FIG. 53B, which is a plot, generally indicated by reference number 510, graphing the operation of BRIC 26, during a different day, of the same typical year, during which the bender never operates in the normal incidence mode. The plot employs the same axes employed in plot 470 of FIG. 53A, and is annotated based on the same conventions for indicating the different modes of operation and the transitions therebetween. The BRIC operates in the higher-loss mode during first morning portion of the day 486. At first transition time 478, the BRIC begins to operate in the low-loss mode, during a second morning portion 488′ and continues to do so through a first afternoon portion 492′ until transition time 484 at which time the BRIC returns to the higher-loss mode of operation during a second afternoon portion 494′.

With regard to extending the operation in the low-loss mode in FIG. 53B, it is noted that the aforedescribed modifications to bender 420 may tend to shift transition times 496 and 498 at least generally in the same manner described above in the context of plot 470 of FIG. 53A, thereby increasing the daily harvest for those days. With the absence of any operation in the normal incidence mode, the associated tendencies for decreasing harvest should be correspondingly absent, such that modifying bender 420 may tend to increases the harvest of the BRIC at least for days where the BRIC does not operate in the normal-incidence mode. Applicants recognize that the BRIC may be configured for avoiding operation in the normal incidence mode at least for a majority of days during a typical year, and for a BRIC that is configured in this way, and oriented appropriately with respect to a given geographic location, the modification of increasing angle k, by increasing the daily harvest for those days, can be expected to provide an increase the yearly harvest for that BRIC.

While it is evident that for at least some BRIC embodiments, modifying draft angle κ of the prisms of the bender may increase the yearly harvest, it is to be understood that this remarkable advantage is not without limits, and for a given bender, increases in draft angle κ can also be expected to increase the range of angles for which the bender operates in the normal incidence mode, which in turn may add to the number of days during which the harvest is diminished. It should be appreciated that for any given BRIC, there may be a tradeoff between (i) the tendency to increase yearly harvest resulting from increasing angles, and (ii) an increase in the number of days in which the BRIC operates in the normal incidence mode.

Applicants have verified, both empirically and by computational modeling, that a given BRIC may be configured with particular value of draft angle κ that is suitable for optimizing the yearly harvest. For example, in the context of one embodiment of a BRIC, Applicants have verified that a bender having a draft angle of approximately five degrees can improve yearly harvest by several percent as compared to a bender having a conventional draft angle of less than 2 degrees. It is recognized that the appropriate draft angle κ for at least approximately maximizing the yearly harvest, may vary depending on the features of any given embodiment. However, it is considered that person of ordinary skill in the art, having this disclosure in hand, may readily determine the appropriate angle for any given BRIC.

It is further recognized that for a given geographic location, a typical year may exhibit weather patterns with cloud cover being more or less likely during certain times of the year, and that various features of a given BRIC, including draft angle κ of bender 420, may be customized in order to account for expected weather patterns by at least approximately maximizing the yearly harvest in view of these expected weather patterns. While appropriate computations for such customization may be complex, sufficient statistical data may be readily available, at least for many geographic locations. Applicants believe that a person of ordinary skill in the art, having this disclosure in hand, may readily account for considerations relating to weather, at least insofar as reliable data can be obtained for a given location in which a BRIC is expected to be deployed.

A person of ordinary skill in the art will recognize that conventional benders, and other conventional fresnel optical arrangements that may rely on prisms for causing optical diffraction, tend to be manufactured with second interfaces of each prism therein being oriented at the smallest draft angle κ that can be reasonably achieved using state-of-the art manufacturing techniques. For each prism of a given fresnel optical arrangement, manufacturers typically will strive to minimize the draft angle κ of each prism in a given optical element, at least insofar as their conventional manufacturing techniques may reasonably allow. In many cases manufacturers of conventional fresnel optics may put forth vigorous efforts in this regard, competing with one another to modify manufacturing procedures for decreasing draft angle κ. One common motivation for minimizing draft angle κ is that conventional fresnel optics are often utilized in applications where a majority of light received thereby tends to be incident in a perpendicular orientation with respect to the input surface of a typical fresnel optical arrangement. In the context of conventional fresnel optics, reduced values of draft angle κ generally provide for correspondingly reduced amounts of diverted light. It will be appreciated by a person of ordinary skill in the art that these operating conditions are so prevalent, with respect to conventional fresnel optics, that fabrication of the smallest possible draft angle κ has become established as a widely recognized figure of merit for characterizing one fresnel optical arrangement as compared with another. Fresnel optical arrangements having low values of κ are generally regarded as being superior at least for these reasons. By contrast, Applicants routinely employ angles of κ>3 degrees, to provide remarkable increases in yearly harvest in accordance with the foregoing descriptions, and Applicants are unaware of any applications in which concentrating fresnel optical elements utilize prisms having second interfaces with angles greater than 2 degrees.

Summarizing with respect to the above descriptions, a bender, defining an input axis and serving as an input arrangement for a given solar concentrator, may operate in different modes, to receive and bend input rays of light, at least for a range of orientations thereof, producing output rays of light that are bent with respect to the input rays of light. In particular, for a bender having an array of prisms that are characterized in part by a second interface tilted at an angle κ, the different modes may include a low-loss mode at least for input orientations having a predetermined range of input angles φ_{T1}<φᵢₙ<φ_{T2}. For a range of steeper angles such that φᵢₙ exceeds transition angle φ_{T2}, the bender may operate in a higher-loss mode in which the bender diverts a portion of the received rays of light in a substantially different direction as compared to bent output rays that are collected. For a given bender, the transition angle φ_{T2} may depend at least in part n the draft angle κ of that bender.

Furthermore, a given solar concentrator, defining a focus region and having the bender as an input arrangement for initially receiving incoming rays of light may be configured to track the sun, at least in part by rotation of the bender about the input axis, to operate in corresponding modes of operation, based on the bender modes of operation, to collect an amount of the received light for focusing into the focus region. At least for a number of days of the year, the concentrator may transition between these modes responsive to (i) changes in orientation of the incoming rays, due to motion of the sun, and (ii) changes in the rotational orientation of the bender, for tracking the sun, such that the amount of collected light may depend in part on the mode of operation, and the solar concentrator may operate in the low loss mode for at least a portion of each of these days, and in the higher-loss mode for other portions of these days. In accordance with the above descriptions, for the range of input orientations φ_{T1}<φᵢₙ<φ_{T2} the concentrator may operate in the low-loss mode, and for the range of steeper angles φᵢₙ>φ_{T2}, the concentrator may operate in a higher-loss mode in which at least a substantial portion of the diverted rays fall outside the focus region of the concentrator, or are otherwise misdirected, and may therefore be regarded as lost light.

Applicants appreciate that the bender may be modified, for increasing the yearly harvest of a given solar concentrator, by increasing draft angle κ associated with the prisms of the bender, at least somewhat, as compared to unmodified benders, to extend the portion of the day associated with the low-loss mode of operation, and to correspondingly increase the yearly harvest.

While the foregoing descriptions have brought to light various aspects of light loss and/or harvest, at least in the context of different modes of operation for one concentrator embodiment (a BRIC), these descriptions are in no way intended to be limiting in this regard. It is to be appreciated that any given solar concentrator that includes the bender, as an input arrangement for initially receiving incoming rays of light, may exhibit the aforedescribed modes of operation such that cooperation between these modes may influence the yearly harvest of a given concentrator. Moreover, the descriptions relating to light loss and/or harvest may be considered especially relevant with respect to any solar concentrators in which the input bender is configured to rotate, or otherwise precess, about it's optical axis, for tracking the sun throughout a typical year. Depending on details of a particular embodiment, it may be feasible to customize the daily harvest, in order to increase the yearly harvest, by configuring the bender in accordance with the teachings that have been brought to light herein. As one non-limiting example, during portions of a given day when bender 33 operates in the higher-loss mode, at least some of the diverted rays of light may be lost by the concentrator such that they fall outside of elongated receiving surface 346. It may be feasible to increase the yearly harvest at least by increasing the draft angle of the bender, thus causing lower daily harvest on a minority of days in the year and higher daily harvest for a majority of days during the year. While it is recognized that the bender and the single axis focusing arrangement may cooperate in complex ways, at least with respect to the aforedescribed modes of operation, it is considered by Applicants that a person of ordinary skill in the art, having this disclosure in hand, may readily determine if such modifications may be employed for improving the yearly harvest for any given embodiment of the concentrator.

It is again noted that modifying the draft angle of an input bender, for shifting the transition between the low-loss and the higher-loss modes of a given concentrator to increase in yearly harvest, may cause a decrease in daily harvest during some number of days during the year, depending in part on the orientation and geographic location of the given concentrator. It is further noted that during these particular days, for example during the days near the two equinoxes for the aforementioned example located in Boulder, Colo., the concentrators described herein may be advantageously configured for exhibiting a dip and/or decrease in collection efficiency in the middle of some days when the sunlight may be expected to be at its most intense levels. In other words, the concentrators described herein may be configured for collecting and/or harvesting less light during midday portions of each of a predetermined number of days in a typical year when the sunlight tends to be most intense, in order to harvest more sunlight throughout the year. Applicants submit that this aspect of the collectors described herein may be considered as being both surprising and remarkable, at least in the context of conventional techniques relating to solar collectors, concentrating or otherwise, especially for the reason that conventional solar collectors and/or concentrators are generally configured to maximize collection efficiency during times that would normally be considered as being the best times for collecting sunlight. It is noted that conventional tracking concentrators in particular tend to be configured for pointing directly towards the sun, at least to an approximation, and therefore are generally configured to exhibit maximum collection efficiency for light that is normally incident thereon. In the context of conventional solar collectors, Applicants are unaware of any exceptions to this approach. By contrast, Applicants have disclosed concentrators that at least in certain cases may be advantageously configured for dramatically reducing collection efficiency during these prime times in order to provide substantial increases in the yearly harvest.

As described above with reference to FIG. 26C, there is no requirement that an input arrangement of a given concentrator should be a bender, and the input optical arrangement may be configured to provide bending and/or focusing actions, and to cooperate with one or more additional arrangements in a variety of complex ways as described previously with primary reference to FIG. 26C. While the above descriptions, relating to shading effects of prisms, have been directed to benders, these descriptions are in no way intended to be limited in this regard, and it is to be understood that the considerations set forth above may apply with respect to any concentrator that utilizes an input arrangement that employs prisms for receiving and redirecting input rays of light to contribute to focusing and/or concentrating thereof.

### Tilted Benders

Having described a number of remarkable advantages associated with modifying benders, by increasing draft angle κ, for extending periods of operation in the low-loss mode, it is noted that additional techniques, brought to light immediately hereinafter, may be employed for further enhancing the daily and/or yearly harvest of a given solar collector, at least in part by configuring the associated solar concentrator for further avoiding operation in the higher-loss mode.

Based at least on the foregoing descriptions with reference to FIGS. 51, 52A, 52B, 52C, 53A and 53B, it is evident that a given concentrator may tend exhibit the higher-loss mode in the beginning and towards the end of any given day, when the incoming rays of sunlight may tend to be substantially skewed, relative to a given concentrator, such that φᵢₙ may exceed the threshold φᵢₙ=φ_{T2}.

As described previously, with reference to FIGS. 33A, 33B, 34, 35 and 36, the bender of a given concentrator may be tilted at least in order to significantly reduce shading losses. Furthermore, tilting the bender may increase the amount of light, at least at times, that is received by the bender. Furthermore, tilting a given bender, towards the sun, may cause more light to fall on that bender. Having described a number of aspects relating to light loss due to shading by prisms, with reference to FIGS. 51, 52A, 52B, 52C, 53A and 53B, a number of these aspects will now be described in light of various considerations relating to concentrators that employ tilted benders, as input arrangements, for initially receiving incoming rays of sunlight.

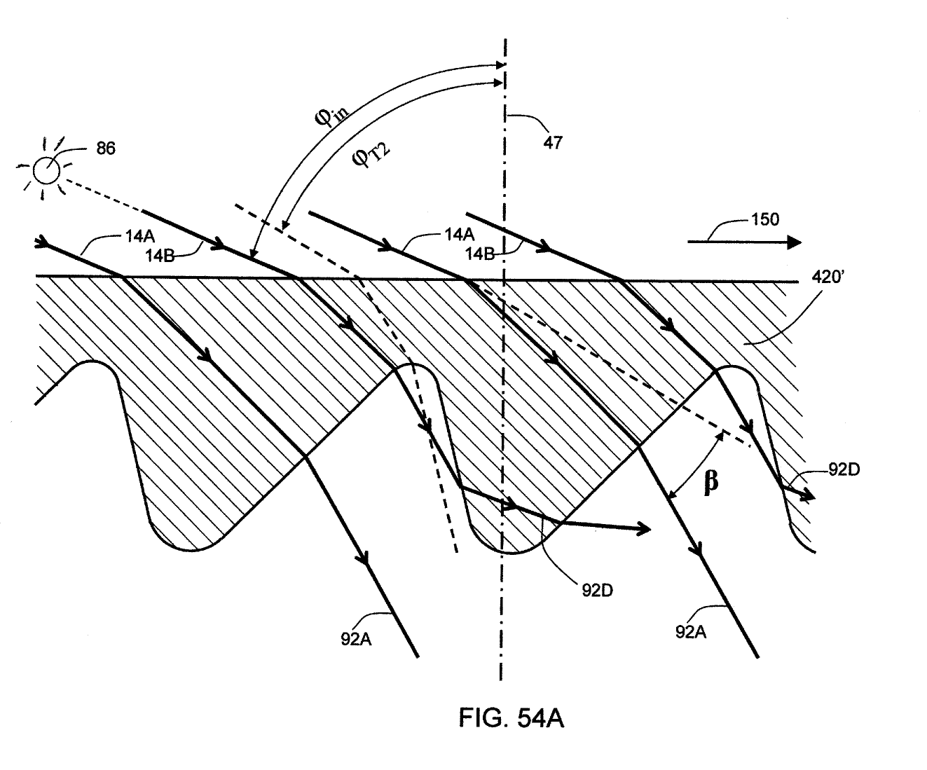

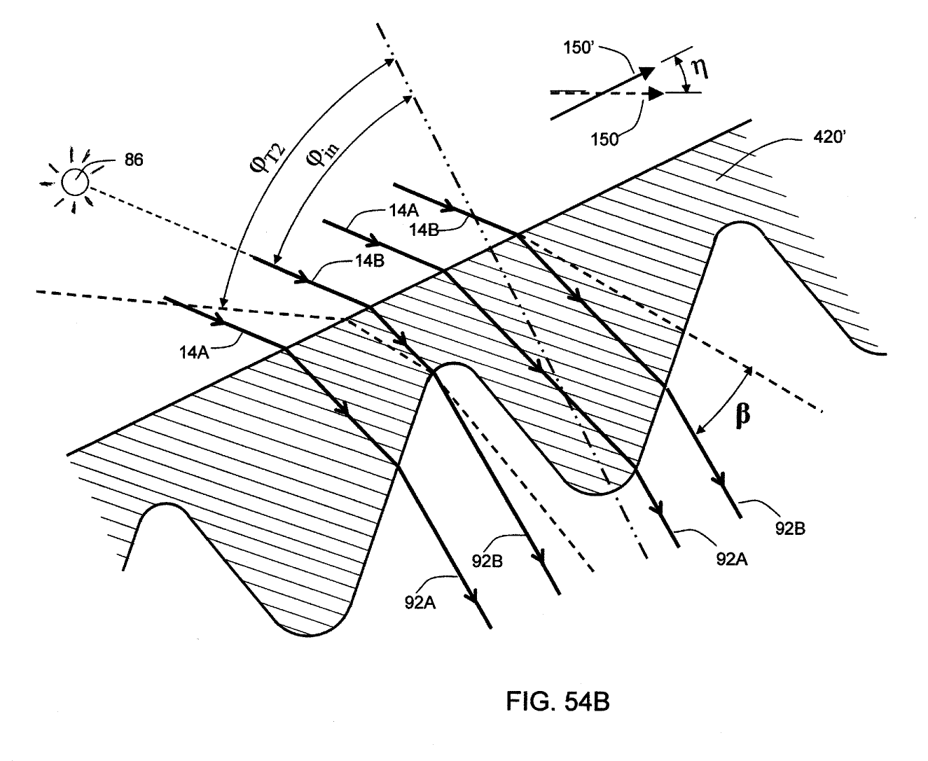

Attention is now turned to FIG. 54A, which is a further enlarged diagrammatic elevational cutaway view illustrating operation of bender 420′ operating in the higher-loss mode, as described previously with reference to FIG. 52C. Based at least on the foregoing descriptions, it can be appreciated that this illustration can be considered as representing operation in the higher-loss mode, in the early morning and/or in the late afternoon. As indicated in FIG. 54A, and in accordance with the foregoing descriptions of the higher-loss mode, the incoming rays of light, produced by the sun in position 86, have an input orientation, relative to the bender, with an incoming angle φᵢₙ that exceeds threshold φ_{T2} of the bender, such that some of the incoming rays (incoming rays 14A) serve as collected rays that are bent, by bender angle β, to produce output rays 92A, and some of the incoming rays (incoming rays 14B) are diverted and may be rejected as an amount of lost light 92D. Applicants appreciate that tilting the bender may reduce the resulting amount of light loss at least by causing the same incoming rays of light to be oriented for low loss operation with respect to these same input rays, as will be described immediately hereinafter.

Attention is now turned to FIG. 54B, which is a diagrammatic elevational cutaway view illustrating the same bender 420′ oriented for receiving the same input rays of sunlight from the same position 86 of the sun. However, bender 420′ is tilted, by a tilt angle η, for reducing light loss as compared to the orientation in FIG. 54A. It is noted that FIG. 54B is to be interpreted as illustrating the bender from at least approximately the same frame of reference as that of FIG. 54A, as indicated by a dashed arrow showing reference direction 150 of the bender associated with the bender orientation previously illustrated in FIG. 54A, and by a solid arrow showing the first reference direction associated with the first reference direction 150′ of the tilted bender. Based on the foregoing descriptions, as illustrated in FIG. 54B, this tilted orientation of the bender may cause the bender to operate in the low-loss mode such that incoming rays of sunlight 14A and 14B are both collected and bent, by bender angle β, to produce output rays of light 92A and 92B. Moreover, as will be described immediately hereinafter, Applicants appreciate that a concentrator, having a tilted input bender, may be configured for increasing daily and/or yearly harvest, as will be described immediately hereinafter.

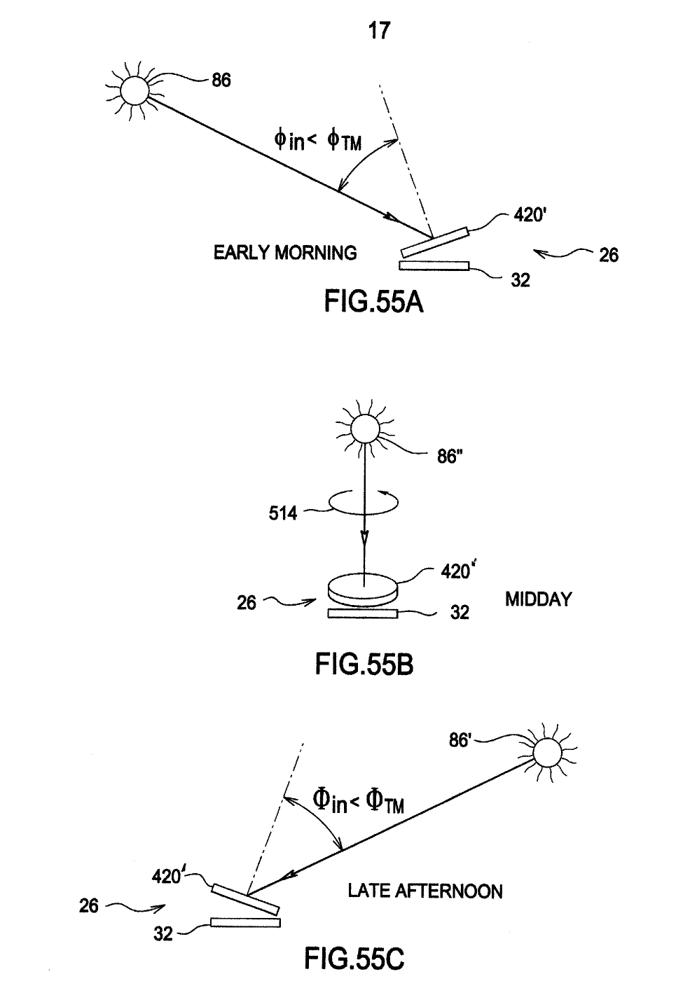

Attention is now directed to FIGS. 55A, 55B and 55C, which are diagrammatic plan views illustrating one embodiment of a BRIC, generally indicated by the reference number 26, in early morning, midday, and late afternoon portions, respectively, of a given day of a typical year. The BRIC is assumed to be positioned at a geographic location substantially north of the equator, for example in Colorado, and these illustrations are to be interpreted as representing a single point of view of an observer who is standing in a location that lies directly south of this location, while looking directly northward, as the BRIC tracks the sun throughout the given day. In the early morning and late afternoon, with the sun in positions 86 and 86′ respectively, bender 420′ may be tilted towards the sun, such that the BRIC operates in the aforedescribed low-loss mode during morning and afternoon times when it may otherwise, in the absence of any tilt, operate in the aforedescribed higher-loss mode.

FIG. 55B is included, for purposes of further clarification, to illustrate that the bender may be configured to co-rotate with the IOA, in a coordinated way, as indicated in FIG. 55B by an arrow 514, such that the bender remains at least somewhat tilted relative to the IOA, while tracking the sun, throughout each day. Accordingly, this figure represents the bender facing southward at midday towards the aforementioned observer.

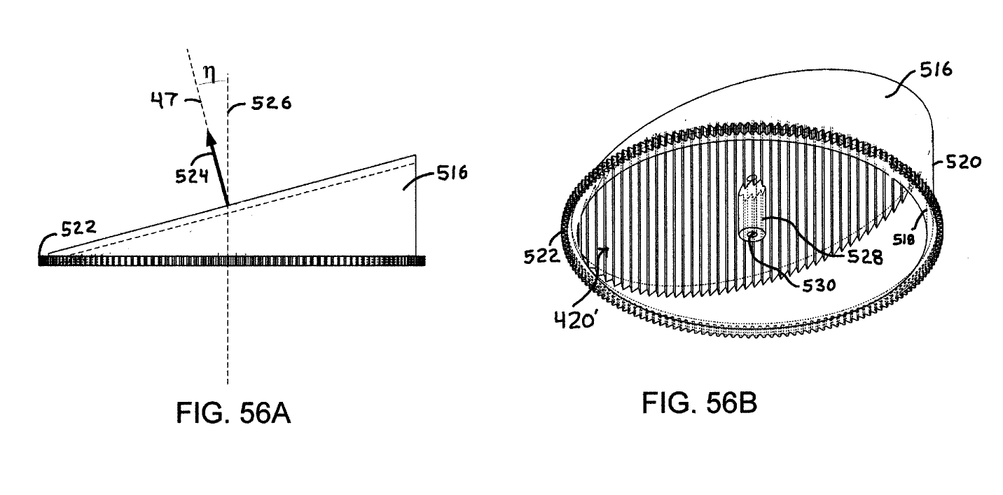

Attention is now directed to FIGS. 56A and 56B, which respectively illustrate an elevational view and a perspective view (looking at an angle from beneath) of one embodiment of a tilted bender assembly 516. In one embodiment, tilted bender assembly 516 may be configured as a hollow cylinder having one sidewall with inner and outer surfaces 518 and 520, respectively, supporting a bender 420 (FIG. 56B) in a bender orientation 524 (FIG. 56A) that is tilted at an angle η with respect to a central axis of the cylinder. The tilted bender assembly may include an engagement feature configured for engagement by a drive mechanism (not shown). In one embodiment the engagement feature may be a gear 522, that defines an axis of rotation 526 (FIG. 56A). The assembly may be configured such that engaging the gear, for example, using a matching drive gear (not shown), causes the assembly to rotate about axis of rotation 526 such that bender orientation 524 precesses about axis of rotation 526. The tilted bender assembly may include a support post 528 having a center bore 530 therethrough such that the center post can be supported at a fixed axle (not shown).

It can be appreciated that tilted bender assembly 516 may be configured as a single injection molded arrangement, or as an assembly of separate components. Furthermore, the embodiment illustrated in FIGS. 56A and 56B is provided for explanatory purposes and is in no way intended to be limiting. A number of variations will be readily apparent to a person of ordinary skill in the art having this disclosure in hand. In one embodiment, gear 522 may be replaced by some other drive mechanisms, such as an inset groove (not shown), configured in mechanical communication with an appropriate matching drive component, such as a drive belt or filament. In yet another variation of the illustrated embodiment, the assembly may be supported through the drive mechanism, at the lower peripheral extents of the sidewall, such that the support post may be omitted.

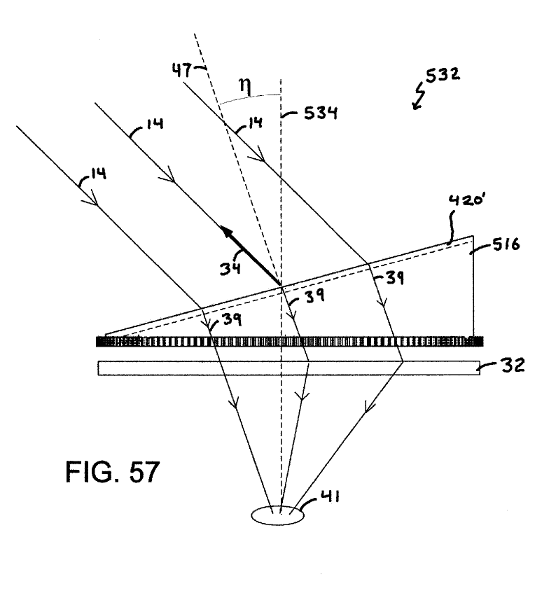

Attention is now directed to FIG. 57, which is a diagrammatic elevational view illustrating a concentrator 532 including tilted bender assembly 516 and IOA 32. Tilted bender 420′ serves as input optical arrangement defining an input aperture having an input area and an input axis 47 that is approximately orthogonal to the input area, and the tilted bender is configured for receiving incoming rays of light 14 and bending the received rays for acceptance by IOA 32. The IOA, in a series relationship following the tilted bender assembly, defines an output axis 534 and is configured for accepting the rays of light from the bender and for focusing and concentrating the rays into focus region 41. The bender and the IOA are configured to cooperate with one another for defining (i) a focus region 41 having a surface area that is smaller than the input area and is located at an output position along the output axis offset from the additional optical arrangement and opposite the input optical arrangement such that the output axis passes through the focus region. As described previously with respect to a number of other BRIC embodiments, the bender and the IOA may cooperate with one another to define a receiving direction 34, defined as a vector that is characterized by a predetermined acute receiving angle with respect to axis 534 such that the input axis and the receiving direction define a plane, and which receiving direction extends in one fixed azimuthal direction outward from axis 534 and in the plane. The tilted bender assembly is supported for rotational alignment, as described previously with reference to FIGS. 56A and 56B. Furthermore, the IOA is supported for rotation, and the bender and the IOA are configured to cooperate with one another, for alignment of the receiving direction such that the input light rays are at least approximately antiparallel with receiving direction 34. In accordance with previous descriptions herein, the bender and the IOA are further configured to cooperate with one another to focus the plurality of input light rays to converge toward the output axis until reaching the focus region such that the input light is concentrated at the focus region.

While it is recognized, with respect to the subject embodiment of concentrator 532, that tilted bender assembly 516 may be supported for rotational motion that is at least approximately limited to precession of the bender around the output axis, Applicants appreciate that there is no requirement that the rotational motion be limited in this regard, as will be described immediately hereinafter.

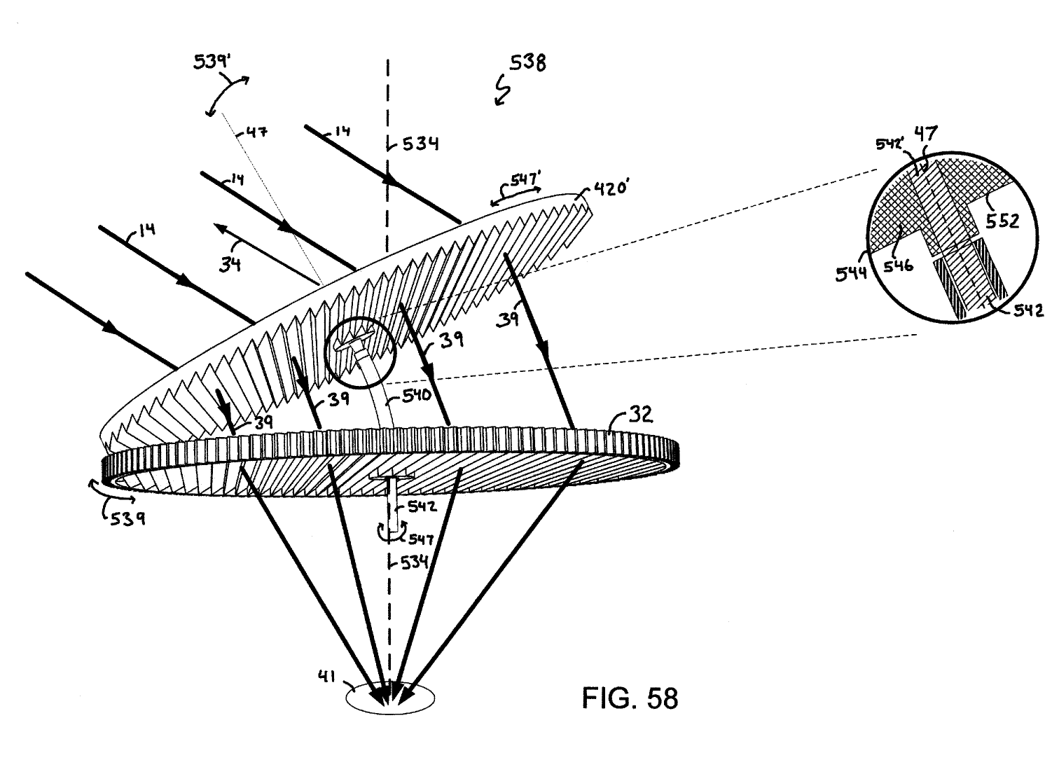

Attention is now turned to FIG. 58, which is a perspective view of another BRIC embodiment, generally indicated by reference number 538, having a tilted bender 420′ that is supported by a tube 540 such that input axis 47 of the bender is maintained in a fixed relationship, at tilt angle η, with respect to an output axis 534 of IOA 32. Tube 540 may be fixedly attached with IOA 32, and may be sufficiently stiff for at least approximately maintaining this fixed angle between the input axis and the output axis to support the bender such that the bender and the IOA co-rotate, with one another, about output axis 534. In one non-limiting embodiment, a drive mechanism (not shown) may be employed to rotate the IOA, in a clockwise or counterclockwise manner as indicated by arrow 539, and tube 540 may co-rotate therewith to cause the bender (and its input axis 47) to correspondingly precess in a rotational motion about output axis 534, as indicated by arrow 539′. While tilted bender assembly 420 of FIG. 58 is supported for rotational motion as precession 539′ around the output axis, it is noted that rotational motion of the bender, for the embodiment at hand, is not limited in this regard, and the bender may also be rotated about axis 47 as will be described immediately hereinafter.

In one embodiment, tube 540 may be hollow, and a cable 542 may be coaxially inserted through tube 540 and configured for transmitting rotational torque therethrough for rotating bender 420′ about input axis 47. FIG. 58 includes a detailed view 544 illustrating one embodiment of a connection between cable 542 and a flange 546 that is fixedly attached to with bender 420. The cable and the tube may be configured to cooperate with one another such that a clockwise or counterclockwise twisting motion of the cable, indicated by arrow 547, may be produced by an external cable drive mechanism (not shown) to cause a corresponding clockwise or counterclockwise rotation of the bender about input axis 47, as indicated by an arrow 547′.

It is noted that rotational motions 539′ and 547′ may be controlled independently from one another such that one rotation or the other can be provided without necessarily influencing the other. For example, IOA 32 may be rotated while cable 542 is rotationally constrained by its associated cable drive mechanism (not shown) such that the cable does not co-rotate with the IOA. As described above, tube 540 may be expected to co-rotate with the IOA causing the bender (and its input axis 47) to correspondingly precess in a rotational motion about output axis 534, as indicated by arrow 539′. While the rotational motion associated with precession 539′ may not cause the bender to azimuthally rotate about input axis 47, it is to be appreciated that this rotational motion of the bender causes a corresponding rotational alignment of acceptance direction 34 in accordance with the teachings that have been brought to light throughout this disclosure as a whole.

It is noted that that an end portion 542′ of the cable may aligned to be at least approximately parallel with input axis 47, as indicated by a dashed line in detail 544 of FIG. 58, such that any rotation of the cable causes the aforedescribed rotation 547′ while substantially avoiding any corresponding reorientation and/or rotational motion of the input axis. While this may be a desirable feature, at least for various BRIC embodiments, Applicants appreciate that there is no requirement in this regard, as will be described immediately hereinafter.

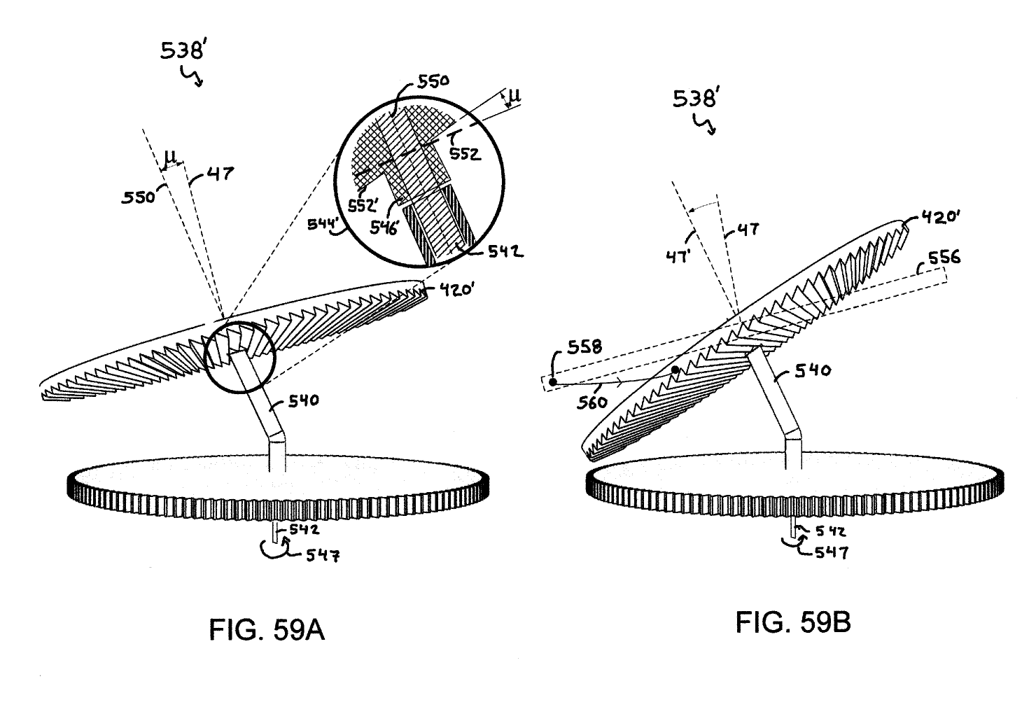

Attention is now turned to FIG. 59A, which is a perspective view of a modified BRIC, generally indicated by the reference number 538′, that may be produced by modifying BRIC 538 such that end portion 542′ of the cable is tilted by angle μ, relative to input axis 47. In one non-limiting embodiment, this modification could be achieved by replacing flange 546 with a modified flange 546′ that receives cable 542 at angle μ as compared to the unmodified flange, as indicated in detailed view 544′ of FIG. 59A, wherein a major surface 552′ (FIG. 59B) is indicated as being tilted with respect to corresponding major surface 552 of the unmodified bender (illustrated in FIG. 58A and indicated in detail 544′ of FIG. 59A using a dotted line).

FIG. 59B, is included for purposes of completeness, depicts a change in position due to simultaneous tilting and rotating actions caused by a rotation 546 of the cable. Dashed lines 556 indicate a phantom position of the bender before rotation 546, and solid lines illustrate bender 420′ after the rotation, and a curve 560 indicates the motion of a given location 558 on the outer perimeter of the bender.

### Dual-Tracking Concentrators

As described previously with reference primary to FIG. 16A, a conventional solar panel may be supported by a conventional single axis tracker, such as an external tracking arrangement, that is configured for tracking the sun by pointing the conventional solar panel towards the sun, for example by moveably tilting the panel about an axis of rotation for tracking daily east-west motion of the sun during a typical day.

However, as described previously with primary reference to FIGS. 17A, 17B and 17C and as summarized herein, a conventional linear concentrator configured for pointing any given solar panel, conventional or otherwise, for tracking daily east-west motion of the sun, may be substantially unable to track north-south seasonal variations in the position of the sun. Furthermore, mechanical accuracy of the external tracking arrangement may be sufficiently limited to cause a degree of tracking error, causing misalignment between incoming rays of sunlight and a preferred input orientation for the given solar panel, resulting in corresponding loss of light at least during those times of the day. On the other hand, as described previously, benders and/or IOAs may be incorporated in the panel in order to provide one or both of (i) tracking seasonal north-south variation of the sun and (ii) tracking the sun in an accurate way such that the external tracker is not required to provide accurate alignment.

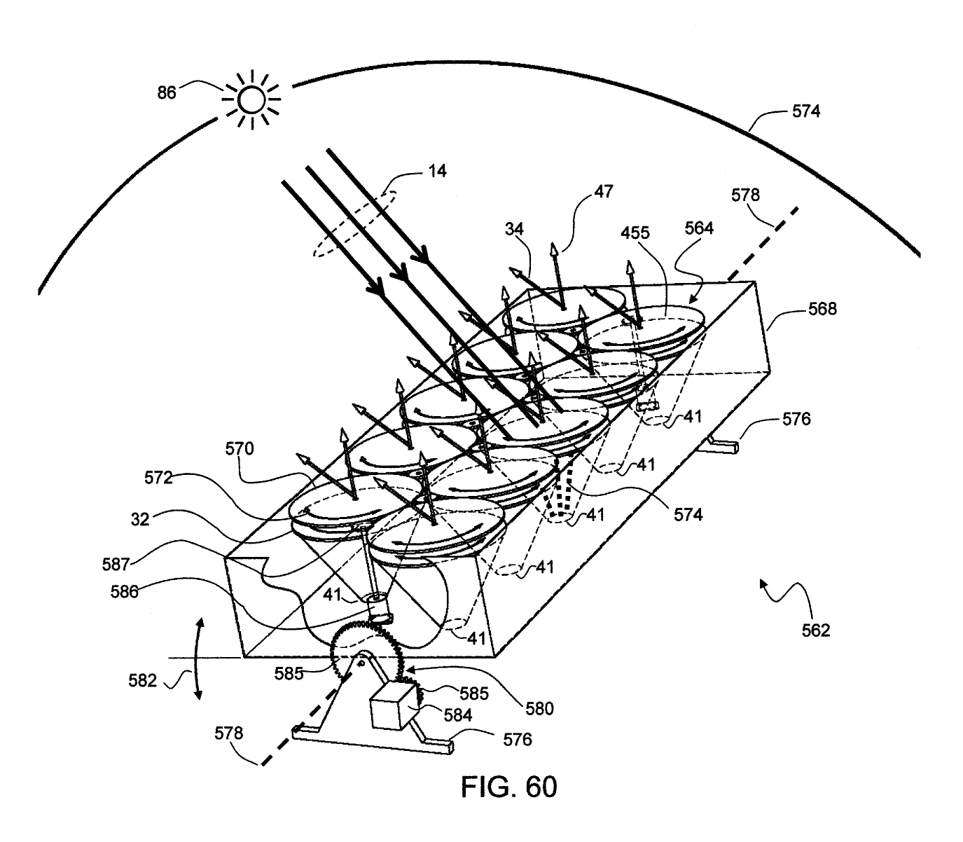

Attention is now directed to FIG. 60, which is a diagrammatic partially cutaway perspective view of one embodiment of a dual-tracking solar collector. Dual-tracking solar collector 562 includes a group of solar concentrators 564 (one of which is individually designated) each of which concentrators is configured to define (i) an input aperture 455 (one of which is individually designated), having an input area, and (ii) a focus region 41 that is smaller than the input area, and all of the solar concentrators are supported by a support structure 568 that is movable to face the input aperture of each concentrator in a skyward direction such that each input aperture receives incoming rays of sunlight 14. Each concentrator includes an input optical arrangement 570 (one of which is individually designated) having a rotatably adjustable orientation with respect to the support structure, as indicated by arrows 572 (one of which is individually designated). Each concentrator is configured to redirect the received light, responsive to the orientation of the optical arrangement, at least for concentrating the received sunlight, to produce concentrated rays of sunlight 574 that are focused into focus region 41 of each concentrator. While the input rays of sunlight 14, and the concentrated rays of sunlight 574 are illustrated in FIG. 59 only with respect to a selected one of the solar collectors, it is to be understood that the descriptions herein are equally applicable with respect to each of the concentrators. With respect to the embodiment at hand, each concentrator 564 may be a BRIC, having a bender serving as input arrangement 570, followed by an IOA 32. However, the descriptions herein are in no way intended to be limiting, and are to be considered as being at least generally applicable with respect to various concentrators that utilize an input arrangement for tracking the sun in accordance with the teachings throughout this overall disclosure.

An internal tracking arrangement 586 may be supported by the support structure and in mechanical communication with each optical arrangement 570, for example using a gear 587, and the internal tracking arrangement may be configured for rotating the input arrangements, as at least part of tracking the sun, throughout a typical year, as the sun moves through a predetermined range 574 of positions, by adjusting the orientation of each optical arrangement. Each solar concentrator may include an input axis of rotation 47 (one of which is individually designated) that extends through the aperture in the skyward direction and the input optical arrangement may be supported for rotation about the input axis such that the rotation serves as the adjustable orientation for producing the additional tracking using no more than the rotation of the optical arrangement around the input axis, such that the rotation does not change the skyward orientation of the aperture.

The support structure may be supported by fixed support 576 and positioned with respect to a given location above the Earth's surface, such that the fixed supports and support structure are cooperatively configured to define a fixed axis of rotation 578 having a fixed orientation with respect to the location. An external tracking arrangement 580 may be arranged in mechanical communication with fixed support structure 576 and configured to provide additional tracking of the sun, on the given day, by pivoting support structure 576 about fixed axis 578 for causing the external tracking, as indicated by arrow 582, to tilt all of the input apertures towards the sun. In one non-limiting embodiment, the external tracking arrangement may include a motor 584 and a system of gears 585 configured according to well known techniques, for tiltably moving support structure 568.

It is noted that the dual-tracking collector illustrated in FIG. 60 may be utilized for enhancing daily and/or yearly harvest of solar concentrators 564, as compared with a solar collector that is positioned in a fixed skyward orientation throughout each day, for example, at least by utilizing the external tracking arrangement for tilting the input arrangements toward the sun such that (i) the amount of sunlight incident on each aperture is increased, at least for a portion of each day (for example early morning or late afternoon), compared to an amount that would otherwise be incident thereon, and (ii) shading losses may be reduced, at least during the early morning and/or late afternoon portions of each day. Applicants appreciated that it may be unnecessary to control this external tracking to high precision, such that the dual tracking collector may be configured to rely primarily on the internal tracking mechanism as a way to provide accurate tracking while the external tracker provides coarse tracking. That is, it may be sufficient for the external tracker to operate with a comparatively low degree of precision. In this regard, it can be appreciated that the additional tracking provided by the external tracker can be utilized for improving collection efficiency, at least as compared with collectors having no additional tracking, even while the input apertures may, at times, be somewhat misaligned with respect to the input rays of light, as illustrated in FIG. 60, where input axes 47 are illustrated as being skewed with respect to input rays 14, and acceptance directions 34 (one of which is individually designated) are oriented approximately anti parallel with the input rays. It is noted that FIG. 60 is intended for illustrative purposes, and the illustrated misalignment, between input axis 47 and acceptance direction 34, is highly exaggerated in the figure for purposes of illustrative clarity.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A concentrating optical element, for receiving and concentrating a plurality of input light rays that are each oriented at least approximately parallel with one another, said concentrating optical element, comprising:
a first single-axis focusing arrangement at least generally defining (i) a first plane having an input area, (ii) a first reference direction within said first plane, and (iii) a first orthogonal reference direction within said first plane and perpendicular to said first reference direction, and said first arrangement is configured to accept the plurality of input light rays in said parallel orientations and to redirect at least a majority of the light rays in a way that causes the majority of the light rays to converge towards one another along the first reference direction substantially without converging the light rays along the first orthogonal reference direction; and
a second single-axis focusing arrangement at least generally defining (i) a second plane, (ii) a second reference direction within said second plane, and (iii) a second orthogonal reference direction within said second plane and perpendicular to said second reference direction, and said second optical arrangement is aligned in a series relationship following said first arrangement and is configured for receiving said majority of light rays from said first arrangement and for further redirecting said majority of light rays in a way that causes the majority of light rays to converge toward one another along said second reference direction substantially without causing convergence of the light rays along said second orthogonal direction and without substantially influencing said convergence of said light rays along said first reference direction,
wherein said second reference direction is azimuthally offset with respect to said first reference direction by a particular azimuthal angle such that the convergence along the first reference direction and the convergence along the second reference direction cooperatively cause said majority of light rays to concentrate within a focus region having an area that is smaller than said input area.

2. The concentrating optical element of claim 1 wherein said particular azimuthal angle is at least approximately ninety degrees.

3. The concentrating optical element of claim 1 wherein said first single axis focusing arrangement is integrally formed of an optical material and includes a plurality of optical prisms that are parallel with one another in adjacent side-by-side relationships such that said prisms cooperatively define said first plane.

4. The concentrating optical element of claim 3 wherein at least a majority of said prisms are each configured for bending said input rays of light in said first reference direction.

5. The concentrating optical element of claim 4 wherein said majority of said prisms each extend in a lengthwise direction along said first orthogonal reference direction.

6. The concentrating optical element of claim 1, configured as an inverted off-axis optical element wherein said first arrangement and said second arrangement are positioned in said series relationship along an axis of rotation that is at least approximately centered with respect to said first and second arrangements, and said first and second arrangements are cooperatively configured to accept said input rays of light oriented in an acceptance direction characterized by (i) a fixed orientation with respect to said first reference direction and (ii) a fixed acute angle with respect to said central axis, and at least a selected one of said first and second arrangements is configured to bend said light, along a corresponding one of said first and second reference directions, such that said focus region is centered on the central axis.

7. A concentrating optical element defining a receiving surface and configured for receiving a plurality of input rays of light that are parallel with one another and incident on said receiving surface with a specific input orientation with respect to said concentrating element, and for concentrating said input rays of light into a focus region that is smaller than a surface area of said receiving surface such that any given transverse extent across said focus region is substantially smaller than a corresponding transverse extent across said receiving surface, said concentrating optical element comprising:
a plurality of sub-elements transversely distributed in side-by-side relationships with one another to cooperatively define said receiving surface having a surface area such that each sub-element (i) defines one of a plurality of segments of said surface area that is aligned for receiving a corresponding subset of said plurality of input rays of light that is incident on said segment, and (ii) is configured for transmissively redirecting the corresponding subset of light rays toward said focus region such that said plurality of sub-elements cooperate with one another to cause said concentrating of said input rays into said focus region,
wherein for any selected one of said sub-elements that is associated with a selected segment, individual ones of said rays in the corresponding subset impinge on different positions from one another on the selected segment of surface area to redirect all the rays in the corresponding subset in a predetermined orientation with respect to said input orientation, and the selected sub-element is further configured to redirect all the rays in the subset in the same way such that (i) the predetermined orientation is the same for all of said rays in the corresponding subset, and (ii) the predetermined orientation is independent of said different positions.

8. The concentrating optical element of claim 7 wherein each sub-element defines a corresponding interface, between a first optical medium having a first index of refraction and a second optical medium having a second index of refraction that is different from said first index of refraction, and for any selected one of said sub-elements the corresponding interface is aligned such that all rays in the corresponding subset pass transmissively through that interface from said first optical medium to said second optical medium, and that interface is configured to cause said redirecting, by optical refraction, based at least in part on the difference between the first index of refraction and the second index of refraction.

9. The concentrating optical element of claim 8 wherein said first optical medium is one of an optical material and a gas, and the second optical medium is the other one of said optical material and said gas.

10. The concentrating optical element of claim 8 wherein each interface is at least substantially flat and each interface is tilted with a particular orientation with respect to said concentrating element, such that said redirecting, by optical refraction, is based at in part on the particular orientation of the interface.

11. The concentrating optical element of claim 7, configured to serve as an inverted off-axis optical element wherein said plurality of subsections cooperatively define a central axis that passes through a central region of said receiving surface, and
said plurality of subsections is cooperatively configured to accept said input rays of light oriented in an acceptance direction characterized by (i) a fixed acute angle with respect to said central axis, and (ii) a fixed azimuthal orientation with respect to said off-axis optical element, and to bend at least some of said rays of light, as at least part of said redirecting, for centering said focus region such that said central axis passes through said focus region.

12. An optical concentrator assembly having an optical axis and configured for receiving and concentrating a plurality of incoming rays of light that are at least approximately parallel with one another and that are oriented at an acute angle with respect to said optical axis, said optical concentrator assembly comprising:
a bender defining an input aperture for receiving said incoming rays and supported for selective rotation about said optical axis over a range of rotational orientations, and said bender is configured for redirecting said incoming rays of light, in a way that depends on a selected rotational orientation of the bender, to produce a plurality of intermediate rays of light; and
a single-axis focusing arrangement in a series relationship following said bender and aligned for receiving at least a subset of said plurality of intermediate rays of light, and said single-axis focusing arrangement is characterized at least in part by first and second reference directions that are both at least approximately transverse to said optical axis and perpendicular to one another, and said single-axis focusing arrangement is configured such that any received intermediate light rays that are oriented orthogonally to said first reference direction are redirected for focusing with respect to said first reference direction, without being focused with respect to said second reference direction, such that the light is concentrated onto an elongated focus region that is at least generally oriented along a line of focus that is at least approximately parallel with said second reference direction,
wherein for at least one selected rotational orientation of said bender, said bender redirects said input light such that at least a majority of said intermediate rays are aligned in said orthogonal orientation for focusing by the single-axis focusing arrangement.

13. The optical concentrator of 12 wherein said single-axis focusing arrangement is a reflective optical element that includes at least one reflective surface that is aligned for said receiving of said intermediate light rays and, said reflective surface is configured for reflecting said light, as said redirecting, to provide said focusing.

14. A solar collector including an array of two or more of the optical concentrators of claim 12, and each of said concentrators is in a fixed position in said array and each concentrator is positionable to face the input aperture in a skyward direction such that each aperture is oriented for initially receiving sunlight from the sun as said incoming rays of light, and for producing said focusing of the received sunlight into said elongated focus region of each concentrator.

15. The Solar collector of claim 14 wherein all of said concentrators are arranged in a row and aligned with one another such that the second reference direction of all of the focusing arrangements are approximately aligned along a single axis such that all of the lines of focus of said concentrators are aligned with one another to form a combined elongated focus region that is oriented along one combined line of focus that is at least approximately parallel with said single axis, and the elongated focus region of each concentrator serves as a corresponding portion of said combined elongated focus region.

16. The solar collector of claim 15 wherein all of the single-axis focusing arrangements of said concentrators are integrally formed with one another as one combined focusing arrangement that is shared by all concentrators in said array such that said single axis serves as the second reference direction of the one combined focusing arrangement, and the combined focusing arrangement receives the intermediate rays of light from each of said benders for focusing into the corresponding portion of said combined elongated focus region.

17. An inverted off-axis lens, comprising:
an optical arrangement having an at least generally planar configuration defining (i) an input surface having an input surface area and (ii) an optical axis that is at least generally perpendicular thereto, and
said optical arrangement is configured for
defining an acceptance direction as a vector that is characterized by a predetermined acute acceptance angle with respect to said optical axis such that the optical axis and the acceptance direction define a plane, and which acceptance direction extends in one fixed azimuthal direction outward from the optical axis in said plane such that the optical arrangement is rotatable about the axis for alignment of the acceptance direction, and
receiving a plurality of input rays of light that are parallel with one another, at least to within an approximation, and oriented with an acute input angle with respect to said optical axis,
and said optical arrangement is supported for rotation about said optical axis and is further configured for operation in one of a first mode and a second mode, such that a selected one of said modes of operation is based at least in part on said acute input angle,
wherein, in said first mode, said acute input angle matches the acute acceptance angle of the acceptance direction, and said optical arrangement is rotatably aligned to accept the plurality of parallel light rays such that said rays are each at least approximately antiparallel with said vector, and said optical arrangement transmissively passes the plurality of input light rays therethrough while focusing the plurality of input light rays to converge toward one another until reaching an on-axis focus region that is smaller than the input surface and is at least approximately centered on said axis, and
in said second mode, the input rays of light are sufficiently misaligned with respect to the acceptance direction such that said optical arrangement focuses the plurality of light rays to converge toward one another until reaching an off-axis focus region that is smaller than the input surface area and is spaced apart from said optical axis in an azimuthal direction that depends on the rotational alignment of said optical arrangement such that said off-axis focus region is movable, by rotational of said optical arrangement, along an arcuate path having a shape that is depends at least in part on said input angle.

18. An optical concentrator for tracking motion of the sun through a predetermined range of positions, said solar concentrator comprising:
the inverted off-axis lens of claim of 17 arranged such that the input surface thereof is positionable to face in a skyward direction and is oriented to receive sunlight, as said plurality of input rays of light, and for said predetermined range of positions of the sun, the lens is operable in said second mode, to focus said sunlight, such that said rotation of said optical arrangement causes said off-axis focus region to move along said arcuate path; and
an elongated receiver in a series relationship following said inverted off-axis lens, said elongated receiver having a receiving surface with a width and an extended length that is substantially longer than said width, and said receiving surface is cooperatively aligned with said inverted off axis lens such that for any selected position of the sun in said range of positions, said arcuate path overlaps a corresponding portion of said receiving surface so that the focus region is movable along said arcuate path, responsive to said rotational alignment, for tracking the sun by positioning the focus region to overlap the corresponding portion of the receiving surface.

19. An optical concentrator, for receiving and concentrating a plurality of input rays of light that are parallel with one another, said optical concentrator comprising:
an at least generally planar input optical arrangement defining an input aperture having an input area and an input axis that is approximately orthogonal with said planar input area, and said input optical arrangement is configured for receiving and redirecting said rays of light; and
an additional optical arrangement, in a series relationship following said input optical arrangement, defining an output axis and configured for accepting the rays of light from said input arrangement and for further redirecting said rays of light, and
said input optical arrangement and said additional optical arrangement are configured to cooperate with one another for defining (i) a focus region having a surface area that is smaller than the input area and is located at an output position along said output axis offset from the additional optical arrangement and opposite the input optical arrangement such that said output axis passes through said focus region, and (ii) a receiving direction defined as a vector that is characterized by a predetermined acute receiving angle with respect to said input axis such that the input axis and the receiving direction define a plane, and which receiving direction extends in one fixed azimuthal direction outward from said input axis and in said plane such that at least the input arrangement is supported at least for rotation to align the receiving direction to receive said input light rays that each are at least approximately antiparallel with said vector and said input optical arrangement and said additional optical arrangement are configured to cooperate with one another to focus the plurality of input light rays to converge toward said output axis until reaching said focus region such that the input light is concentrated at the focus region,
wherein said input arrangement is tilted with respect to said additional arrangement such that the input axis is tilted by an acute tilt angle with respect to said output axis, and said rotation of said input arrangement, for said rotational alignment of said receiving direction, includes at least one of (i) azimuthal rotation of said input arrangement about said input axis and (ii) precession of said input arrangement about said output axis.

20. The optical concentrator of claim 19 wherein for at least one orientation of said input rays of light said receiving and said redirecting of said input light rays cooperatively causes a particular loss of light through said input arrangement that is less than a different loss that would otherwise be presented without the tilt in the input arrangement.

21. The optical concentrator of claim 19 including a rotation arrangement which supports the input arrangement for motion that is limited to said precession of said input arrangement about said output axis and does not include rotation of said input arrangement about said input axis.

22. The optical concentrator of claim 19 including a rotation arrangement which supports the input arrangement for motion that is limited to said rotation about said input axis and does not include precession of said input arrangement about said output axis.

23. The optical concentrator of claim 19 wherein said input arrangement is configured for bending the received rays of light, as said redirecting, to produce bent rays of light for said acceptance by said additional arrangement.

24. The optical concentrator of claim 23 wherein said additional arrangement is an IOA configured to accept the bent light rays of light from the input arrangement, and the IOA is configured to cause said focusing.

25. The optical concentrator of claim 24 wherein said IOA is supported for selective rotation about said output axis, and said input arrangement and said IOA are configured to cooperate with one another in performing said receiving and said focusing based at least in part on (i) said rotation of said input arrangement and (ii) said rotation of said IOA.

26. The optical concentrator of claim 25, further comprising
a first rotation arrangement that supports the input arrangement to match said precession of said input arrangement with said selective rotation of said IOA such that the input arrangement and the IOA co-rotate about said output axis; and
a second rotation arrangement configured to rotate said input arrangement about said input axis such that any rotation of said input arrangement relative to said IOA is limited to said rotation about said input axis.

27. A dual-tracking solar collector for tracking the sun throughout a portion of a given year, said collector comprising:
a group of solar concentrators, each of which concentrators is configured to define (i) an input aperture having an input area, and (ii) a focus region that is smaller than said input area, and all of said solar concentrators are supported by a support structure that is movable to face the input aperture of each concentrator in a skyward direction such that each input aperture receives sunlight, and each concentrator includes at least one optical arrangement having an adjustable orientation with respect to said support structure and each concentrator is configured to redirect the received light, responsive to said orientation of said optical arrangement, at least for concentrating the received sunlight to produce concentrated sunlight that is focused into the focus region of each concentrator;
an internal tracking arrangement supported by said support structure and in mechanical communication with each optical arrangement, and said internal tracking arrangement is configured for tracking of the sun, during said portion of said given year as the sun moves through a predetermined range of positions, by adjusting said orientation of each optical arrangement, and each solar concentrator includes an input axis of rotation that extends through said aperture in said skyward direction and the optical arrangement is supported for rotation about said input axis such that said rotation serves as said adjustable orientation for producing said tracking using no more than said rotation of the optical arrangement around the input axis such that said rotation does not change the skyward orientation of the aperture;
an external tracking arrangement in mechanical communication with said support structure, and said external tracking arrangement is configured to cause additional tracking of the sun by moving said support structure for simultaneously tilting all of the input apertures towards the sun during said portion of said given year as the sun moves through a predetermined range of positions, to influence said redirecting of said sunlight such that a total amount of collected sunlight is concentrated into each focus region, as an accumulation of all of said concentrated sunlight throughout said portion of said given day, and said total amount of collected sunlight is greater than a different amount sunlight that would be otherwise be collected without said additional tracking.

28. A solar collector comprising:
a solar concentrator supported by a support structure such that said concentrator is in a fixed position with a fixed alignment with respect to said support structure and said concentrator is configured to define (i) an input aperture having an input area such that the support structure is positionable to face the input aperture of the concentrator in a skyward direction so that the input aperture is oriented to receive sunlight from the sun, (ii) an input axis of rotation extending through the input aperture in said skyward direction, and (iii) a focus region that is substantially smaller than said aperture area, and the concentrator includes an optical assembly having at least one optical arrangement that is supported for rotation about said input axis for tracking the sun within a predetermined range of positions of said sun using no more than said rotation of the optical arrangement around the input axis such that said rotation does not change the direction of the aperture from said skyward direction,
wherein for any specific one of said positions within said predetermined range of positions, said optical arrangement is orientable, as at least part of said tracking, at a corresponding rotational orientation as at least part of concentrating the received sunlight within said focus region, for subsequent collection and use as solar energy.

29. The solar collector of claim 28 wherein said optical arrangement serves as an input arrangement for initially receiving the sunlight, and said optical assembly includes an additional optical arrangement following said input arrangement to accept the sunlight from the input arrangement, and said input arrangement and said additional arrangement are configured to cooperate in performing said tracking based at least in part on said rotation of said input arrangement about said input axis of rotation.

30. The solar collector of claim 29 wherein said input arrangement is integrally formed of an optical material, and said input arrangement is configured to bend said received rays of light for said acceptance by said additional optical arrangement.

31. The solar collector of claim 30 wherein said input arrangement includes a plurality of optical prisms that cooperatively define (i) an at least generally planar input surface for said receiving of said input rays of light, (ii) a first reference direction lying at least approximately in said planar input surface, and (iii) a second reference direction that lies at least approximately in said planar input surface and is at least approximately orthogonal with said first reference direction, and wherein said plurality of prisms is configured to cooperate to cause said bending of said light rays substantially in said first reference direction, substantially without causing bending in said second reference direction.

32. The solar collector of claim 31 wherein each of said prisms receives and redirects a corresponding subset of the received light rays such that at least some of the light rays of the corresponding subset serve as a collected portion of the corresponding subset of light for acceptance by the additional arrangement.

33. The solar collector of claim 32 wherein said optical material has a first index of refraction and each of said prisms of said input arrangement defines an interface between said optical material and an optical medium having a second index of refraction that is different from said first index of refraction, and for any selected one of said prisms the corresponding interface is aligned for bending, as at least part of said redirecting, at least the collected portion of the corresponding subset of the light rays, responsive to the difference between the first index of refraction and the second index of refraction, for said acceptance by said additional arrangement.

34. The solar collector of claim 33 wherein for any selected one of said prisms the corresponding interface extends lengthwise along said second reference direction and is width-wise tilted at a first acute tilt angle with respect to said input axis such that said input axis serves as one side of said first acute tilt angle and said interface defines another side of said first acute angle, and said bending depends in part on said first acute tilt angle.

35. The solar collector of claim 34 wherein said corresponding interface serves as a first interface having a first width, and the selected one of said prisms further defines a second interface between said first optical medium and said second optical medium, that is tilted at a second acute angle with respect to said input axis such that the first interface and the second interface intersect to form an edge that extends in said second reference direction, and the first acute angle and the second acute angle are aligned to cooperate as adjacent angles such that said input axis also serves as one side of said second acute tilt angle, and said first and second acute tilt angles share a vertex that is at least approximately aligned along said edge such that said vertex points at least generally towards said second optical arrangement, and said second interface has a second width that is smaller as compared to said first width.

36. The solar collector of claim 35 configured for providing said tracking, at least for a number of days in a year, in different modes including a first mode and a second mode, corresponding to first and second non-overlapping portions, respectively, of each one of said number of days, and
for each one of said number of days said solar collector operates for a first period of time in said first mode and said solar collector operates for a second period of time in said second mode, and
said solar collector is further configured to transition from one of said first and second modes to the other one of said first and second modes at a particular time of transition in that day based at least in part on the position of the sun at that time, and
in said first mode, said input arrangement and said additional arrangement are configured to cooperate to provide said tracking, throughout said first portion of each given day, such that for each of said prisms, said collected portion of said corresponding subset of light rays, incident on said first interface, includes at least a majority of said subset of light rays, and no rays in the subset are directly incident on said second interface, and
in said second mode, said input arrangement and said additional arrangement are configured to cooperate to provide said tracking, throughout the second portion of each day, such that for each of said prisms, a diverted portion of the received light rays is incident on a section of the first interface of that prism, and at least for any prisms that lie between two adjacent prisms, said diverted portion of the light is bent, as part of said redirecting, to impinge on a particular one of said adjacent prisms such that the diverted portion is further redirected, by the particular adjacent prism, and is not accepted by said additional arrangement.

37. The solar collector of claim 36 wherein for each of said prisms said second angle is greater than or equal to four degrees, and for each respective one of said number of days, said time of said transition is shifted as compared to a different time of transition that would otherwise occur by having the second angle of less than four degrees.

38. The solar collector of claim 37 wherein throughout said year the solar collector collects an annual harvest of light for that year as a sum of all sunlight received, concentrated, and collected for use as solar energy, and
said solar collector is configured to cause said shift of said time of transition, for each of said number of days, to extend the first period of time of said first mode to at least contribute to increasing the annual harvest as compared to a different annual harvest that would otherwise be collected throughout said year by having the second angle of less than four degrees.

39. The solar collector of claim 38 wherein at least for each one of said number of days said solar collector is configured to operate in said second mode during a morning portion of that day and to subsequently transition to said first mode at a first time of transition for that day, and
said solar collector is configured to operate in said first mode during an afternoon portion of that day and to subsequently transition to said second mode, at a second time of transition for that day, and
such that said shift causes said first time of transition to occur earlier, and said second time of transition to occur later than would otherwise occur by having the second angle of less than four degrees.

40. The solar collector of claim 39 further configured for providing said tracking by operating in an additional mode during an additional non-overlapping portion of each one of a subset of said number of days such that said additional portion begins after said first time of transition and ends before said second time of transition, and
in said additional mode, said input arrangement and said additional arrangement cooperatively provide said tracking, throughout said additional portion of each given day, such that for each prism, a rejected portion of said corresponding subset is incident on the second interface of that prism, and said rejected portion is bent differently from said received portion, as part of said redirecting, such that the rejected portion is not accepted by said additional arrangement and therefore does not contribute to said annual harvest,
and said shifting of said first and second times of transition compensates for said rejection such that said annual harvest remains higher, despite said rejection, as compared to the different annual harvest that would otherwise be collected throughout said year by said different solar collector having the bender with the smaller second angle.

41. A method for receiving and concentrating a plurality of input light rays that are each oriented at least approximately parallel with one another, said method comprising:
configuring a first single-axis focusing arrangement, for at least generally defining (i) a first plane having an input area, (ii) a first reference direction within said first plane, and (iii) a first orthogonal reference direction within said first plane and perpendicular to said first reference direction, and for accepting the plurality of input light rays for redirecting at least a majority of the light rays in a way that causes the majority of the light rays to converge towards one another along the first reference direction substantially without converging the light rays along the first orthogonal reference direction;
configuring a second single-axis focusing arrangement at least generally defining (i) a second plane, (ii) a second reference direction within said second plane, and (iii) a second orthogonal reference direction within said second plane and perpendicular to said second reference direction;
aligning the second single-axis focusing arrangement in a series relationship following said first arrangement for receiving said majority of light rays from said first arrangement and for further redirecting said majority of light rays in a way that causes the majority of light rays to converge toward one another along said second reference direction substantially without causing convergence of the light rays along said second orthogonal direction and without substantially influencing said convergence of said light rays along said first reference direction; and
offsetting said second reference direction azimuthally with respect to said first reference direction by a particular azimuthal angle such that the convergence along the first reference direction and the convergence along the second reference direction cooperatively cause said majority of light rays to concentrate within a focus region having an area that is smaller than said input area.

42. A method for producing a concentrating optical element defining a receiving surface and configured for receiving a plurality of input rays of light that are parallel with one another and incident on said receiving surface with a specific input orientation with respect to said concentrating element, and concentrating said input rays of light into a focus region that is smaller than a surface area of said receiving surface such that any given transverse extent across said focus region is substantially smaller than a corresponding transverse extent across said receiving surface, said method comprising:
distributing a plurality of sub-elements transversely in side-by-side relationships with one another for cooperatively defining said receiving surface having a surface area such that each sub-element (i) defines one of a plurality of segments of said surface area that is aligned for receiving a corresponding subset of said plurality of input rays of light that is incident on said segment, and (ii) is configured for transmissively redirecting the corresponding subset of light rays toward said focus region such that said plurality of sub-elements cooperate with one another to cause said concentrating of said input rays into said focus region;
configuring said plurality of sub-elements such that for any selected one of said sub-elements that is associated with a selected segment, individual ones of said rays in the corresponding subset impinge on different positions from one another on the selected segment of surface area to redirect all the rays in the corresponding subset in a predetermined orientation with respect to said input orientation, and the selected sub-element is further configured to redirect all the rays in the subset in the same way such that (i) the predetermined orientation is the same for all of said rays in the corresponding subset, and (ii) the predetermined orientation is independent of said different positions.

43. A method for producing an optical concentrator assembly having an optical axis and configured for receiving and concentrating a plurality of incoming rays of light that are at least approximately parallel with one another and that are oriented at an acute angle with respect to said optical axis, and with a particular incoming azimuthal orientation with respect to said concentrator assembly, said method comprising:
providing a bender for defining an optical axis and an input aperture, and aligning the input aperture for receiving said incoming rays at an acute angle with respect to said optical axis, and with a particular incoming azimuthal orientation with respect to said bender;
supporting the bender for selective rotation about said optical axis over a range of rotational orientations, and configuring the bender for redirecting said incoming rays of light, in a way that depends on a selected rotational orientation of the bender, to produce a plurality of intermediate rays of light;
arranging a single-axis focusing arrangement, in a series relationship following said bender and aligning the single-axis focusing arrangement for receiving at least a subset of said plurality of intermediate rays of light; and
configuring said single-axis focusing arrangement for defining first and second reference directions that are both at least approximately transverse to said optical axis and perpendicular to one another such that any received intermediate light rays that are oriented orthogonally to said first reference direction are redirected for focusing with respect to said first reference direction, without being focused with respect to said second reference direction, for concentrating the light onto an elongated focus region that is at least generally oriented along a line of focus that is at least approximately parallel with said second reference direction, so that rotatably aligning the bender to a selected rotational orientation causes said bender to redirect said input light such that at least a majority of said intermediate rays are aligned in said orthogonal orientation for focusing by the single-axis focusing arrangement.

44. A method for producing an inverted off-axis lens, said method comprising:
configuring an optical arrangement having an at least generally planar configuration for defining:
an input surface having an input surface area and (ii) an optical axis that is at least generally perpendicular thereto,
an acceptance direction as a vector that is characterized by a predetermined acute acceptance angle with respect to said optical axis such that the optical axis and the acceptance direction define a plane, and which acceptance direction extends in one fixed azimuthal direction outward from the optical axis in said plane such that the optical arrangement is rotatable about the axis for alignment of the acceptance direction, and for receiving a plurality of input rays of light that are parallel with one another, at least to within an approximation, and oriented with an acute input angle with respect to said optical axis; and
supporting said optical arrangement for rotation about said optical axis for operation in one of a first mode and a second mode, such that a selected one of said modes of operation is based at least in part on said acute input angle,
wherein, in said first mode, said acute input angle matches the acute acceptance angle of the acceptance direction, and said optical arrangement is rotatably aligned to accept the plurality of parallel light rays such that said rays are each at least approximately antiparallel with said vector, and said optical arrangement transmissively passes the plurality of input light rays therethrough while focusing the plurality of input light rays to converge toward one another until reaching an on-axis focus region that is smaller than the input surface and is at least approximately centered on said axis, and
in said second mode, the input rays of light are sufficiently misaligned with respect to the acceptance direction such that said optical arrangement focuses the plurality of light rays to converge toward one another until reaching an off-axis focus region that is smaller than the input surface area and is spaced apart from said optical axis in an azimuthal direction that depends on the rotational alignment of said optical arrangement such that said off-axis focus region is movable, by rotational of said optical arrangement, along an arcuate path having a shape that is depends at least in part on said input angle.

45. A method for producing a dual-tracking solar collector for tracking the sun throughout a portion of a given year, said method comprising:
providing a group of solar concentrators, and configuring each of the concentrators to define (i) an input aperture having an input area, and (ii) a focus region that is smaller than said input area, and supporting all of said solar concentrators using a support structure that is movable to face the input aperture of each concentrator in a skyward direction such that each input aperture receives sunlight, and each concentrator includes at least one optical arrangement having an adjustable orientation with respect to said support structure and configuring each concentrator to redirect the received light, responsive to said orientation of said optical arrangement, at least for concentrating the received sunlight to produce concentrated sunlight that is focused into the focus region of each concentrator;
supporting an internal tracking arrangement using said support structure in mechanical communication with each optical arrangement, and configuring said internal tracking arrangement for tracking of the sun, during said portion of said given year as the sun moves through a predetermined range of positions, by adjusting said orientation of each optical arrangement;
configuring each solar concentrator to include an input axis of rotation that extends through said aperture when oriented in said skyward direction and supporting the optical arrangement for rotation about said input axis such that said rotation serves as said adjustable orientation for producing said tracking using no more than said rotation of the optical arrangement around the input axis such that said rotation does not change the skyward orientation of the aperture; and
coupling an external tracking arrangement in mechanical communication with said support structure, and configuring said external tracking arrangement to cause additional tracking of the sun by moving said support structure for simultaneously tilting all of the input apertures towards the sun during said portion of said given year as the sun moves through a predetermined range of positions, to influence said redirecting of said sunlight such that a total amount of collected sunlight is concentrated into each focus region, as an accumulation of all of said concentrated sunlight throughout said portion of said given day, and said total amount of collected sunlight is greater than a different amount sunlight that would be otherwise be collected without said additional tracking.

46. A method for producing a solar collector, said method comprising:
supporting a solar concentrator using a support structure such that said concentrator is in a fixed position with a fixed alignment with respect to said support structure;
configuring said concentrator to define (i) an input aperture having an input area such that the support structure is positionable to face the input aperture of the concentrator in a skyward direction so that the input aperture is oriented to receive sunlight from the sun, (ii) an input axis of rotation extending through the input aperture in said skyward direction, and (iii) a focus region that is substantially smaller than said aperture area; and
providing an optical assembly, as part of the concentrator, having at least one optical arrangement that is supported for rotation about said input axis for tracking the sun within a predetermined range of positions of the sun using no more than said rotation of the optical arrangement around the input axis such that said rotation does not change the direction of the aperture from said skyward direction,
wherein for any specific one of said positions within said predetermined range of positions, said optical arrangement is orientable, as at least part of said tracking, at a corresponding rotational orientation as at least part of concentrating the received sunlight within said focus region, for subsequent collection and use as solar energy.
